(19) United States
(12) Patent Application Publication
(10) Pub. No.: US 2010/0293194 A1
(43) Pub. Date: Nov. 18, 2010

(54) DISCRIMINATION BETWEEN MULTI-DIMENSIONAL MODELS USING DIFFERENCE DISTRIBUTIONS

(76) Inventors: Timothy L. Andersen, Boise, ID (US); Richard D. Newman, Meridian, ID (US)

Correspondence Address: PERKINS COIE LLP;Attn: Stephen E. Arnett, P.O. Box 1247, Seattle, WA, 98111-1247, US

(21) Appl. No.: 12/722,476

(22) Filed: Mar. 11, 2010

Related U.S. Application Data
(60) Provisional application No. 61/209,972, filed on Mar. 11, 2009.
(60) Provisional application No. 61/313,074, filed on Mar. 11, 2010.

(51) Int. Cl. G06F 17/30; G06F 17/18

(52) U.S. Cl. 707/772; 702/180; 707/E17.14

(57) ABSTRACT

Multi-dimensional models are discriminated, or distinguished, based on difference distribution histograms. One or more models having multiple attributes are received. Each model includes at least one non-spatial attribute, such as a physical, chemical, and/or dynamic attribute. A sampling function is selected and applied to the received models to generate difference distribution histograms that represent the models. Once multiple difference distribution histograms have been generated, two or more histograms are compared by applying a distribution test function to the histograms. Based on the comparison, the similarity of the models represented by the histograms may be determined.

### CROSS-REFERENCE TO RELATED APPLICATION(S)

This application claims priority to and incorporates by reference in its entirety U.S. Provisional Patent Application No. 61/209,972, entitled SYSTEMS AND METHODS FOR CELL-CENTRIC SIMULATION OF BIOLOGICAL EVENTS AND CELL-BASED MODELS PRODUCED THEREFROM, filed on Mar. 11, 2009; and U.S. Provisional Application No. 61/313,074, entitled DISCRIMINATION BETWEEN MULTI-DIMENSIONAL MODELS USING DIFFERENCE DISTRIBUTIONS, filed concurrently herewith (attorney docket no. 43332-8001.US06).

In addition, this application claims priority to and incorporates by reference in their entirety copending U.S. patent application Ser. No. 11/234,413, entitled METHOD, SYSTEM AND APPARATUS FOR VIRTUAL MODELING OF BIOLOGICAL TISSUE WITH ADAPTIVE EMERGENT FUNCTIONALITY, filed on Sep. 23, 2005; and copending U.S. patent application Ser. No. 12/554,870, entitled SYSTEMS AND METHODS FOR CELL-CENTRIC SIMULATION OF BIOLOGICAL EVENTS AND CELL-BASED MODELS PRODUCED THEREFROM, filed on Sep. 4, 2009.

### STATEMENT REGARDING FEDERALLY SPONSORED RESEARCH

The U.S. Government has a paid-up license in this invention and the right in limited circumstances to require the patent owner to license others on reasonable terms as provided for by the terms of Contracts DAMD17-02-2-0049 and W81XWH-08-2-0003 as awarded by the US Army Medical Research Acquisition Activity (USAMRAA).

### BACKGROUND

Shape-based retrieval of three-dimensional data (i.e., 3D shape searching) has become of great interest in a variety of research fields including computer vision, mechanical engineering, artifact searching, molecular biology, chemistry, and other fields. 3D shape searching techniques retrieve virtual objects from a database of 3D objects based on the integral similarity of the virtual objects.

Techniques for 3D shape searching include techniques based on global attributes, manufacturing attribute recognition, graphs, histograms, product information, and 3D object-recognition. Many of these techniques convert objects into attribute vectors or relational data structures, such as graphs or trees, in order to determine object similarity.

Histogram-based 3D shape searching techniques sample data points on a surface of a 3D object and extract characteristics from the sampled points. The extracted characteristics are organized in a histogram, or distribution, based on frequency of occurrence. A histogram is a graphical display of frequencies of occurrence. Histogram-based 3D shape searching techniques compare multiple objects by applying a distribution test function to the histograms that represent the objects.

Histogram-based 3D shape searching techniques include a shape distributions method. This method uses a shape function to sample the global geometric properties of a 3D object. These geometric properties are organized into a histogram, or shape distribution, based on frequency of occurrence. 3D shape searching techniques are described in additional detail in Osada, R. et al., Shape Distributions, 21 ACM Transactions on Graphics 807 (2002), which is incorporated herein by reference in its entirety. Among other benefits, the shape distributions method is a robust method for discriminating between objects despite the presence of arbitrary translations, rotations, scales, mirrors, and/or other scale or aspect differences.

While the shape distributions method is both simpler and more robust than many 3D shape searching techniques, different objects may have similar shape distributions. Moreover, 3D shape searching techniques, including the shape distributions method, do not measure object attributes other than shape. That is, these techniques measure spatial attributes only, and fail to capture non-spatial attributes, such as physical, chemical, and/or dynamic object attributes. As a result, 3D shape searching techniques cannot distinguish between similarly shaped objects having different non-spatial attributes.

Accordingly, techniques for distinguishing among objects that have similar shapes but different non-spatial attributes, such as physical, chemical, and/or dynamic attributes, are desired to better recognize objects, in addition to distinguishing among non-physical and/or non-object models. The techniques should apply to large data sets, while keeping computational costs feasible.

### BRIEF DESCRIPTION OF THE DRAWINGS

FIG. 1 is a block diagram of a computing system for implementing aspects of the technology described herein.

FIG. 2 is a block diagram of an environment in which aspects of the described technology may be implemented.

FIG. 3A is a flow diagram of a process for generating difference distribution histograms.

FIG. 3B is a flow diagram of a process for comparing difference distribution histograms.

FIG. 4 includes graphs of models having similar spatial attributes but different non-spatial attributes.

FIG. 5 includes histograms generated according to an HDCN sampling function to represent the models of FIG. 4.

FIGS. 6-9 include histograms generated according to an HDEN sampling function to represent the models of FIG. 4.

FIG. 10 includes histograms generated according to a MODD sampling function to represent the models of FIG. 4.

FIGS. 11-13 include sub-histograms generated according to the MODD sampling function to represent the models of FIG. 4.

FIG. 14 includes graphs of models having similar spatial attributes but different non-spatial attributes.

FIG. 15 includes histograms generated according to an HDCN sampling function to represent the models of FIG. 14.

FIGS. 16-19 include histograms generated according to an HDEN sampling function to represent the models of FIG. 14.

FIG. 20 includes histograms generated according to a MODD sampling function to represent the models of FIG. 14.

FIGS. 21-26 are graph diagrams depicting comparisons between multiple difference distribution histograms representing the models of FIG. 4.

FIGS. 27-41 are graph diagrams depicting comparisons between multiple difference distribution histograms representing the models of FIG. 14.

FIGS. 42-44 include difference score landscapes generated according to a MODD sampling function for the models of FIG. 4.

FIG. 45 includes difference score landscapes generated according to an HDCN sampling function for the models of FIG. 4.

FIGS. 46-49 include difference score landscapes generated according to an HDEN sampling function for the models of FIG. 4.

FIGS. 50-52 include difference score landscapes generated according to a MODD sampling function for the models of FIG. 14.

FIG. 53 includes difference score landscapes generated according to an HDCN sampling function for the models of FIG. 14.

FIGS. 54-57 include difference score landscapes generated according to an HDEN sampling function for the models of FIG. 14.

### DETAILED DESCRIPTION

Methods and systems for discriminating between multi-dimensional models using difference distributions are described herein. In some embodiments, the system receives one or more models for which difference distribution histograms are to be generated. A model is a virtual object, pattern, phenomenon, behavior, event, data set, or other entity having multiple attributes, including at least one non-spatial attribute. In some embodiments, a model has both spatial attributes and non-spatial attributes. Non-spatial attributes include physical, chemical, dynamic, and/or other attributes. Physical attributes include, for example, material, density, luminance, and color. Chemical attributes include, for example, molecule type, element, and charge. In addition, physical, chemical, and/or other non-spatial attributes may vary dynamically over time.

Once the models have been received, the system selects a sampling function to be applied to the received models. A sampling function measures the difference between two or more data samples from a model with regard to a parameter including, but not limited to, distance, area, or volume. For example, a sampling function may measure the distance between data sample A, a random point on the surface of the model, and data sample B, a fixed point, such as the center of mass of the model. The selected sampling function is applied to multiple groups of two or more data samples (e.g., multiple pairs of data samples) from each received model to generate a difference distribution histogram for that model.

Once multiple difference distribution histograms have been generated to represent multiple models, the similarity of the difference distribution histograms—and thus the models—is determined. In some embodiments, the system receives two or more difference distribution histograms for comparison. In some embodiments, at least one of the difference distribution histograms is stored in a database. For example, the system may receive one or more difference distribution histograms that are to be matched against a database of multiple predefined models. In some embodiments, at least one of the difference distribution histograms is a target specified in a fitness function for a genetic algorithm or machine learning search, to be compared against the difference distribution histograms generated from one or more candidate models. Once the difference distribution histograms have been received, the system selects a distribution test function, which measures the similarity of two or more histograms. The selected distribution test function is applied to the received difference distribution histograms to measure the similarity of the histograms.

Among other benefits, the technology described herein distinguishes among models that have similar shapes but different non-spatial attributes. The described technology also distinguishes among models having only non-spatial attributes. In addition, the described technology offers a general and versatile approach for recognition, analysis, and classification of data patterns. The technology described herein has a variety of applications, including, but not limited to, genetic simulations, text classification, weather and natural disaster prediction, biometric identification and authentication, enemy military tactics and strategy analysis prediction, target acquisition, image intelligence analysis, terrorist activity, medical diagnoses, decryption pattern analysis, and/or a variety of other applications. For example, the described technology may be used to determine model fitness in a genetic simulation. In some embodiments, a genetic algorithm uses difference distributions to compare a modeled object and a target object to determine comparable profiles. The genetic algorithm may make one or more determinations based on whether the difference distribution of the modeled object is sufficiently similar to that of target object. For example, the genetic algorithm may keep, replace, discard, modify, or take other action regarding the modeled object based on the similarity determination. A suitable genetic algorithm is described in additional detail in copending U.S. patent application Ser. No. 11/234,413, entitled METHOD, SYSTEM AND APPARATUS FOR VIRTUAL MODELING OF BIOLOGICAL TISSUE WITH ADAPTIVE EMERGENT FUNCTIONALITY, filed on Sep. 23, 2005; and U.S. patent application Ser. No. 12/554,870, entitled SYSTEMS AND METHODS FOR CELL-CENTRIC SIMULATION OF BIOLOGICAL EVENTS AND CELL-BASED MODELS PRODUCED THEREFROM, filed on Sep. 4, 2009, which are hereby incorporated by reference in their entirety.

Various embodiments of the technology will now be described. The following description provides specific details for a thorough understanding and an enabling description of these embodiments. One skilled in the art will understand, however, that the described technology may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the technology.

### 1. SUITABLE SYSTEM FOR DISCRIMINATING BETWEEN MULTI-DIMENSIONAL MODELS

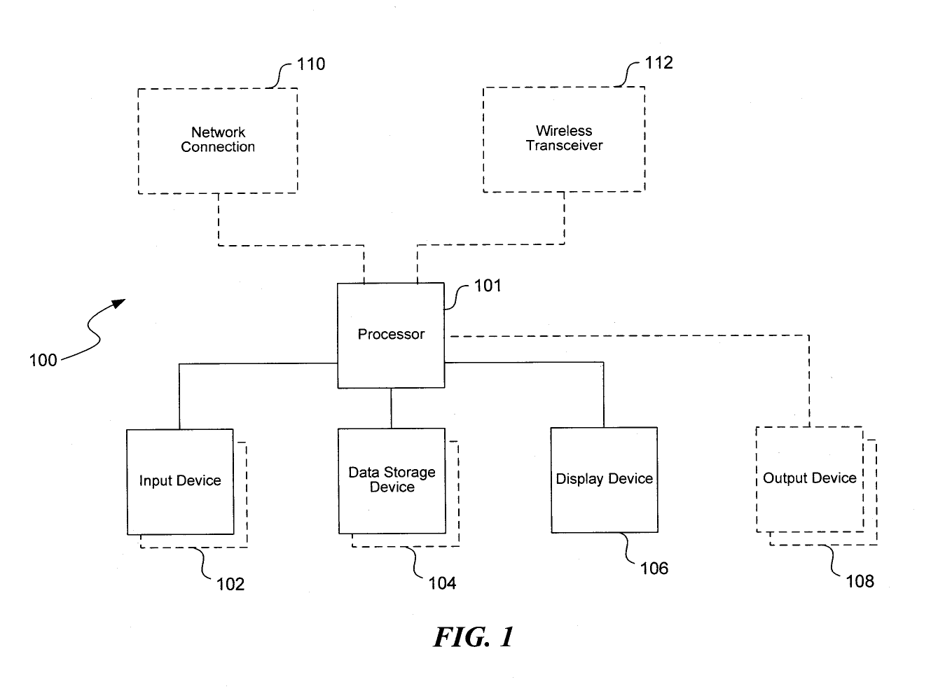

FIG. 1 depicts a suitable computing system 100 for implementing aspects of technology described herein. Although not required, aspects of the technology may be described herein in the general context of computer-executable instructions, such as routines executed by a general or special purpose data processing device (e.g., a server or client computer). Those skilled in the art will appreciate that the described technology can be practiced with other computer system configurations, including Internet appliances, multi-processor systems, mainframe computers, game consoles, portable media players, portable gaming devices, cell phones, smart phones, and/or other computer system configurations. Alternatively or additionally, the described technology can be embodied in a special purpose computer or data processor that is specifically programmed, configured, and/or constructed to perform one or more of the computer-executable instructions described herein.

The described technology can also be practiced in distributed computing environments, where tasks or modules are performed by remote processing devices, which are linked through a communications network, such as a LAN, WAN, or the Internet. In a distributed computing environment, program modules or sub-routines may be located in both local and remote memory storage devices. In addition, those skilled in the art will recognize that portions of the described technology may reside on a server computer, while corresponding portions reside on a client computer.

The computing system 100 of FIG. 1 includes one or more processors 101 coupled to at least one user input device 102 and at least one data storage device 104. The processor(s) 101 are also coupled to at least one output device such as a display device 106 and/or one or more optional additional output devices 108 (e.g., a printer, plotter, speakers, tactile or olfactory output device, and/or other output device). In some embodiments, the processor(s) 101 are also coupled to one or more external computing systems, such as via an optional network connection 110 and/or an optional wireless transceiver 112.

The input devices 102 may include a keyboard and/or a pointing device such as a mouse. Other input devices may include a microphone, joystick, pen, stylus, game pad, scanner, and/or other input device. The data storage devices 104 may include any type of tangible computer-readable media, including magnetically or optically readable computer discs, hard-wired or preprogrammed chips (e.g., EEPROM semiconductor chips), nanotechnology memory, biological memory, and/or other data storage media. Data may be stored in a data storage device 104 according to one or more data structures encompassed within the scope of the described technology. Alternatively or additionally, computer implemented instructions, data structures, screen displays, and other data related to the technology may be distributed over the Internet or over other networks (including wireless networks) via the optional network connection 110 and/or optional wireless transceiver 112, on a propagated signal on a propagation medium (e.g., an electromagnetic wave(s), a sound wave, etc.) over a period of time. In some implementations, the data may be provided on any analog or digital network (e.g., a packet switched, circuit switched, or other network scheme).

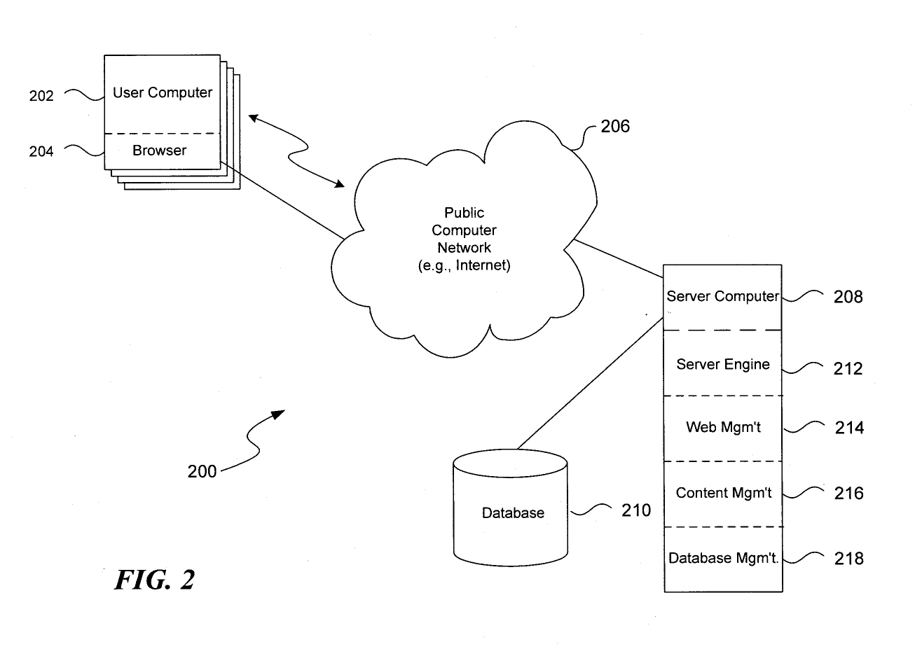

Aspects of the described technology may be practiced in a variety of other computing environments, such as that depicted by FIG. 2. FIG. 2 includes a distributed computing environment 200 with a web interface includes one or more user computers 202, each of which includes a browser program module 204 that permits the computer to access and exchange data with the Internet 206, including web sites within the World Wide Web portion of the Internet. The user computers may be substantially similar to the computing system 100 described above with respect to FIG. 1. User computers may include other program modules such as an operating system, one or more application programs (e.g., word processing or spread sheet applications), and the like. The computers may be general-purpose devices that can be programmed to run various types of applications, or they may be single-purpose devices optimized or limited to a particular function or class of functions. More importantly, while shown with web browsers, any application program for providing a graphical user interface to users may be employed, as described in detail below; the use of a web browser and web interface are only used as a familiar example here.

At least one server computer 208, coupled to the Internet or World Wide Web (“Web”) 206, performs many or all of the functions for receiving, routing, and storing of electronic messages, such as web pages, audio signals, and electronic images. While the Internet is shown, a private network, such as an intranet may indeed be preferred in some applications. The network may have a client-server architecture, in which a computer is dedicated to serving other client computers, or it may have other architectures such as a peer-to-peer, in which one or more computers serve simultaneously as servers and clients. A database 210 or databases, coupled to the server computer(s), stores much of the web pages and content exchanged between the user computers. The server computer(s), including the database(s), may employ security measures to inhibit malicious attacks on the system, and to preserve integrity of the messages and data stored therein (e.g., firewall systems, secure socket layers (SSL), password protection schemes, and/or encryption).

The server computer 208 may include a server engine 212, a web page management component 214, a content management component 216, and a database management component 218. The server engine performs basic processing and operating system level tasks. The web page management component handles creation and display or routing of web pages. Users may access the server computer by means of a URL associated therewith. The content management component handles most of the functions in the embodiments described herein. The database management component includes storage and retrieval tasks with respect to the database, queries to the database, and storage of data.

### 2. DISCRIMINATING BETWEEN MULTI-DIMENSIONAL MODELS USING DIFFERENCE DISTRIBUTIONS

The described technology distinguishes among multi-dimensional models using difference distributions. A model is a virtual object, pattern, phenomenon, behavior, event, data set, or other entity having multiple attributes, including at least one non-spatial attribute. Non-spatial attributes include, but are not limited to, physical, chemical, and/or dynamic attributes of the model. Physical attributes include, for example, material, density, luminance, and color. Chemical attributes include, for example, molecule type, indicant, and sensitivity. In addition, physical, chemical, and/or other non-spatial attributes may vary dynamically over time. For example, the chemical attributes of a genetic model may vary over the duration of a simulation.

In some embodiments, a model has both spatial attributes and non-spatial attributes. Spatial attributes include the x-, y-, and/or z-coordinates of the model. For example, in some embodiments, a model is a three-dimensional or other spatial model generated by a genetic simulation, a medical diagnosis system, a weather or natural disaster system, and/or any other information system and/or algorithm.

A. Generating Difference Distribution Histograms

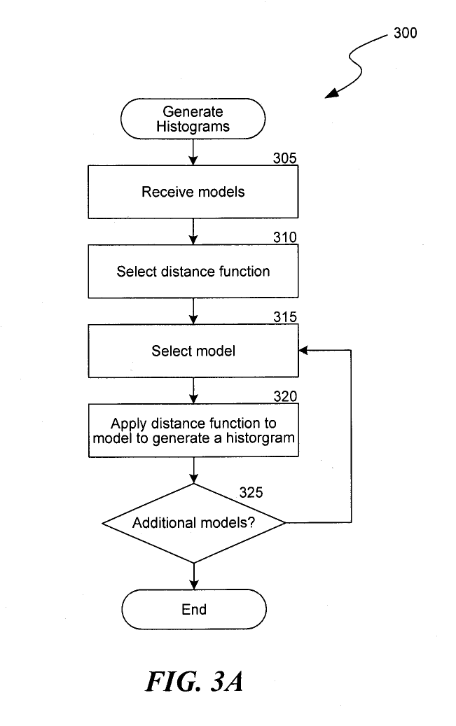

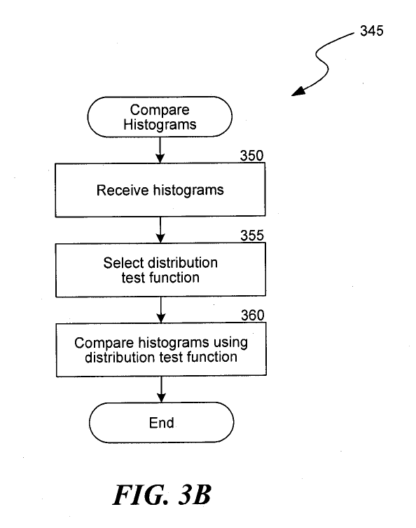

FIG. 3A is a flow diagram of a suitable process 300 for generating difference distribution histograms in accordance with the described technology. In some embodiments, the process is executed by the computing system 100 depicted in FIG. 1 and/or in the computing environment 200 depicted in FIG. 2.

At a block 305, the process 300 receives one or more models for which difference distribution histograms are to be generated. The models may be provided by a modeling and/or information system, a user, and/or in another manner. Sample models are described in reference to example 1 (bug) and example 2 (ellipse).

At a block 310, the process 300 selects a sampling function to be applied to the received models to generate the difference distribution histograms. A sampling function measures the difference between two or more data samples from a model with regard to a parameter including, but not limited to, distance, area, or volume. A variety of sampling functions may be selected for application to the models. The sampling functions described herein are provided for illustrative purposes only, and are not intended to limit the described technology. One skilled in the art will appreciate that a variety of other sampling functions may be used. In addition, although a single sampling function is applied to each model in the illustrated embodiment, in other embodiments multiple sampling functions are applied each model.

In some embodiments, the sampling function incorporates both continuous and nominal attributes of a model, while in other embodiments, the sampling function (or functions) separates the continuous and nominal attributes. An attribute is a nominal attribute if it is assigned one or more distinct values. For example, color is a nominal attribute if it may be assigned values such as blue, red, green, and yellow. Nominal values may be assigned associated numerical values, such as 1 (blue), 2 (red), 3 (green), and 4 (yellow). An attribute is continuous if it may be assigned a value corresponding to any real number along a given number line. For example, position is a continuous attribute if it may be assigned any real number value along a given axis. However, position is a nominal attribute if it may be assigned distinct values such as left, center, and right.

In some embodiments, a sampling function that generates a heterogeneous distance based on differences of continuous and nominal values (herein referred to as “HDCN”) is applied to the models. This sampling function incorporates both the continuous and nominal attributes of a model, as previously described. An example of an HDCN sampling function is provided in equations (1)-(4):

$$\begin{matrix}d ( {A}_{i} , {B}_{i} ) = \{ \begin{matrix}binNomn ( {A}_{i} , {B}_{i} ) , if i \text{-} th attribute is nominal \\ normCont ( {A}_{i} , {B}_{i} ) , if i \text{-} th attribute is continuous\end{matrix} & ( 1 ) \\ binNomn ( {A}_{i} , {B}_{i} ) = \{ \begin{matrix}0 , if {A}_{i} = {B}_{i} \\ 1 , otherwise\end{matrix} & ( 2 ) \\ normCont ( {A}_{i} , {B}_{i} ) = \frac{\vert {A}_{i} - {B}_{i} \vert}{{max}_{i}} & ( 3 )\end{matrix}$$

A and B represent two data samples selected from a model. Each sample comprises n attributes. Equation (1), d(Aᵢ,Bᵢ), represents the distance between A and B in reference to the i-th attribute of the data samples. If the i-th attribute is a nominal attribute, equation (2) is applied to calculate the distance between the attributes. binNomn is set to 0 if the nominal attributes have the same value, or to 1 if the nominal attributes have different values. If the i-th attribute is a continuous attribute, equation (3) is applied to calculate the distance between the attributes. normCont represents the normalized distance between the continuous attributes. max, represents the maximum distance for the i-th continuous attribute of the model. max, normalizes the distance between each pair of samples, such that the distance for each attribute will not exceed 1. The overall distance is defined based on a Euclidean distance function represented by equation (4):

$$HDCN ( A , B ) = \sqrt{{\sum }_{i = 1}^{n} {d ( {A}_{i} , {B}_{i} )}^{2}} \qquad ( 4 )$$

Data samples A and B may be selected in a variety of manners. For example, A may be a random point on the surface of the model, while B is a fixed point. As another example, A and B may both be random points on the surface of the model. In the illustrated embodiments, A is a random point on the surface of the model, while B is the center of mass of the model (i.e., a fixed point). In other embodiments, three or more samples are selected. For example, three or four random points on the surface of the object may be selected, and the area or volume between the points measured. Moreover, although the illustrated embodiments select points on the surface of a model, one skilled in the art will appreciate that other embodiments may select points anywhere within the model, not necessarily on the surface of the model.

In some embodiments, the value of a nominal attribute for a fixed data point B is assigned a constant value. In the illustrated embodiments, the constant value of the color attribute is assigned the value of red (2), as described in additional detail herein. In other embodiments, the constant value of the color attribute is assigned the color value that has a maximum number of neighbors from a fixed data point B. Neighbors are described in additional detail herein. One skilled in the art will appreciate that the constant value of a nominal attribute for a fixed data point may be determined in a variety of other ways.

In some embodiments, a sampling function that generates a heterogeneous distance with an extension to nominal values (herein referred to as “HDEN”) is selected and applied to the model. Like the HDCN sampling function, the HDEN sampling function incorporates both continuous and nominal attributes. However, while the HDCN sampling function is generally dominated by the continuous attributes, the HDEN sampling function typically captures more information about nominal attributes. Rather than simply assigning a value of 0 or 1 to the nominal attribute, the HDEN sampling function generates and compares distances within a local geometric landscape surrounding the data points for each discrete value of the nominal attribute. Accordingly, the HDEN sampling function generally facilitates improved discrimination between models having different nominal attribute values. An example of an HDEN sampling function is provided in equations (5)-(7):

$$\begin{matrix}numNgbr ( {point}_{j} ) = number of neighbors holding the j \text{-} th value of a nominal attribute & ( 5 ) \\ {d}_{e} ( {NA}_{j} , {NB}_{j} ) = \frac{\vert numNgbr ( {A}_{j} ) - numNgbr ( {B}_{j} ) \vert}{{Max}_{j}} & ( 6 ) \\ HDEN ( A , B ) = \sqrt{{\sum }_{i = 1}^{n} {d ( {A}_{i} , {B}_{i} )}^{2} + {\sum }_{j = 1}^{m} {{d}_{e} ( {NA}_{j} , {NB}_{j} )}^{2}} & ( 7 )\end{matrix}$$

As previously described, A and B represent two data samples selected from a model. Each sample comprises n attributes. Equation (6) represents an extension to nominal values, defined as the distance between A and B in reference to the j-th attribute of the data samples. dₑ(NAⱼ,NBⱼ) is the normalized difference between the number of neighbors of A that have the j-th value of the nominal attribute and the number of neighbors of B that have the j-th value of the nominal attribute. Each nominal attribute has m discrete values. Equation (7) calculates the distance between A and B by combining equation (4) (the HDCN sampling function) and equation (6) (the extension to the nominal values).

In some embodiments, the number of neighbors having a specific nominal value for a fixed data point B is assigned a constant value. In the illustrated embodiments, the constant value for the number of neighbors having a specific color value is zero. In other embodiments, the constant value is assigned based on the number of neighbors of the fixed data point B having the specific nominal value (according to a particular radius ratio). One skilled in the art will appreciate that the constant value may be determined in a variety of other ways.

In some embodiments, a sampling function that generates multiple one-dimensional difference distributions (herein referred to as “MODD”) is applied to the model. This sampling function separates continuous and nominal attributes of an model, as previously described. An example of a MODD sampling function is provided in equations (8)-(10):

$$\begin{matrix}dC ( A , B ) = \sqrt{{\sum }_{i = 1}^{C} {( {A}_{i} - {B}_{i} )}^{2}} & ( 8 ) \\ {dN}_{jk} = {numNgbr ( {a}_{k} )}_{itself = {a}_{j}} & ( 9 )\end{matrix}$$

As previously described, A and B represent two data samples selected from a model. C represents the number of continuous attributes of the model. Equation (8) is applied to the continuous attributes of the model, while equation (9) is applied to the nominal attributes. Equation (8) calculates the distance between the continuous attributes of A and B. The distance for each data sample is computed and a corresponding histogram is generated. Equation (9) defines a nominal attribute distance as the number of neighbors having the k-th value of a nominal attribute, where the sample itself holds the j-th value of the nominal attribute. If the number of discrete values for a nominal attribute is N, then N² sub-histograms are generated based on the fixed values of j and k. All sub-histograms are then concatenated, to facilitate comparison between models.

An example average difference score for comparing models according to the MODD sampling function is defined by equation (10):

DiffScore=w₁*S_{c}+w₂*Sₙ (10)

S_{c} represents a difference score for continuous attributes, while Sₙ represents a difference score for nominal attributes. w₁ and w₂ denote weights that may be adjusted according to different application requirements. In some embodiments, the weights are equal, such that the continuous and nominal difference scores are evenly distributed, while in other embodiments, the weights are different. Compared to the HDCN and HDEN sampling functions, the MODD sampling function tends to better isolate continuous and nominal attributes, facilitating discrimination between models with complex attributes.

Returning to FIG. 3A, at blocks 315-325, for each received model, the process 300 applies the sampling function to the multiple data samples from the model to generate a difference distribution histogram that represents the model. Difference distribution histograms are described in additional detail herein.

### i. Example 1

### Bug

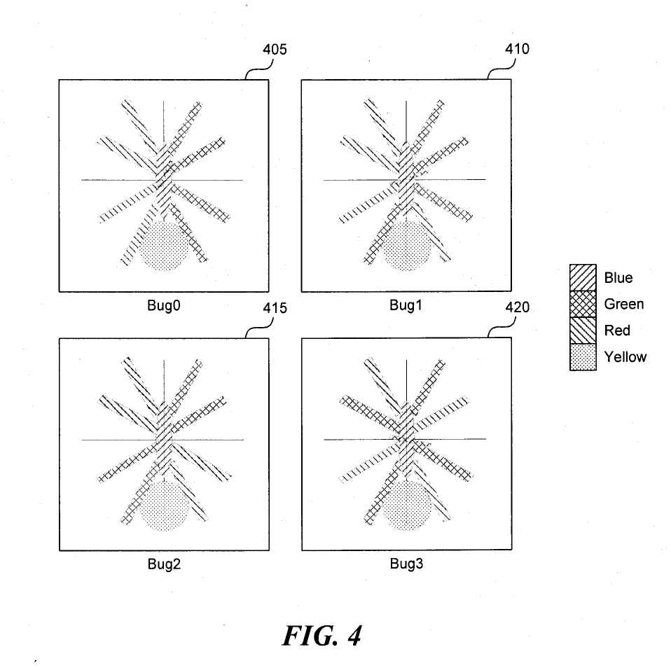

As previously described in reference to FIG. 3, the system receives one or more models for which difference distribution histograms are to be generated. FIG. 4 includes graphs 405-420 of example models that may be received. These models have similar continuous attributes (bug shape, or spatial coordinates) but different nominal attributes (colored legs). In the illustrated embodiment, the models are “point clouds” of multiple virtual objects that comprise the model. For example, a genetic model may comprise multiple cells that make up the genetic model. In other embodiments, the models may be solid, continuous, and/or other types of models.

In the illustrated embodiment, the value of the nominal attribute (color) may be blue, red, green, or yellow. In a clockwise manner from the top right quadrant of the graph 405, Bug0 has legs that are green, green, green, green, red, red, red, and red. Bug1 depicted by graph 410 has legs that are green, green, green, red, green, red, red, and red. Bug2 depicted by graph 415 has legs that are green, green, red, red, green, green, red, and red. Bug3 depicted by graph 420 has legs that are green, red, green, red, green, red, green, and red.

Once models such as those depicted in FIG. 4 are received, a sampling function is selected for application to the models. As previously described, a variety of sampling functions may be applied to the models. In some embodiments, the sampling function incorporates both the continuous and nominal attributes of a model, while in other embodiments, the sampling function (or functions) separates the continuous and nominal attributes.

a. HDCN Sampling Function

In some embodiments, the HDCN sampling function is applied to the models. As previously described, in some embodiments, the value of a nominal attribute for a fixed data point B is assigned a constant value. In the illustrated embodiment, the color attribute for data point B is assigned a constant value of 2 (red). This value is selected based on an assignment of the value 1 to the color blue; the value 2 to the color red; the value 3 to the color green; and the value 4 to the color yellow. Because colors 1 and 4 (blue and yellow) do not vary among the models (i.e., only the colors 2 and 3 (red and green) of the legs varies), selecting a constant value of 2 is representative.

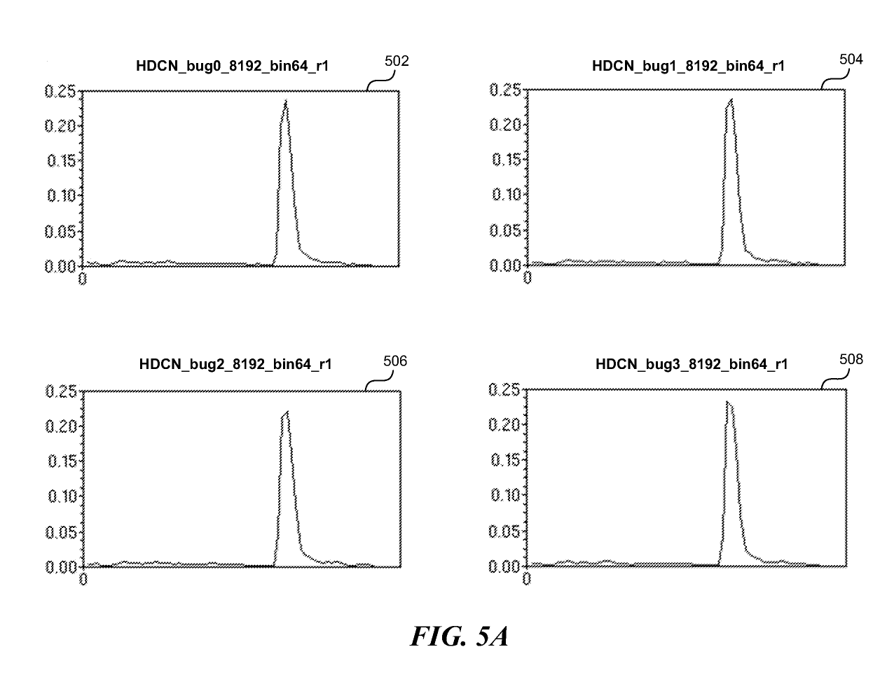

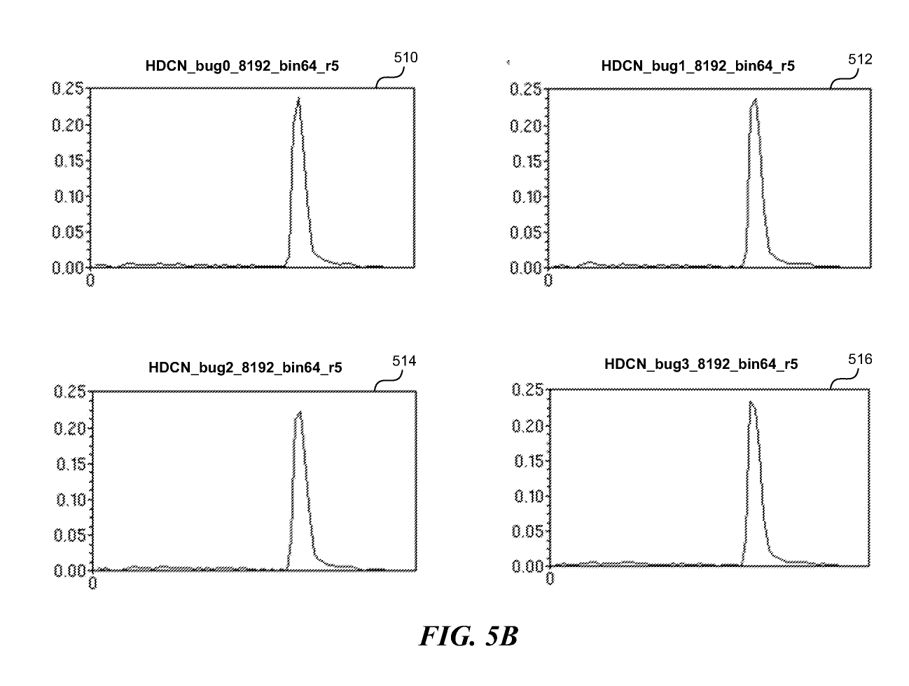

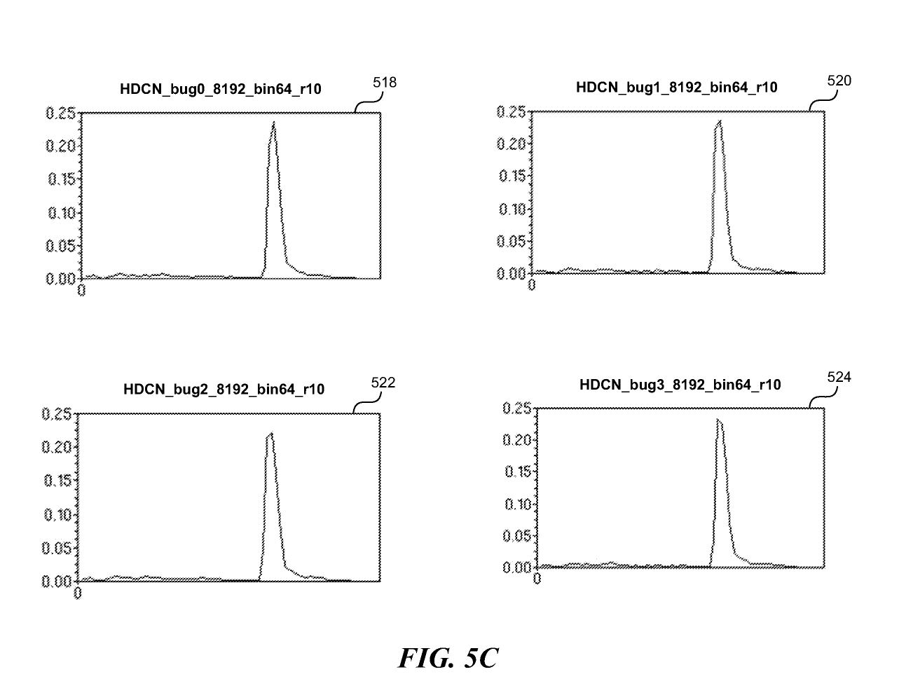

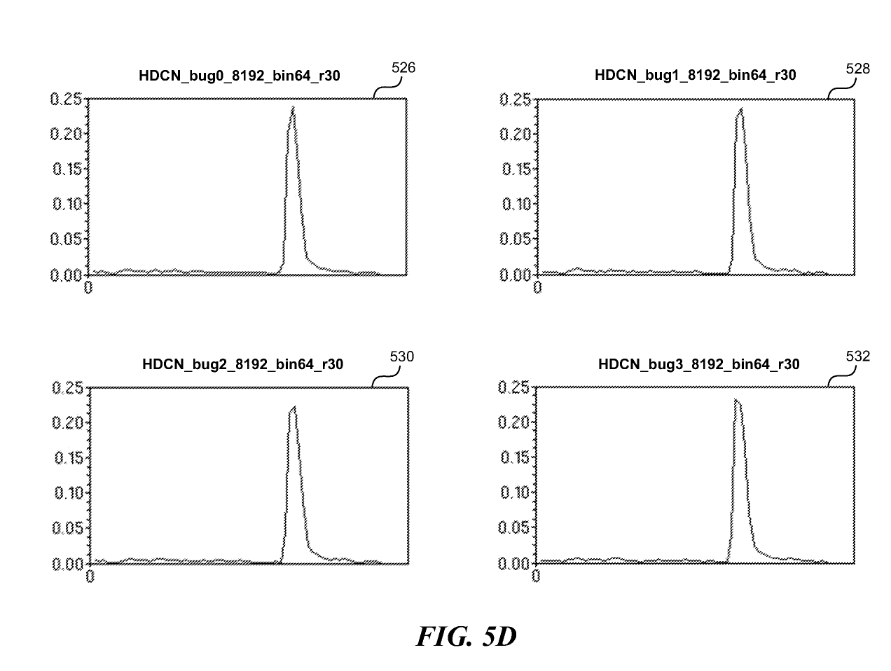

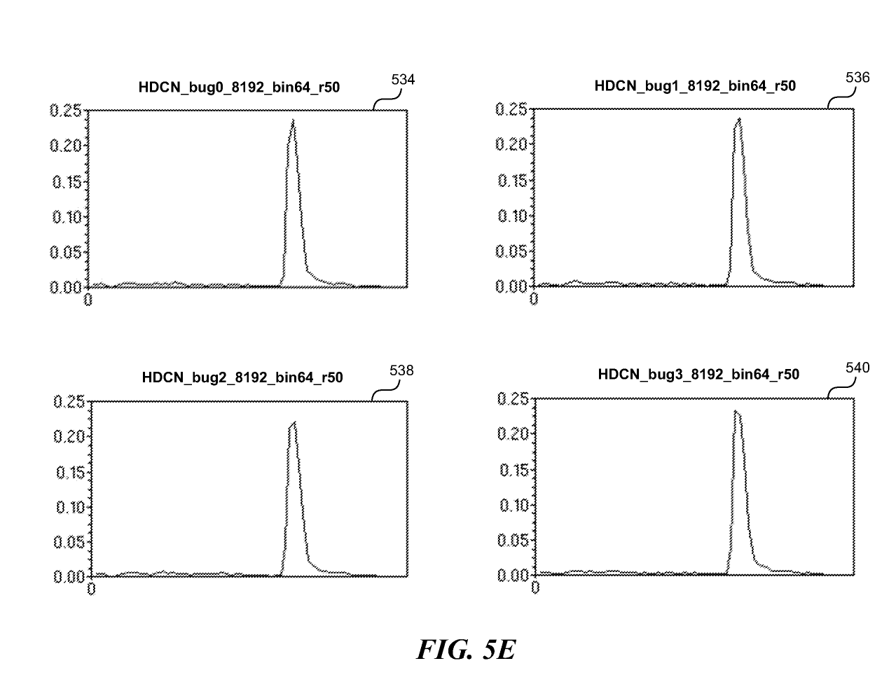

FIG. 5 includes histograms 502-540 generated according to the HDCN sampling function to represent the models of FIG. 4. In FIGS. 5 through 13, each histogram represents 8192 samples taken from the corresponding model, separated into 64 bins. When a sample is measured, it is placed in a bin according to its measurement. That is, each bin corresponds to a portion of possible measurements (e.g., distance values). A histogram is plotted based on the proportion of samples in each bin. Accordingly, the size and number of bins affects the plot, or shape, of the histogram. In the illustrated embodiment, each bin is the same size, while in other embodiments the bins may be of varying sizes.

The histograms in each column correspond to the same model. Histograms 502, 510, 518, 526, and 534 correspond to Bug0 depicted by graph 405; histograms 504, 512, 520, 528, and 536 correspond to Bug1 depicted by graph 410; histograms 506, 514, 522, 530, and 538 correspond to Bug2 depicted by graph 415; and histograms 508, 516, 524, 532, and 540 correspond to Bug3 depicted by graph 420.

The histograms in each row correspond to a common radius ratio. The radius ratio is a multiplier for determining a neighborhood from which the data samples are to be selected. The radius ratio is a percentage of the distance between the maximum and minimum spatial distance of a model. In the illustrated embodiment, the radius ratio is selected from the set comprised of 0.01, 0.05, 0.10, 0.30, and 0.50. For example, the radius ratio of 0.01 indicates that data samples are to be selected from a neighborhood that is 1% of the distance between the maximum and minimum spatial distance of an model. One skilled in the art will appreciate that a variety of other radius ratios may be used.

In FIG. 5, histograms 502-508 correspond to the radius ratio of 0.01; histograms 510-516 correspond to the radius ratio of 0.05; histograms 518-524 correspond to the radius ratio of 0.10; histograms 526-532 correspond to the radius ratio of 0.30; and histograms 534-540 correspond to the radius ratio of 0.50.

b. HDEN Sampling Function

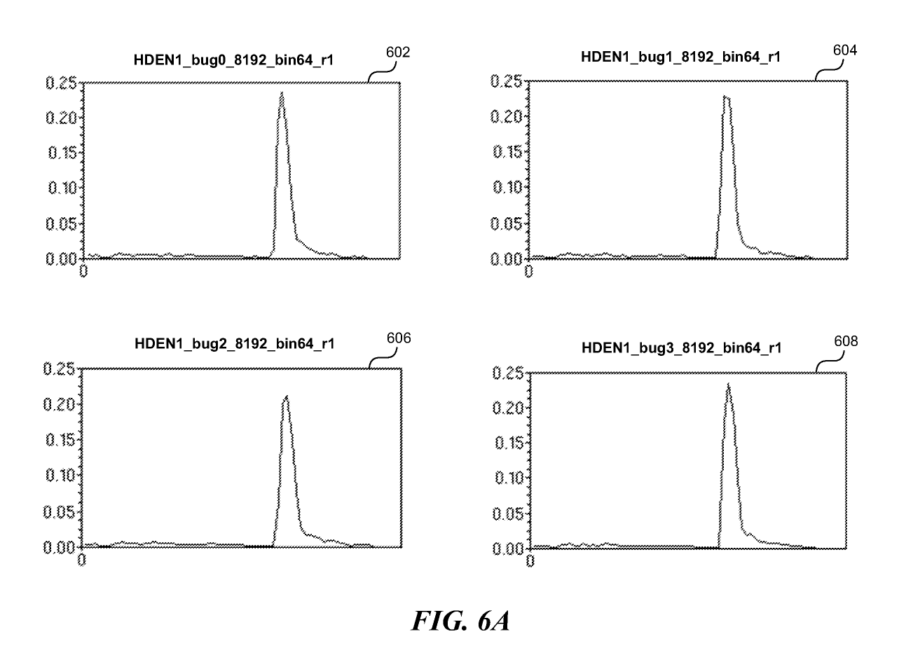

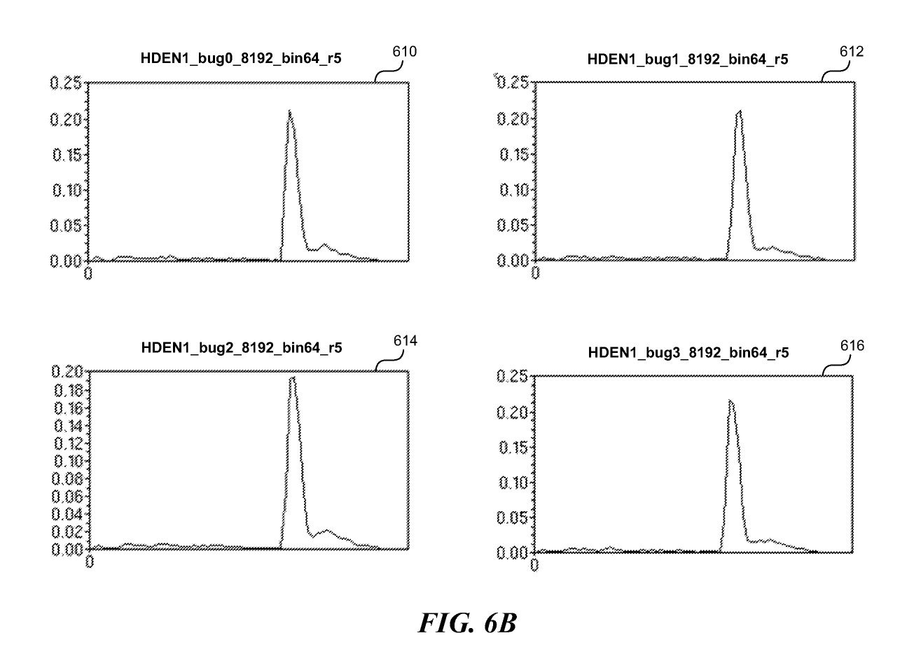

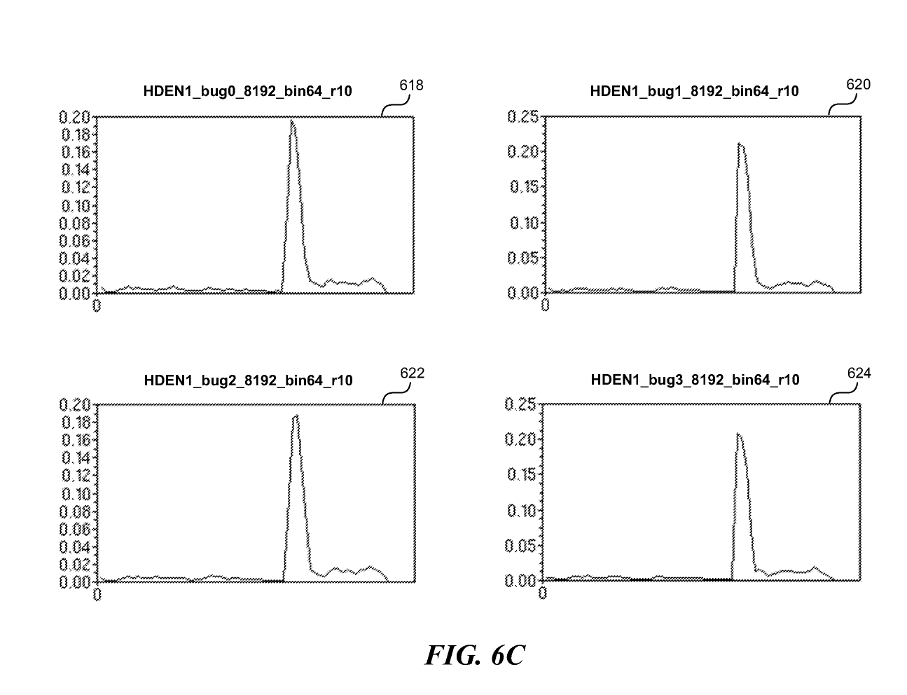

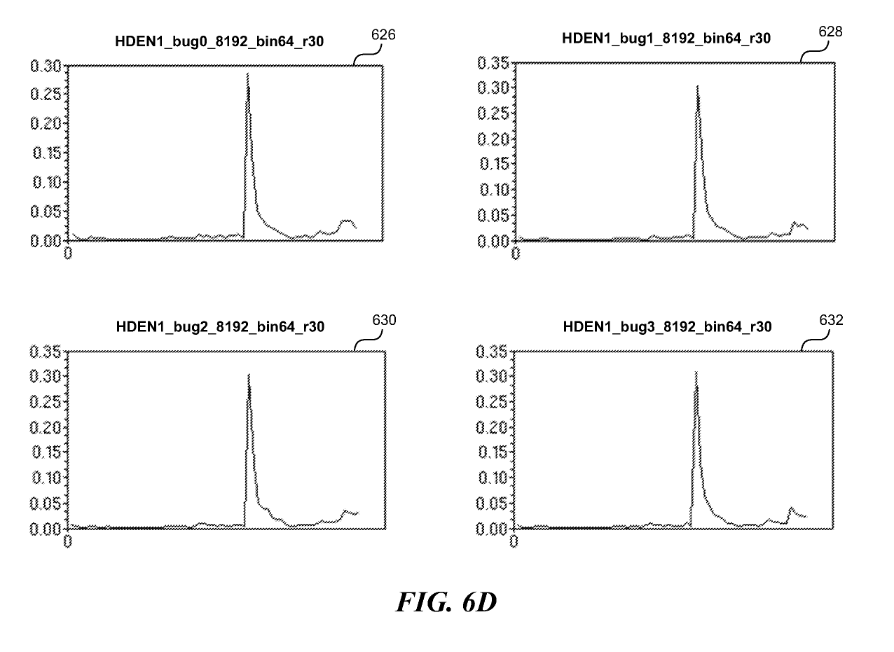

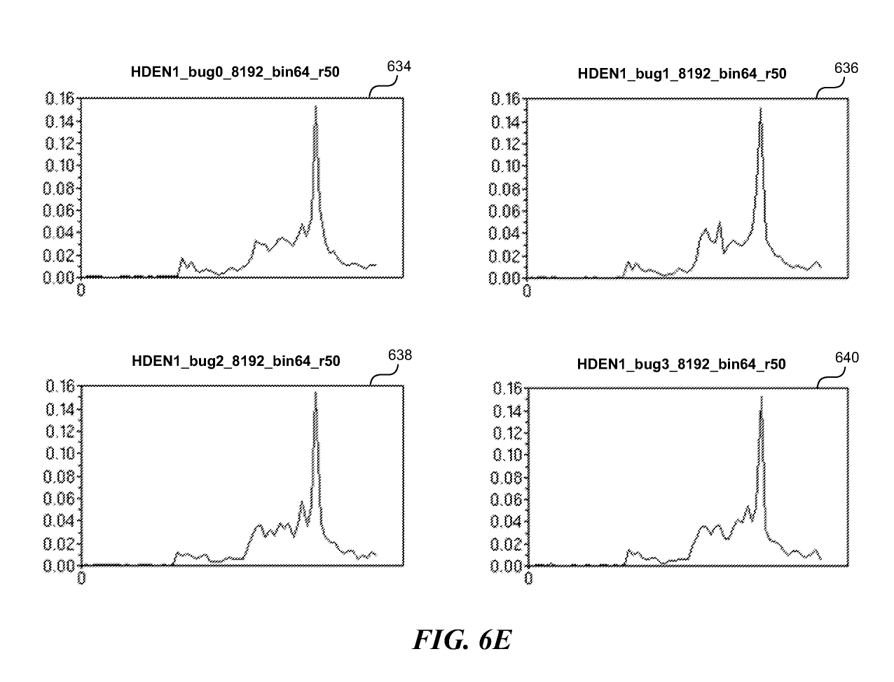

In some embodiments, the HDEN sampling function is applied to the models. FIG. 6 includes histograms 602-640 generated according to the HDEN sampling function with one nominal attribute value (herein referred to as “HDEN1”) to represent the models of FIG. 4. The nominal attribute value in the illustrated embodiment is blue. The histograms 602-640 in each column correspond to the same model. Histograms 602, 610, 618, 626, and 634 correspond to Bug0 depicted by graph 405; histograms 604, 612, 620, 628, and 636 correspond to Bug1 depicted by graph 410; histograms 606, 614, 622, 630, and 638 correspond to Bug2 depicted by graph 415; and histograms 608, 616, 624, 632, and 640 correspond to Bug3 depicted by graph 420.

The histograms in each row correspond to a common radius ratio, selected from the set comprised of 0.01, 0.05, 0.10, 0.30, and 0.50. Histograms 602-608 correspond to the radius ratio of 0.01; histograms 610-616 correspond to the radius ratio of 0.05; histograms 618-624 correspond to the radius ratio of 0.10; histograms 626-632 correspond to the radius ratio of 0.30; and histograms 634-640 correspond to the radius ratio of 0.50.

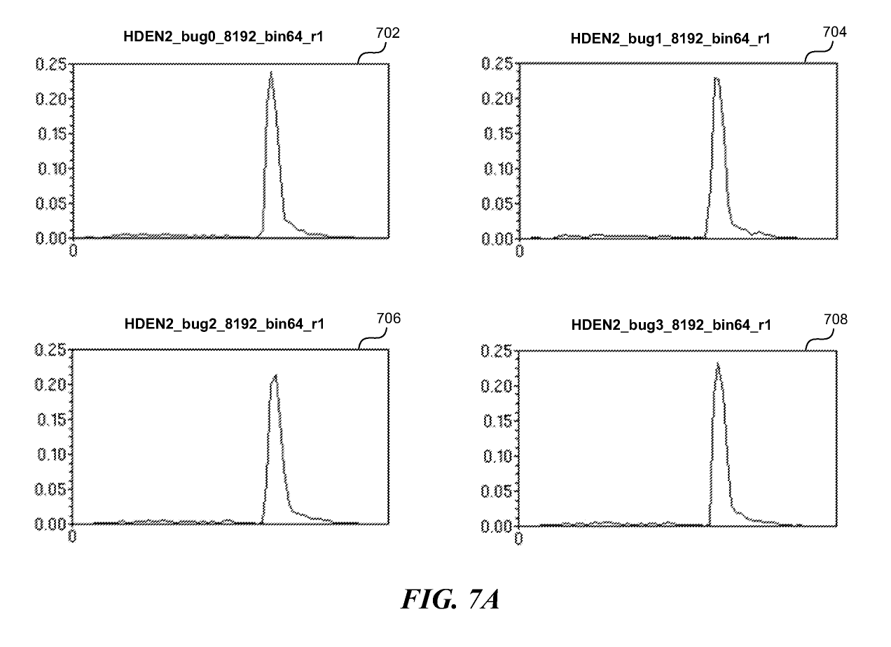

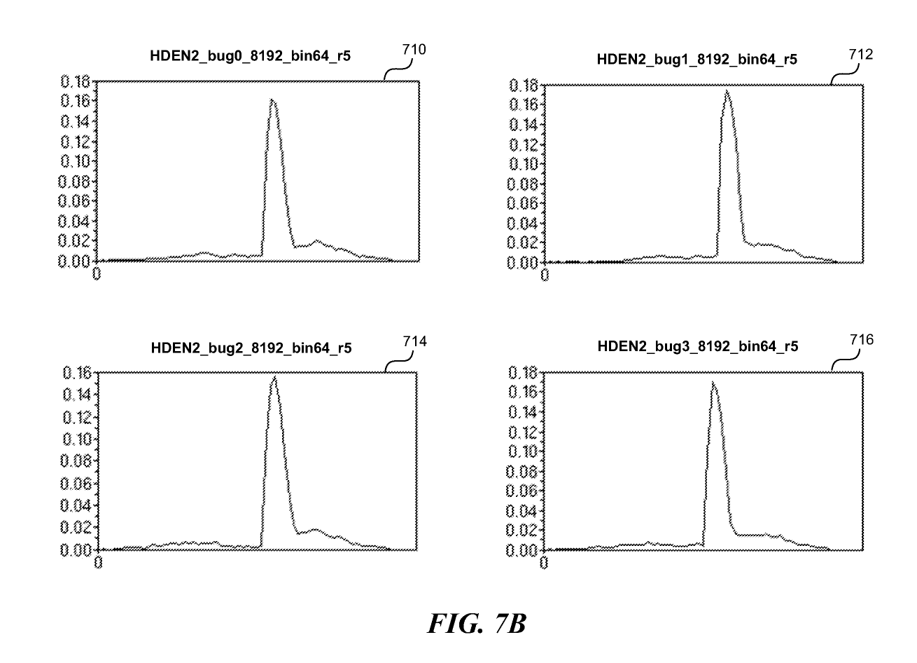

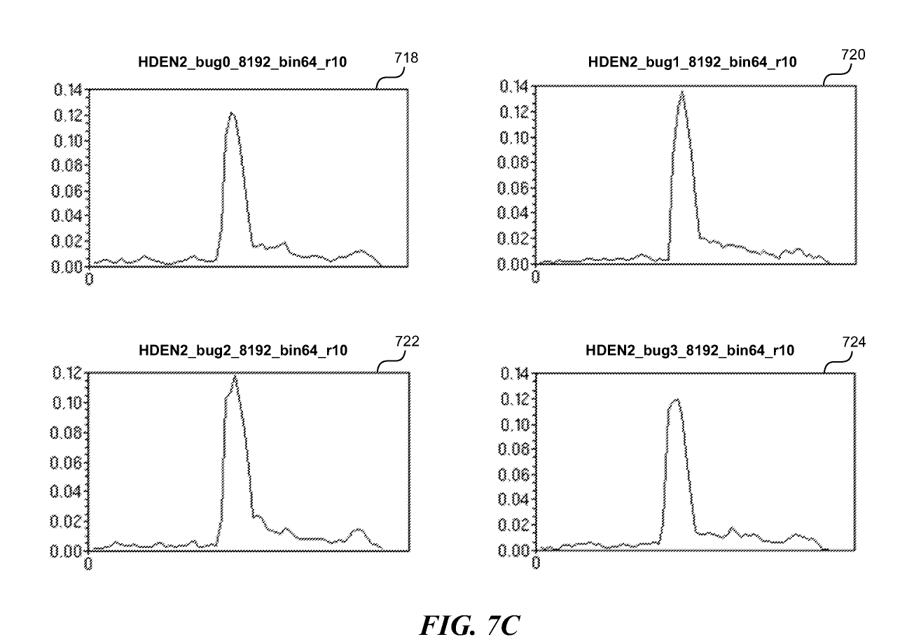

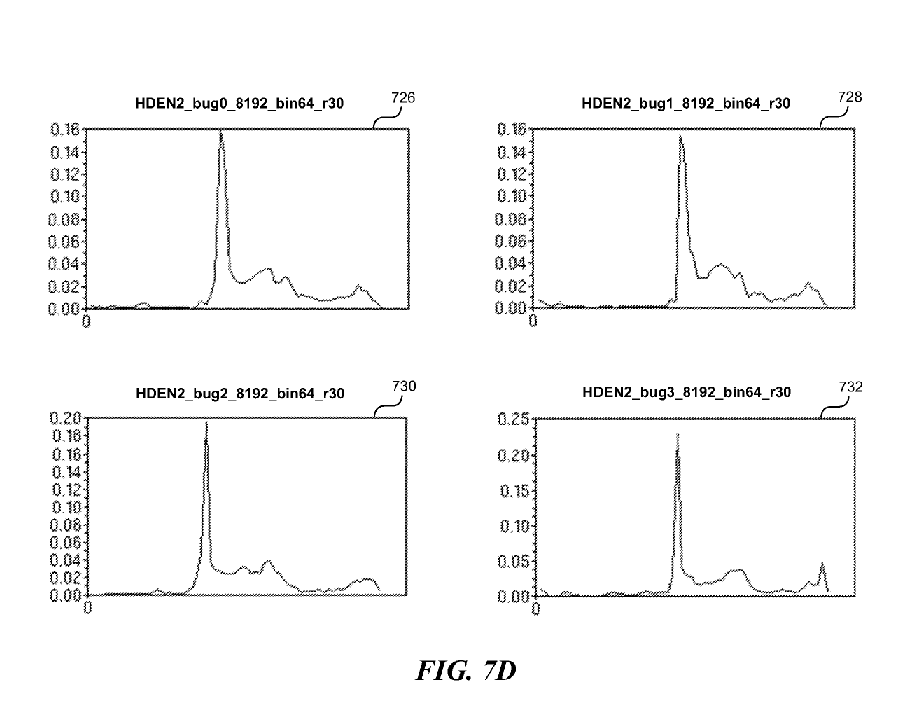

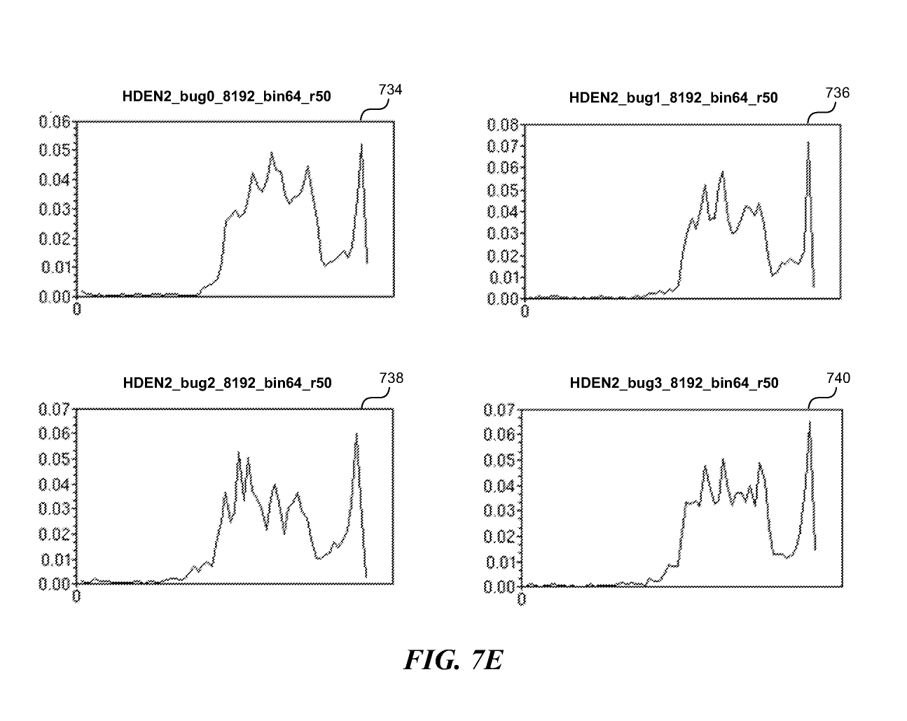

FIG. 7 includes histograms 702-740 generated according to the HDEN sampling function with two nominal attribute values (herein referred to as “HDEN2”) to represent the models of FIG. 4. The nominal attribute values in the illustrated embodiment are blue and red. The histograms 702-740 in each column correspond to the same model. Histograms 702, 710, 718, 726, and 734 correspond to Bug0 depicted by graph 405; histograms 704, 712, 720, 728, and 736 correspond to Bug1 depicted by graph 410; histograms 706, 714, 722, 730, and 738 correspond to Bug2 depicted by graph 415; and histograms 708, 716, 724, 732, and 740 correspond to Bug3 depicted by graph 420.

The histograms in each row correspond to a common radius ratio, selected from the set comprised of 0.01, 0.05, 0.10, 0.30, and 0.50. Histograms 702-708 correspond to the radius ratio of 0.01; histograms 710-716 correspond to the radius ratio of 0.05; histograms 718-724 correspond to the radius ratio of 0.10; histograms 726-732 correspond to the radius ratio of 0.30; and histograms 734-740 correspond to the radius ratio of 0.50.

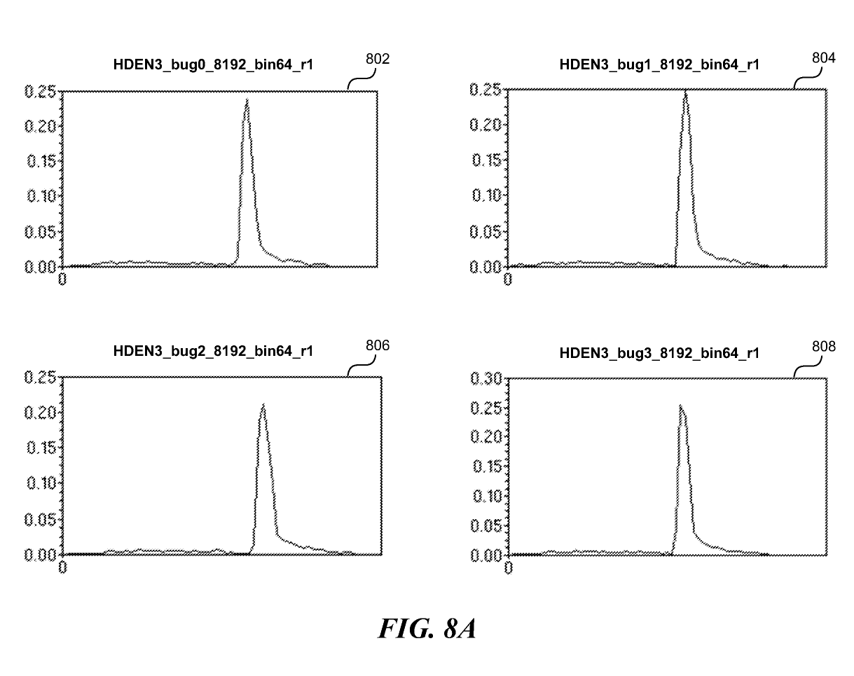

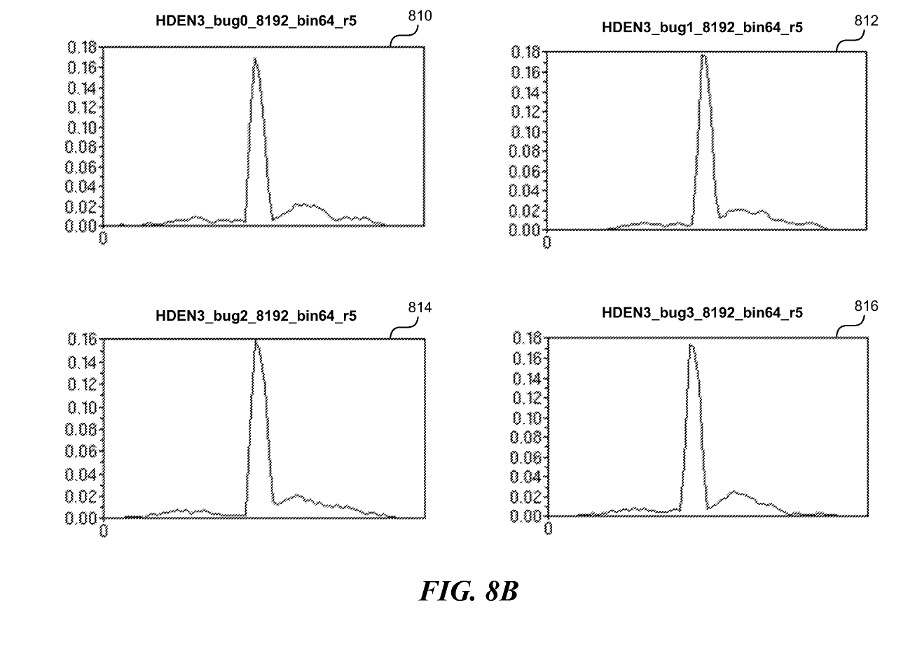

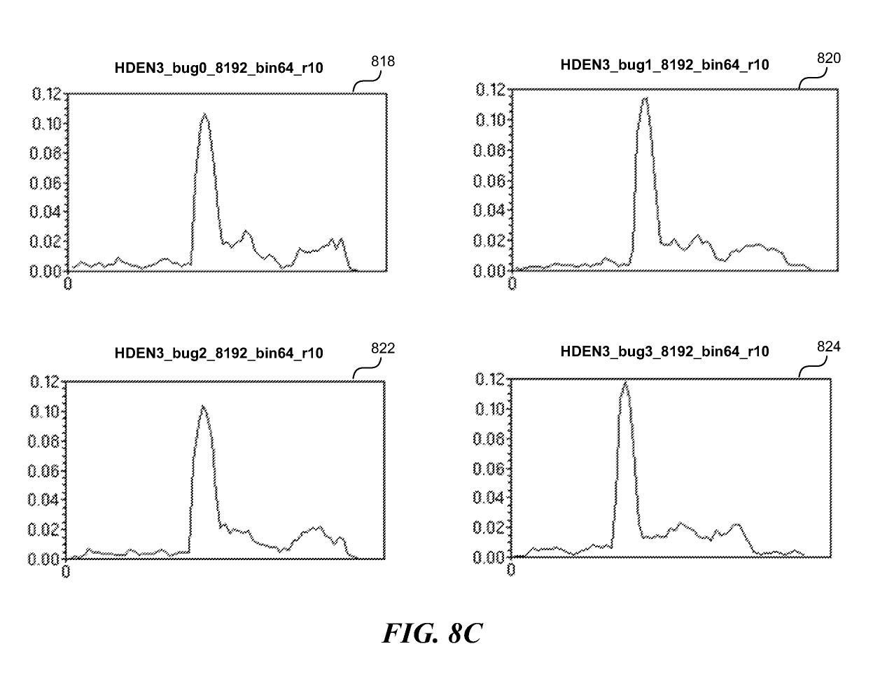

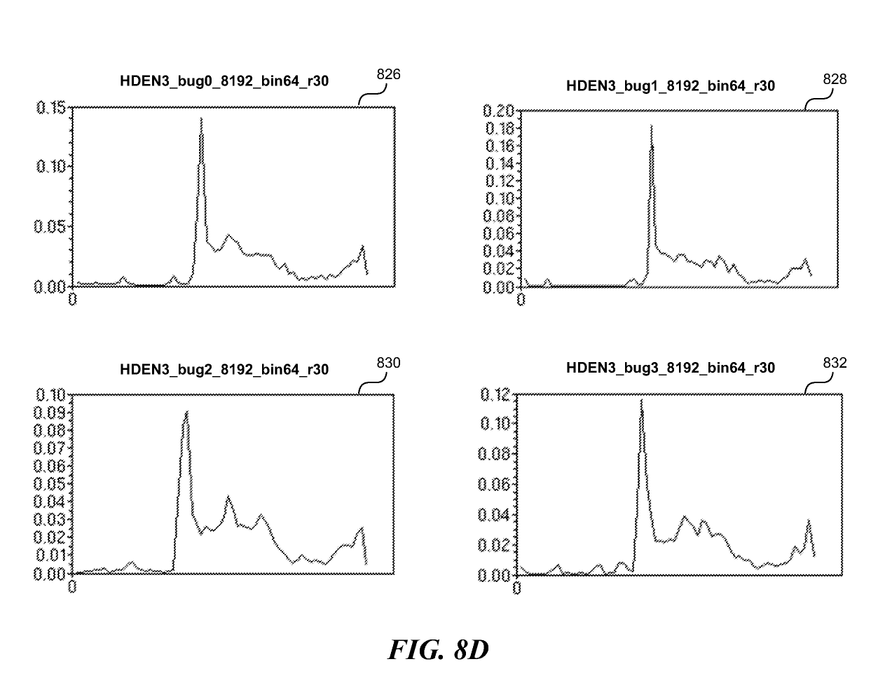

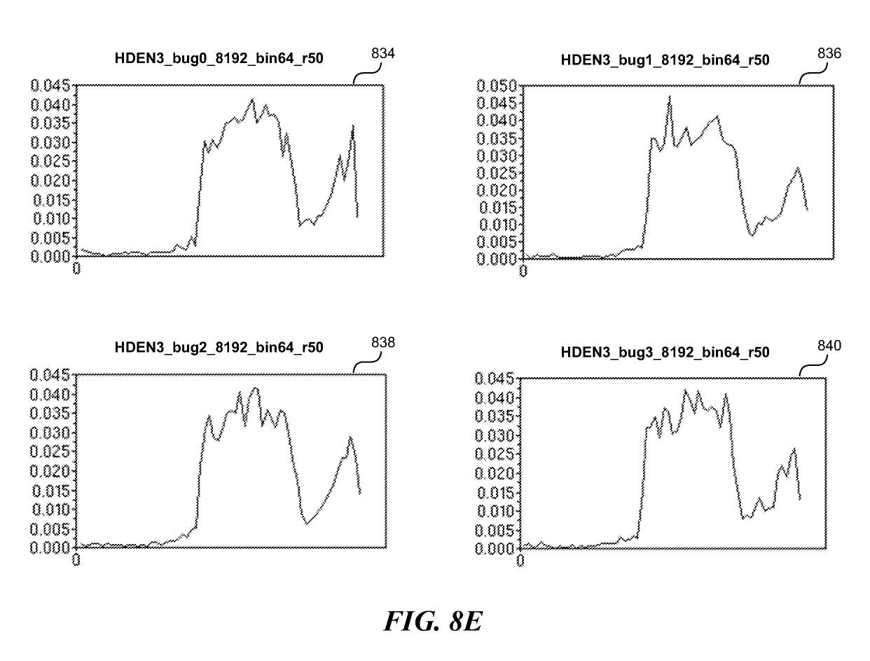

FIG. 8 includes histograms 802-840 generated according to the HDEN sampling function with three nominal attribute values (herein referred to as “HDEN3”) to represent the models of FIG. 4. The nominal attribute values in the illustrated embodiment are blue, red, and green. The histograms 802-840 in each column correspond to the same model. Histograms 802, 810, 818, 826, and 834 correspond to Bug0 depicted by graph 405; histograms 804, 812, 820, 828, and 836 correspond to Bug1 depicted by graph 410; histograms 806, 814, 822, 830, and 838 correspond to Bug2 depicted by graph 415; and histograms 808, 816, 824, 832, and 840 correspond to Bug3 depicted by graph 420.

The histograms in each row correspond to a common radius ratio, selected from the set comprised of 0.01, 0.05, 0.10, 0.30, and 0.50. Histograms 802-808 correspond to the radius ratio of 0.01; histograms 810-816 correspond to the radius ratio of 0.05; histograms 818-824 correspond to the radius ratio of 0.10; histograms 826-832 correspond to the radius ratio of 0.30; and histograms 834-840 correspond to the radius ratio of 0.50.

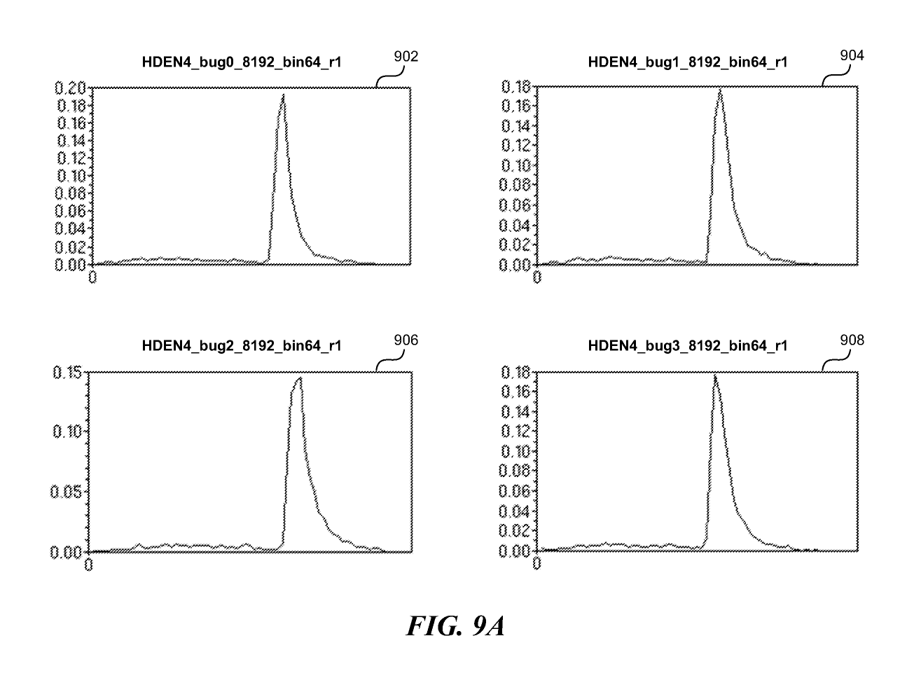

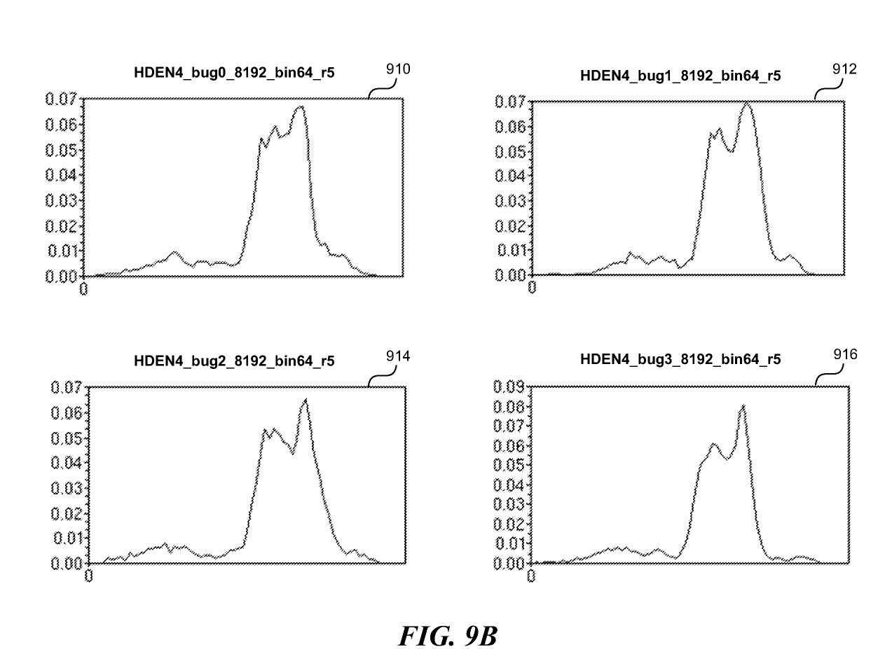

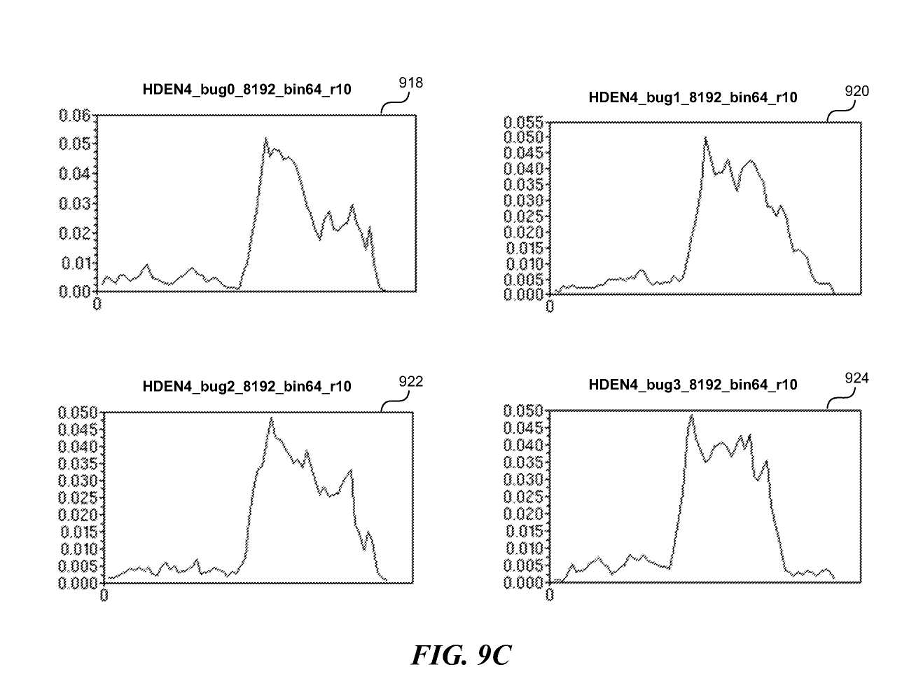

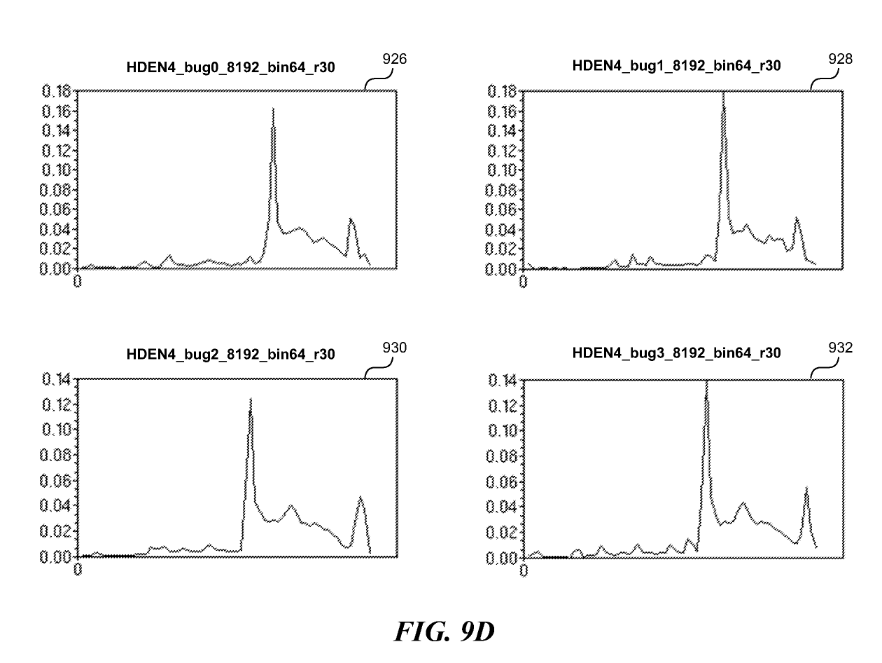

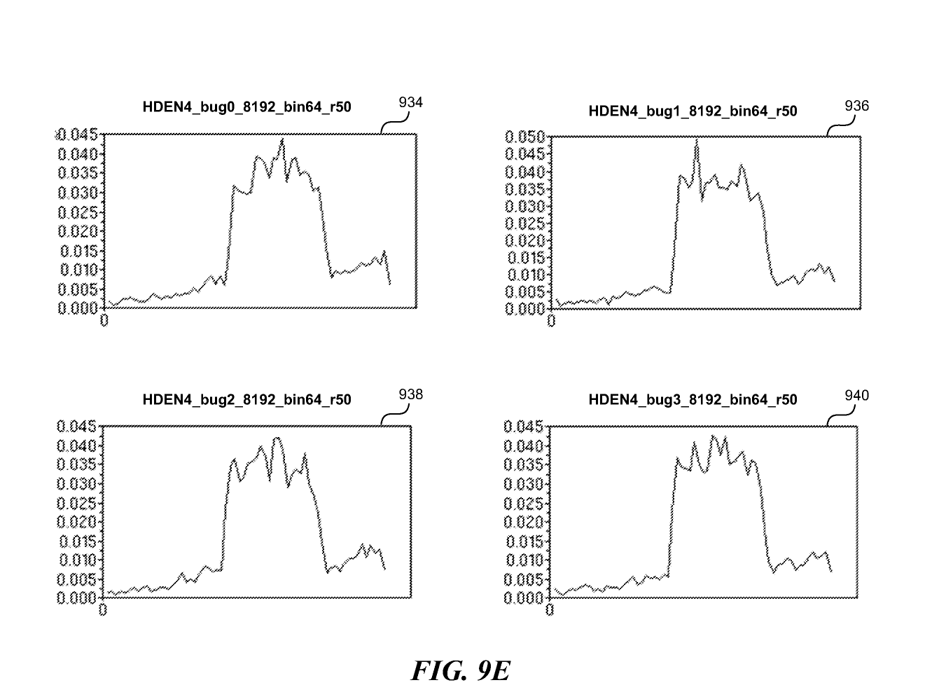

FIG. 9 includes histograms 902-940 generated according to the HDEN sampling function with four nominal attribute values (herein referred to as “HDEN4”) to represent the models of FIG. 4. The nominal attribute values in the illustrated embodiment are blue, red, green, and yellow. The histograms 902-940 in each column correspond to the same model. Histograms 902, 910, 918, 926, and 934 correspond to Bug0 depicted by graph 405; histograms 904, 912, 920, 928, and 936 correspond to Bug1 depicted by graph 410; histograms 906, 914, 922, 930, and 938 correspond to Bug2 depicted by graph 415; and histograms 908, 916, 924, 932, and 940 correspond to Bug3 depicted by graph 420.

The histograms in each row correspond to a common radius ratio, selected from the set comprised of 0.01, 0.05, 0.10, 0.30, and 0.50. Histograms 902-908 correspond to the radius ratio of 0.01; histograms 910-916 correspond to the radius ratio of 0.05; histograms 918-924 correspond to the radius ratio of 0.10; histograms 926-932 correspond to the radius ratio of 0.30; and histograms 934-940 correspond to the radius ratio of 0.50.

The previously described HDCN and HDEN sampling functions incorporate both the continuous and nominal attributes of a model. When the continuous and nominal attributes are incorporated together, these attributes may interfere with each other to some degree. For example, because the continuous and nominal attributes are not treated separately by the sampling function, they may be conflated to a certain extent. In addition, as more dimensions are measured by the data function, the dimensions may wholly or partially cancel each other out. Accordingly, in some embodiments, a sampling function (or functions) is applied that separates the continuous and nominal attributes of a model.

c. MODD Sampling Function

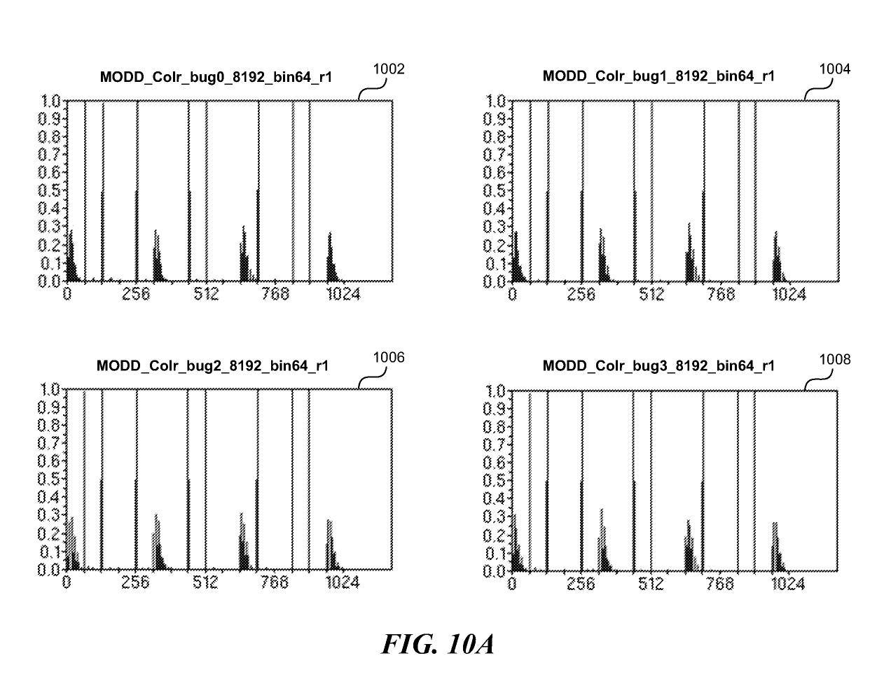

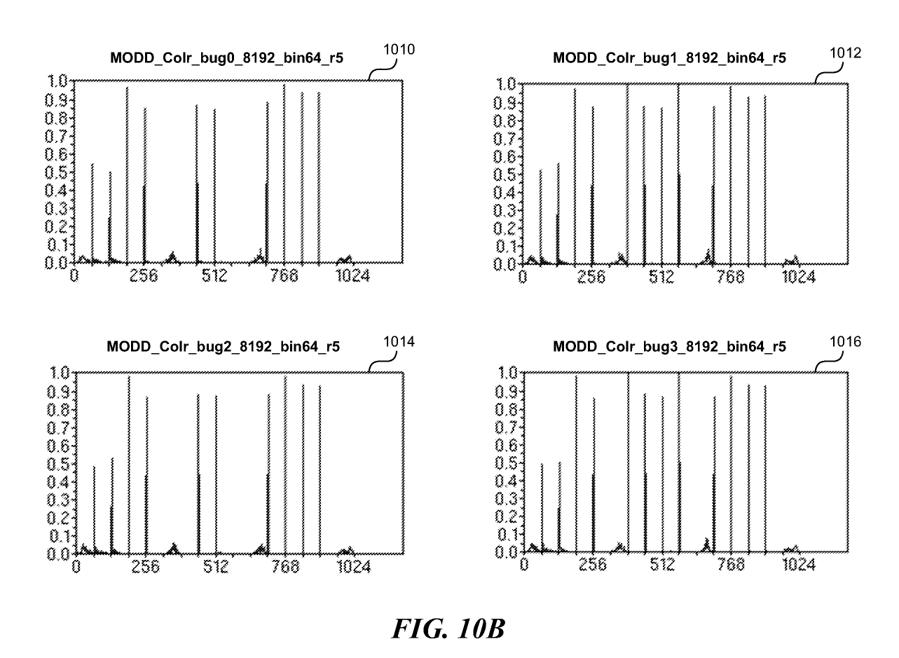

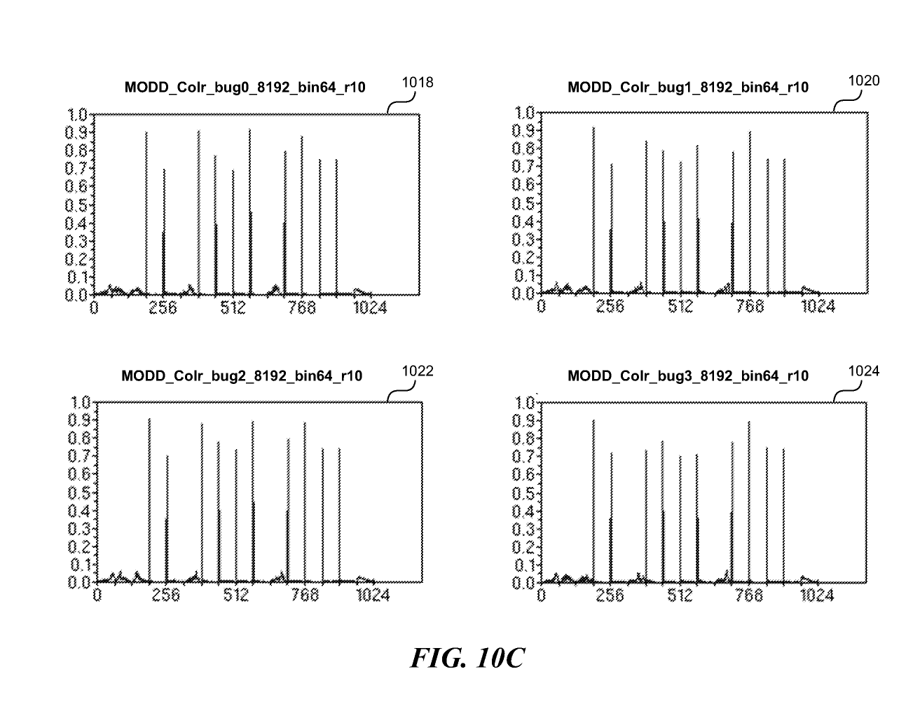

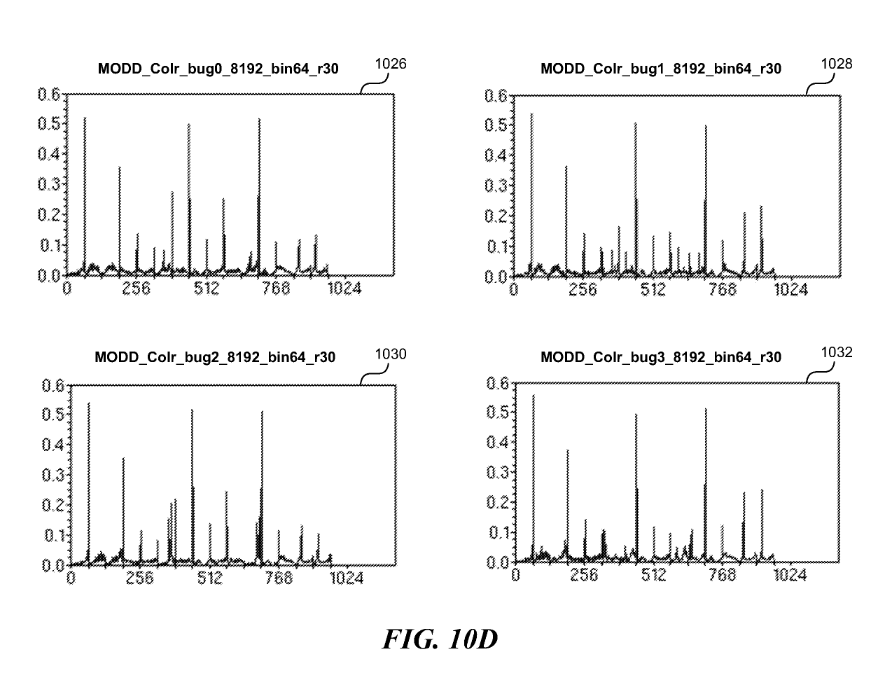

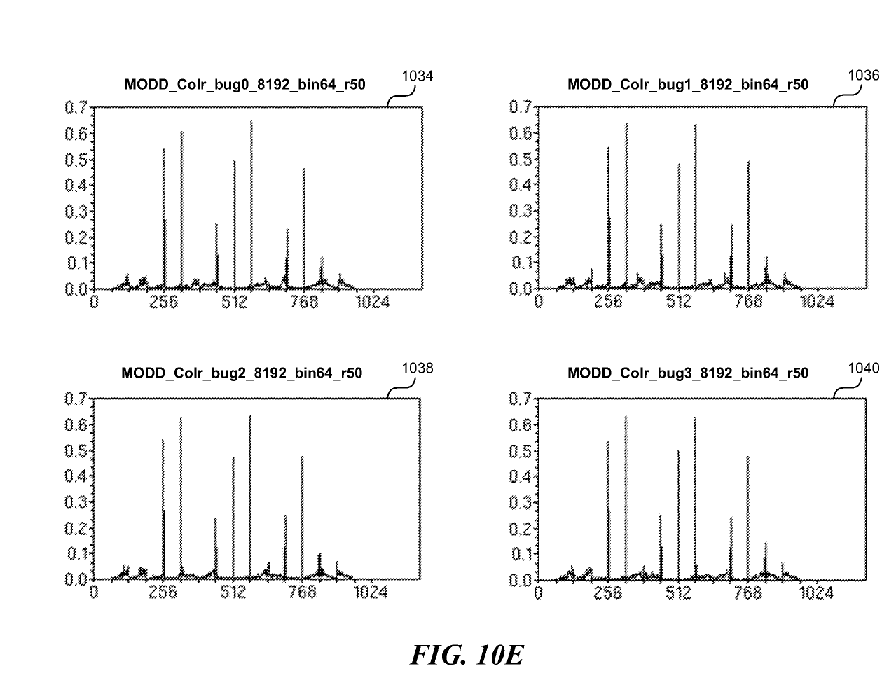

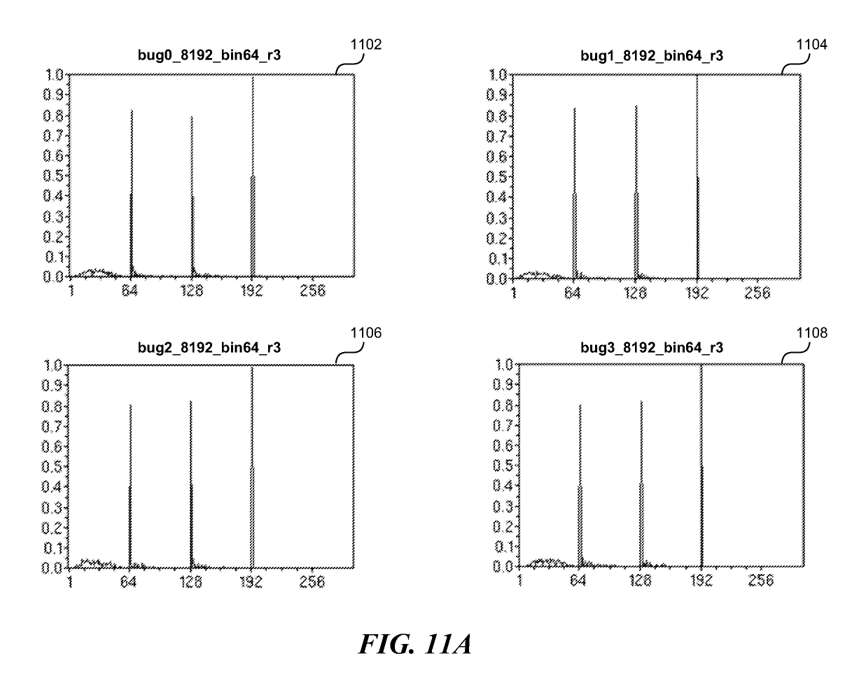

In some embodiments, the MODD sampling function is applied to the models. FIG. 10 includes histograms 1002-1040 generated according to the MODD sampling function to represent the models of FIG. 4. The histograms 1002-1040 in each column correspond to the same model. Histograms 1002, 1010, 1018, 1026, and 1034 correspond to Bug0 depicted by graph 405; histograms 1004, 1012, 1020, 1028, and 1036 correspond to Bug1 depicted by graph 410; histograms 1006, 1014, 1022, 1030, and 1038 correspond to Bug2 depicted by graph 415; and histograms 1008, 1016, 1024, 1032, and 1040 correspond to Bug3 depicted by graph 420.

The histograms in each row correspond to a common radius ratio, selected from the set comprised of 0.01, 0.05, 0.10, 0.30, and 0.50. Histograms 1002-1008 correspond to the radius ratio of 0.01; histograms 1010-1016 correspond to the radius ratio of 0.05; histograms 1018-1024 correspond to the radius ratio of 0.10; histograms 1026-1032 correspond to the radius ratio of 0.30; and histograms 1034-1040 correspond to the radius ratio of 0.50.

Because there are four distinct nominal attribute values in the illustrated embodiment, the number of concatenated bins for each model is 1024 (4²*64 bins). Bins 0-256 represent the self color of 1 (blue) and neighboring colors of 1 (blue), 2 (red), 3 (green), and 4 (yellow), respectively. Bins 257-512 represent the self color of 2 (red) and neighboring colors of 1 (blue), 2 (red), 3 (green), and 4 (yellow). Bins 513-768 and bins 769-1024 are similar, except that the self color is 3 (green) and 4 (yellow), respectively.

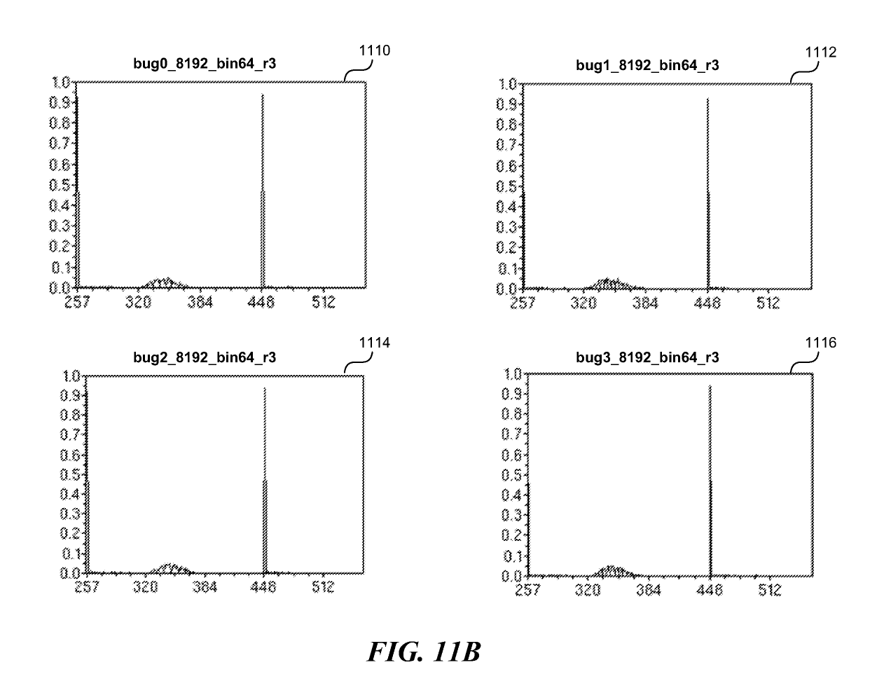

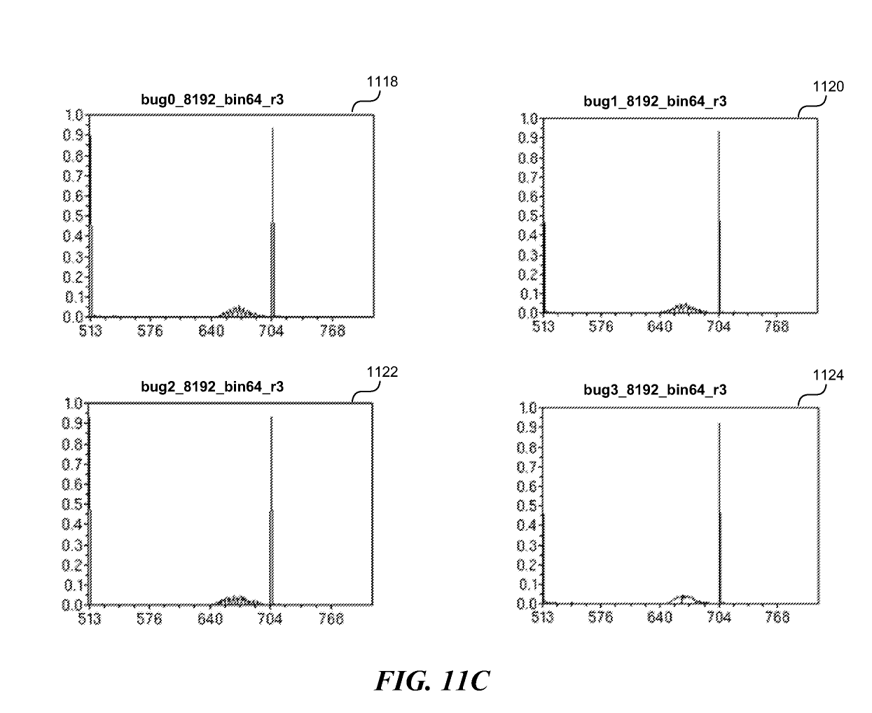

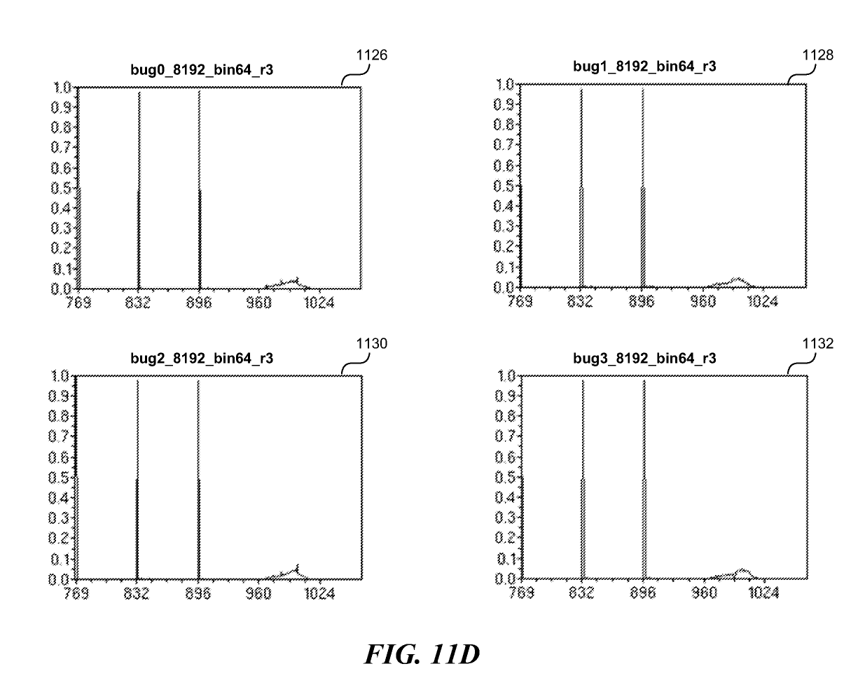

FIG. 11 includes sub-histograms 1102-1132 generated according to the MODD sampling function to represent the models of FIG. 4. The radius ratio is 0.03. The sub-histograms 1102-1132 in each column correspond to the same model. Sub-histograms 1102, 1110, 1118, and 1126 correspond to Bug0 depicted by graph 405; sub-histograms 1104, 1112, 1120, and 1128 correspond to Bug1 depicted by graph 410; sub-histograms 1106, 1114, 1122, and 1130 correspond to Bug2 depicted by graph 415; and sub-histograms 1108, 1116, 1124, and 1132 correspond to Bug3 depicted by graph 420.

The sub-histograms 1102-1132 in each row correspond to one-fourth of the generated histograms. Sub-histograms 1102-1108 correspond to the nominal attribute value of 1 (blue); sub-histograms 1110-1116 correspond to the nominal attribute value of 2 (red); sub-histograms 1118-1124 correspond to the nominal attribute value of 3 (green); and sub-histograms 1126-1132 correspond to the nominal attribute value of 4 (yellow). These sub-histograms are concatenated to generate a single histogram. For example, sub-histograms 1102, 1110, 1118, and 1126 are concatenated to generate a single histogram representing Bug0 depicted by graph 405, and so on.

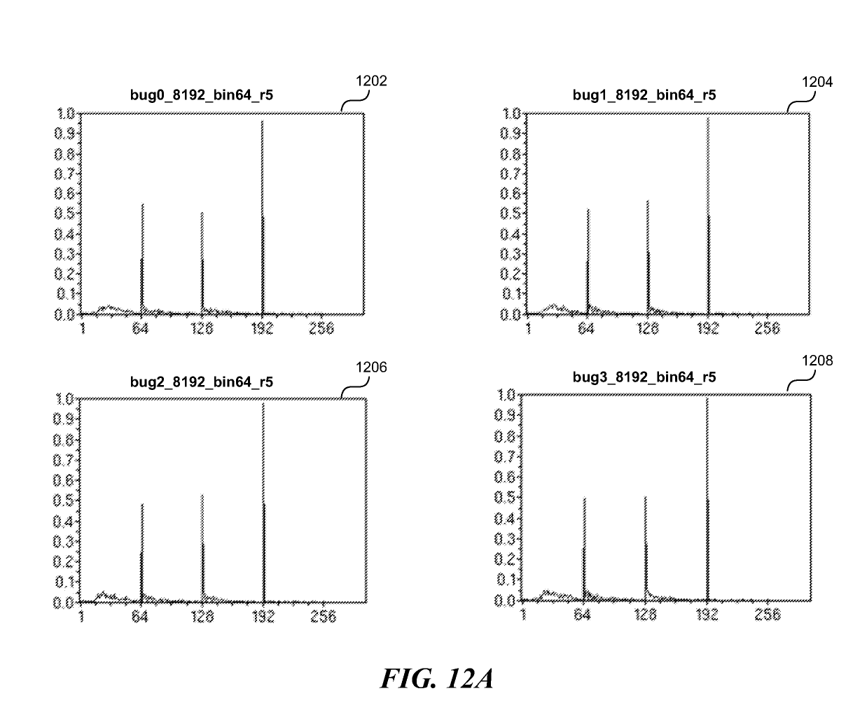

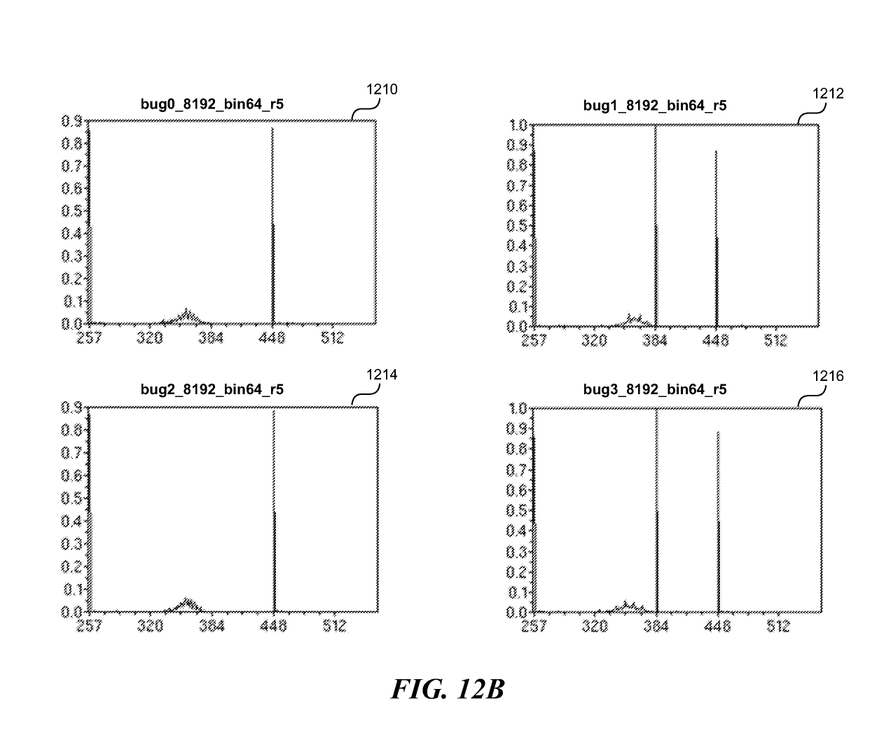

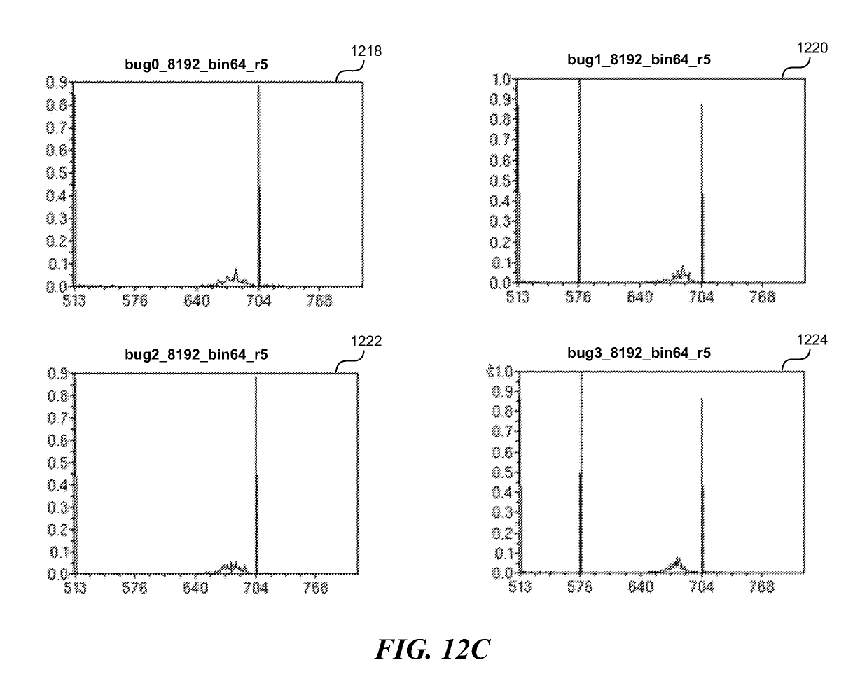

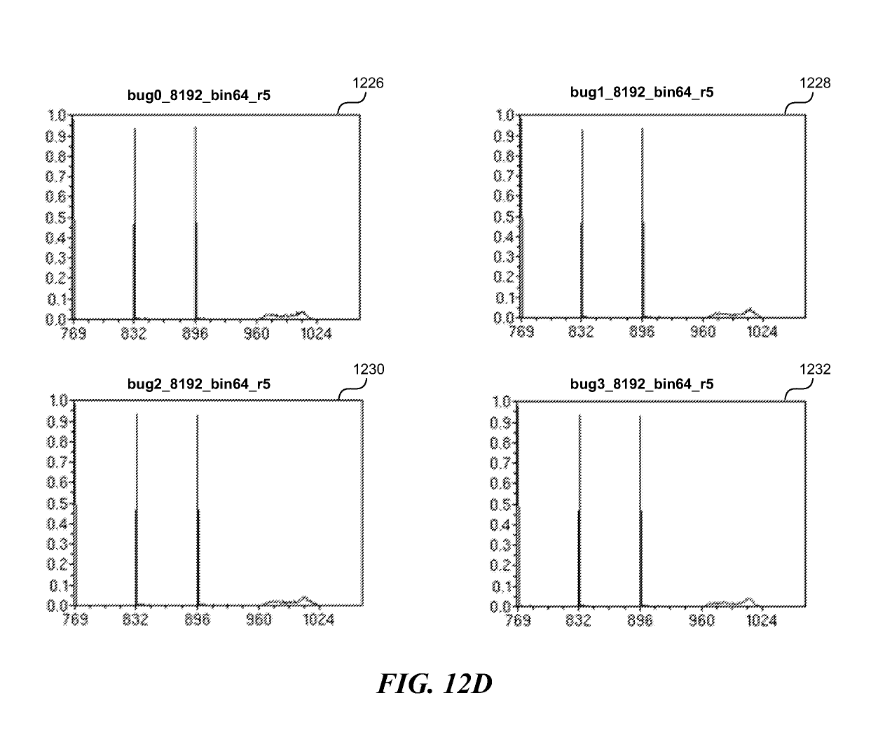

FIG. 12 includes sub-histograms 1202-1232 generated according to the MODD sampling function to represent the models of FIG. 4. The radius ratio is 0.05. The sub-histograms 1202-1232 in each column correspond to the same model. Sub-histograms 1202, 1210, 1218, and 1226 correspond to Bug0 depicted by graph 405; sub-histograms 1204, 1212, 1220, and 1228 correspond to Bug1 depicted by graph 410; sub-histograms 1206, 1214, 1222, and 1230 correspond to Bug2 depicted by graph 415; and sub-histograms 1208, 1216, 1224, and 1232 correspond to Bug3 depicted by graph 420.

The sub-histograms 1202-1232 in each row correspond to one-fourth of the generated histograms. Sub-histograms 1202-1208 correspond to the nominal attribute value of 1 (blue); sub-histograms 1210-1216 correspond to the nominal attribute value of 2 (red); sub-histograms 1218-1224 correspond to the nominal attribute value of 3 (green); and sub-histograms 1226-1232 correspond to the nominal attribute value of 4 (yellow). These sub-histograms are concatenated to generate a single histogram. For example, sub-histograms 1202, 1210, 1218, and 1226 are concatenated to generate the single histogram 1010 of FIG. 10 representing Bug0, and so on.

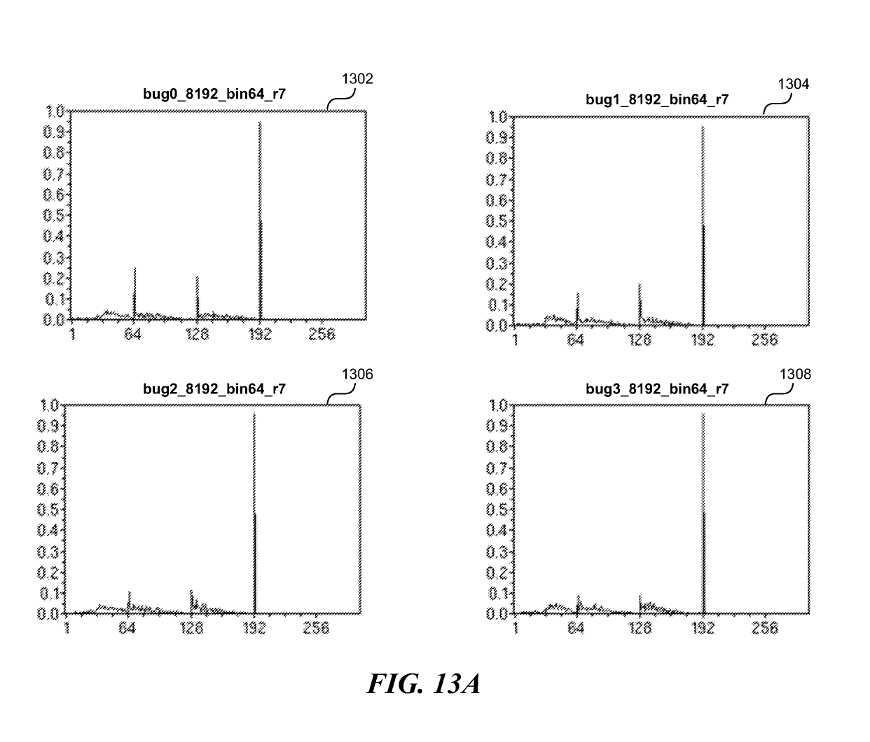

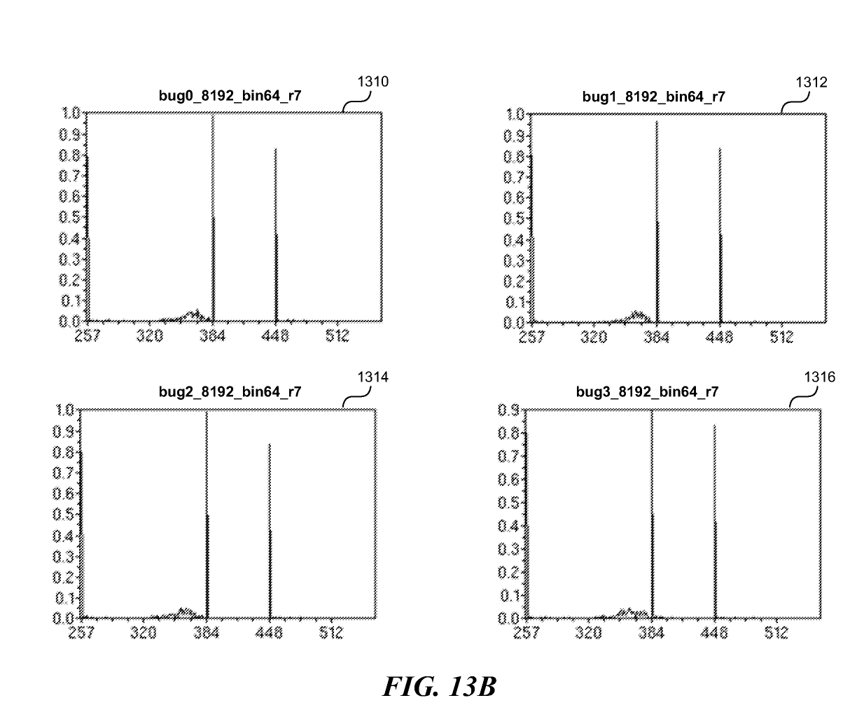

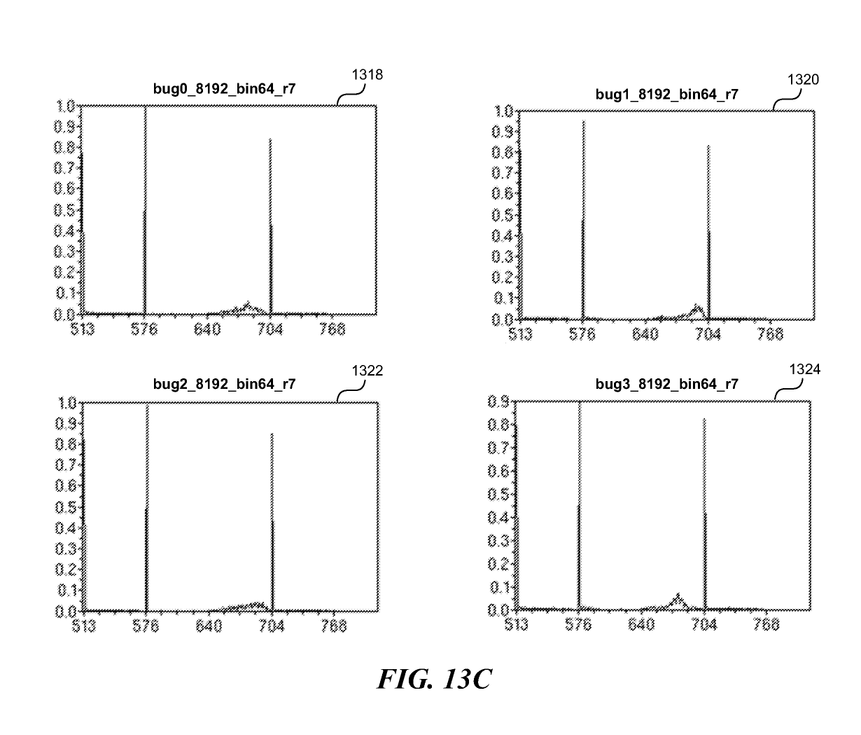

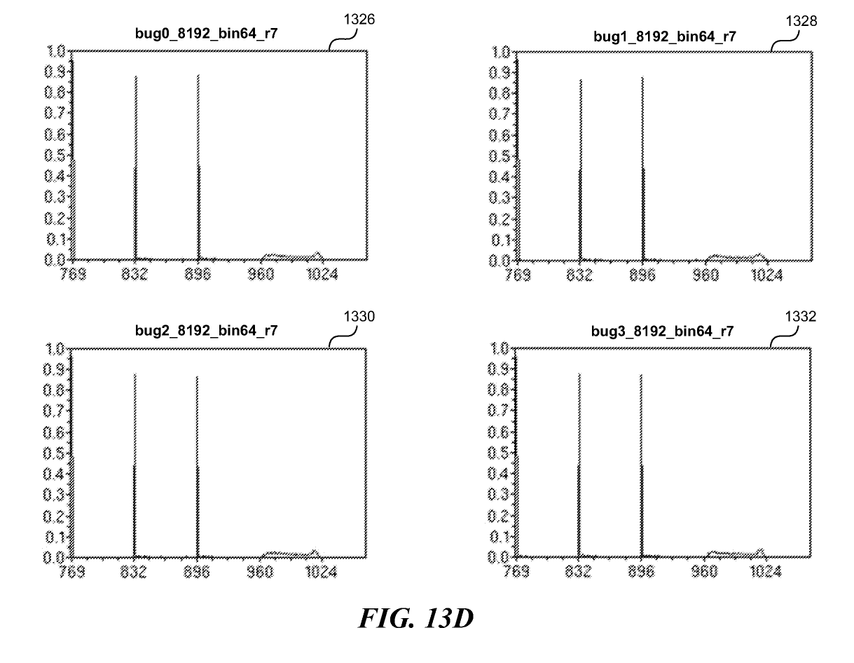

FIG. 13 includes sub-histograms 1302-1332 generated according to the MODD sampling function to represent the models of FIG. 4. The radius ratio is 0.07. The sub-histograms 1302-1340 in each column correspond to the same model. Sub-histograms 1302, 1310, 1318, and 1326 correspond to Bug0 depicted by graph 405; sub-histograms 1304, 1312, 1320, and 1328 correspond to Bug1 depicted by graph 410; sub-histograms 1306, 1314, 1322, and 1330 correspond to Bug2 depicted by graph 415; and sub-histograms 1308, 1316, 1324, and 1332 correspond to Bug3 depicted by graph 420.

The sub-histograms 1302-1332 in each row correspond to one-fourth of the generated histograms. Sub-histograms 1302-1308 correspond to the nominal attribute value of 1 (blue); sub-histograms 1310-1316 correspond to the nominal attribute value of 2 (red); sub-histograms 1318-1324 correspond to the nominal attribute value of 3 (green); and sub-histograms 1326-1332 correspond to the nominal attribute value of 4 (yellow). These sub-histograms are concatenated to generate a single histogram. For example, sub-histograms 1302, 1310, 1318, and 1326 are concatenated to generate a single histogram representing Bug0 depicted by graph 405, and so on.

### ii. Example 2

### Ellipse

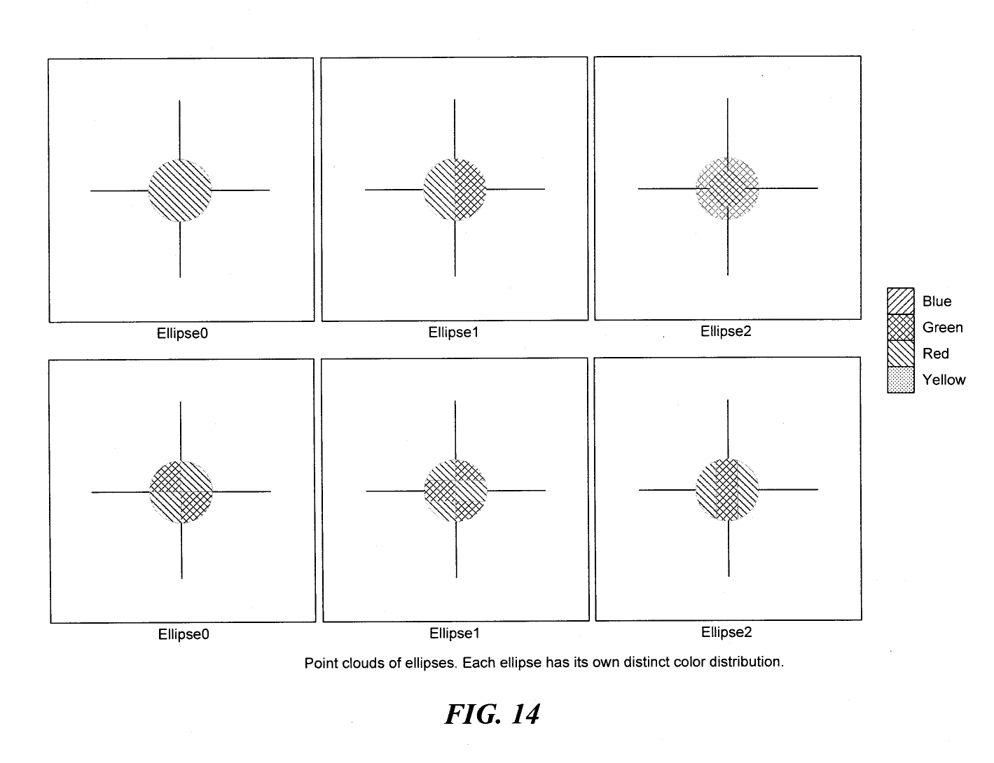

FIG. 14 includes graphs 1405-1430 of other example models that may be received by the system. Similar to the models depicted in FIG. 4, the models in FIG. 14 have similar continuous attributes (ellipse shape, or spatial coordinates) but different nominal attributes (color distribution). In the illustrated embodiment, the value of the nominal attribute (color) may be green or red. Ellipse0 depicted by graph 1405 is entirely red. Ellipse1 depicted by graph 1410 has a red left half and a green right half. Ellipse2 depicted by graph 1415 has a smaller red ellipse located at the center and surrounded by a larger green ellipse. Ellipse3 depicted by graph 1420 has a red top right quadrant, followed in a clockwise manner by green, red, and green quadrants. Ellipse4 depicted by graph 1425 has a red top right portion, followed in a clockwise manner by red, green, red, green, and red portions. Ellipse5 depicted by FIG. 1430 has a green center portion and red right and left portions.

As previously described, a sampling function is selected and applied to the models to generate difference distribution histograms representing the models. As in example 1 (bug), a variety of sampling functions may be applied to the model, including the HDCN, HDEN, and MODD sampling functions described herein.

a. HDCN Sampling Function

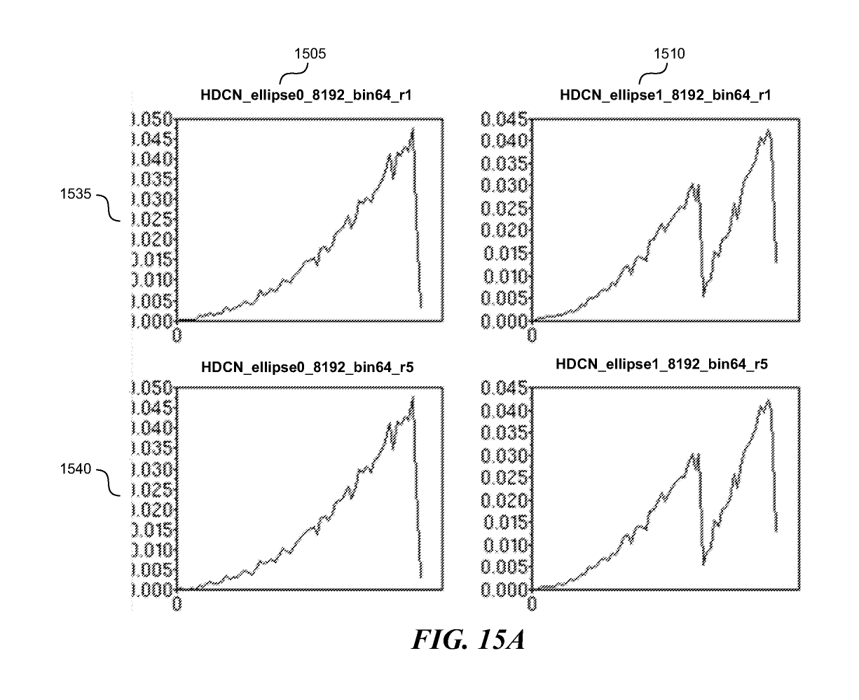

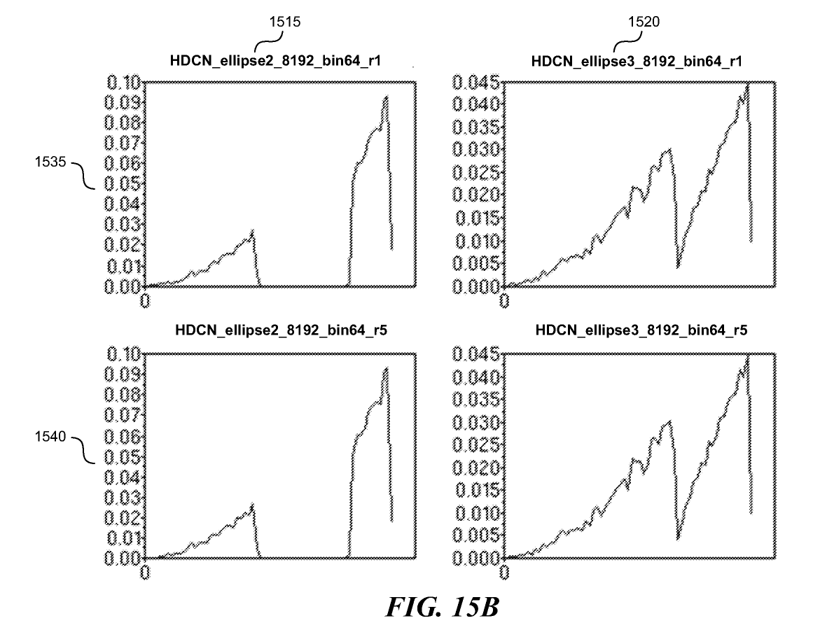

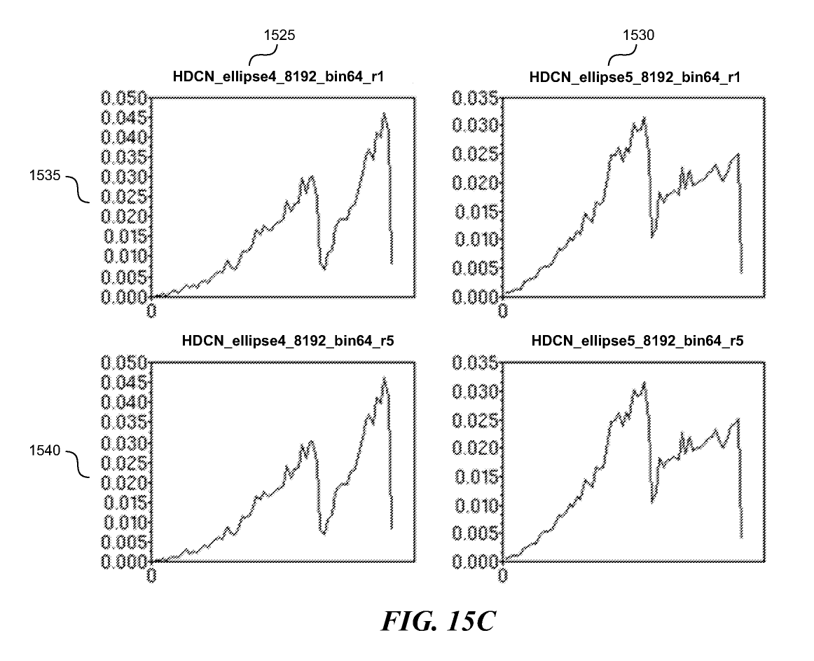

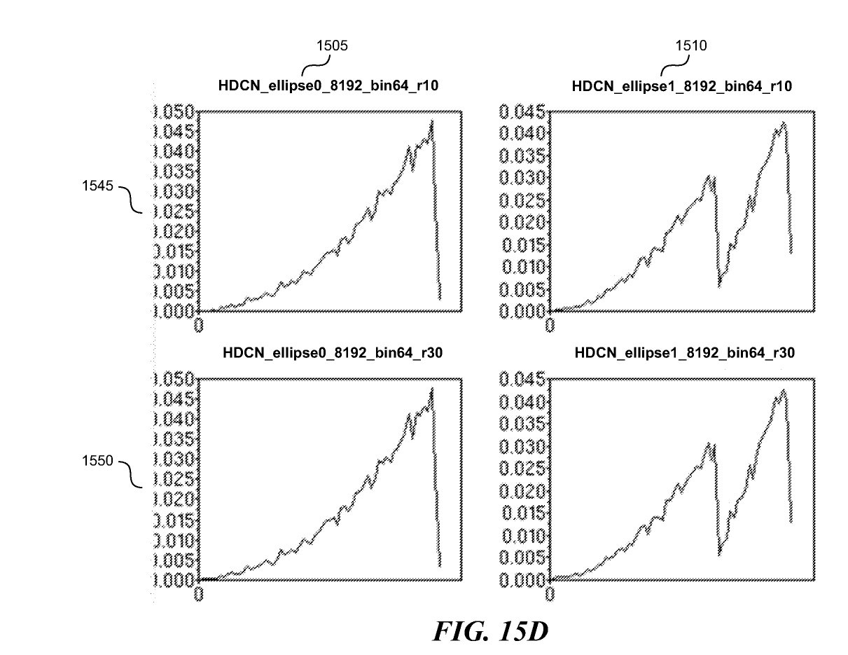

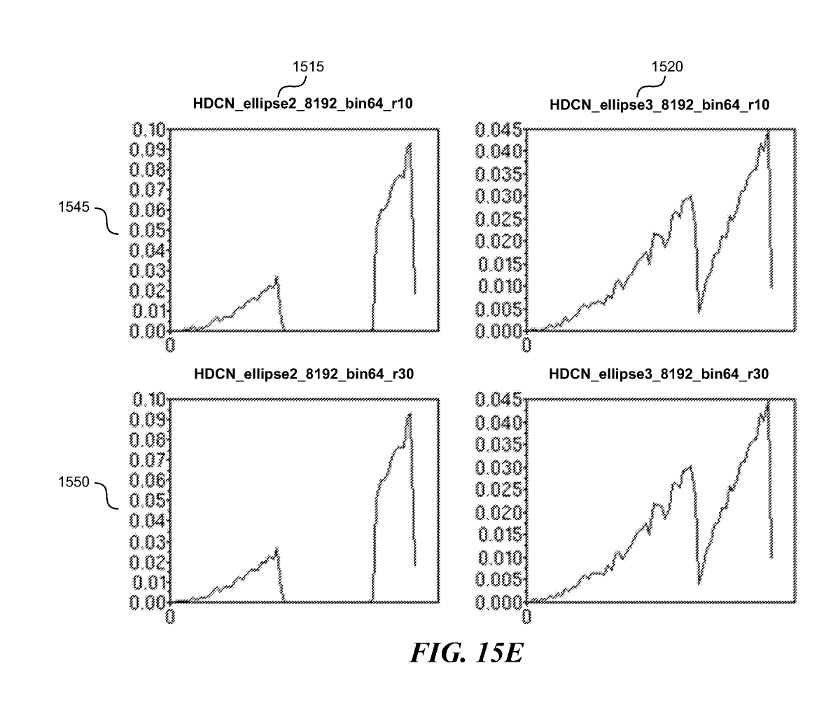

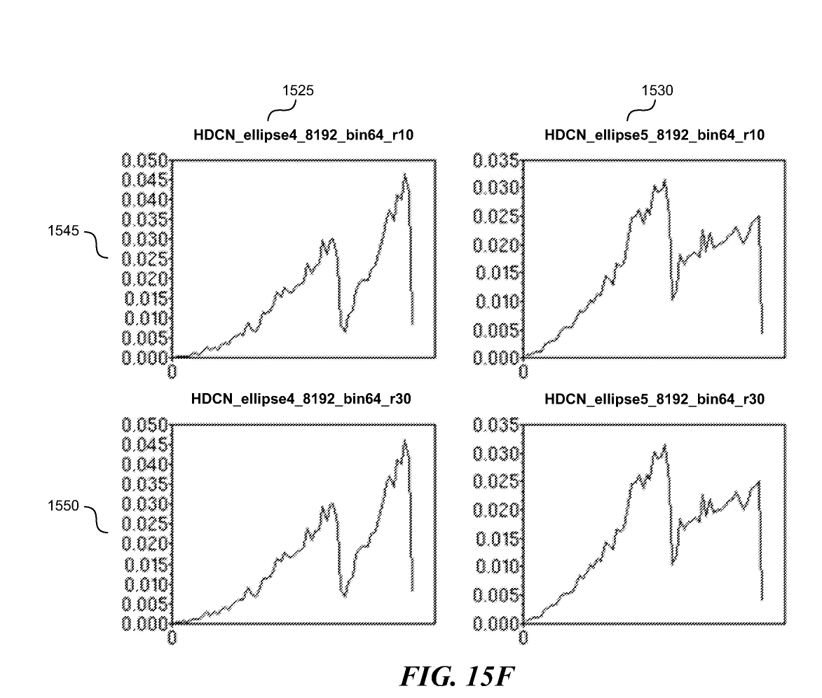

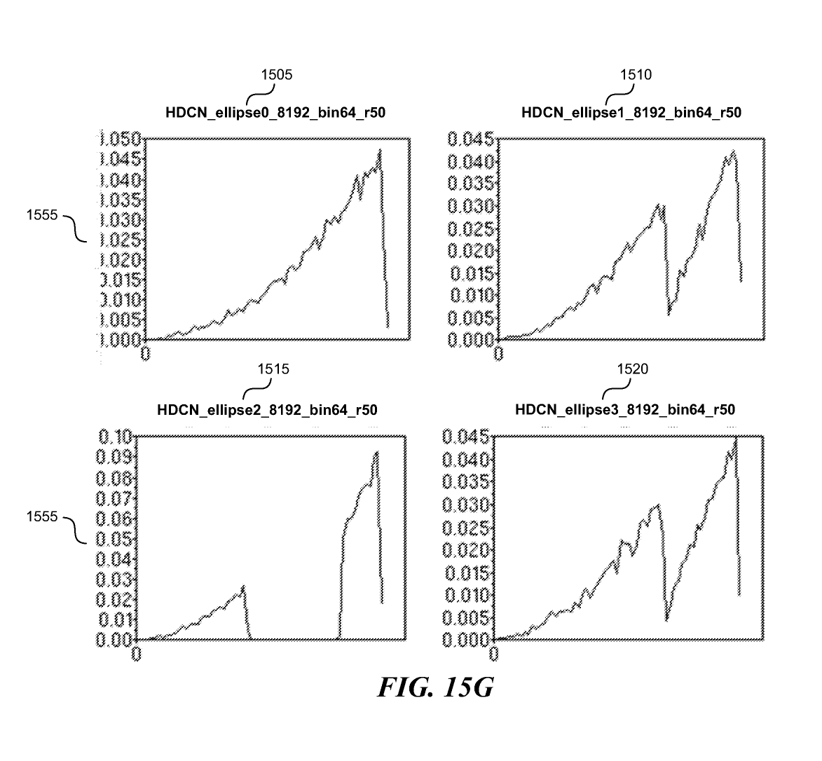

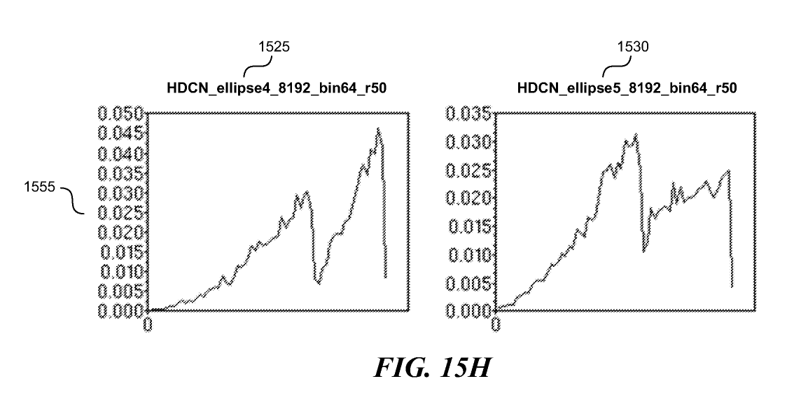

In some embodiments, the HDCN sampling function is applied to the models. FIG. 15 includes histograms in columns 1505-1530 and rows 1535-1555 generated according to the HDCN sampling function to represent the models of FIG. 14. In FIGS. 15-20, each histogram represents 8192 samples taken from the corresponding model, separated into 64 bins. The histograms in each column correspond to the same model. Histograms in column 1505 correspond to Ellipse0 depicted by graph 1405; histograms in column 1510 correspond to Ellipse1 depicted by graph 1410; histograms in column 1515 correspond to Ellipse2 depicted by graph 1415; histograms in column 1520 correspond to Ellipse3 depicted by graph 1420; histograms in column 1525 correspond to Ellipse4 depicted by graph 1425; and histograms 1530 correspond to Ellipse5 depicted by graph 1430.

The histograms in each row 1535-1555 correspond to a common radius ratio, selected from the set comprised of 0.01, 0.05, 0.10, 0.30, and 0.50. Histograms in row 1535 correspond to the radius ratio of 0.01; histograms in row 1540 correspond to the radius ratio of 0.05; histograms in row 1545 correspond to the radius ratio of 0.10; histograms in row 1550 correspond to the radius ratio of 0.30; and histograms in row 1555 correspond to the radius ratio of 0.50.

b. HDEN Sampling Function

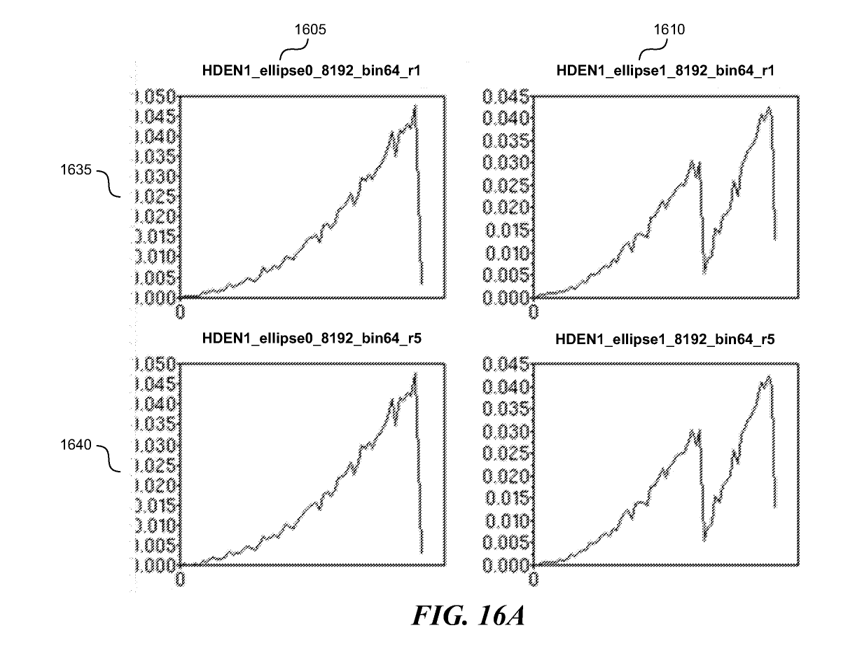

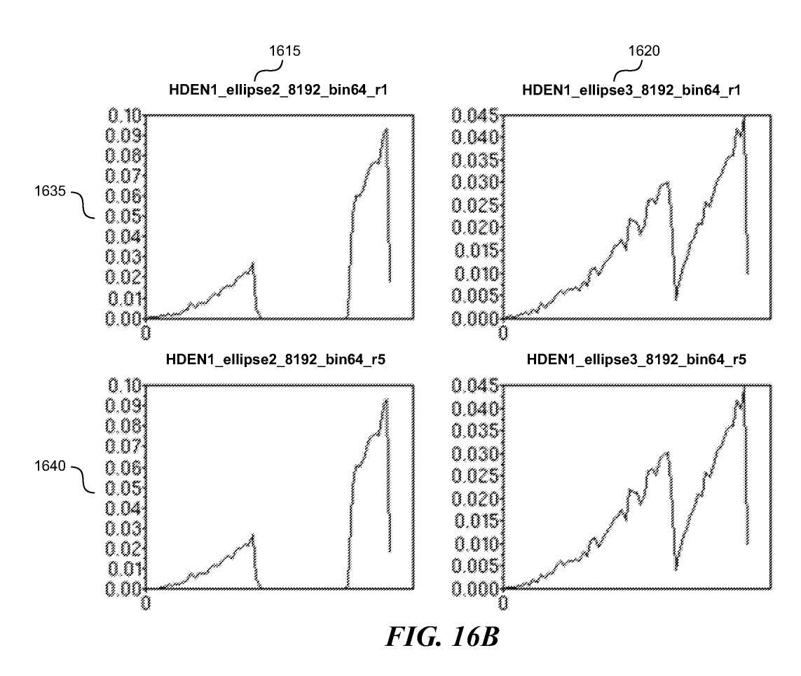

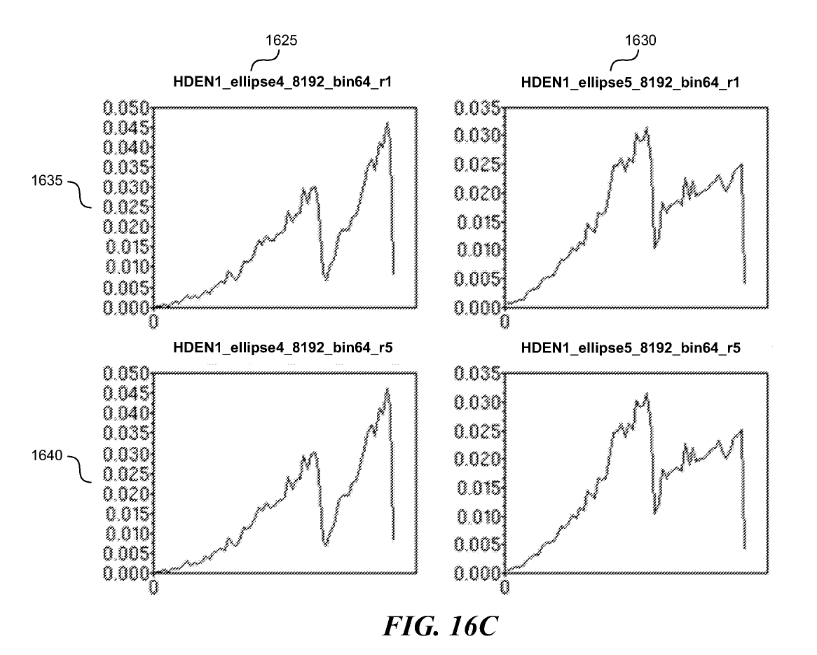

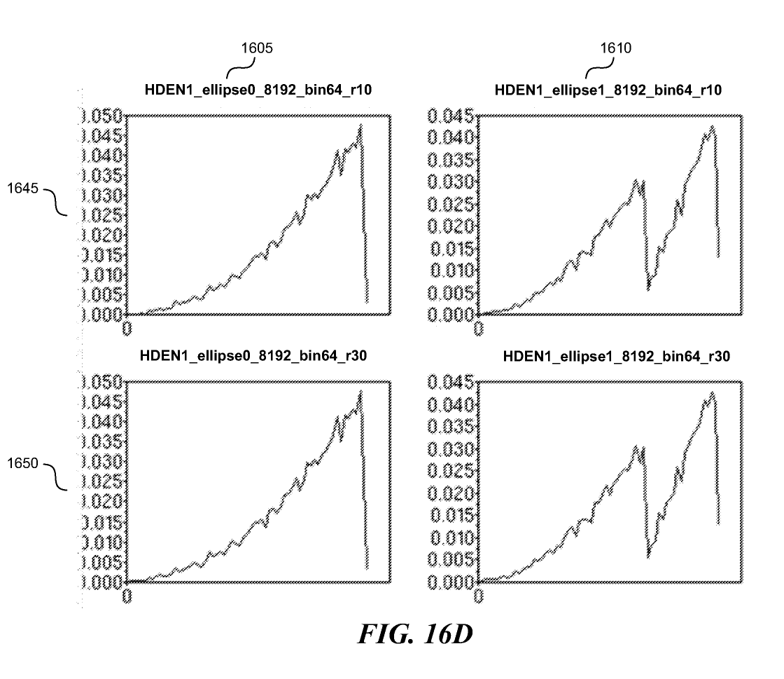

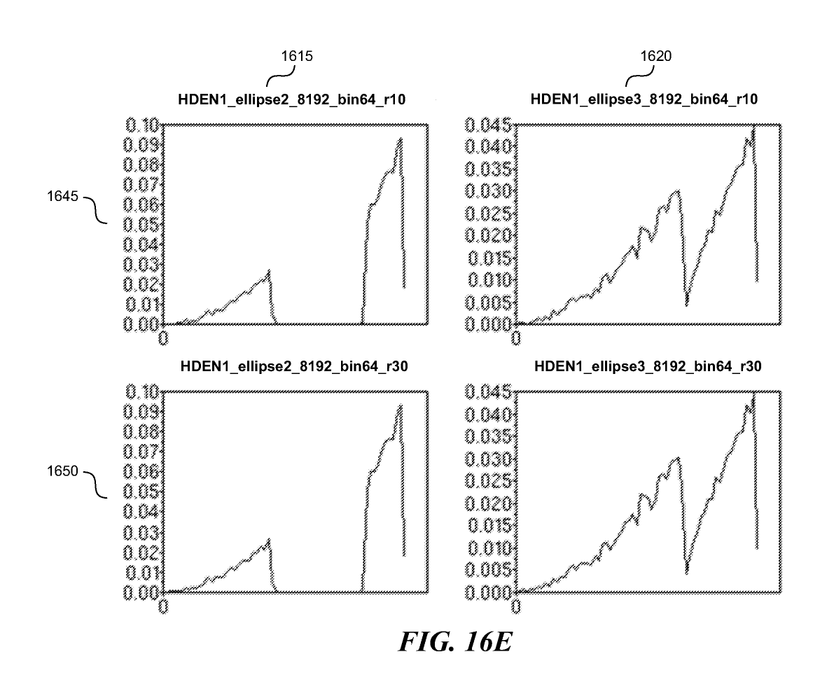

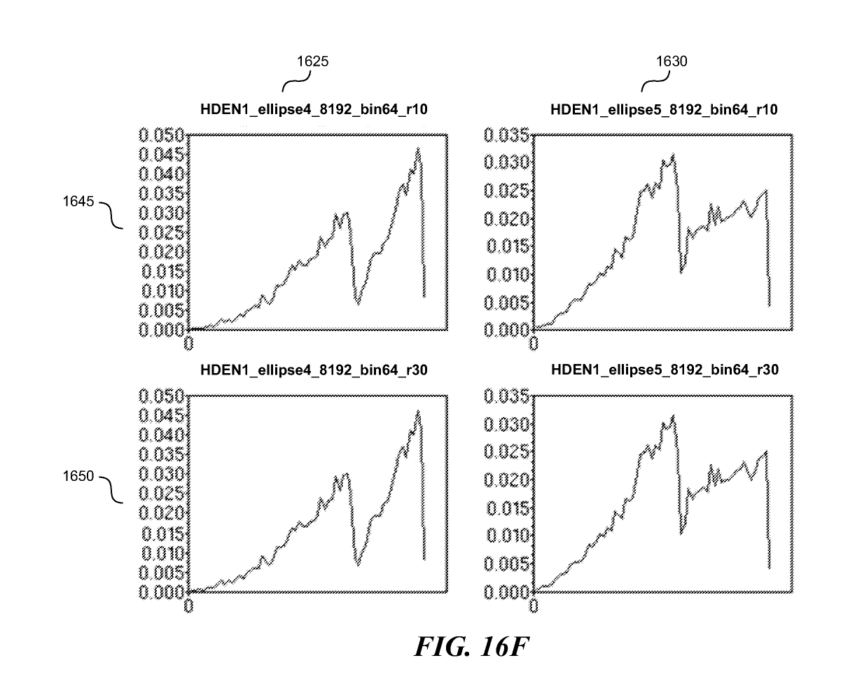

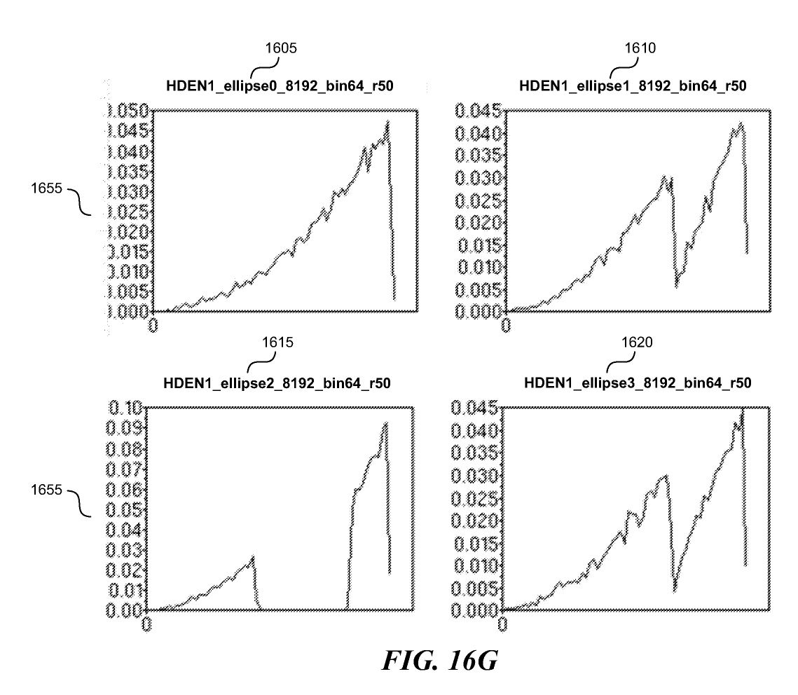

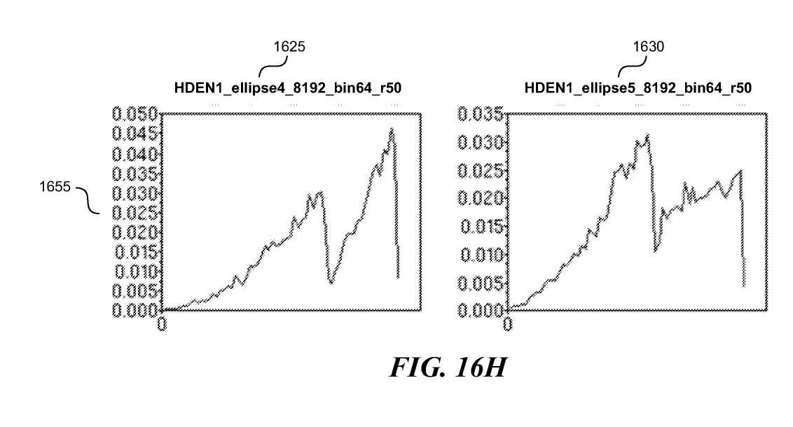

In some embodiments, the HDEN sampling function is applied to the models. FIG. 16 includes histograms in columns 1605-1630 and rows 1635-1655 generated according to the HDEN1 sampling function to represent the models of FIG. 14. The nominal attribute value in the illustrated embodiment is blue. The histograms in each column 1605-1630 correspond to the same model. Histograms in column 1605 correspond to Ellipse0 depicted by graph 1405; histograms in column 1610 correspond to Ellipse1 depicted by graph 1410; histograms in column 1615 correspond to Ellipse2 depicted by graph 1415; histograms in column 1620 correspond to Ellipse3 depicted by graph 1420; histograms in column 1625 correspond to Ellipse4 depicted by graph 1425; and histograms in column 1630 correspond to Ellipse5 depicted by graph 1430.

The histograms in each row 1635-1655 correspond to a common radius ratio, selected from the set comprised of 0.01, 0.05, 0.10, 0.30, and 0.50. Histograms in row 1635 correspond to the radius ratio of 0.01; histograms in row 1640 correspond to the radius ratio of 0.05; histograms in row 1645 correspond to the radius ratio of 0.10; histograms in row 1650 correspond to the radius ratio of 0.30; and histograms in row 1655 correspond to the radius ratio of 0.50.

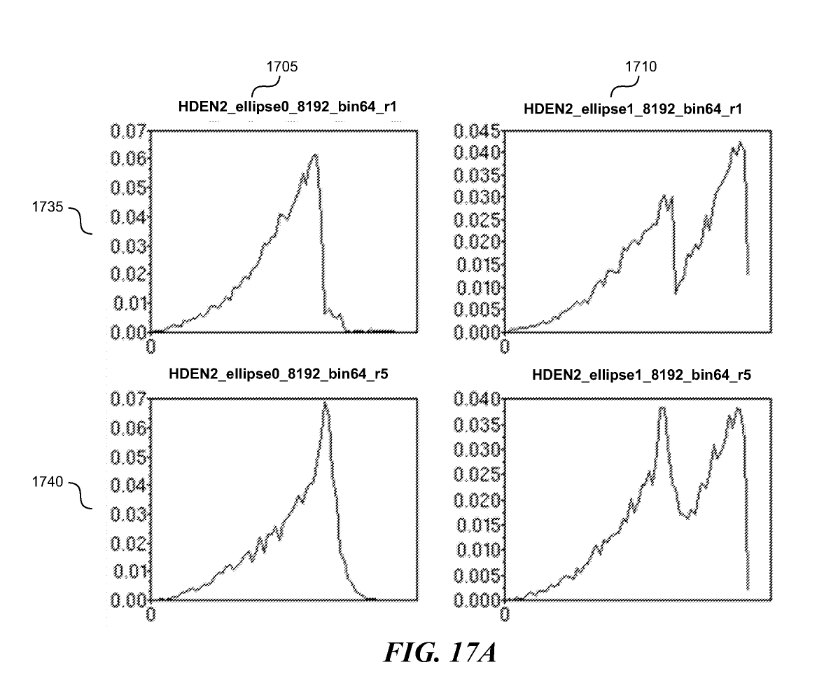

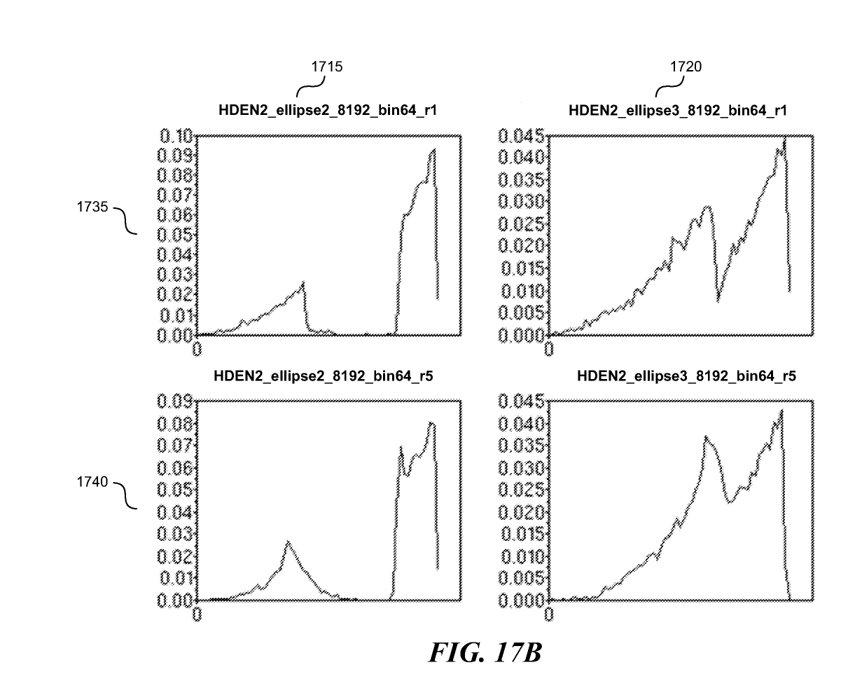

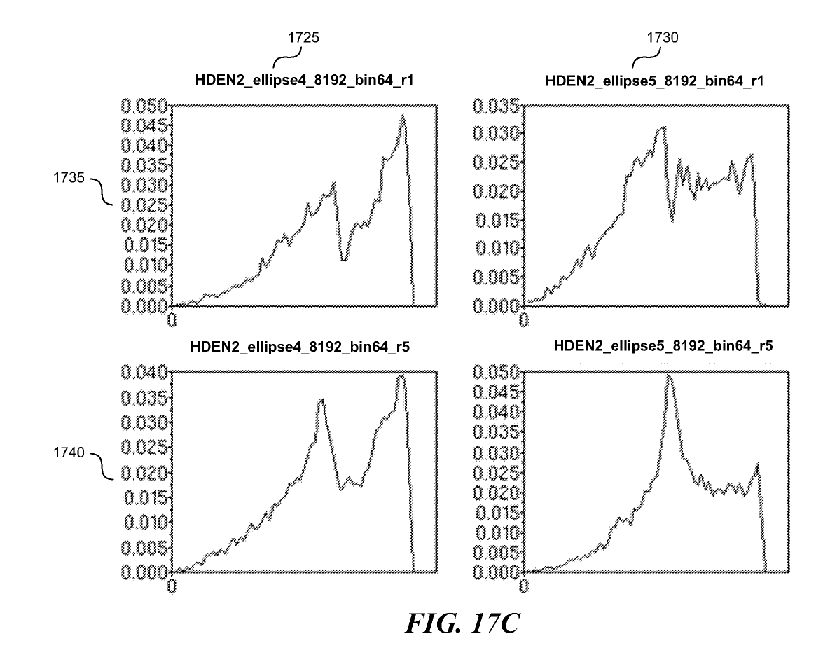

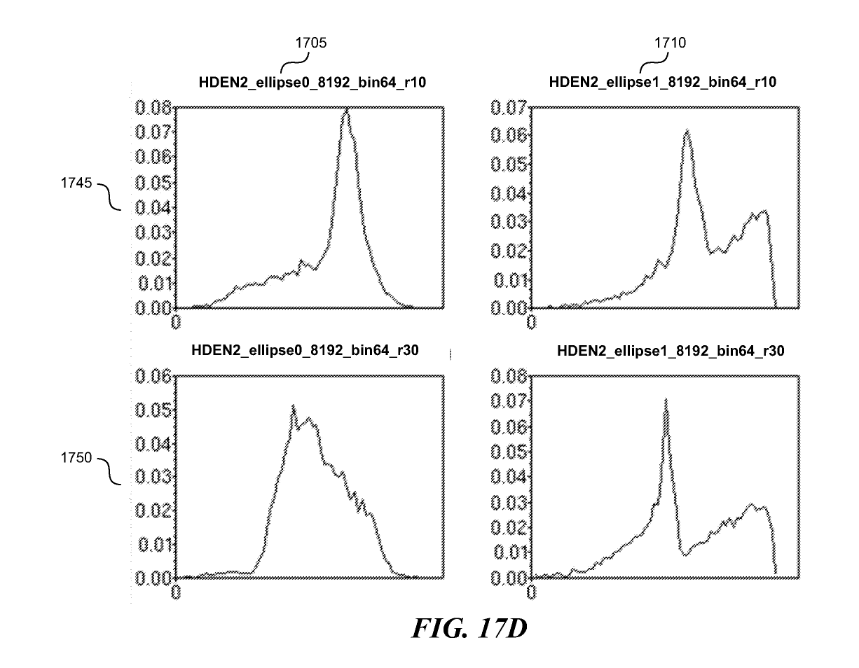

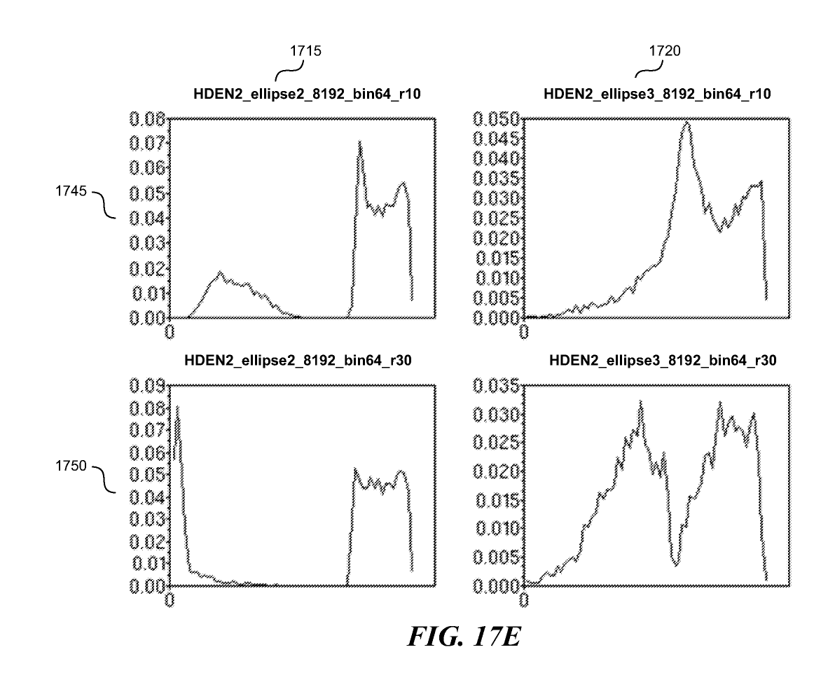

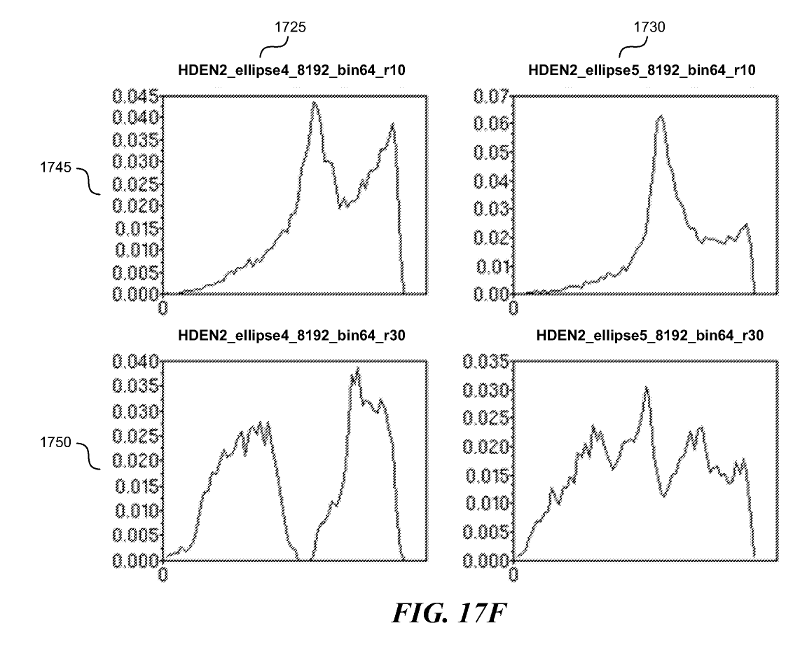

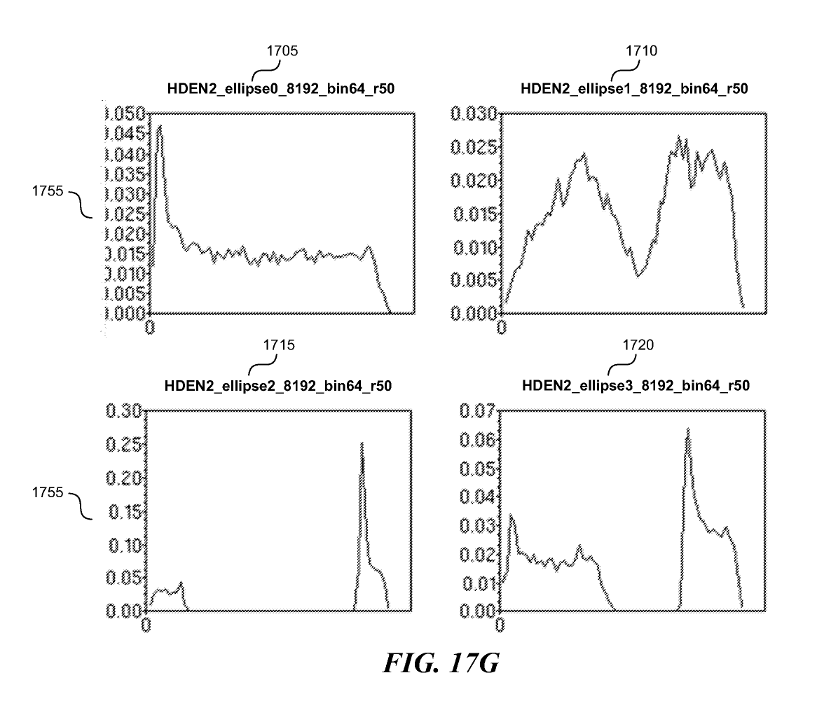

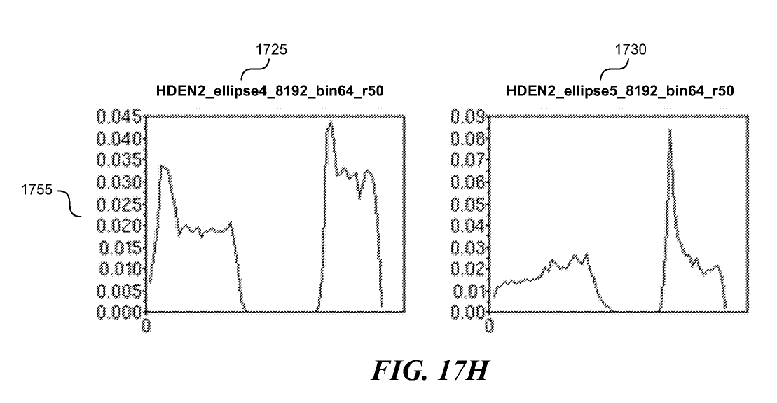

FIG. 17 includes histograms in columns 1705-1730 and rows 1735-1755 generated according to the HDEN2 sampling function to represent the models of FIG. 14. The nominal attribute values in the illustrated embodiment are blue and red. The histograms in each column 1705-1730 correspond to the same model. Histograms in column 1705 correspond to Ellipse0 depicted by graph 1405; histograms in column 1710 correspond to Ellipse1 depicted by graph 1410; histograms in column 1715 correspond to Ellipse2 depicted by graph 1415; histograms in column 1720 correspond to Ellipse3 depicted by graph 1420; histograms in column 1725 correspond to Ellipse4 depicted by graph 1425; and histograms in column 1730 correspond to Ellipse5 depicted by graph 1430.

The histograms in each row 1735-1755 correspond to a common radius ratio, selected from the set comprised of 0.01, 0.05, 0.10, 0.30, and 0.50. Histograms in row 1735 correspond to the radius ratio of 0.01; histograms in row 1740 correspond to the radius ratio of 0.05; histograms in row 1745 correspond to the radius ratio of 0.10; histograms in row 1750 correspond to the radius ratio of 0.30; and histograms in row 1755 correspond to the radius ratio of 0.50.

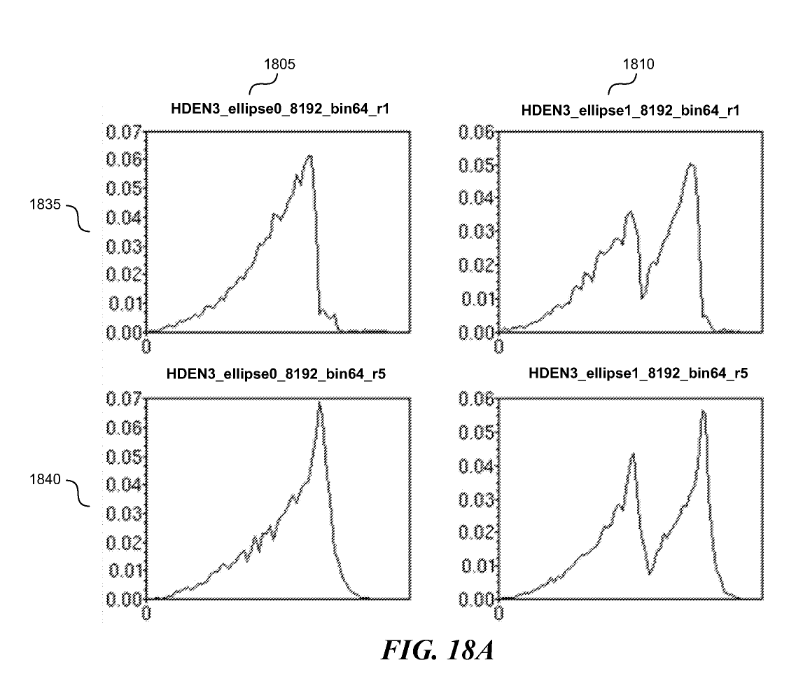

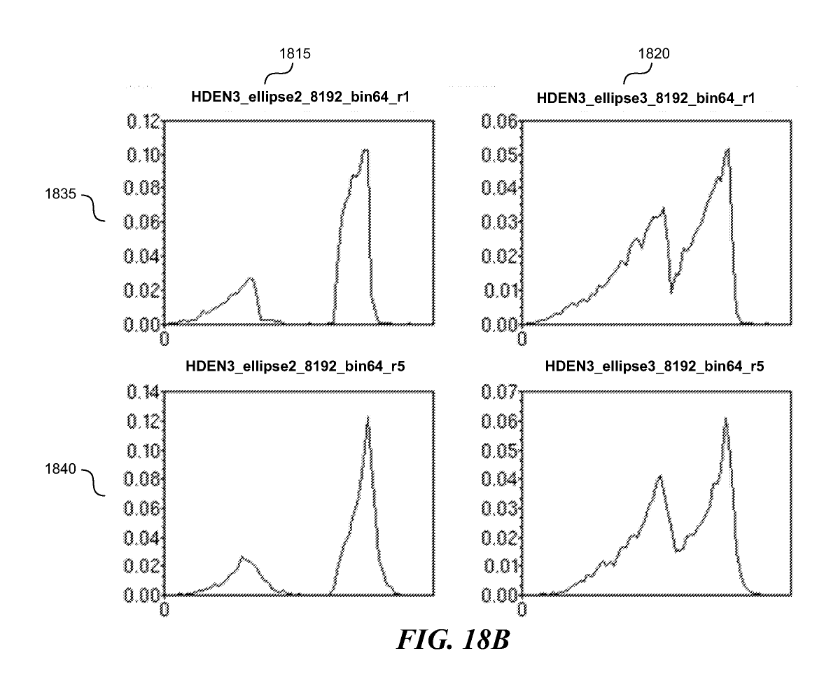

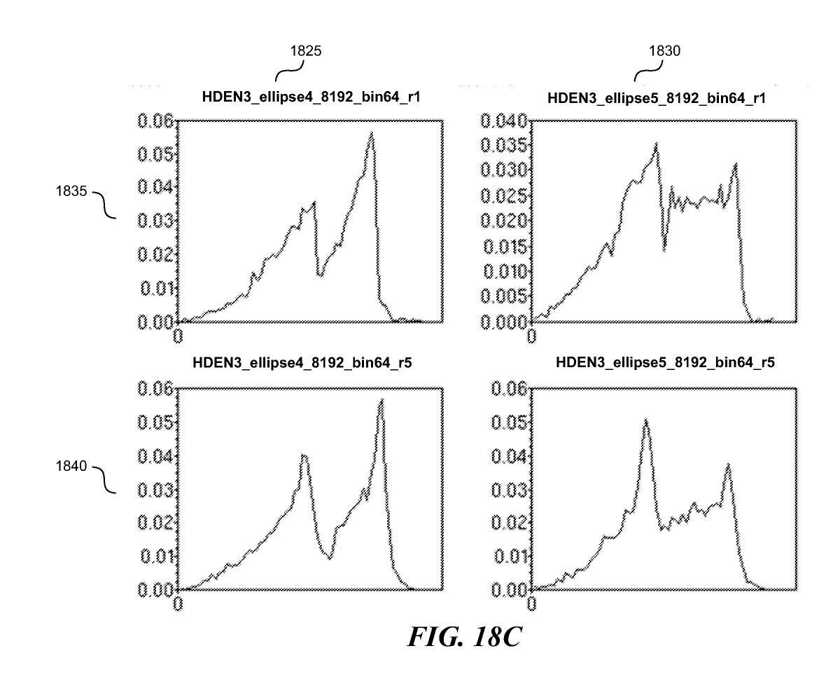

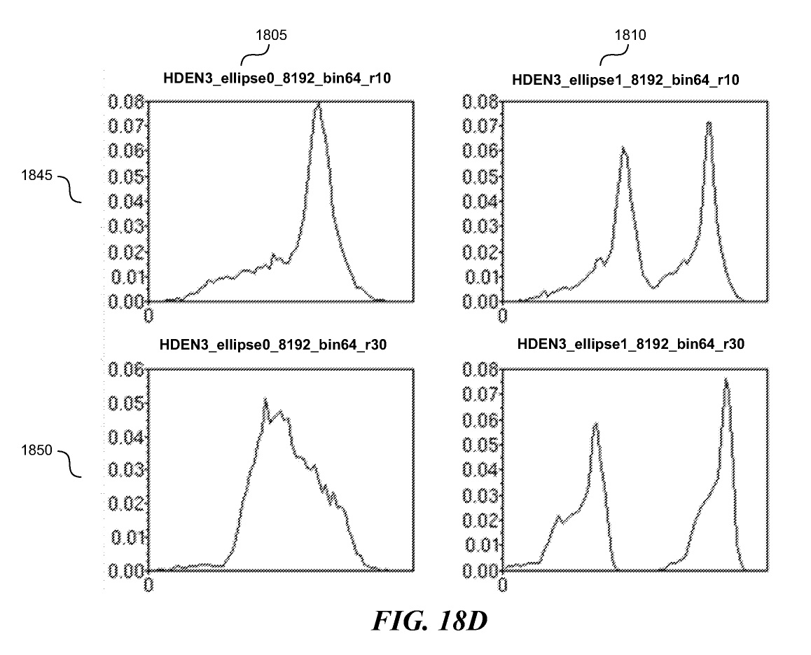

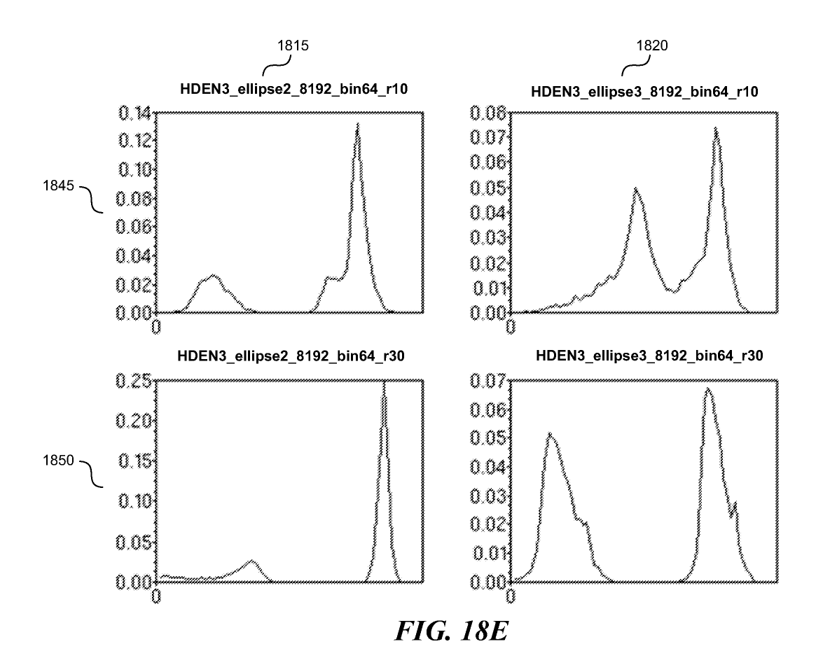

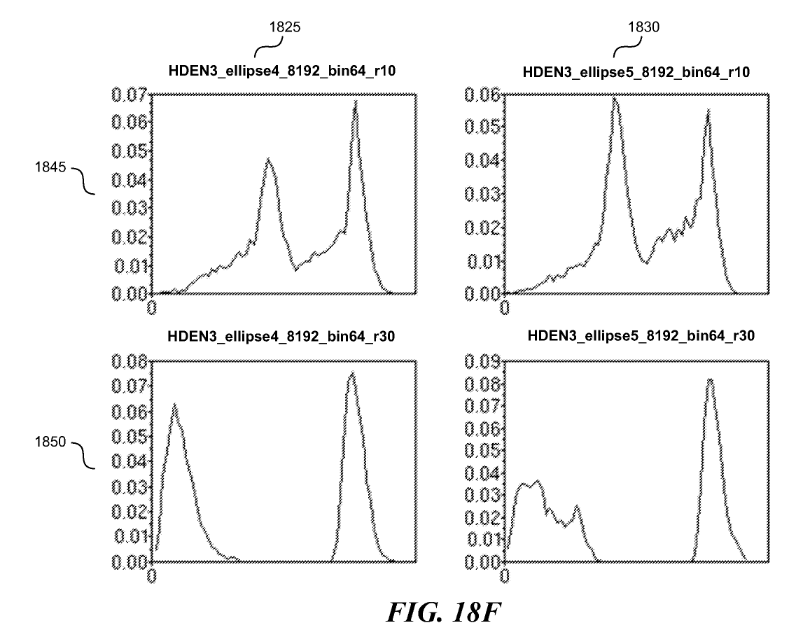

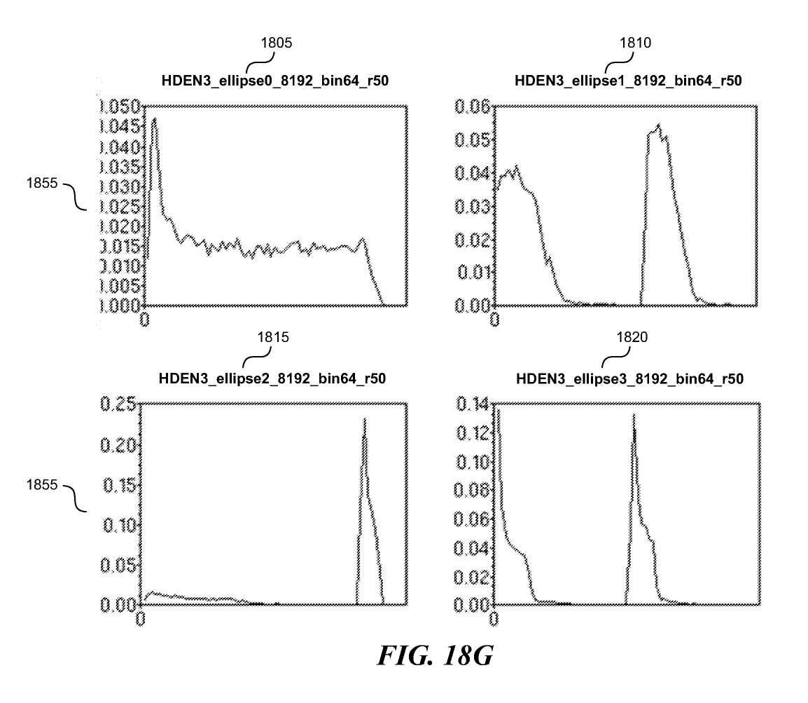

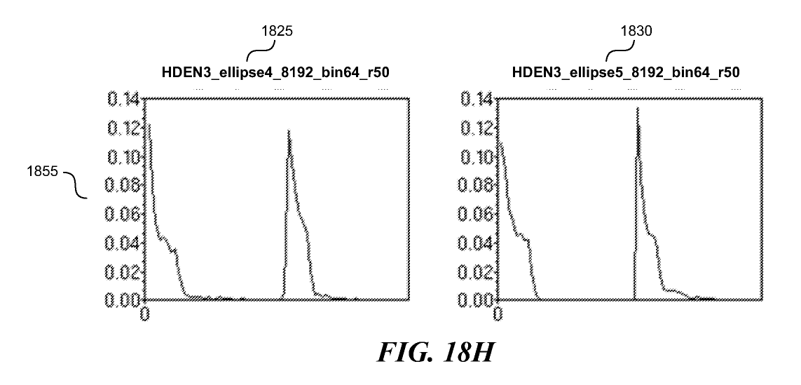

FIG. 18 includes histograms in columns 1805-1830 and rows 1835-1855 generated according to the HDEN3 sampling function to represent the models of FIG. 14. The nominal attribute values in the illustrated embodiment are blue, red, and green. The histograms in each column 1805-1830 correspond to the same model. Histograms in column 1805 correspond to Ellipse0 depicted by graph 1405; histograms in column 1810 correspond to Ellipse1 depicted by graph 1410; histograms in column 1815 correspond to Ellipse2 depicted by graph 1415; histograms in column 1820 correspond to Ellipse3 depicted by graph 1420; histograms in column 1825 correspond to Ellipse4 depicted by graph 1425; and histograms in column 1830 correspond to Ellipse5 depicted by graph 1430.

The histograms in each row 1835-1855 correspond to a common radius ratio, selected from the set comprised of 0.01, 0.05, 0.10, 0.30, and 0.50. Histograms in row 1835 correspond to the radius ratio of 0.01; histograms in row 1840 correspond to the radius ratio of 0.05; histograms in row 1845 correspond to the radius ratio of 0.10; histograms in row 1850 correspond to the radius ratio of 0.30; and histograms in row 1855 correspond to the radius ratio of 0.50.

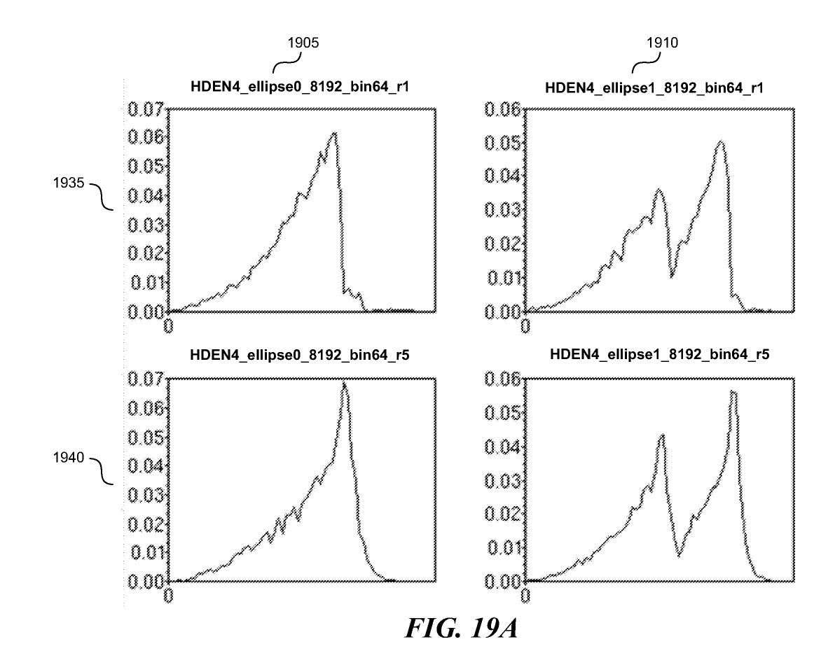

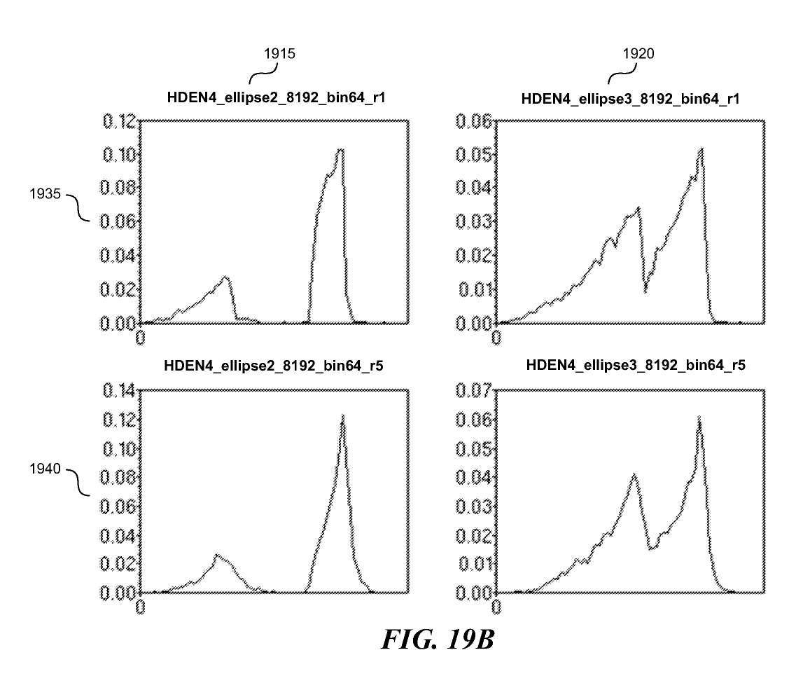

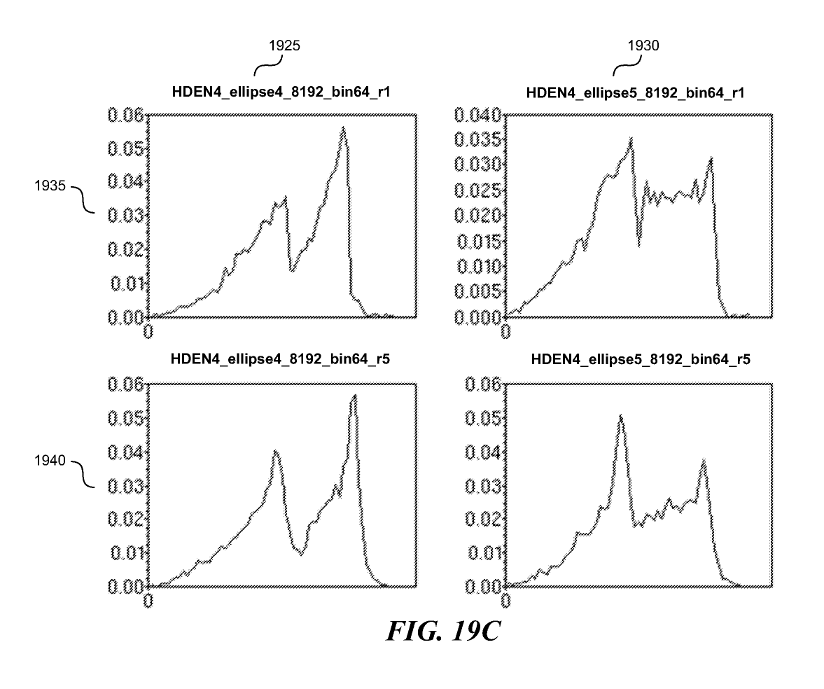

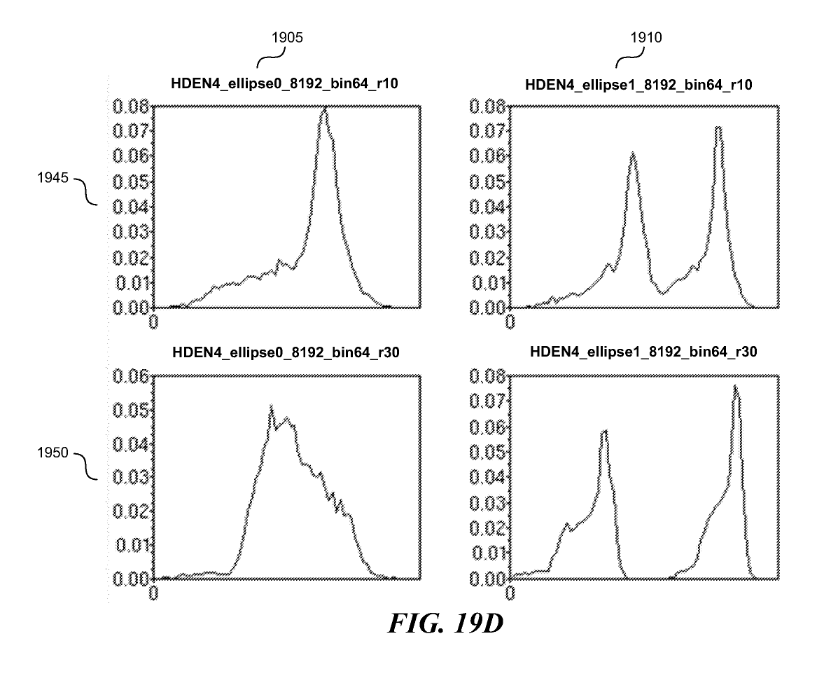

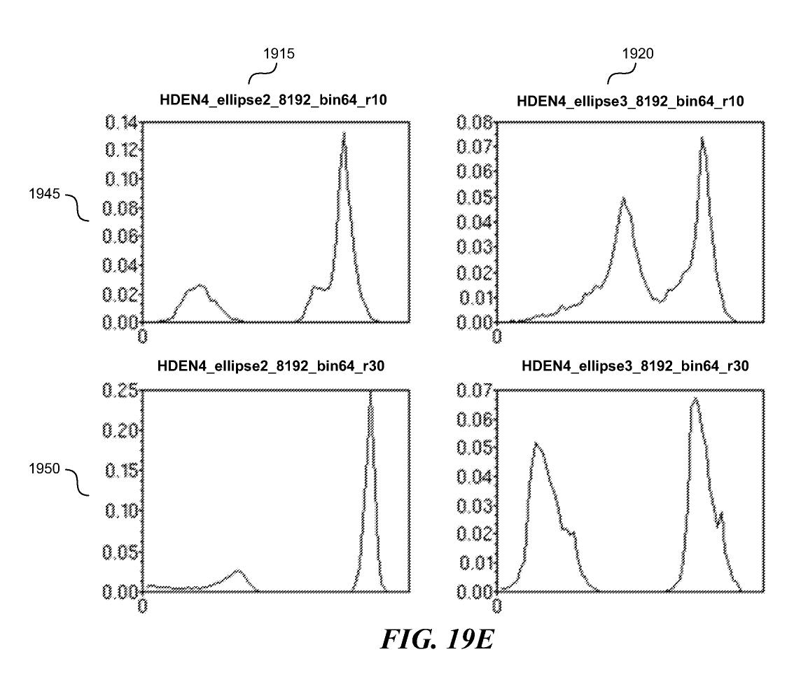

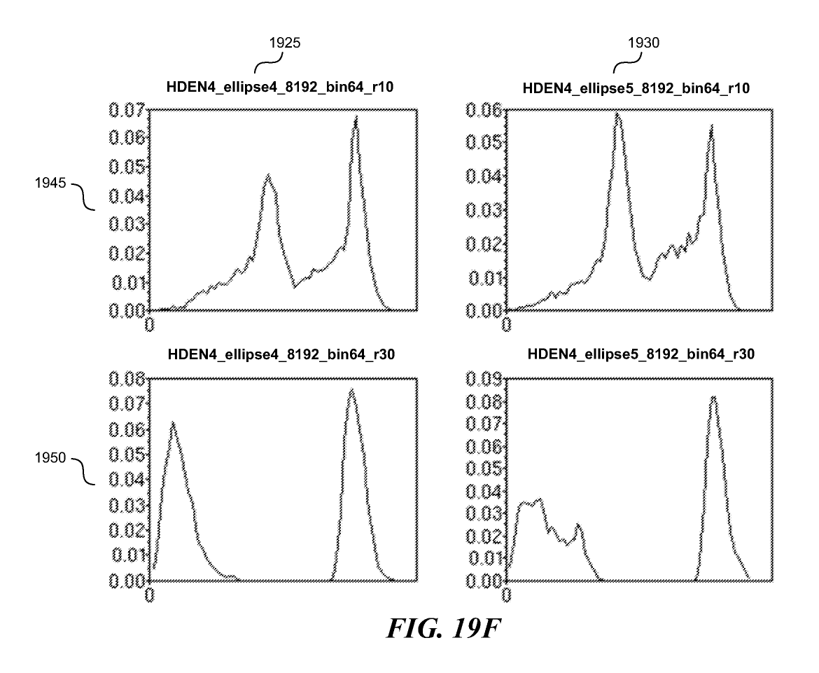

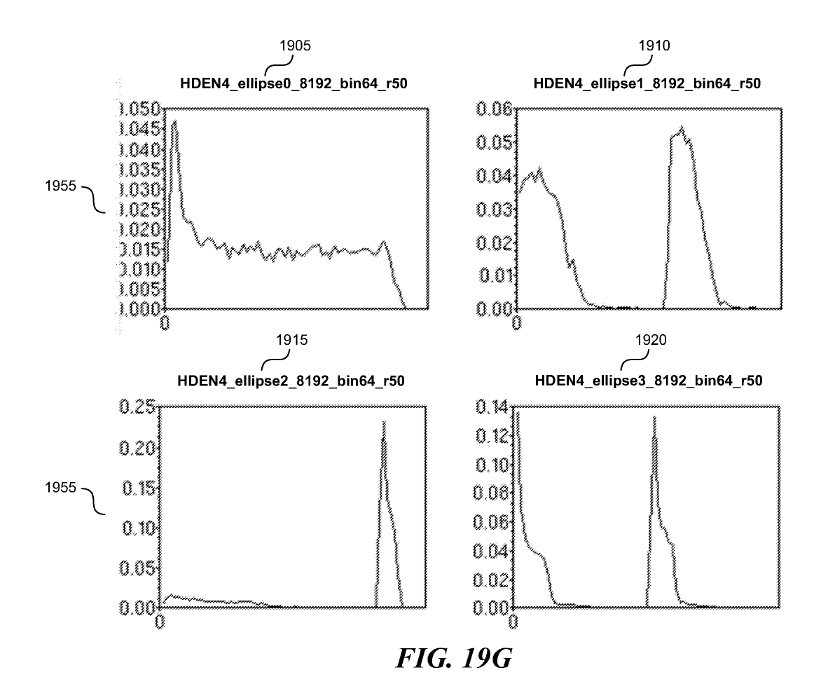

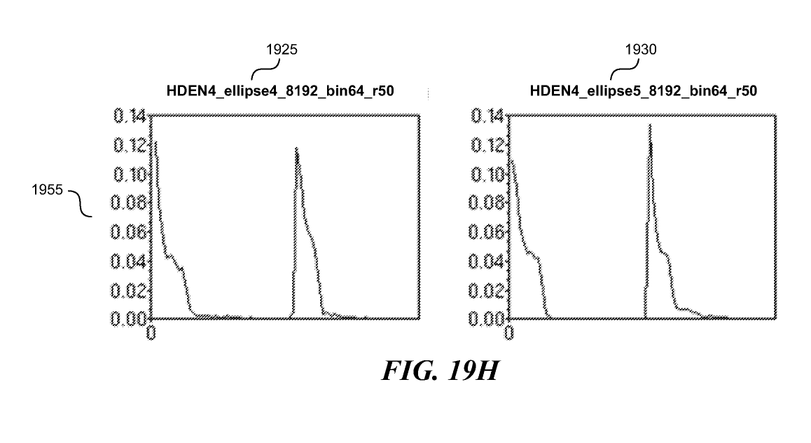

FIG. 19 includes histograms in columns 1905-1930 and rows 1935-1955 generated according to the HDEN4 sampling function to represent the models of FIG. 14. The nominal attribute values in the illustrated embodiment are blue, red, green, and yellow. The histograms in each column 1905-1930 correspond to the same model. Histograms in column 1905 correspond to Ellipse0 depicted by graph 1405; histograms in column 1910 correspond to Ellipse1 depicted by graph 1410; histograms in column 1915 correspond to Ellipse2 depicted by graph 1415; histograms in column 1920 correspond to Ellipse3 depicted by graph 1420; histograms in column 1925 correspond to Ellipse4 depicted by graph 1425; and histograms in column 1930 correspond to Ellipse5 depicted by graph 1430.

The histograms in each row 1935-1955 correspond to a common radius ratio, selected from the set comprised of 0.01, 0.05, 0.10, 0.30, and 0.50. Histograms in row 1935 correspond to the radius ratio of 0.01; histograms in row 1940 correspond to the radius ratio of 0.05; histograms in row 1945 correspond to the radius ratio of 0.10; histograms in row 1950 correspond to the radius ratio of 0.30; and histograms in row 1955 correspond to the radius ratio of 0.50.

c. MODD Sampling Function

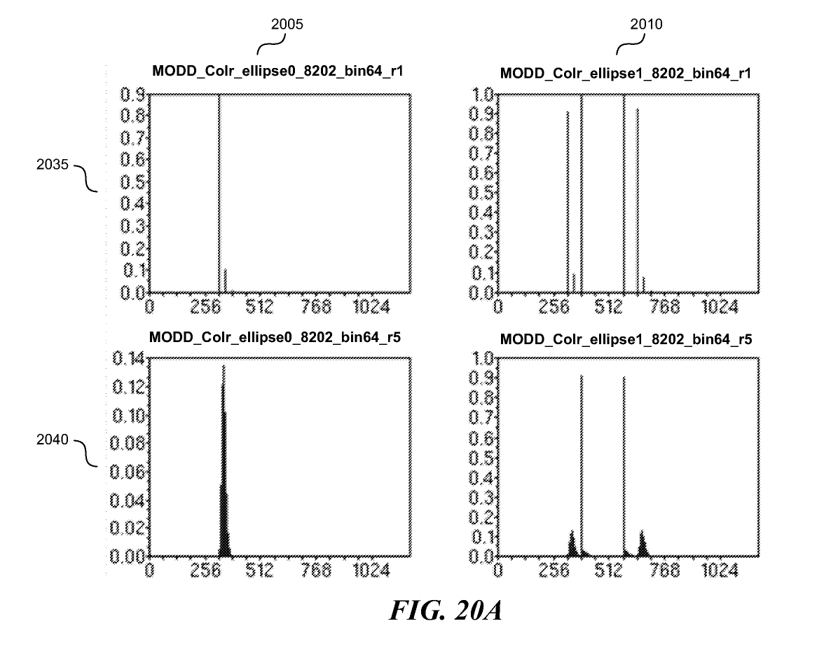

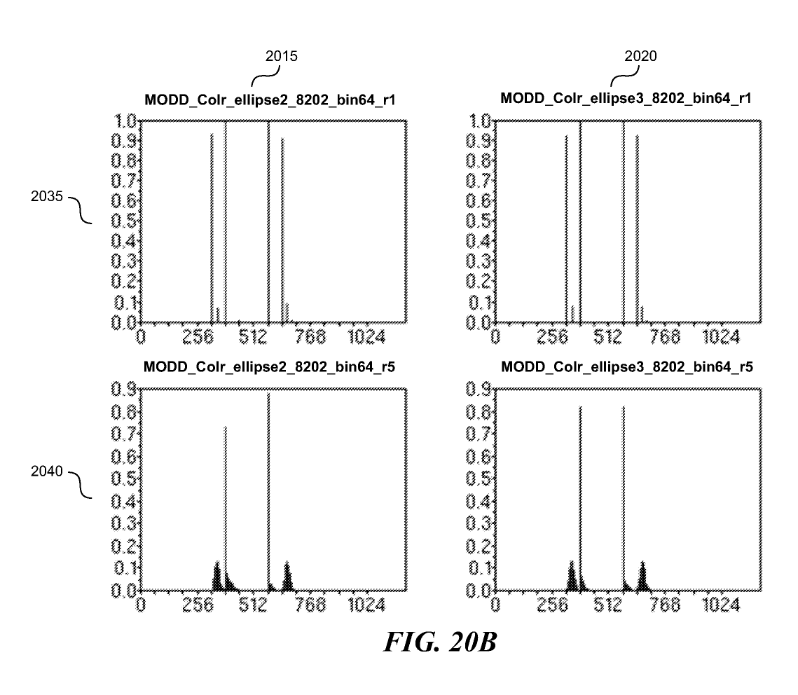

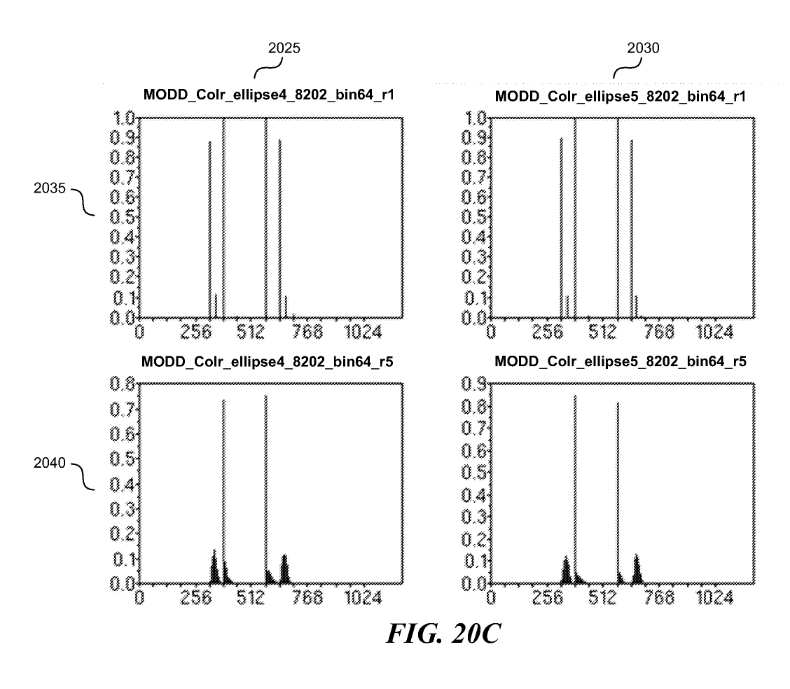

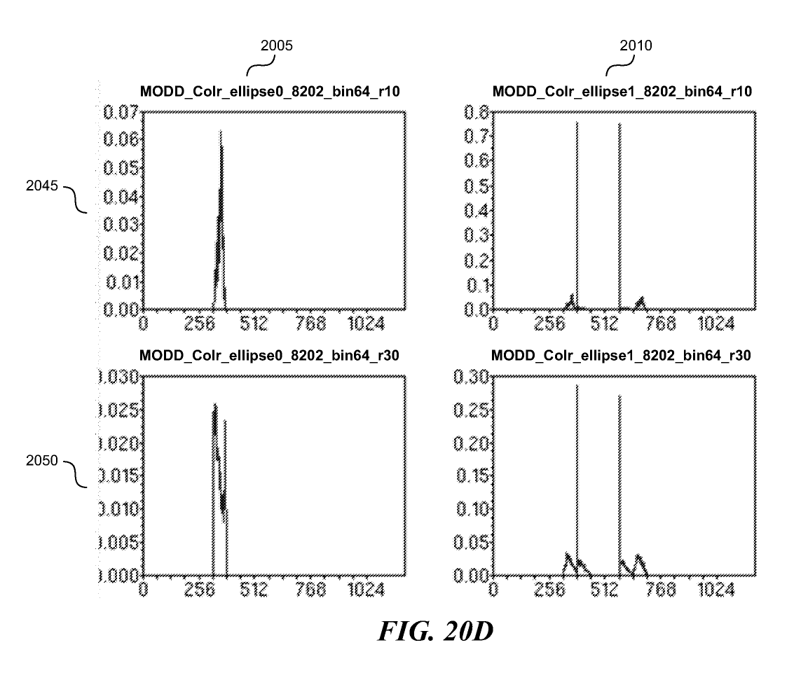

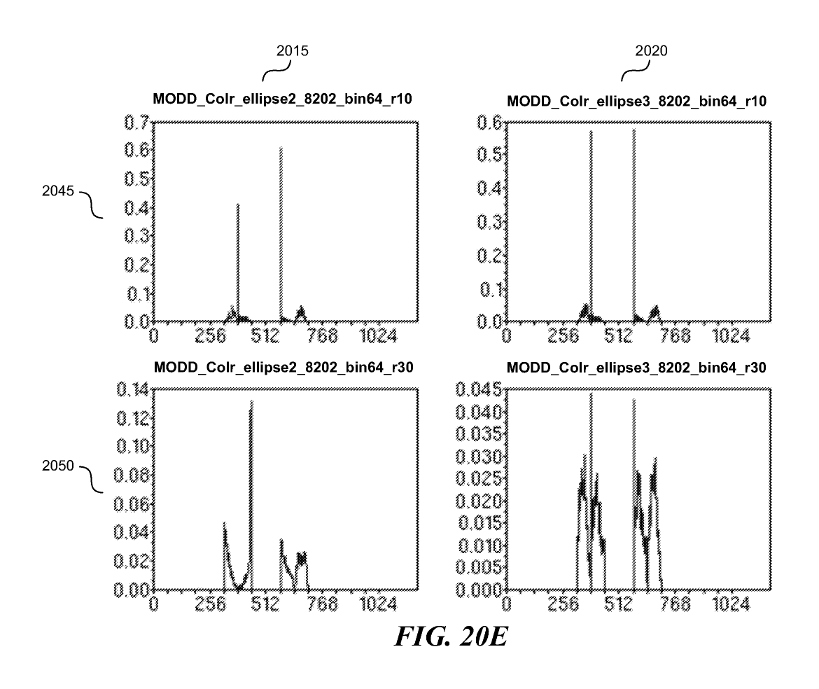

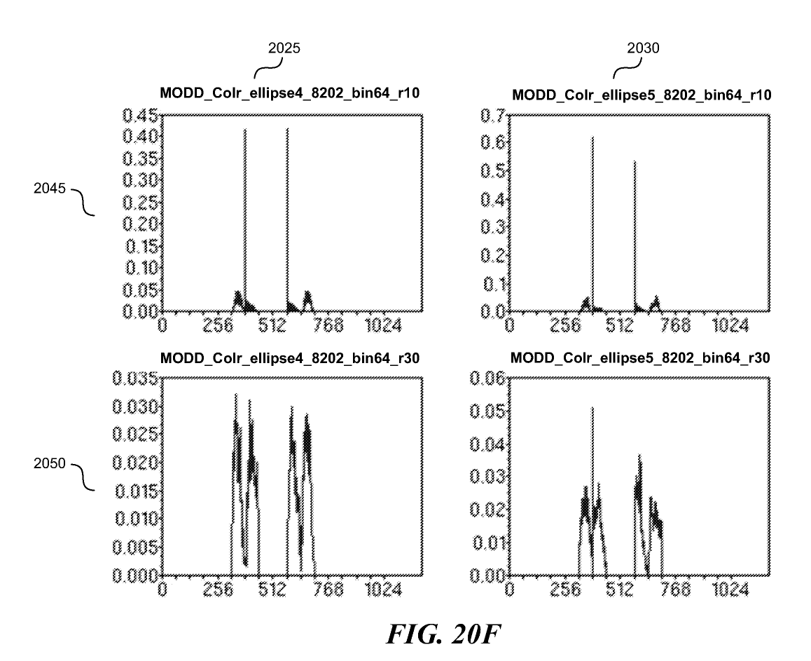

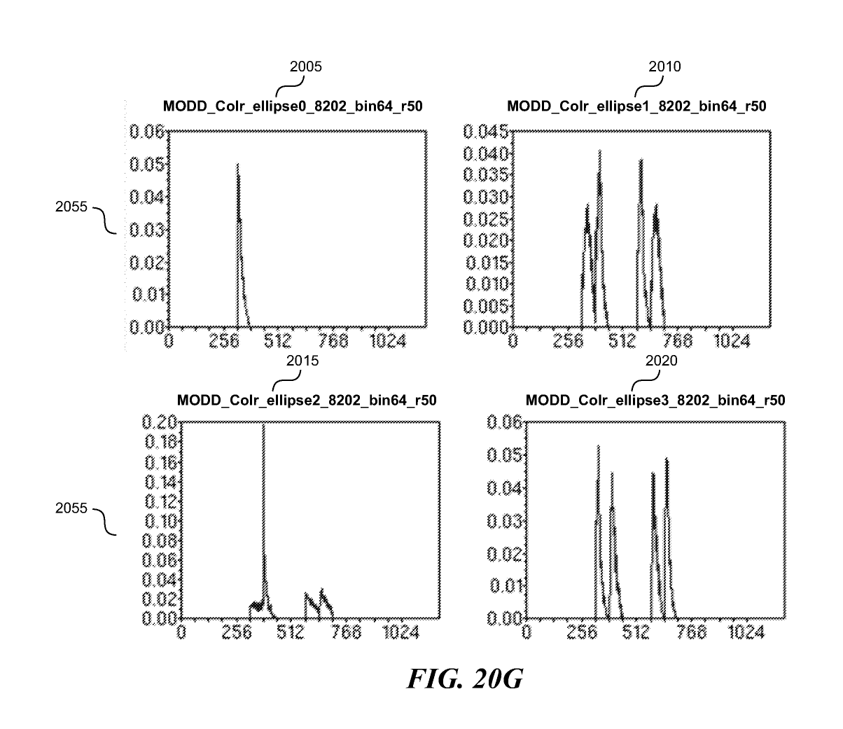

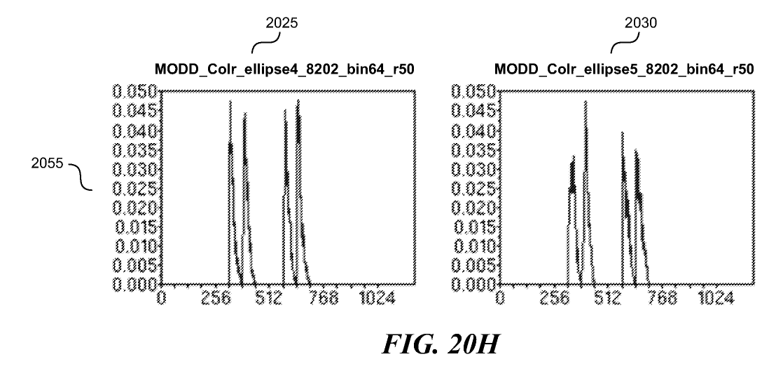

In some embodiments, the MODD sampling function is applied to the models. FIG. 20 includes histograms in columns 2005-2030 and rows 2035-2055 generated according to the MODD sampling function to represent the models of FIG. 14. The histograms in each column 2005-2030 correspond to the same model. Histograms in column 2005 correspond to Ellipse0 depicted by graph 1405; histograms in column 2010 correspond to Ellipse1 depicted by graph 1410; histograms in column 2015 correspond to Ellipse2 depicted by graph 1415; histograms in column 2020 correspond to Ellipse3 depicted by graph 1420; histograms in column 2025 correspond to Ellipse4 depicted by graph 1425; and histograms in column 2030 correspond to Ellipse5 depicted by graph 1430.

The histograms in each row 2035-2055 correspond to a common radius ratio, selected from the set comprised of 0.01, 0.05, 0.10, 0.30, and 0.50. Histograms in row 2035 correspond to the radius ratio of 0.01; histograms in row 2040 correspond to the radius ratio of 0.05; histograms in row 2045 correspond to the radius ratio of 0.10; histograms in row 2050 correspond to the radius ratio of 0.30; and histograms in row 2055 correspond to the radius ratio of 0.50.

B. Measuring the Similarity of Multiple Difference Distribution Histograms

Once multiple difference distribution histograms have been generated to represent multiple models, the similarity of the difference distribution histograms—and thus the models—is determined. FIG. 3B is a flow diagram of a suitable process 345 for comparing difference distribution histograms in accordance with the described technology. In some embodiments, the process 345 is executed by the computing system 100 depicted in FIG. 1 and/or in the computing environment depicted in FIG. 2.

At a block 350, the process 345 receives two or more difference distribution histograms for comparison. The histograms may be provided by the system, a modeling and/or information system, a user, and/or in another manner. In some embodiments, at least one of the difference distribution histograms is stored in a database, such as a database stored on a data storage device 104 (FIG. 1) or database 210 (FIG. 2). For example, the system may receive one or more distribution histograms that are to be matched against a database of multiple predefined models. In some embodiments, at least one of the difference distribution histograms is a target specified in a fitness function for a genetic algorithm or machine learning search, to be compared against the difference distribution histograms generated from one or more candidate models.

At a block 355, the process 345 selects a distribution test function to be applied to the received difference distribution histograms to measure the similarity of the histograms. A variety of distribution test functions may be applied to the difference distribution histograms to determine similarity, including several distribution test functions well known in the field of statistics. Suitable distribution test functions include, but are not limited to the chi-square test (herein referred to as “chi”), the Bhattacharyya distance (herein referred to a “bha”), and/or a Minkowski norm (herein referred to as “pdf”). The distribution test functions described herein are provided for illustrative purposes only, and are not intended to limit the described technology. One skilled in the art will appreciate that a variety of other distribution test functions may be used.

In some embodiments, a chi test function is applied to the difference distribution histograms. The chi test function is provided by equation (11):

$$D ( f , g ) = \int \frac{{( f - g )}^{2}}{( f - g )} \qquad ( 11 )$$

In equation (11), f and g represent two difference distribution histograms for comparison. For each bin, a comparison is made between the number of events observed (i.e., measurements made) in f and the number of events observed in g. In some embodiments, for the distribution test functions described herein, a large distance value indicates a low probability that the difference distribution histograms represent the same model; a small distance value indicates a higher probability that the difference distribution histograms represent the same model.

In some embodiments, a bha test function is applied to the difference distribution histograms. The bha test function is provided by equation (12):

D(f,g)=1−∫\sqrt{fg} (12)

In some embodiments, a pdf test function is applied to the difference distribution histograms. A pdf test function is provided by equation (13):

D(f,g)=∫(|f−g|^{N})^{1/N} (13)

Where the exponent N equals 1, the pdf test function (herein referred to as “pdfL1”) is provided by equation (14):

D(f,g)=∫|f−g| (14)

Where the exponent N equals 2, the pdf test function (herein referred to as “pdfL2”) is defined by equation (15):

D(f,g)=∫(|f−g|²)^{1/2} (15)

Returning to FIG. 3B, once a distribution test function has been selected, at a block 360, the test function is applied to the difference distribution histograms in order to determine the similarity of the histograms. The application of test functions to difference distribution histograms is described in additional detail in reference to example 1 (bug) and example 2 (ellipse).

### i. Example 1

### Bug

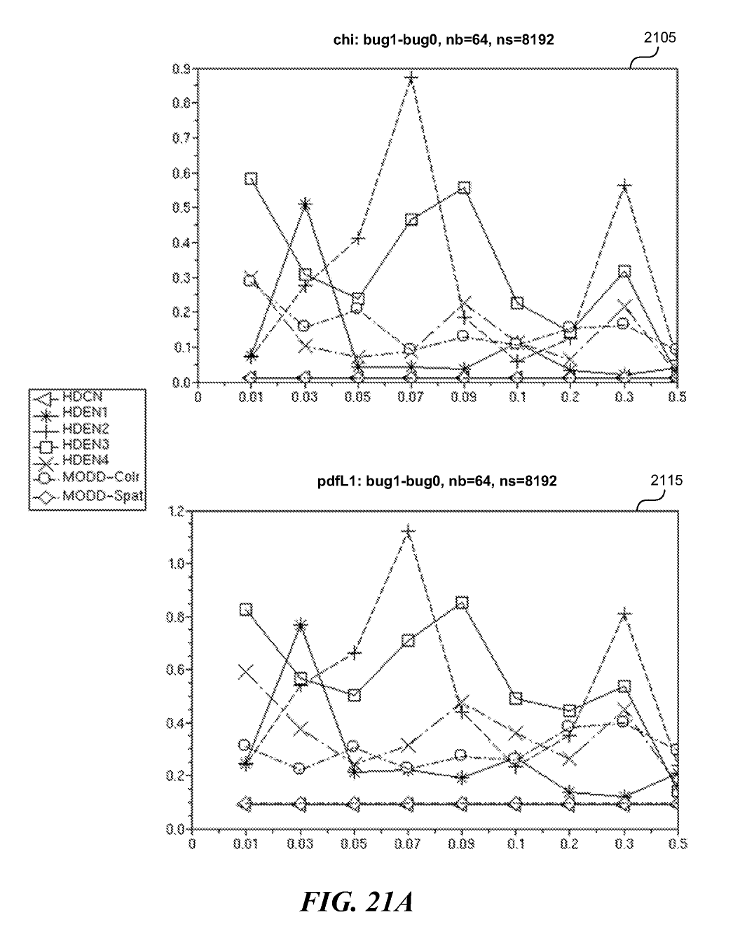

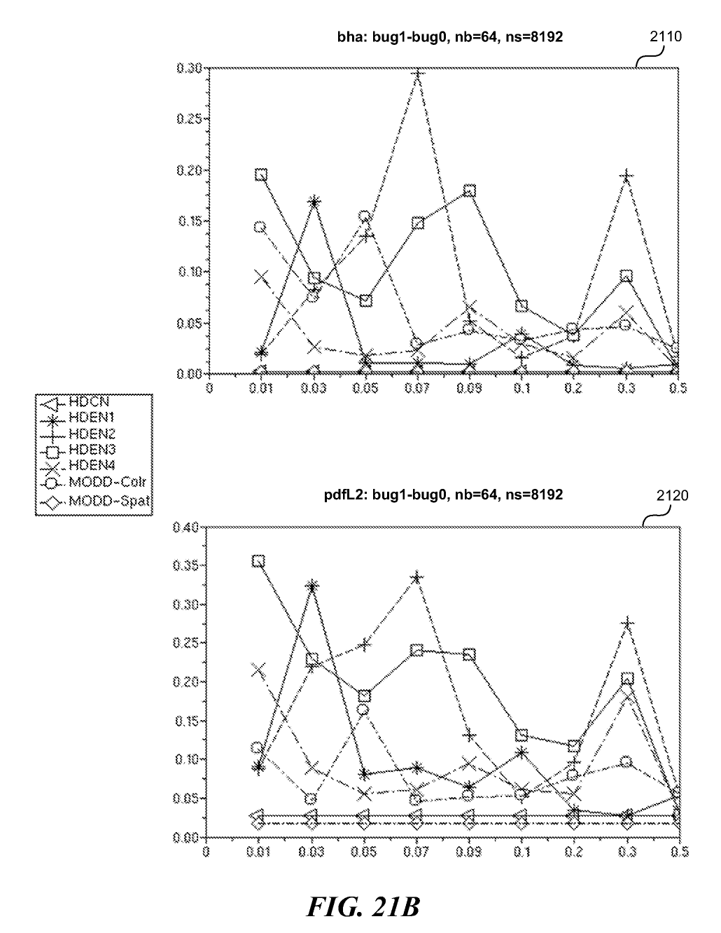

FIGS. 21-26 include graphs depicting comparisons between multiple difference distribution histograms representing the models of FIG. 4 (bugs). Each Figure includes graphs corresponding to the chi, bha, pdfL1, and pdfL2 test functions. In each graph, the x-axis corresponds to the radius ratio, while the y-axis corresponds to the difference score.

FIG. 21 includes graphs 2105-2120 comparing the difference distribution histograms for Bug0 and Bug1. Graph 2105 compares the difference distribution histograms using the chi test function; graph 2110 compares the difference distribution histograms using the bha test function; graph 2115 compares the difference distribution histograms using the pdfL1 test function; and graph 2120 compares the difference distribution histograms using the pdfL2 test function.

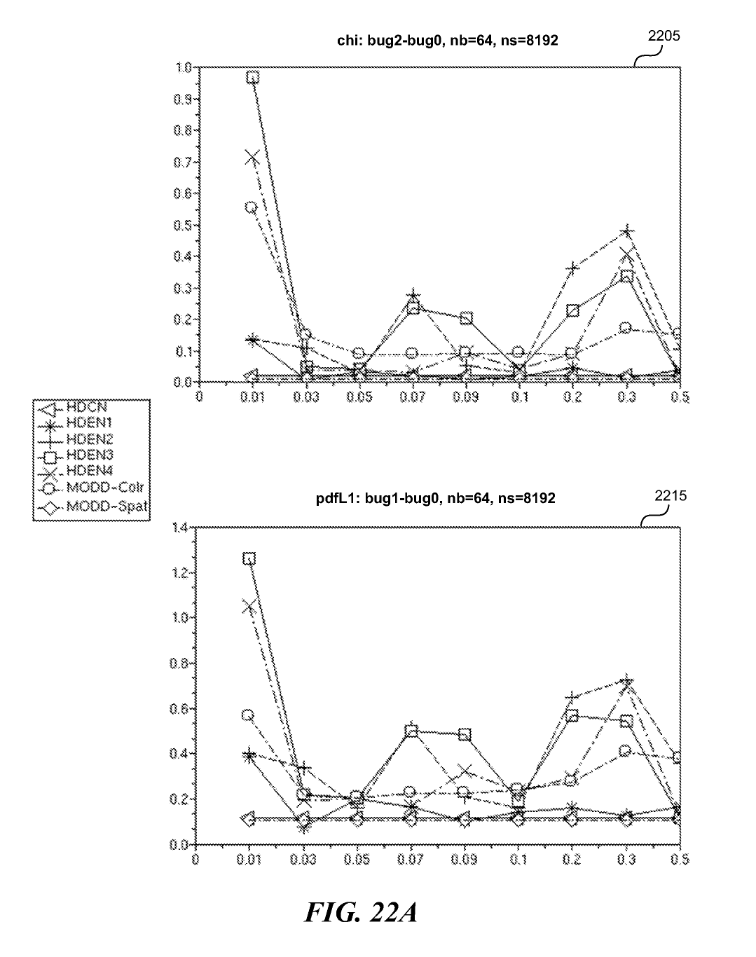

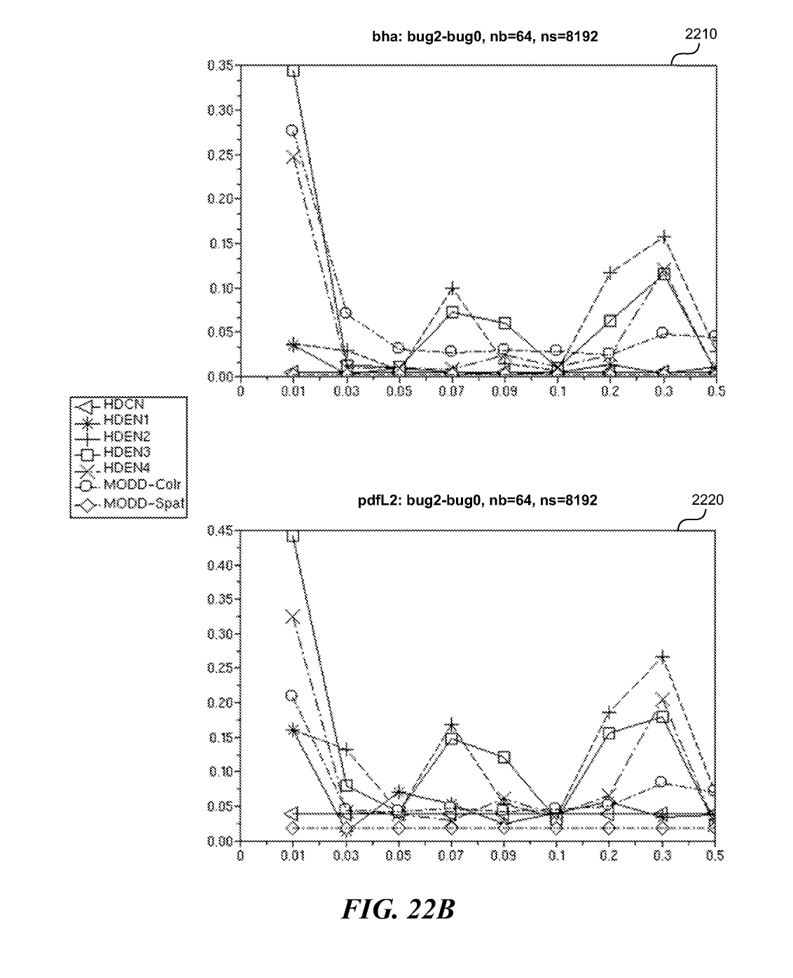

FIG. 22 includes graphs 2205-2220 comparing the difference distribution histograms for Bug0 and Bug2. Graph 2205 compares the difference distribution histograms using the chi test function; graph 2210 compares the difference distribution histograms using the bha test function; graph 2215 compares the difference distribution histograms using the pdfL1 test function; and graph 2220 compares the difference distribution histograms using the pdfL2 test function.

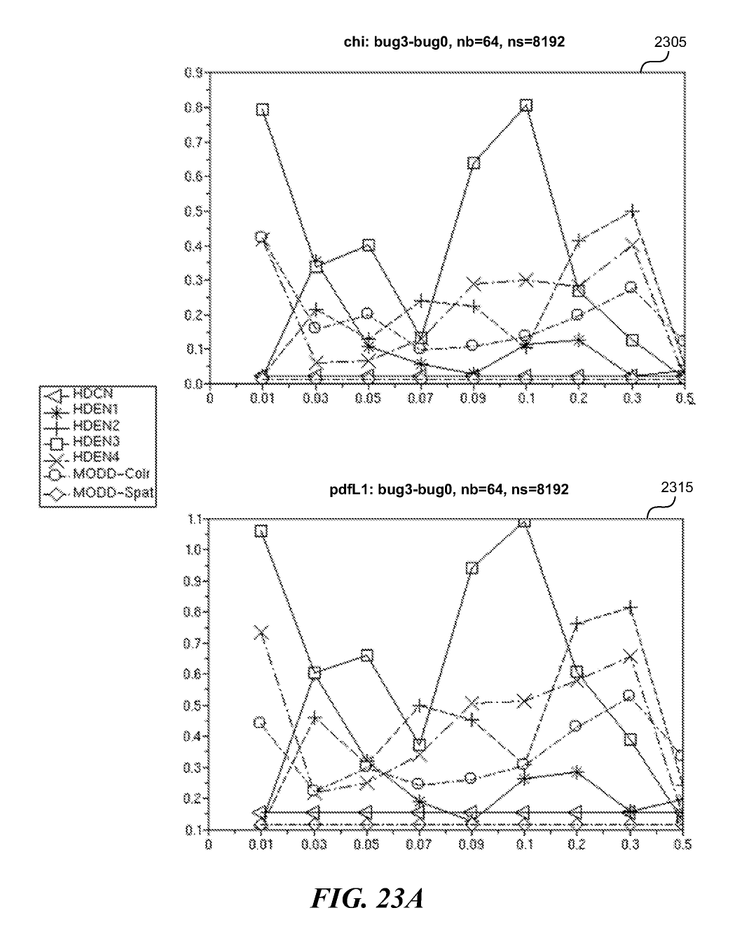

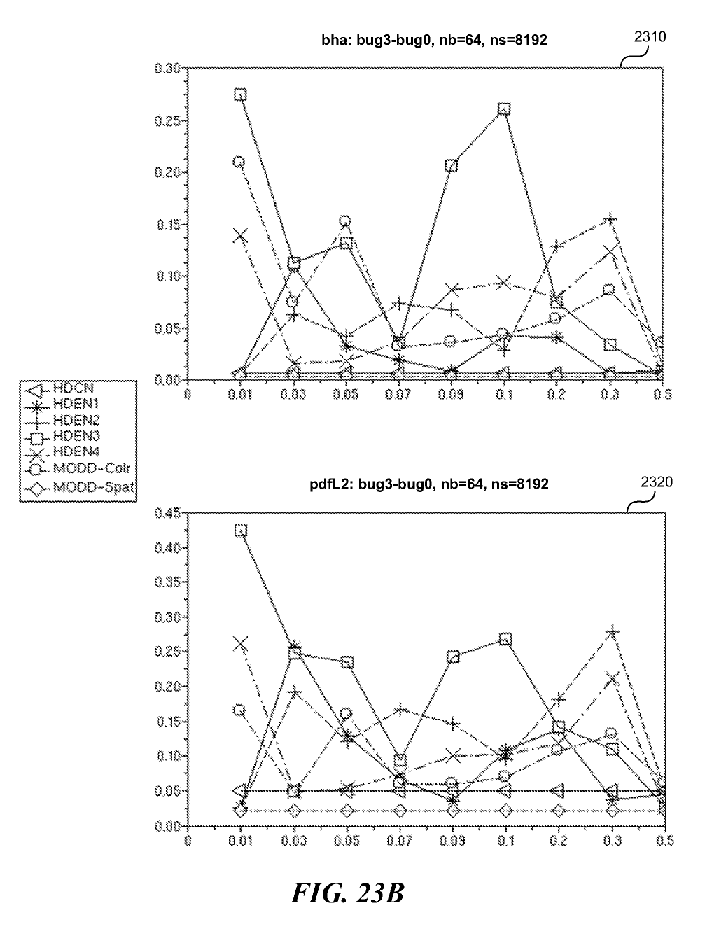

FIG. 23 includes graphs 2305-2320 comparing the difference distribution histograms for Bug0 and Bug3. Graph 2305 compares the difference distribution histograms using the chi test function; graph 2310 compares the difference distribution histograms using the bha test function; graph 2315 compares the difference distribution histograms using the pdfL1 test function; and graph 2320 compares the difference distribution histograms using the pdfL2 test function.

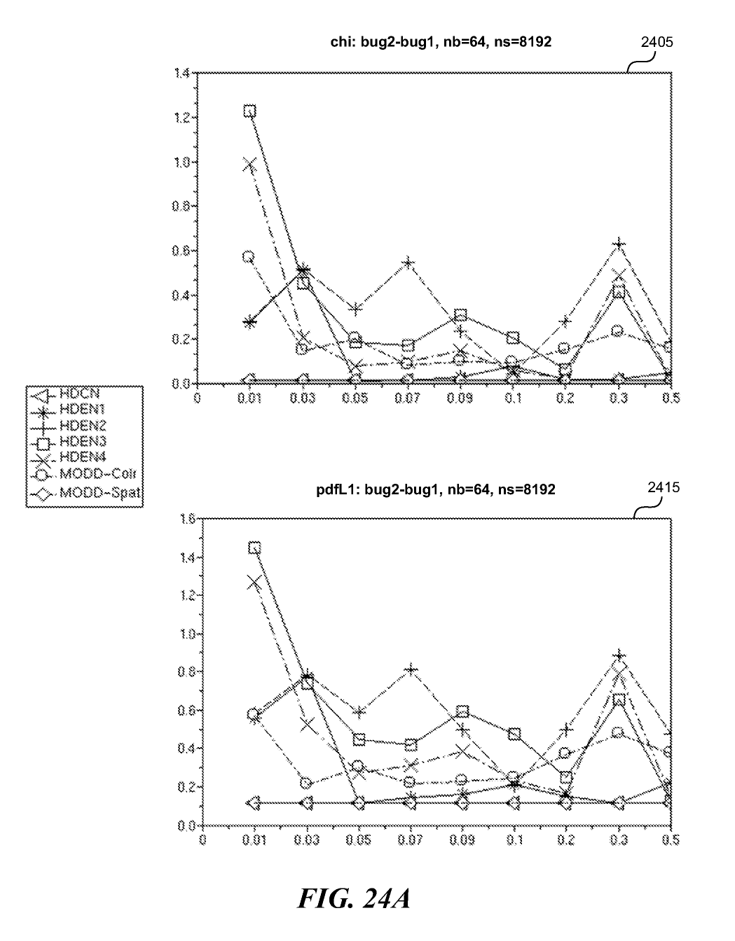

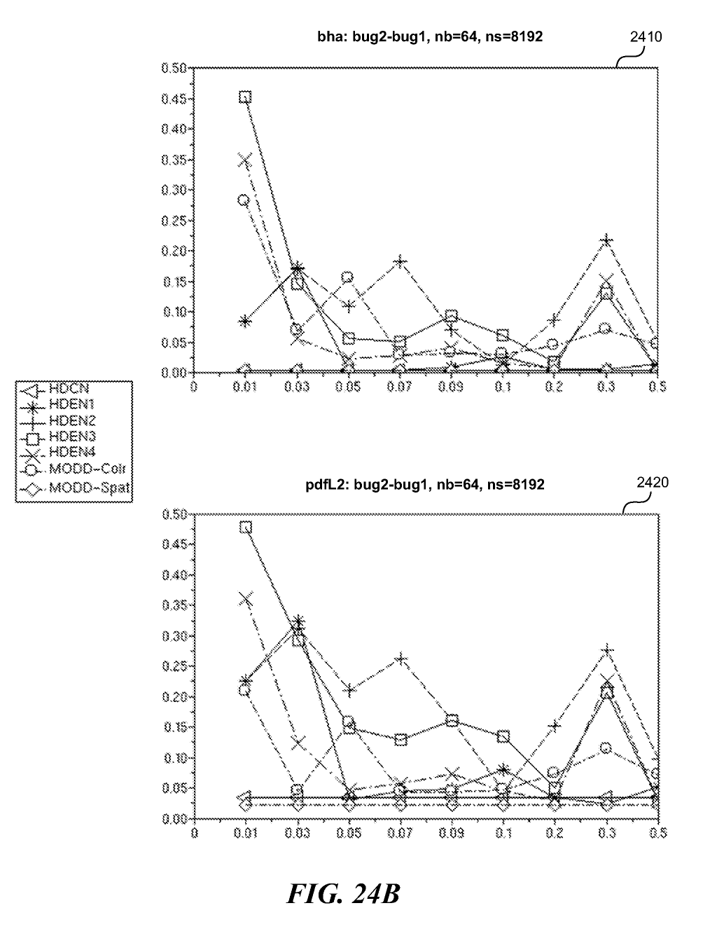

FIG. 24 includes graphs 2405-2420 comparing the difference distribution histograms for Bug1 and Bug2. Graph 2405 compares the difference distribution histograms using the chi test function; graph 2410 compares the difference distribution histograms using the bha test function; graph 2415 compares the difference distribution histograms using the pdfL1 test function; and graph 2420 compares the difference distribution histograms using the pdfL2 test function.

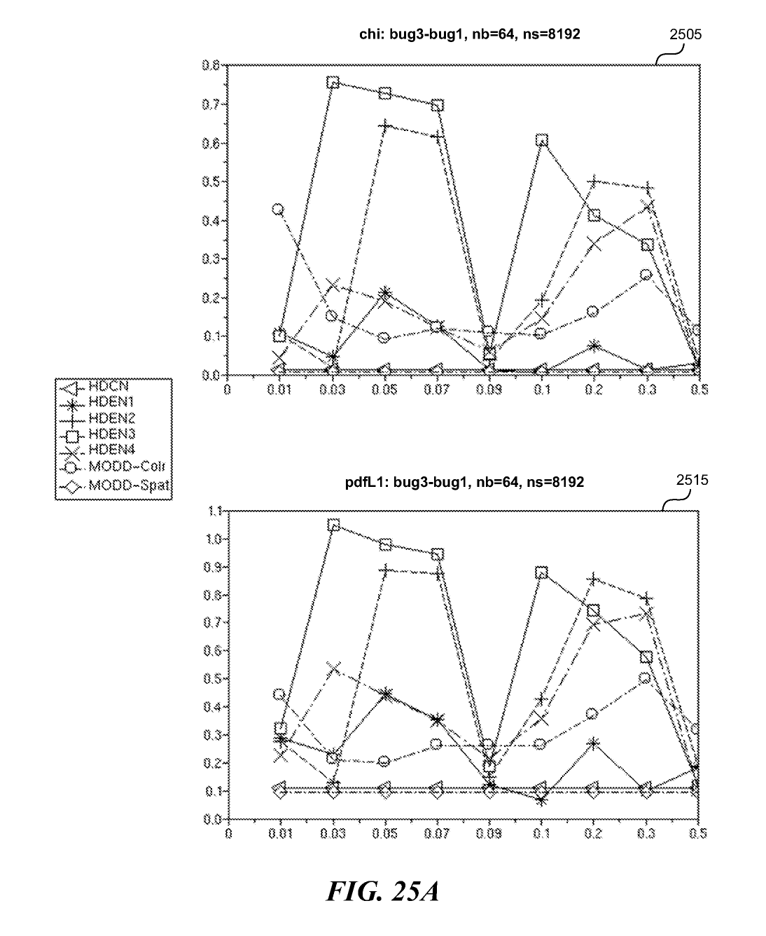

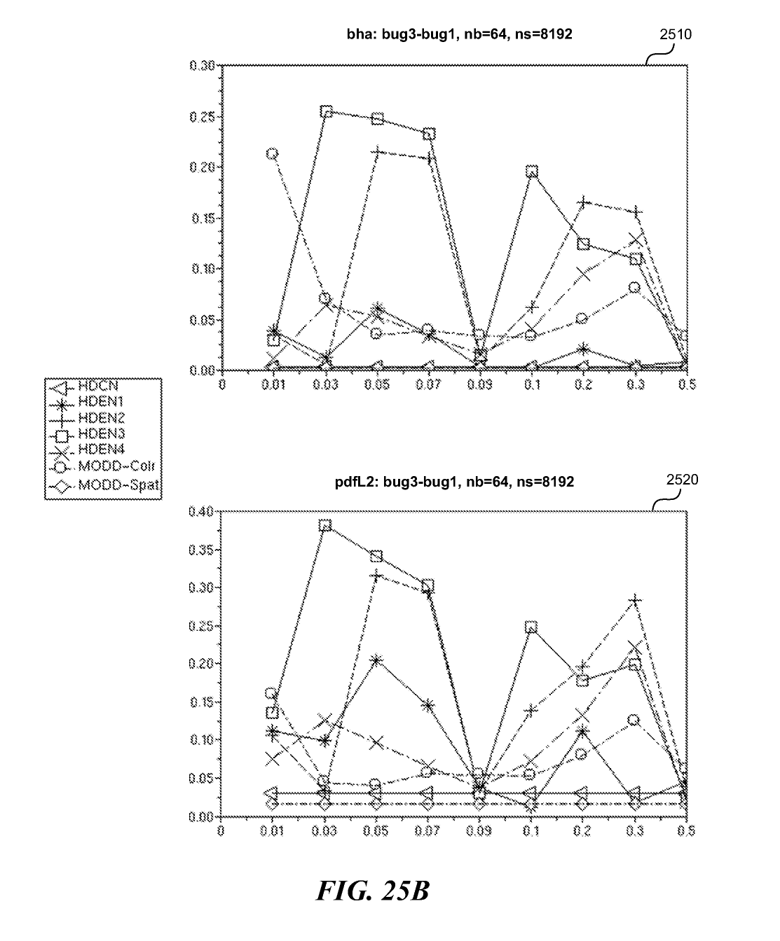

FIG. 25 includes graphs 2505-2520 comparing the difference distribution histograms for Bug1 and Bug3. Graph 2505 compares the difference distribution histograms using the chi test function; graph 2510 compares the difference distribution histograms using the bha test function; graph 2515 compares the difference distribution histograms using the pdfL1 test function; and graph 2520 compares the difference distribution histograms using the pdfL2 test function.

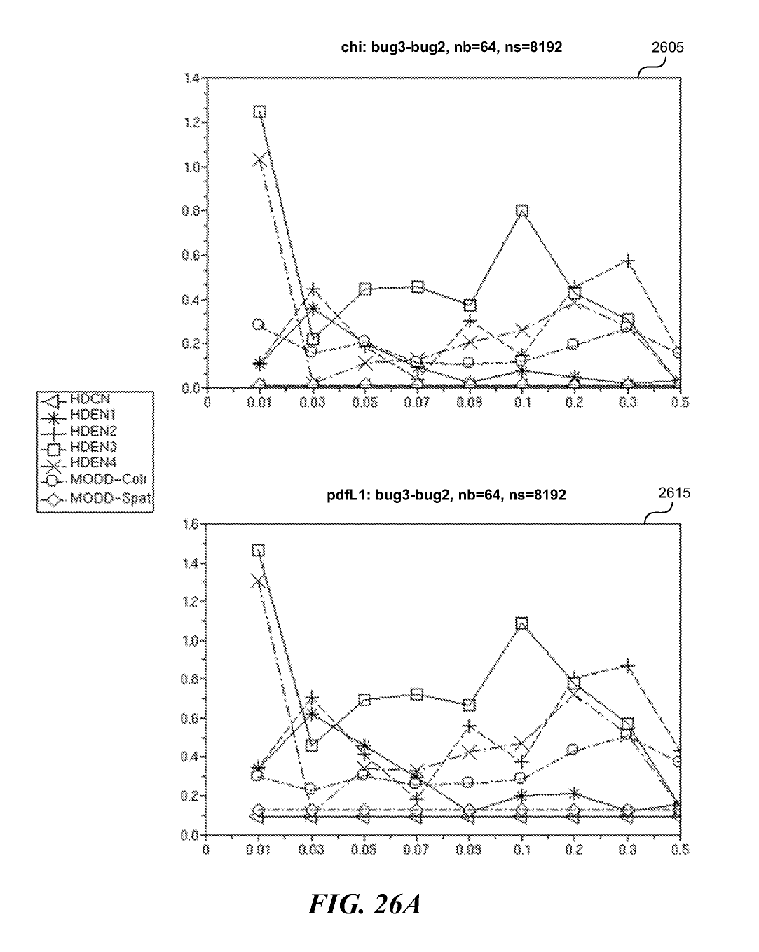

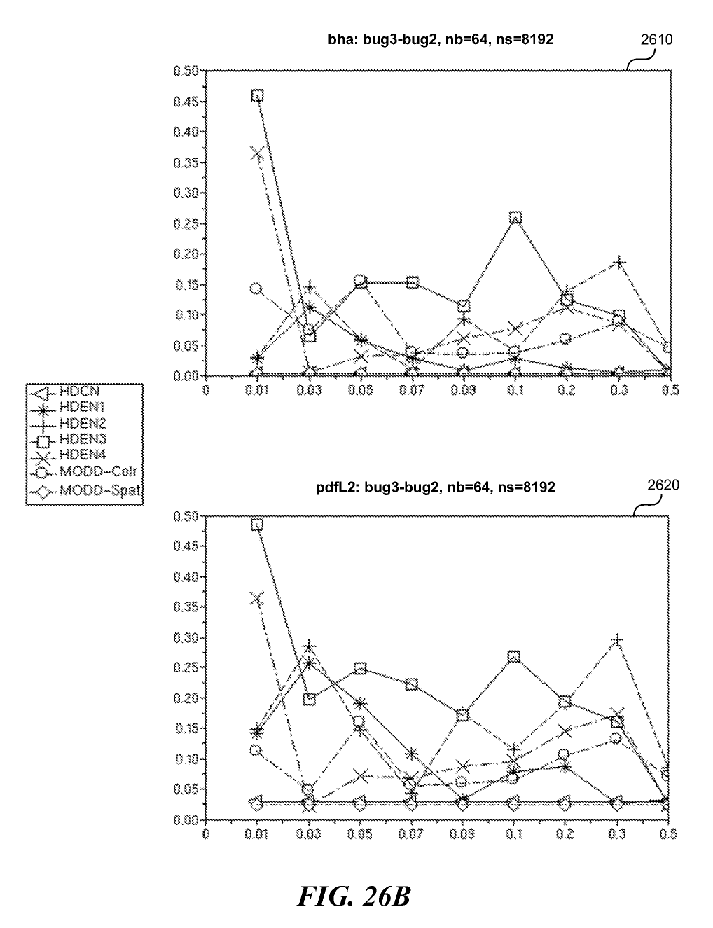

FIG. 26 includes graphs 2605-2620 comparing the difference distribution histograms for Bug2 and Bug3. The x-axis corresponds to radius ratio, while the y-axis corresponds to the difference score. Graph 2605 compares the difference distribution histograms using the chi test function; graph 2610 compares the difference distribution histograms using the bha test function; graph 2615 compares the difference distribution histograms using the pdfL1 test function; and graph 2620 compares the difference distribution histograms using the pdfL2 test function.

### ii. Example 2

### Ellipse

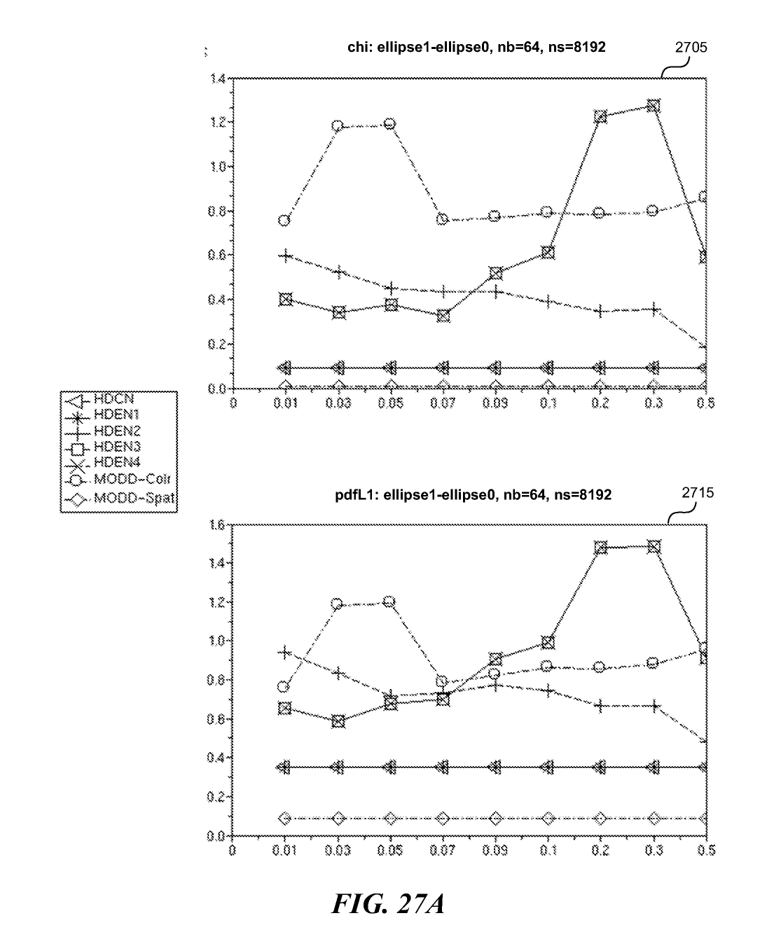

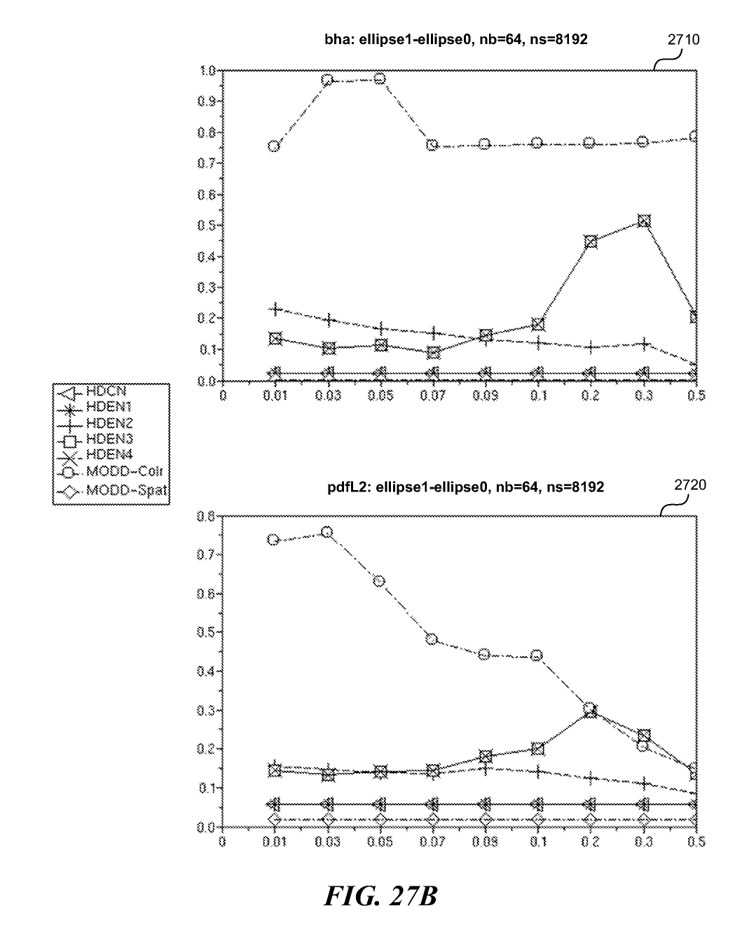

FIGS. 27-41 include graphs depicting comparisons between multiple difference distribution histograms representing the models of FIG. 14 (ellipses). Each Figure includes graphs corresponding to the chi, bha, pdfL1, and pdfL2 test functions. In each graph, the x-axis corresponds to the radius ratio, while the y-axis corresponds to the difference score.

FIG. 27 includes graphs 2705-2720 comparing the difference distribution histograms for Ellipse0 and Ellipse1. Graph 2705 compares the difference distribution histograms using the chi test function; graph 2710 compares the difference distribution histograms using the bha test function; graph 2715 compares the difference distribution histograms using the pdfL1 test function; and graph 2720 compares the difference distribution histograms using the pdfL2 test function.

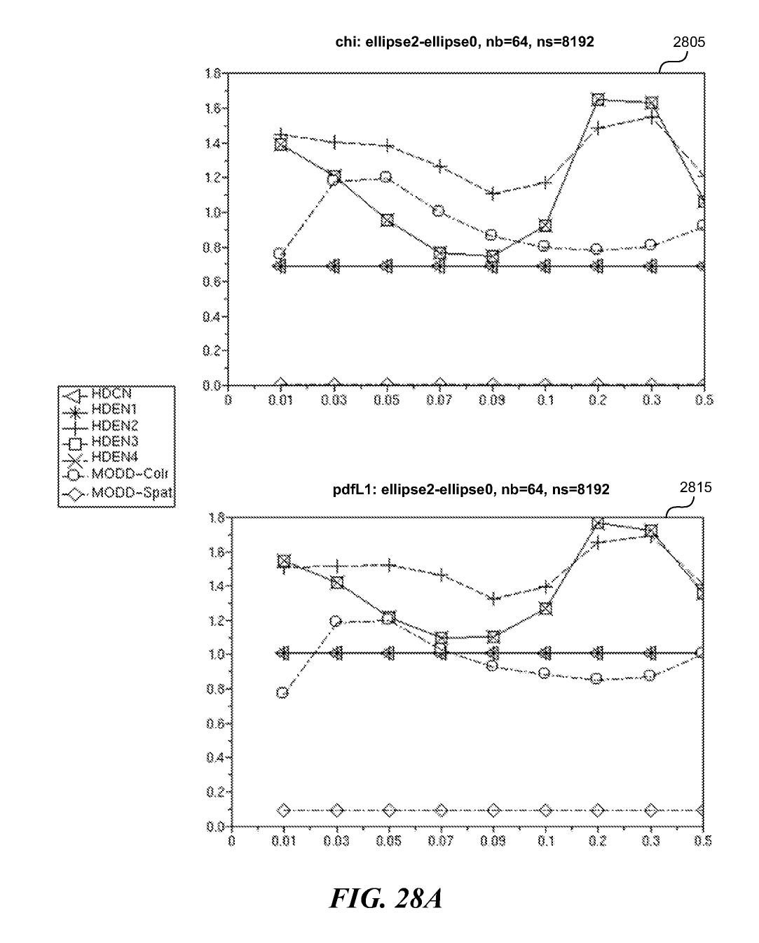

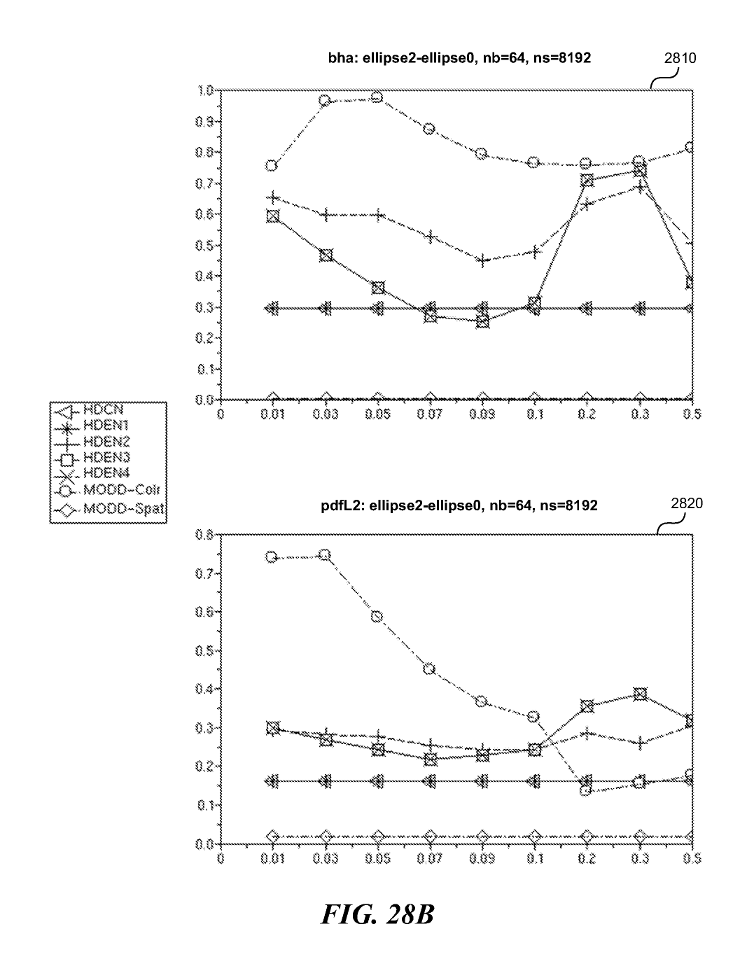

FIG. 28 includes graphs 2805-2820 comparing the difference distribution histograms for Ellipse0 and Ellipse2. Graph 2805 compares the difference distribution histograms using the chi test function; graph 2810 compares the difference distribution histograms using the bha test function; graph 2815 compares the difference distribution histograms using the pdfL1 test function; and graph 2820 compares the difference distribution histograms using the pdfL2 test function.

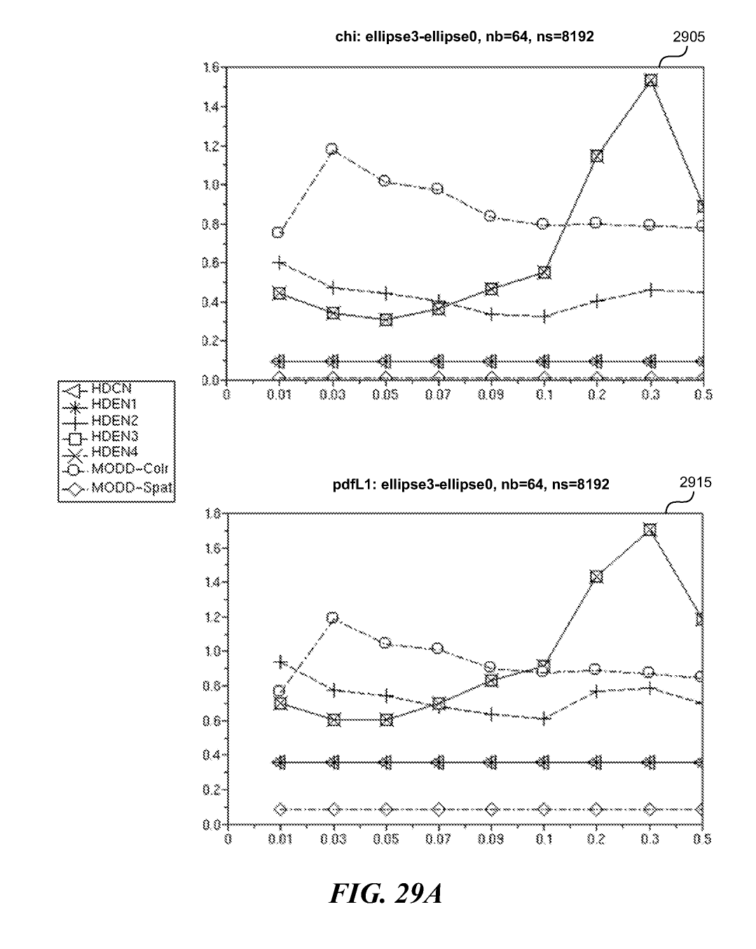

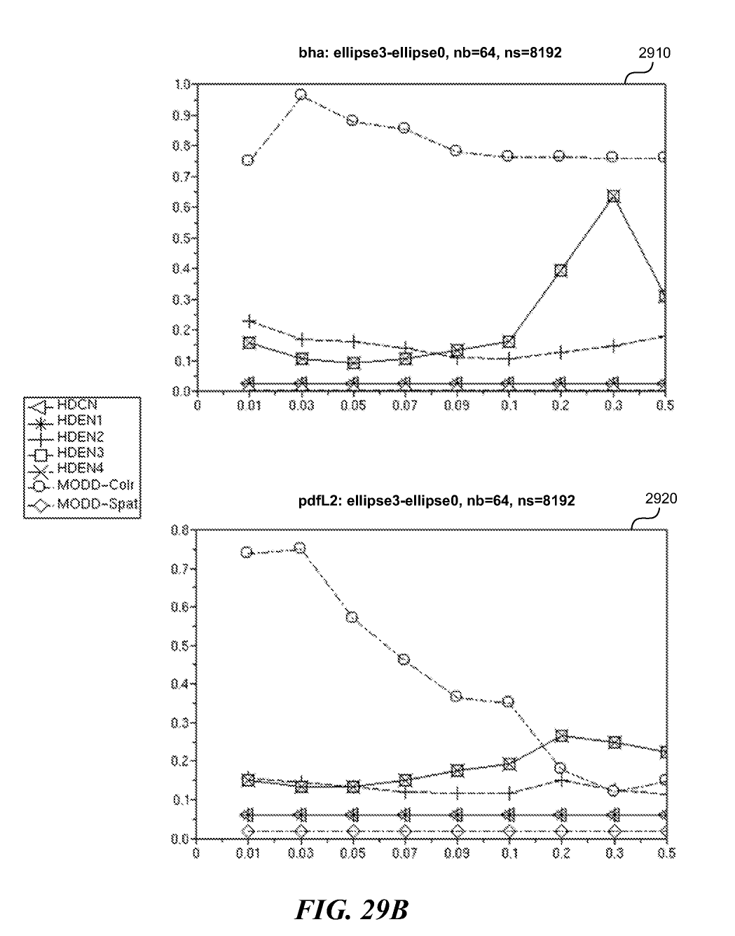

FIG. 29 includes graphs 2905-2920 comparing the difference distribution histograms for Ellipse0 and Ellipse3. Graph 2905 compares the difference distribution histograms using the chi test function; graph 2910 compares the difference distribution histograms using the bha test function; graph 2915 compares the difference distribution histograms using the pdfL1 test function; and graph 2920 compares the difference distribution histograms using the pdfL2 test function.

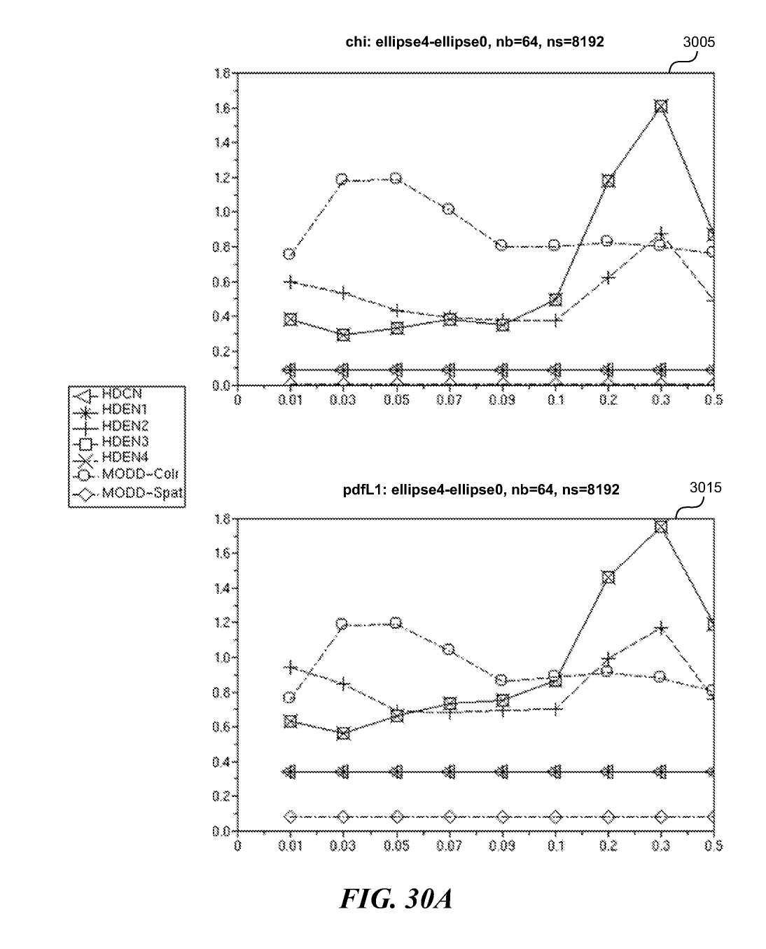

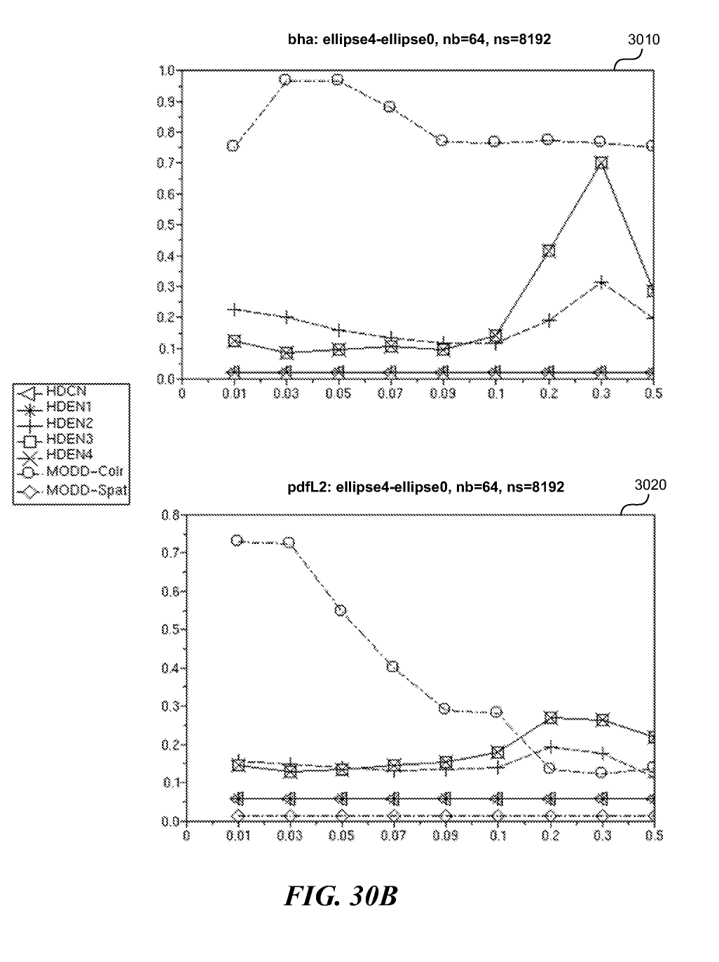

FIG. 30 includes graphs 3005-3020 comparing the difference distribution histograms for Ellipse0 and Ellipse4. Graph 3005 compares the difference distribution histograms using the chi test function; graph 3010 compares the difference distribution histograms using the bha test function; graph 3015 compares the difference distribution histograms using the pdfL1 test function; and graph 3020 compares the difference distribution histograms using the pdfL2 test function.

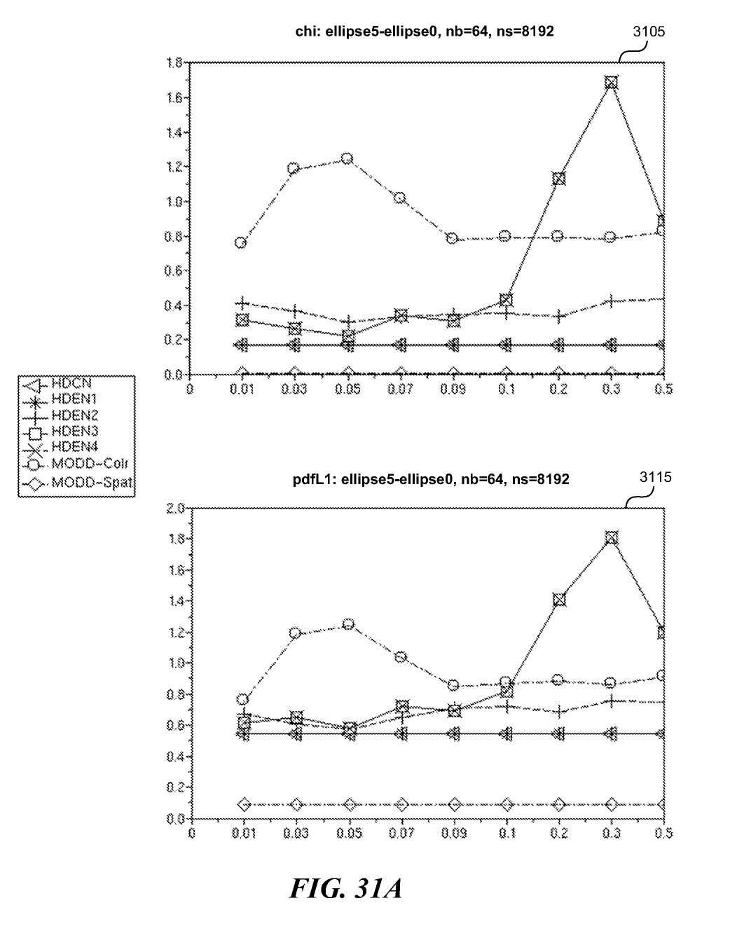

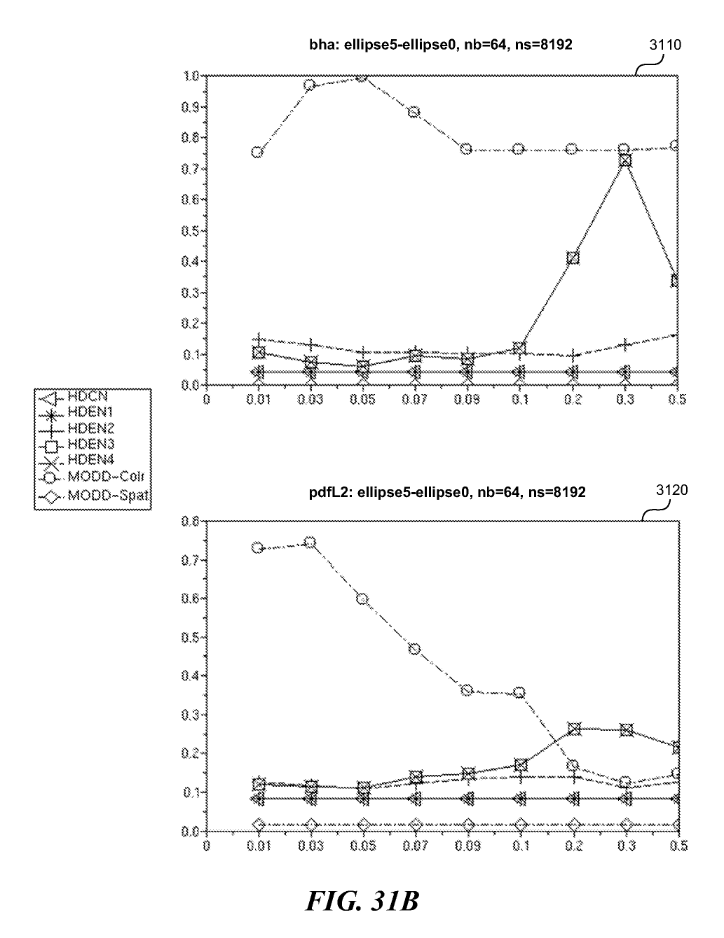

FIG. 31 includes graphs 3105-3120 comparing the difference distribution histograms for Ellipse0 and Ellipse5. Graph 3105 compares the difference distribution histograms using the chi test function; graph 3110 compares the difference distribution histograms using the bha test function; graph 3115 compares the difference distribution histograms using the pdfL1 test function; and graph 3120 compares the difference distribution histograms using the pdfL2 test function.

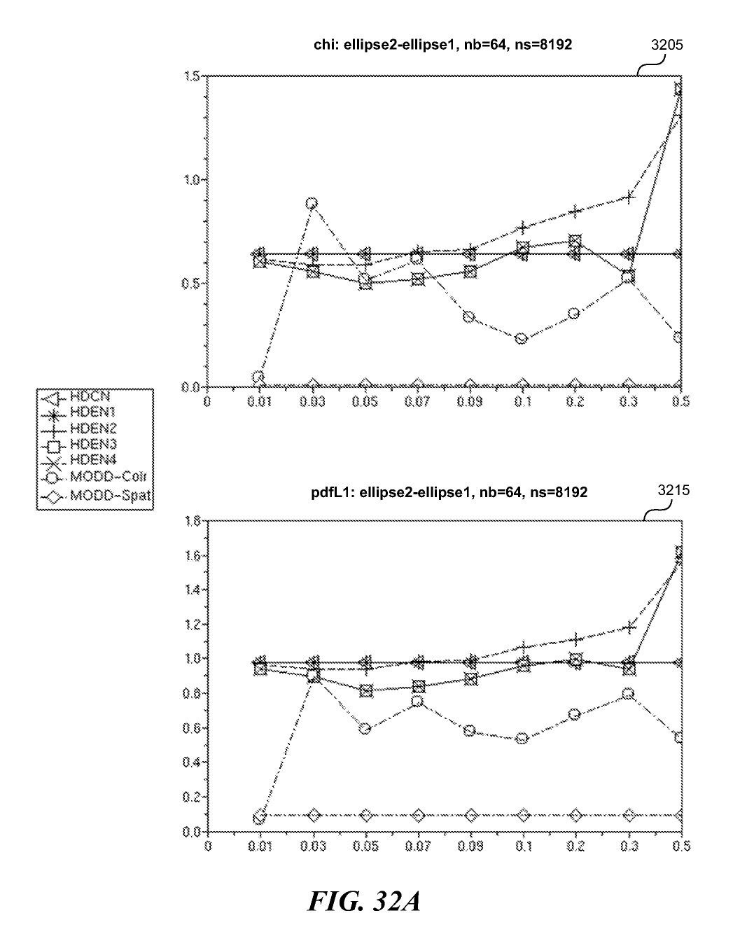

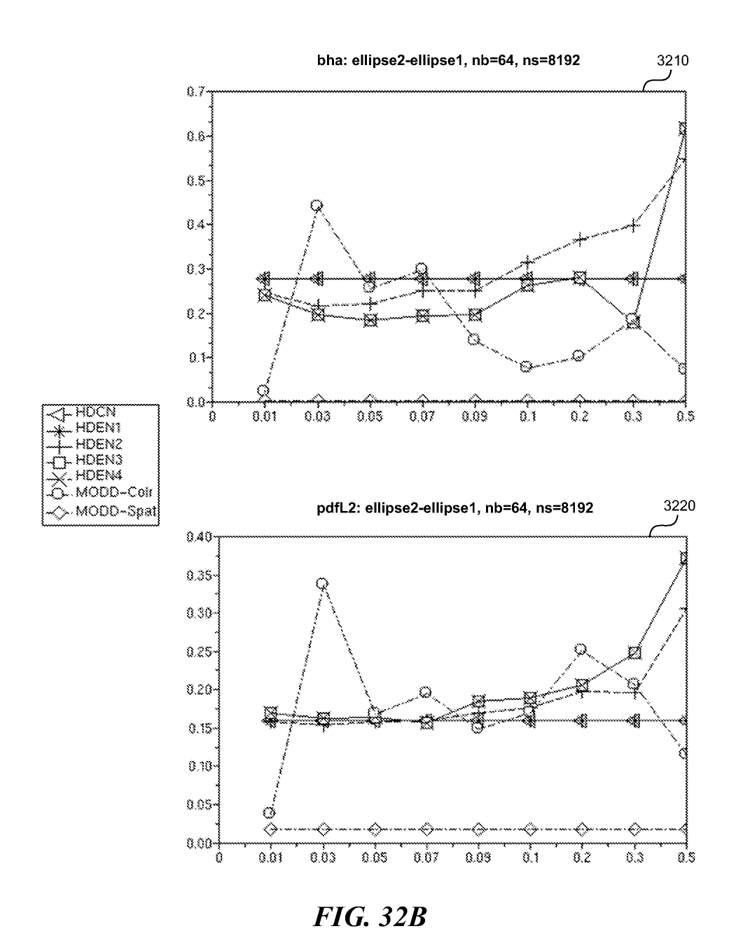

FIG. 32 includes graphs 3205-3220 comparing the difference distribution histograms for Ellipse1 and Ellipse2. Graph 3205 compares the difference distribution histograms using the chi test function; graph 3210 compares the difference distribution histograms using the bha test function; graph 3215 compares the difference distribution histograms using the pdfL1 test function; and graph 3220 compares the difference distribution histograms using the pdfL2 test function.

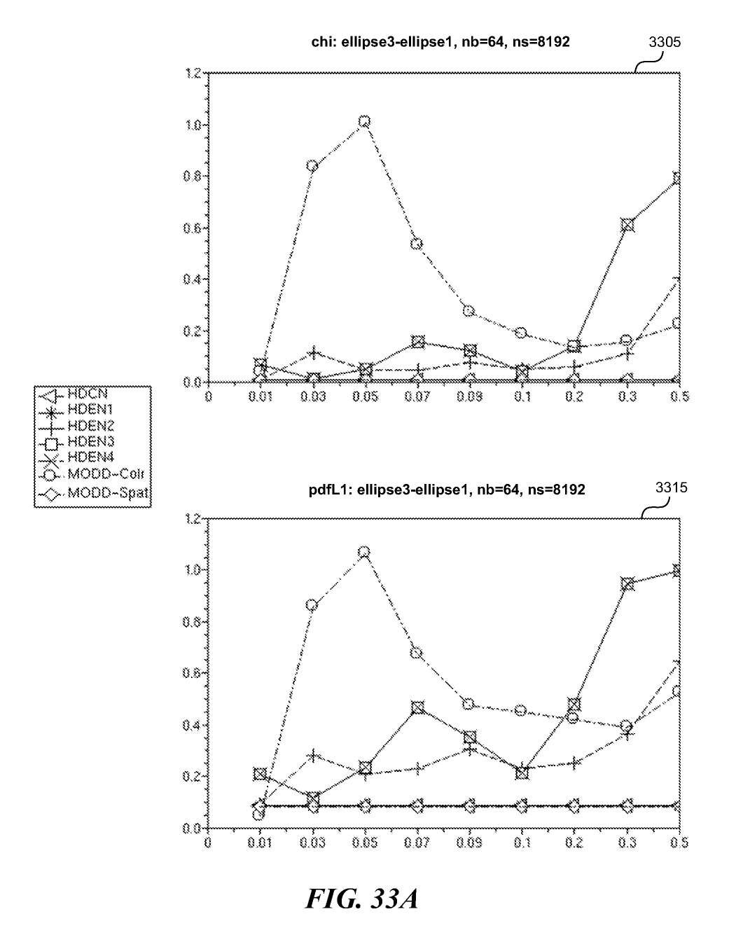

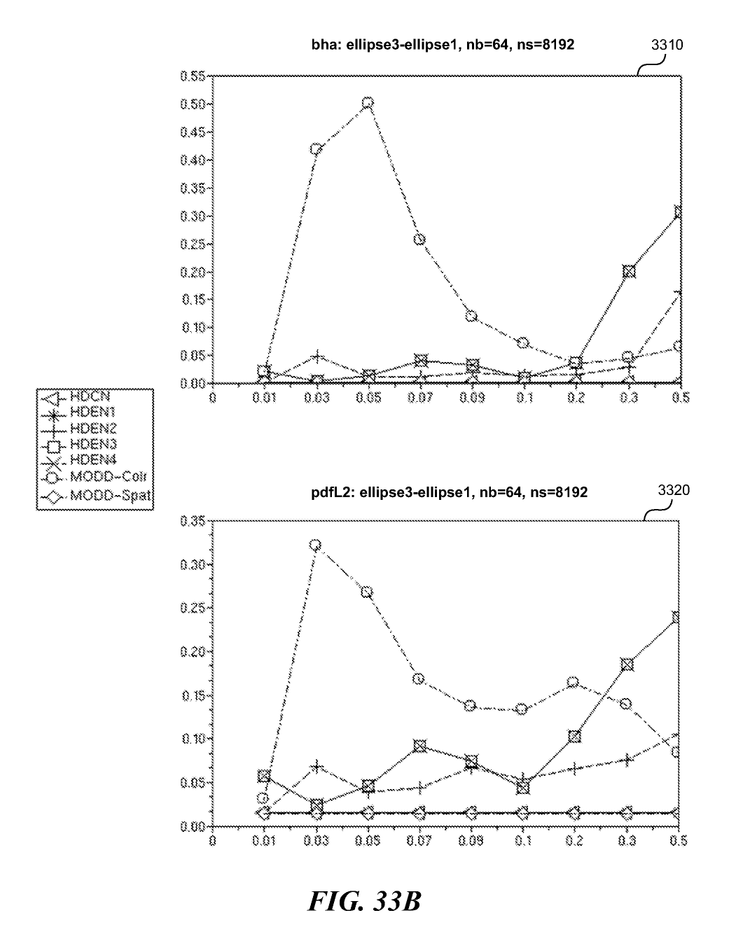

FIG. 33 includes graphs 3305-3320 comparing the difference distribution histograms for Ellipse1 and Ellipse3. Graph 3305 compares the difference distribution histograms using the chi test function; graph 3310 compares the difference distribution histograms using the bha test function; graph 3315 compares the difference distribution histograms using the pdfL1 test function; and graph 3320 compares the difference distribution histograms using the pdfL2 test function.

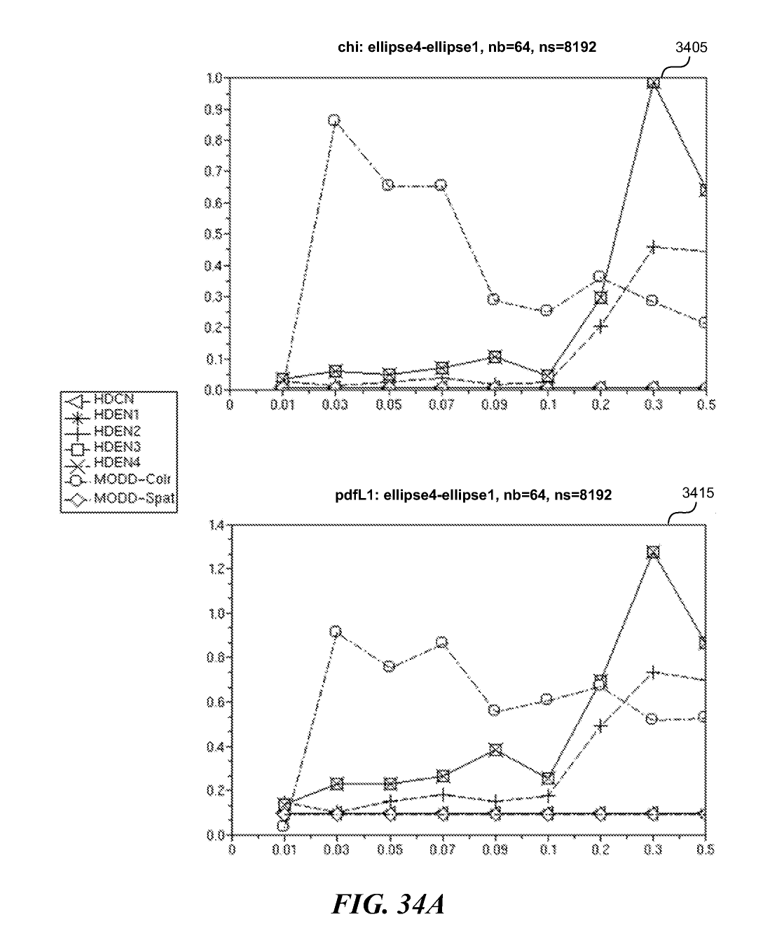

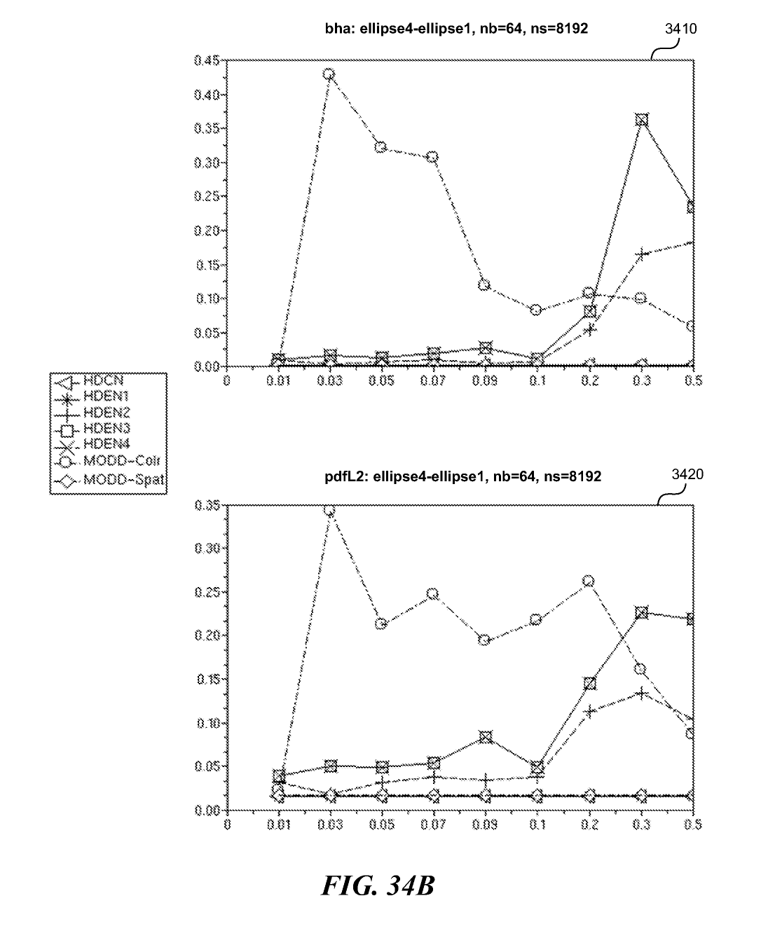

FIG. 34 includes graphs 3405-3420 comparing the difference distribution histograms for Ellipse1 and Ellipse4. Graph 3405 compares the difference distribution histograms using the chi test function; graph 3410 compares the difference distribution histograms using the bha test function; graph 3415 compares the difference distribution histograms using the pdfL1 test function; and graph 3420 compares the difference distribution histograms using the pdfL2 test function.

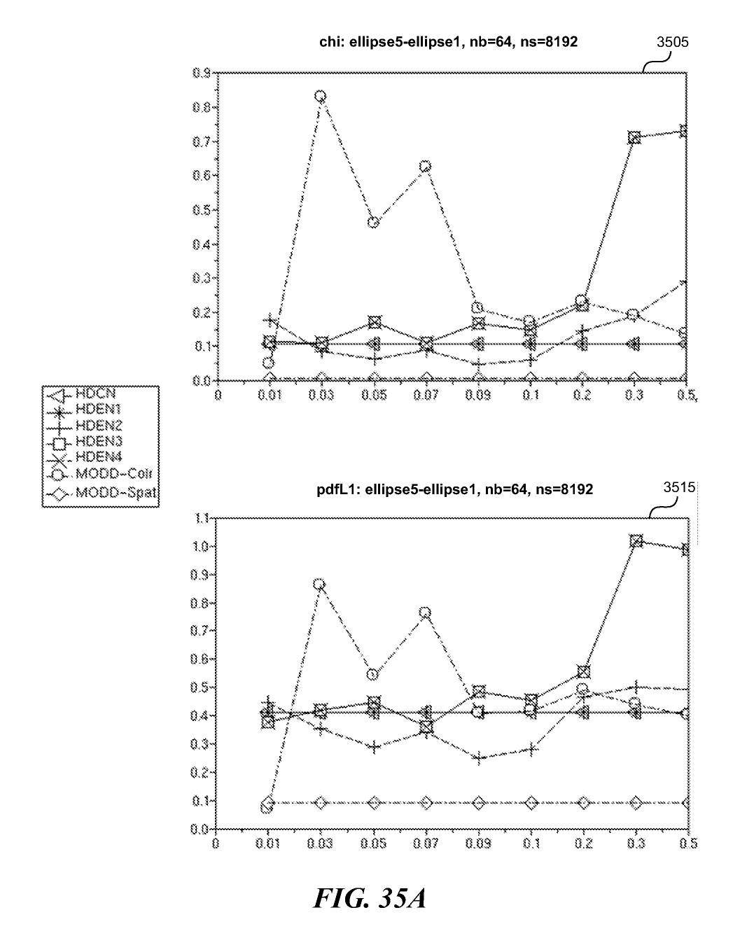

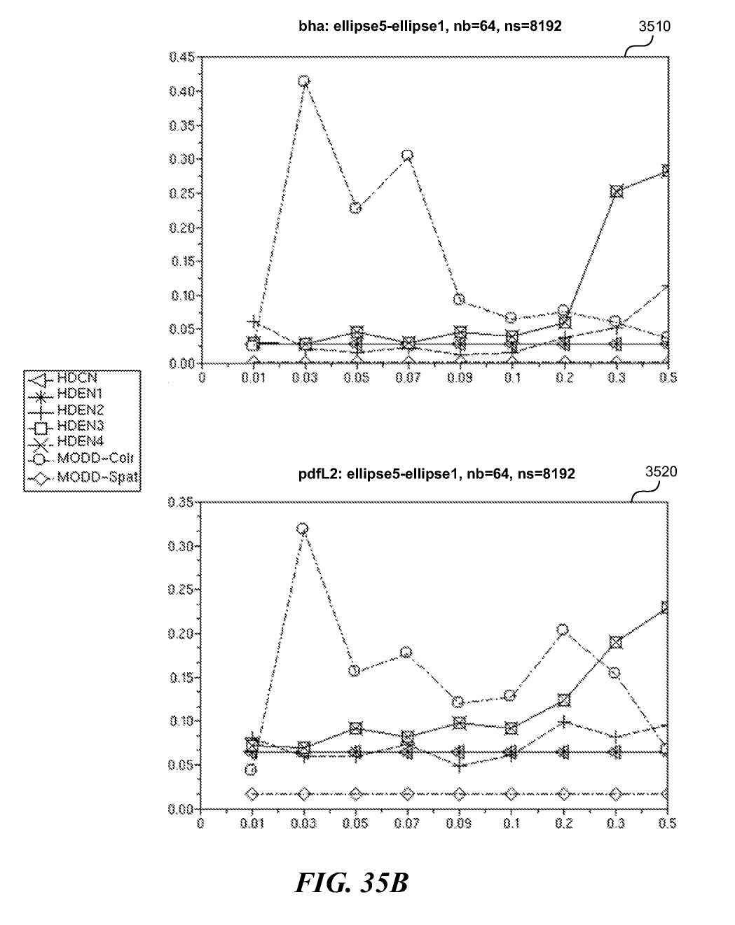

FIG. 35 includes graphs 3505-3520 comparing the difference distribution histograms for Ellipse1 and Ellipse5. Graph 3505 compares the difference distribution histograms using the chi test function; graph 3510 compares the difference distribution histograms using the bha test function; graph 3515 compares the difference distribution histograms using the pdfL1 test function; and graph 3520 compares the difference distribution histograms using the pdfL2 test function.

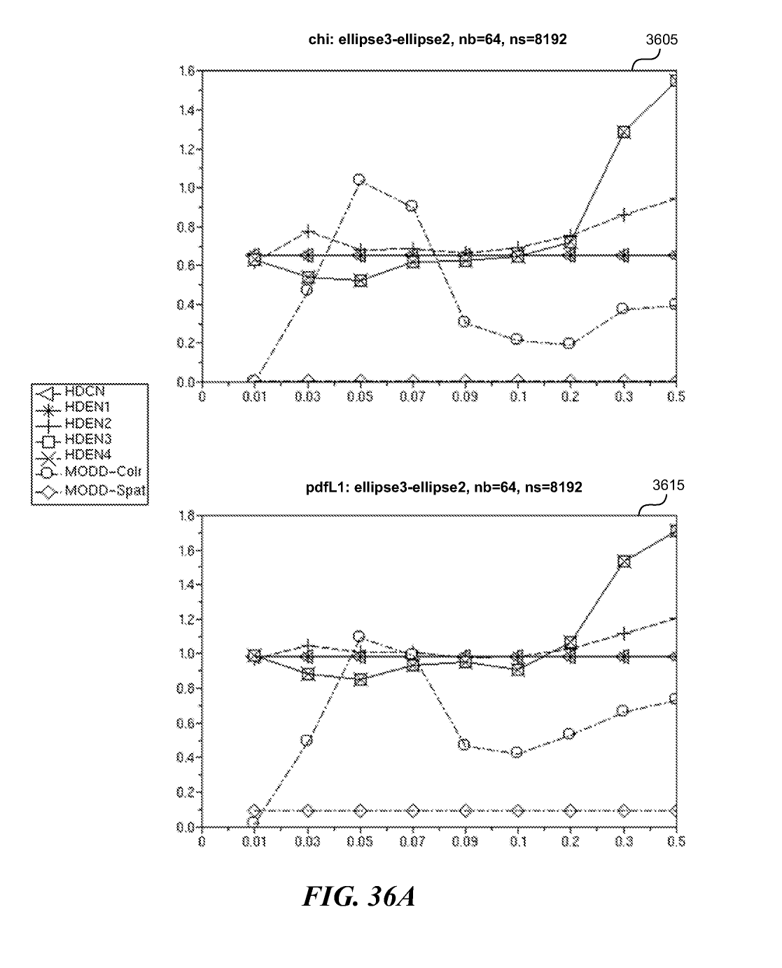

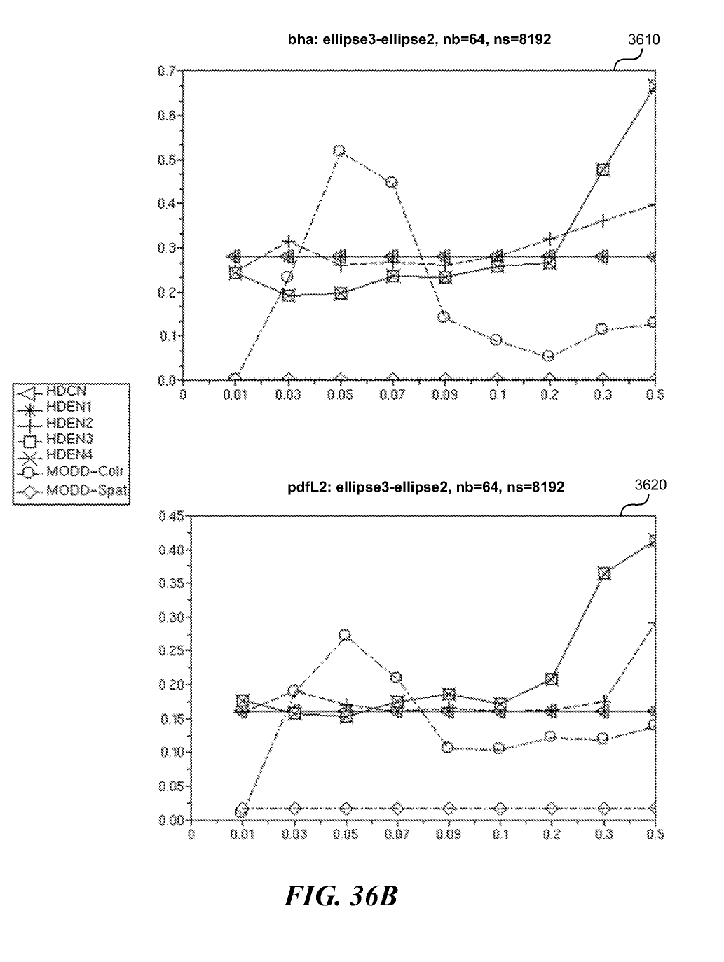

FIG. 36 includes graphs 3605-3620 comparing the difference distribution histograms for Ellipse2 and Ellipse3. Graph 3605 compares the difference distribution histograms using the chi test function; graph 3610 compares the difference distribution histograms using the bha test function; graph 3615 compares the difference distribution histograms using the pdfL1 test function; and graph 3620 compares the difference distribution histograms using the pdfL2 test function.

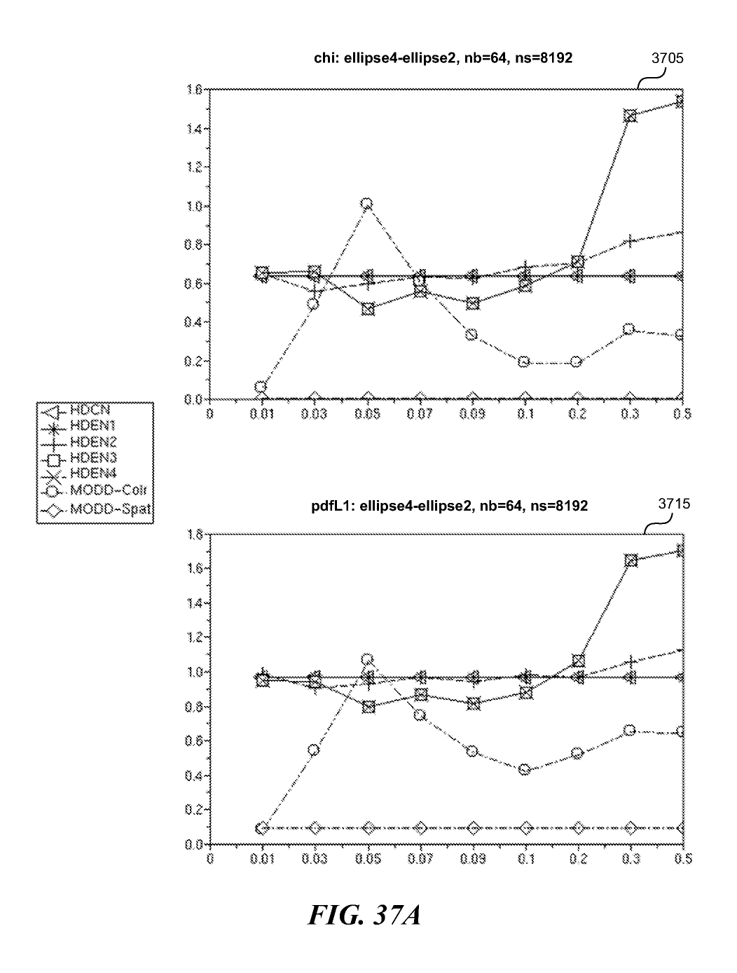

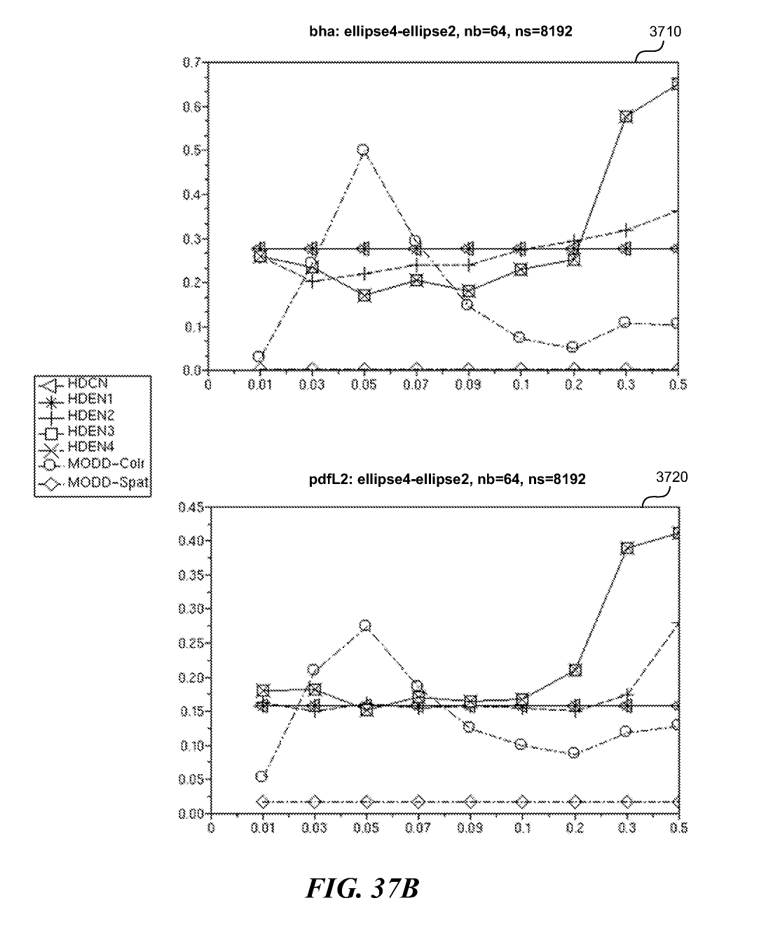

FIG. 37 includes graphs 3705-3720 comparing the difference distribution histograms for Ellipse2 and Ellipse4. Graph 3705 compares the difference distribution histograms using the chi test function; graph 3710 compares the difference distribution histograms using the bha test function; graph 3715 compares the difference distribution histograms using the pdfL1 test function; and graph 3720 compares the difference distribution histograms using the pdfL2 test function.

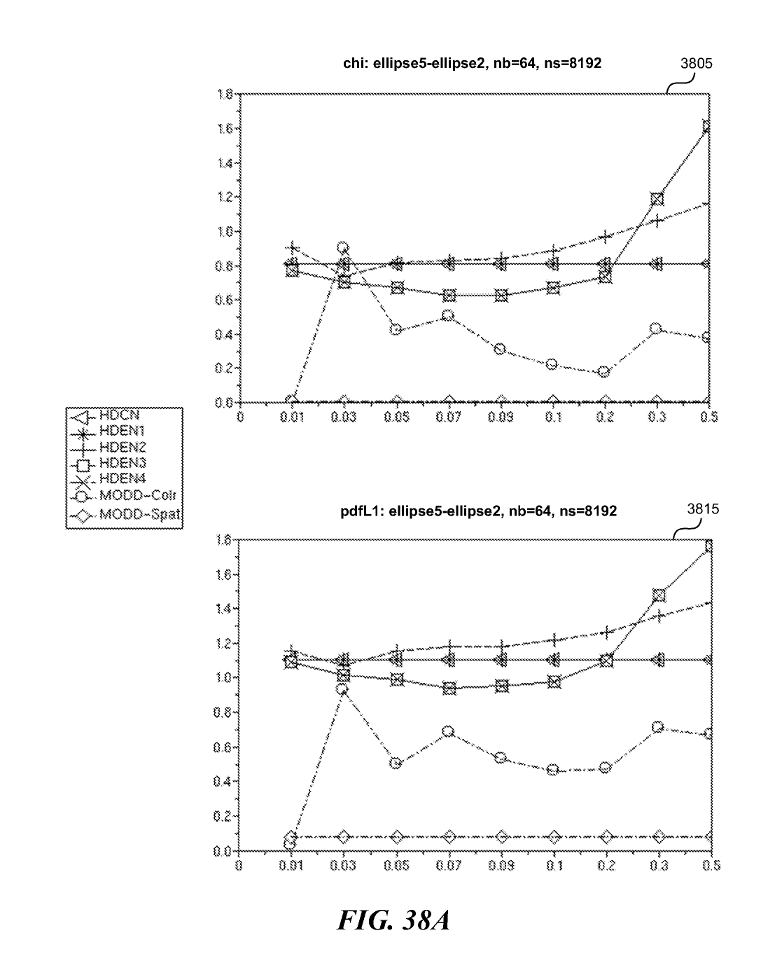

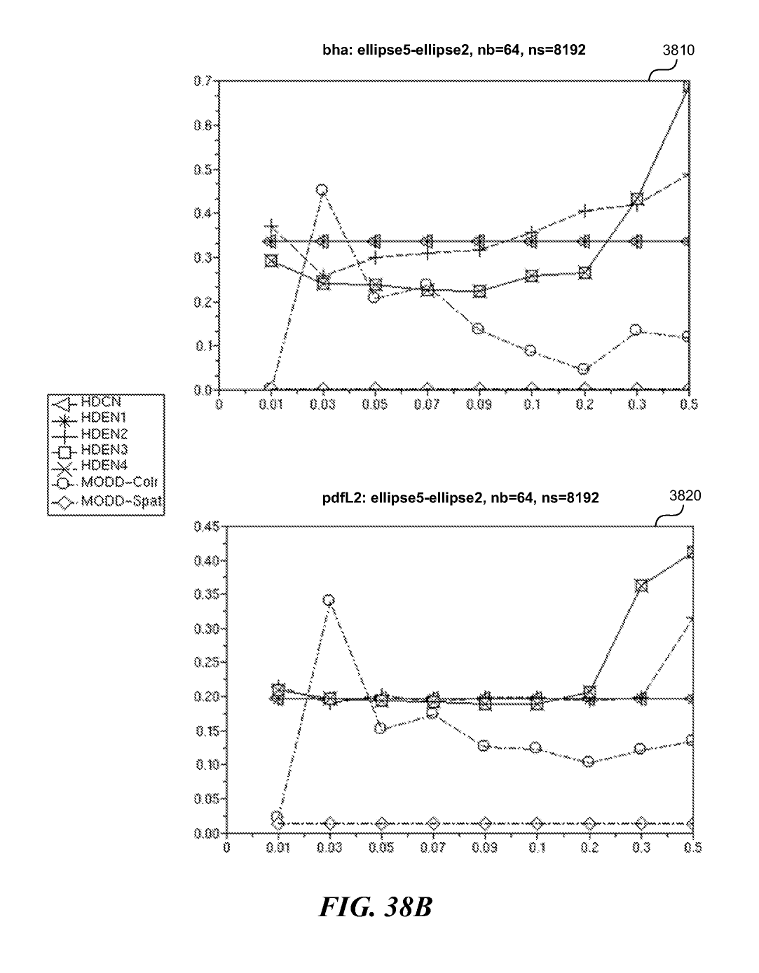

FIG. 38 includes graphs 3805-3820 comparing the difference distribution histograms for Ellipse2 and Ellipse5. Graph 3805 compares the difference distribution histograms using the chi test function; graph 3810 compares the difference distribution histograms using the bha test function; graph 3815 compares the difference distribution histograms using the pdfL1 test function; and graph 3820 compares the difference distribution histograms using the pdfL2 test function.

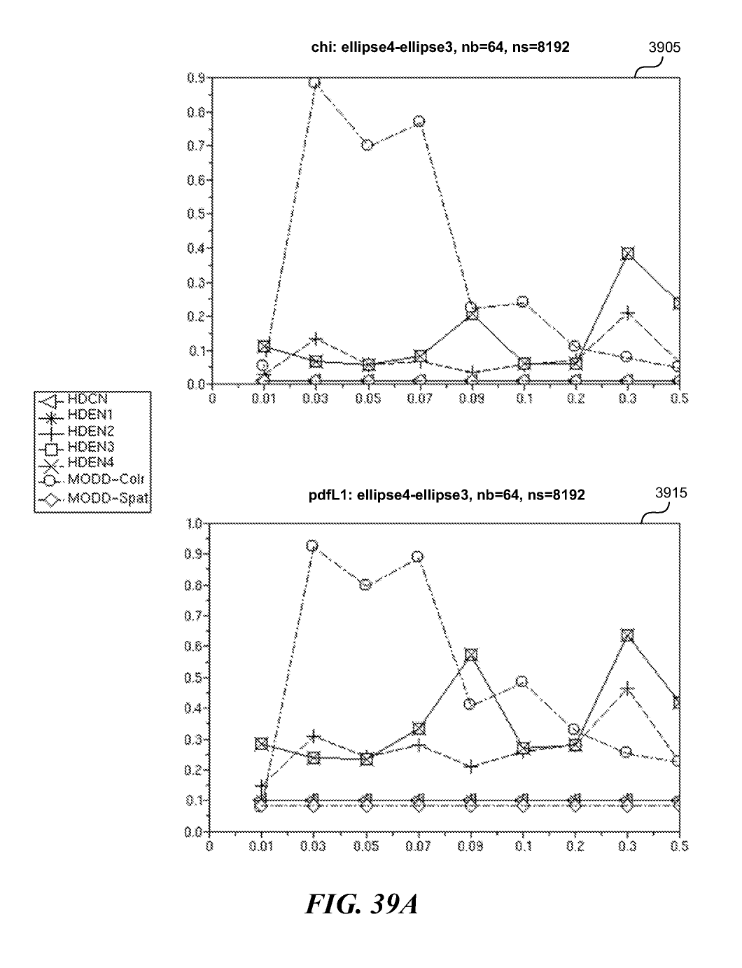

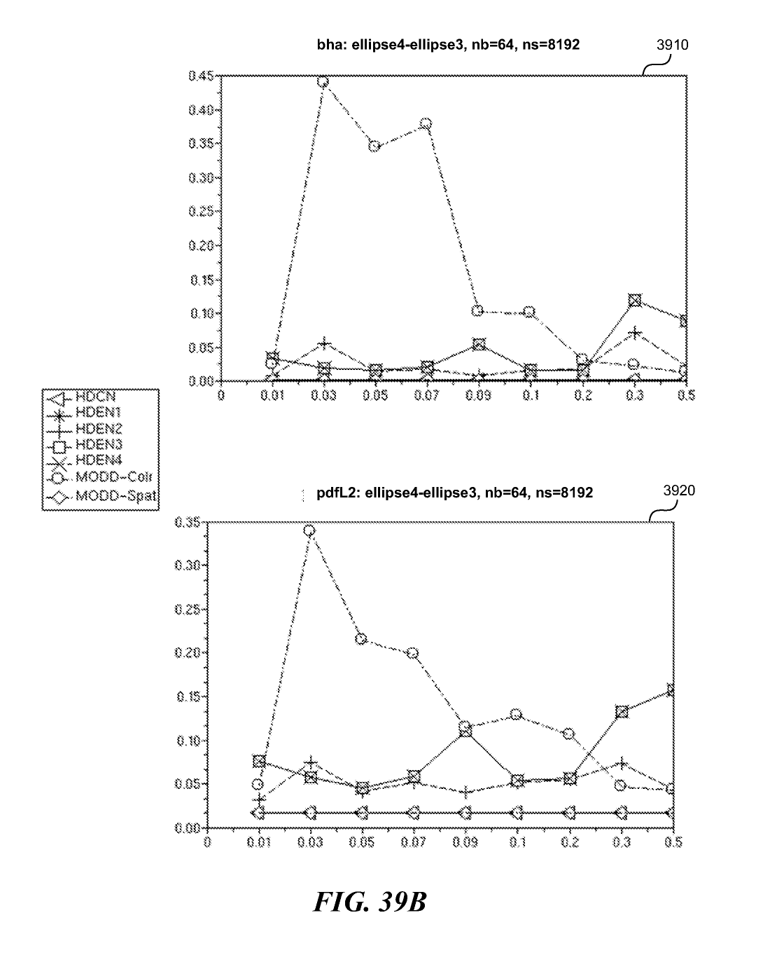

FIG. 39 includes graphs 3905-3920 comparing the difference distribution histograms for Ellipse3 and Ellipse4. Graph 3905 compares the difference distribution histograms using the chi test function; graph 3910 compares the difference distribution histograms using the bha test function; graph 3915 compares the difference distribution histograms using the pdfL1 test function; and graph 3920 compares the difference distribution histograms using the pdfL2 test function.

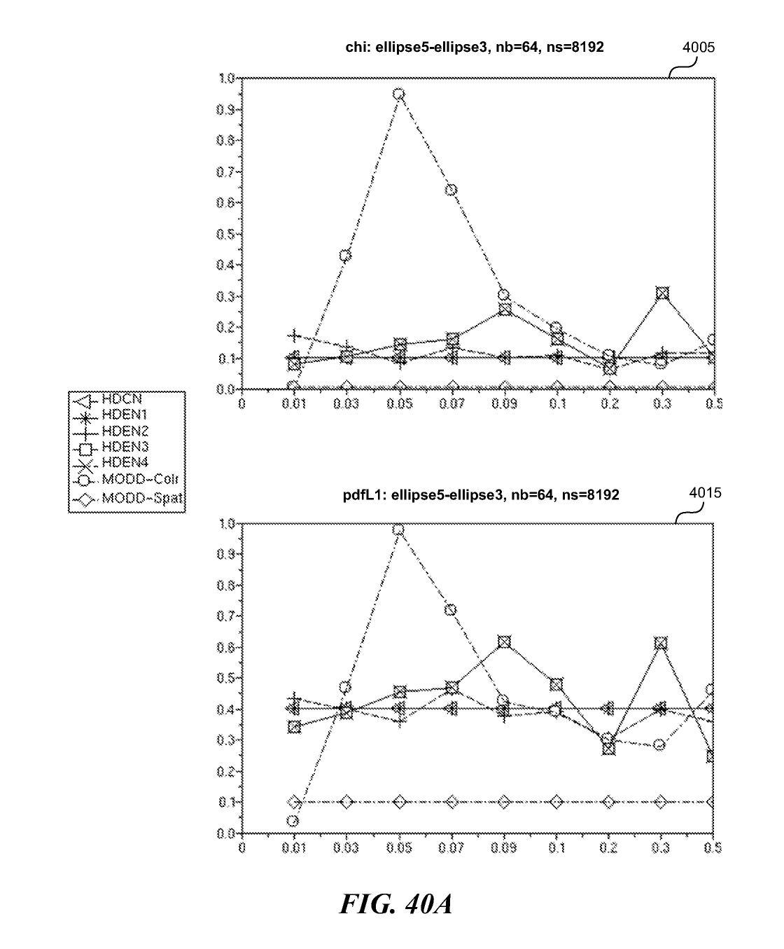

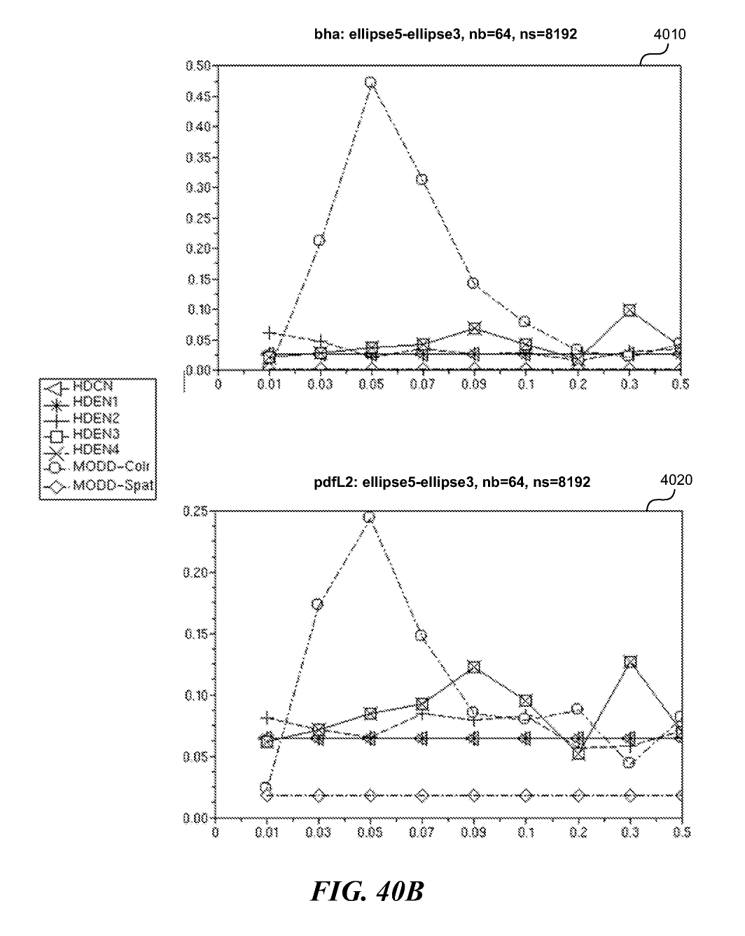

FIG. 40 includes graphs 4005-4020 comparing the difference distribution histograms for Ellipse3 and Ellipse5. Graph 4005 compares the difference distribution histograms using the chi test function; graph 4010 compares the difference distribution histograms using the bha test function; graph 4015 compares the difference distribution histograms using the pdfL1 test function; and graph 4020 compares the difference distribution histograms using the pdfL2 test function.

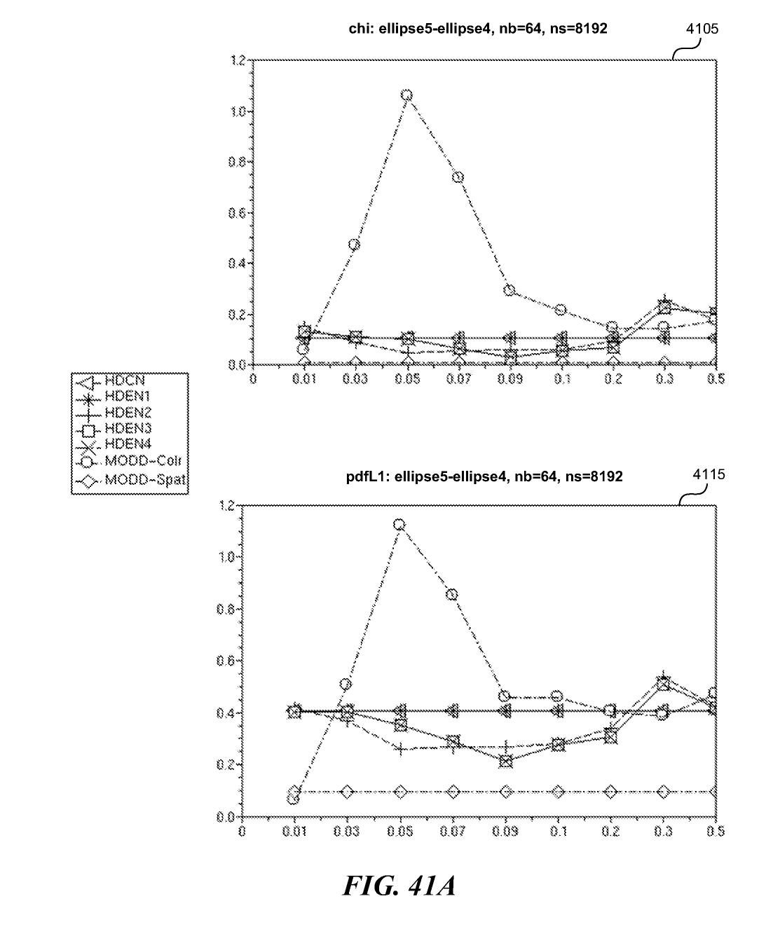

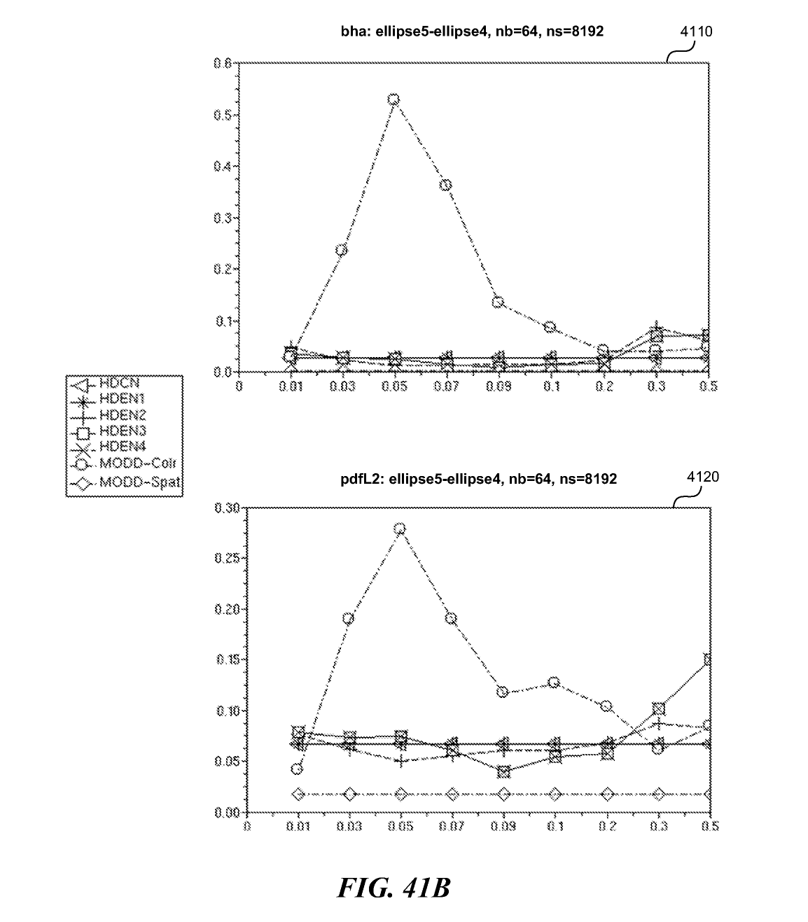

FIG. 41 includes graphs 4105-4120 comparing the difference distribution histograms for Ellipse4 and Ellipse5. Graph 4105 compares the difference distribution histograms using the chi test function; graph 4110 compares the difference distribution histograms using the bha test function; graph 4115 compares the difference distribution histograms using the pdfL1 test function; and graph 4120 compares the difference distribution histograms using the pdfL2 test function.

C. Difference Score Landscapes

In some embodiments, the similarity of difference distribution histograms is measured according to one or more difference score landscapes. Difference score landscapes may be used instead of or in addition to difference distribution histograms to determine model similarity.

### i. Example 1

### Bug

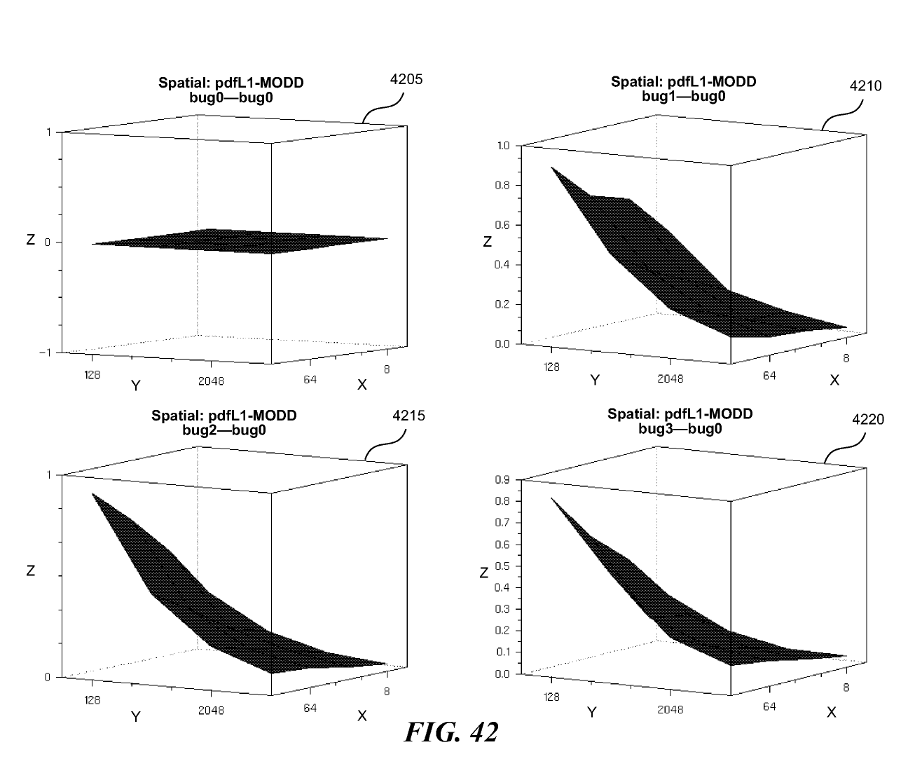

FIGS. 42-49 include difference score landscapes depicting comparisons between multiple difference distribution histograms representing the models of FIG. 4 (bugs). Each difference score landscape is generated according to the pdfL1 test function. The number of samples varies according to the set comprised of 128, 512, 2048, and 8192. The number of bins varies according to the set comprised of 8, 32, 64, and 128. The x-axis denotes the number of bins, on a scale of 8-128; the y-axis denotes the number of samples, on a scale of 128-8192; and the z-axis denotes a difference score of the corresponding sampling function.

FIG. 42 includes difference score landscapes 4205-4220 generated based on the continuous difference score of the MODD sampling function for the models of FIG. 4. Landscape 4205 corresponds to a comparison between Bug0 and itself; landscape 4210 corresponds to a comparison between Bug1 and Bug0; landscape 4215 corresponds to a comparison between Bug2 and Bug0; and landscape 4220 corresponds to a comparison between Bug3 and Bug0.

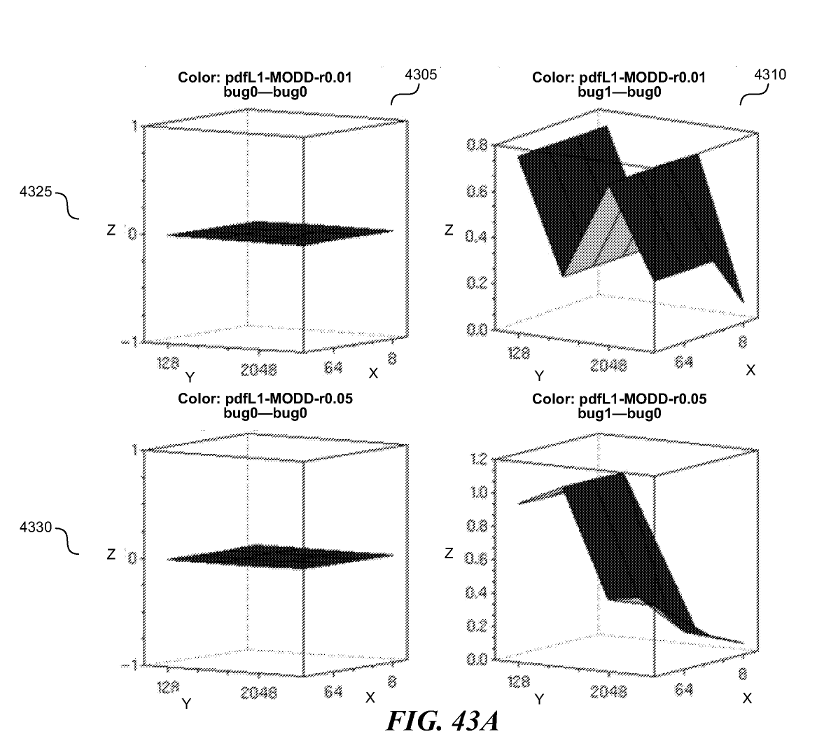

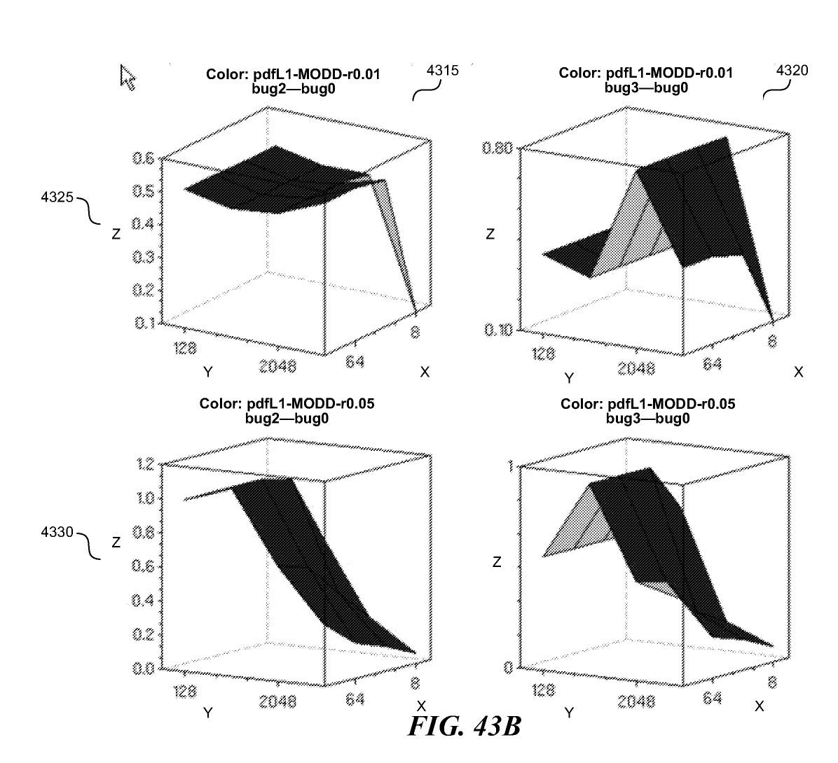

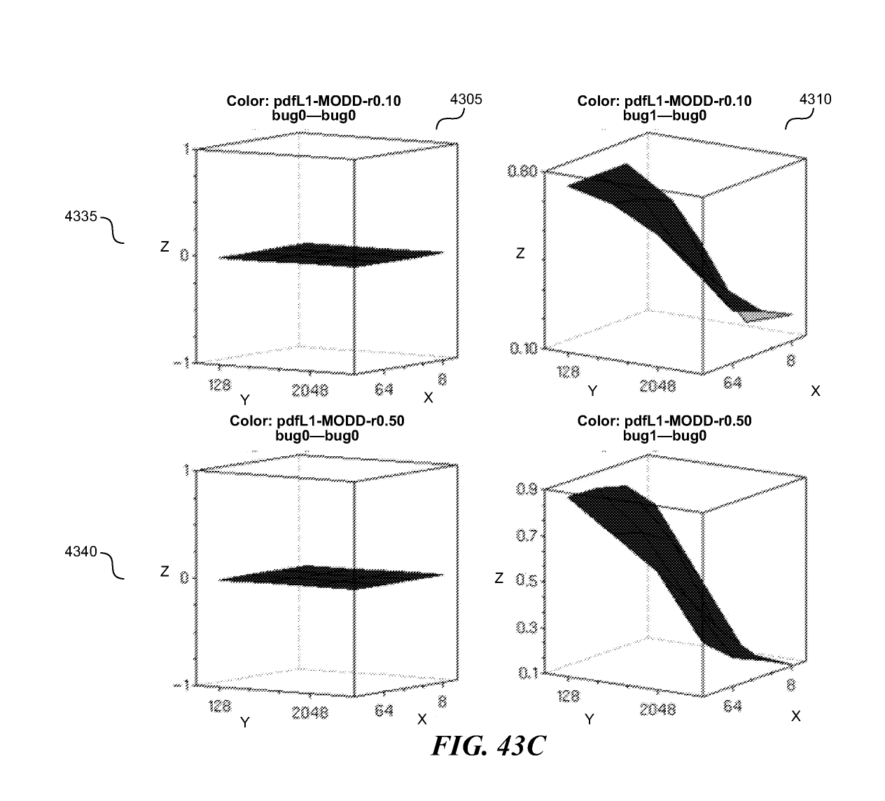

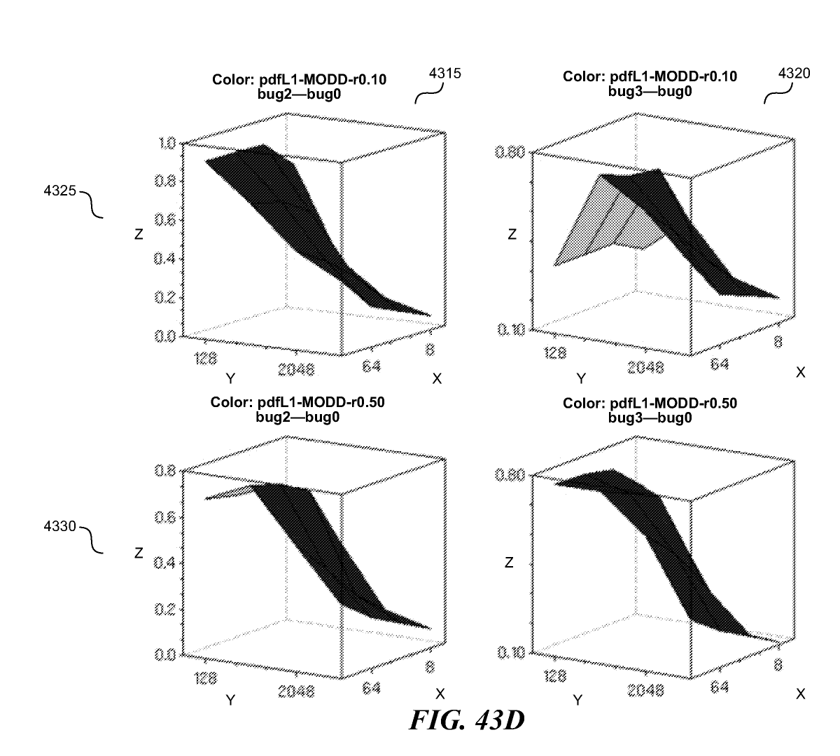

FIG. 43 includes difference score landscapes in columns 4305-4320 and rows 4325-4340 generated based on the nominal difference score of the MODD sampling function for the models of FIG. 4. Landscapes in each column 4305-4320 correspond to a comparison between a common pair of models. Landscapes in column 4305 correspond to a comparison between Bug0 and itself; landscapes in column 4310 correspond to a comparison between Bug1 and Bug0; landscapes in column 4315 correspond to a comparison between Bug2 and Bug0; and landscapes in column 4320 correspond to a comparison between Bug3 and Bug0.

Landscapes in each row 4325-4340 correspond to a common radius ratio, selected from the set comprised of 0.01, 0.05, 0.10, and 0.50. Landscapes in row 4325 correspond to the radius ratio of 0.01; landscapes in row 4330 correspond to the radius ratio of 0.05; landscapes in row 4335 correspond to the radius ratio of 0.10; and landscapes in row 4340 correspond to the radius ratio of 0.50.

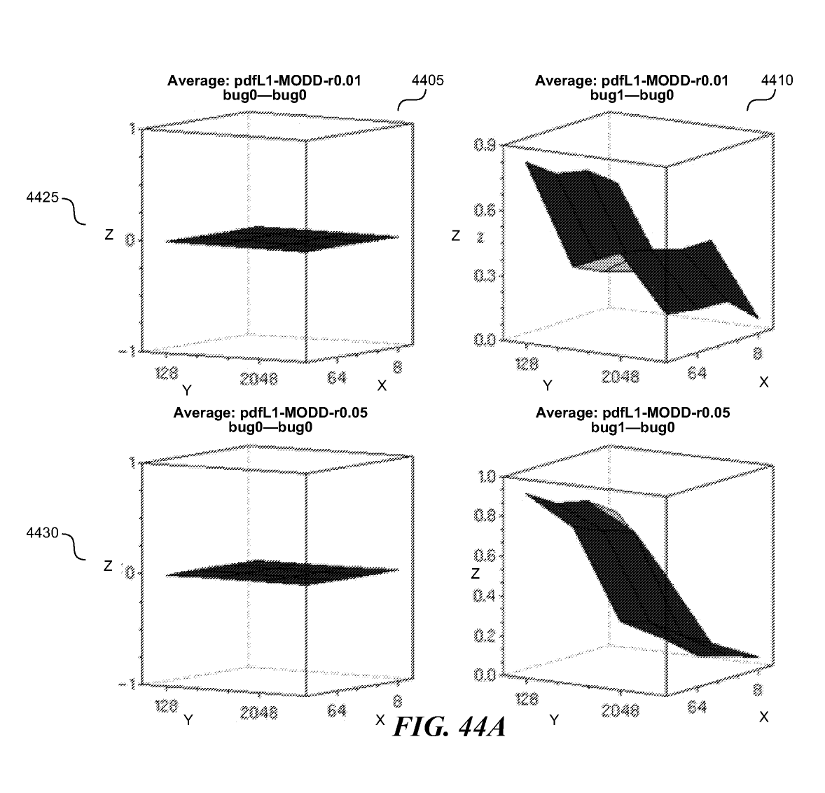

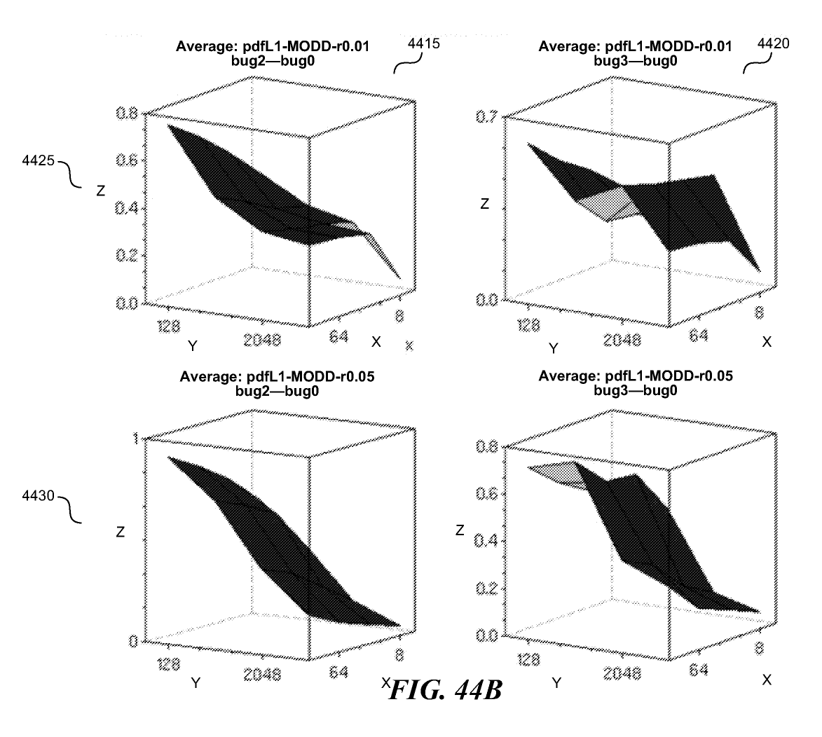

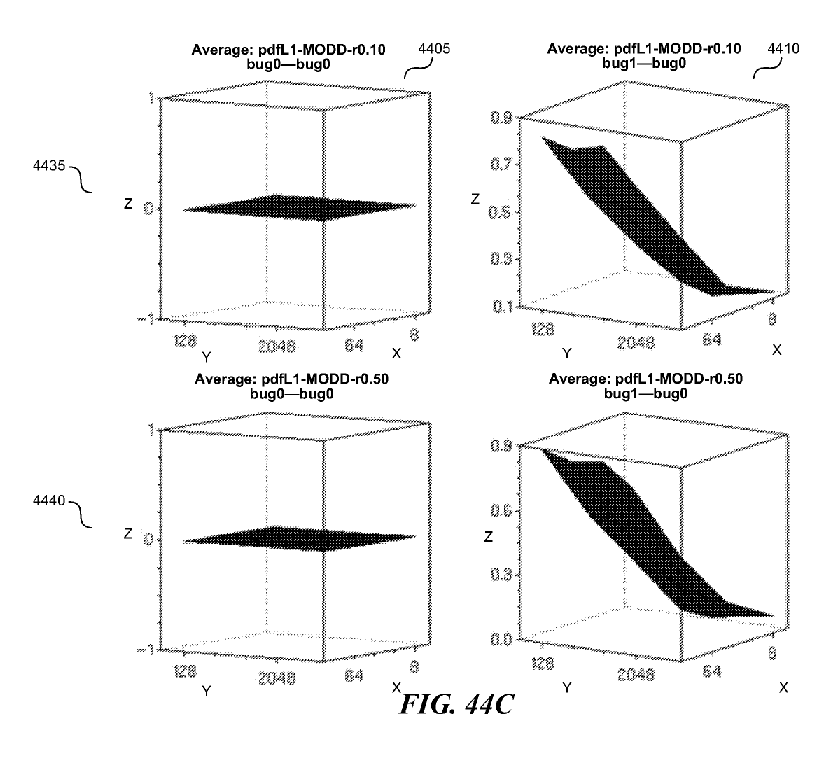

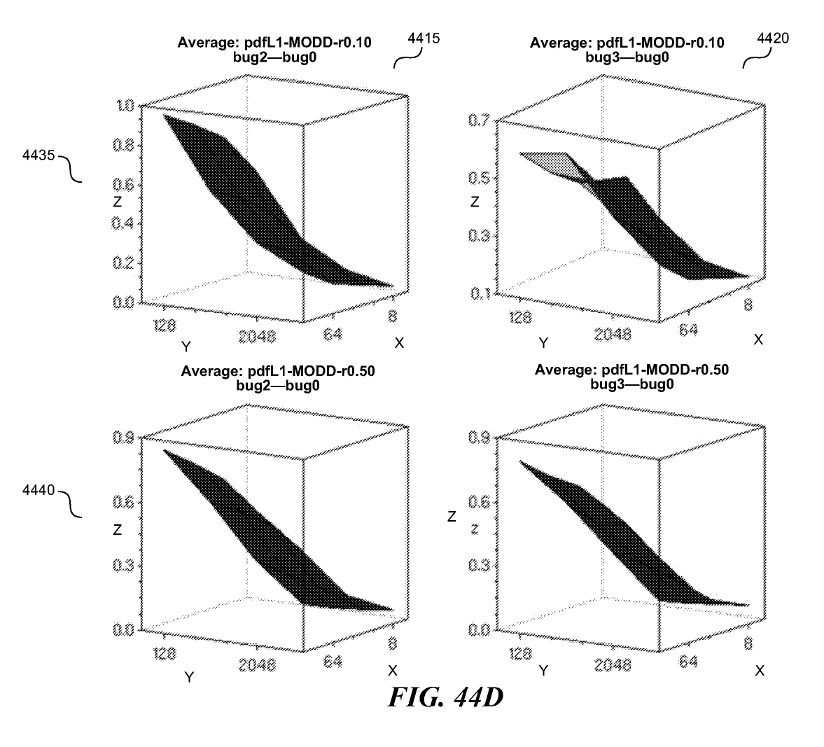

FIG. 44 includes difference score landscapes in columns 4405-4420 and rows 4425-4440 generated based on the average difference score of the MODD sampling function for the models of FIG. 4. The average difference score is generated by distributing the continuous difference scores and the nominal difference scores. In the illustrated embodiment, the continuous and nominal difference scores are evenly distributed, while in other embodiments, the continuous and nominal difference scores are weighted differently, as previously described in reference to equation (10).

Landscapes in each column 4405-4420 correspond to a comparison between a common pair of models. Landscapes in column 4405 correspond to a comparison between Bug0 and itself; landscapes in column 4410 correspond to a comparison between Bug1 and Bug0; landscapes in column 4415 correspond to a comparison between Bug2 and Bug0; and landscapes in column 4420 correspond to a comparison between Bug3 and Bug0.

Landscapes in each row 4425-4440 correspond to a common radius ratio, selected from the set comprised of 0.01, 0.05, 0.10, and 0.50. Landscapes in row 4425 correspond to the radius ratio of 0.01; landscapes in row 4430 correspond to the radius ratio of 0.05; landscapes in row 4435 correspond to the radius ratio of 0.10; and landscapes in row 4440 correspond to the radius ratio of 0.50.

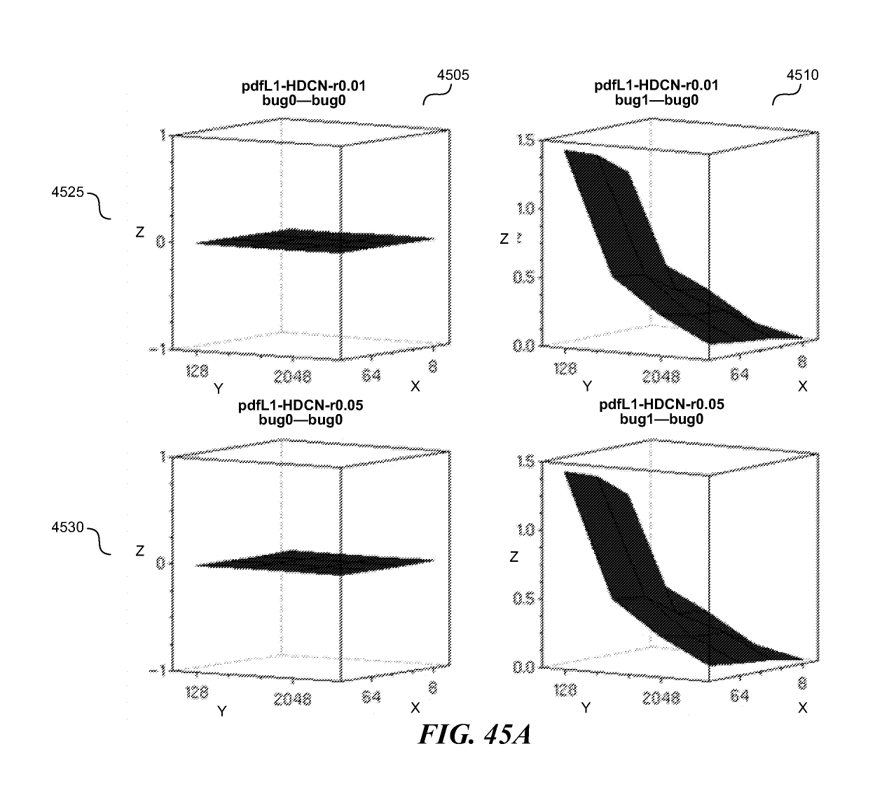

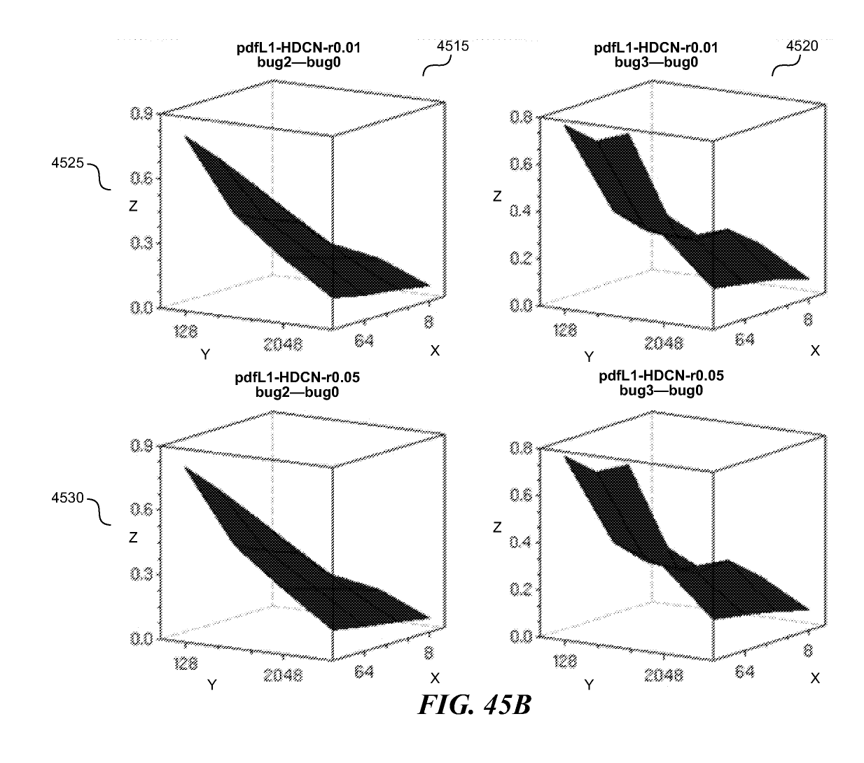

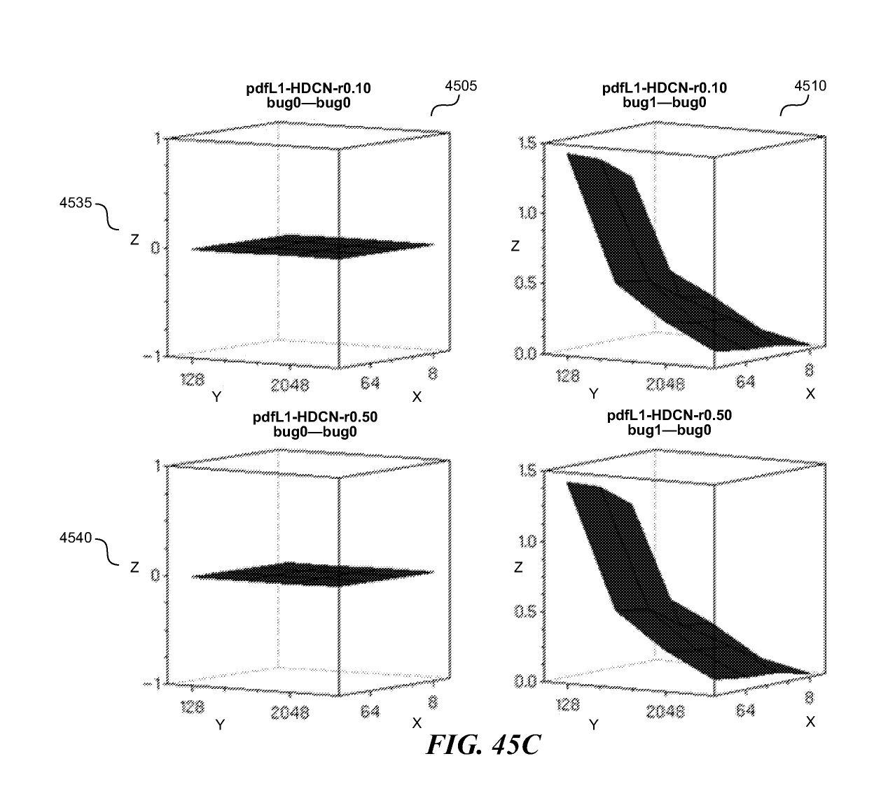

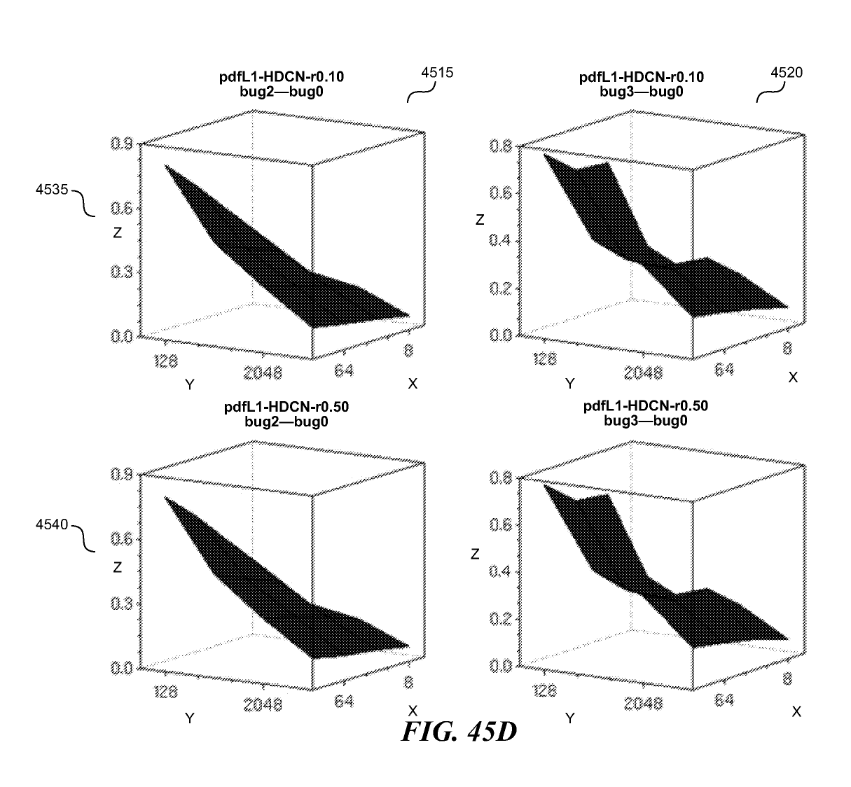

FIG. 45 includes difference score landscapes in columns 4505-4520 and rows 4525-4540 generated according to the HDCN sampling function for the models of FIG. 4. Landscapes in each column 4505-4520 correspond to a comparison between a common pair of models. Landscapes in column 4505 correspond to a comparison between Bug0 and itself; landscapes in column 4510 correspond to a comparison between Bug1 and Bug0; landscapes in column 4515 correspond to a comparison between Bug2 and Bug0; and landscapes in column 4520 correspond to a comparison between Bug3 and Bug0.

Landscapes in each row 4525-4540 correspond to a common radius ratio, selected from the set comprised of 0.01, 0.05, 0.10, and 0.50. Landscapes in row 4525 correspond to the radius ratio of 0.01; landscapes in row 4530 correspond to the radius ratio of 0.05; landscapes in row 4535 correspond to the radius ratio of 0.10; and landscapes in row 4540 correspond to the radius ratio of 0.50.

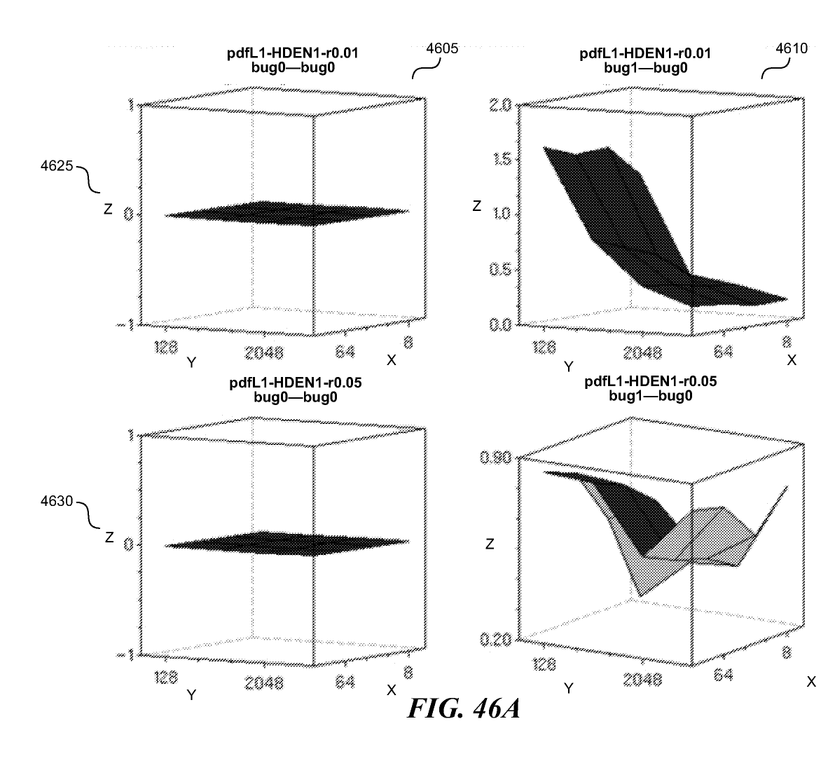

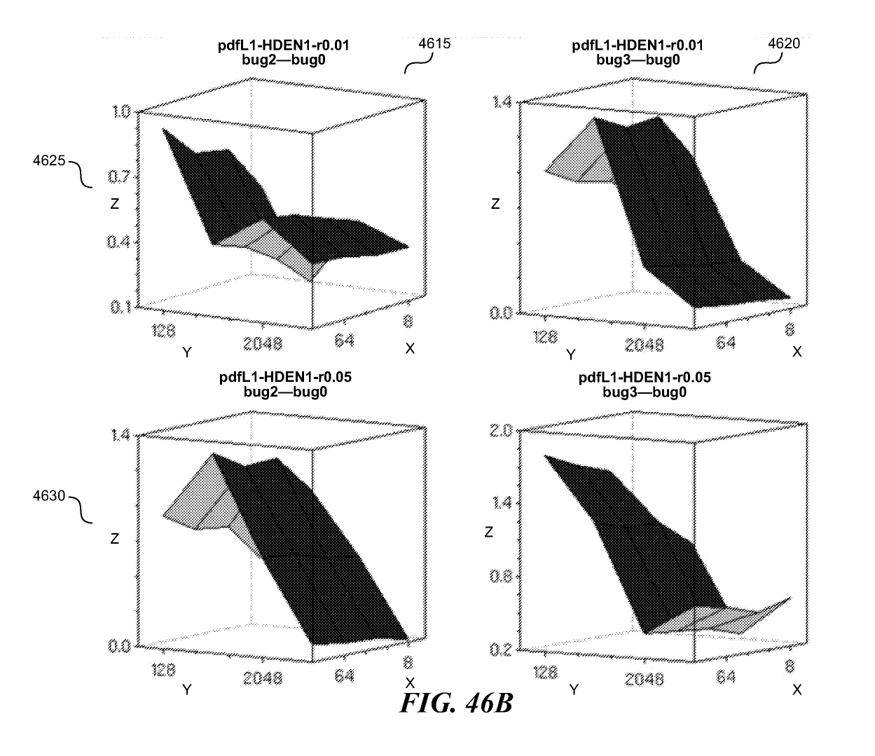

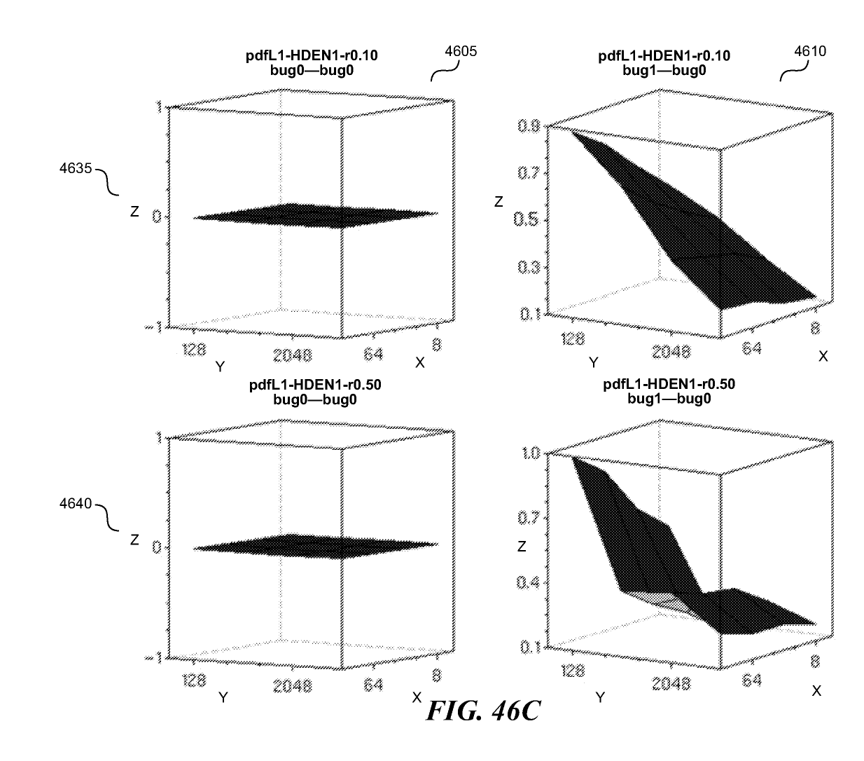

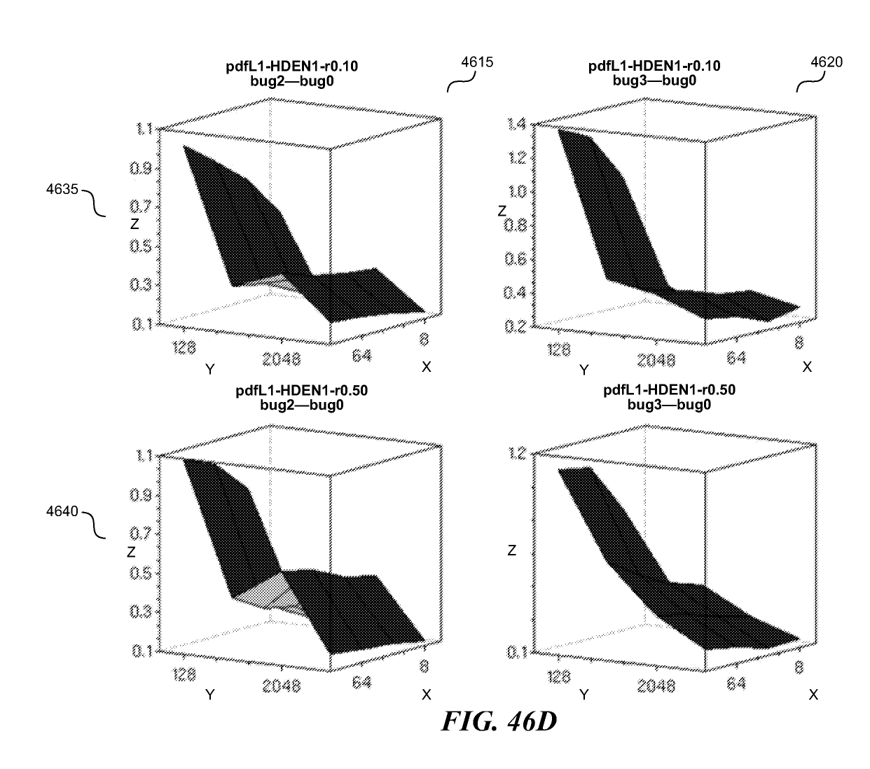

FIG. 46 includes difference score landscapes in columns 4605-4620 and rows 4625-4640 generated according to the HDEN1 sampling function for the models of FIG. 4. Landscapes in each column 4605-4620 correspond to a comparison between a common pair of models. Landscapes in column 4605 correspond to a comparison between Bug0 and itself; landscapes in column 4610 correspond to a comparison between Bug1 and Bug0; landscapes in column 4615 correspond to a comparison between Bug2 and Bug0; and landscapes in column 4620 correspond to a comparison between Bug3 and Bug0.

Landscapes in each row 4625-4640 correspond to a common radius ratio, selected from the set comprised of 0.01, 0.05, 0.10, and 0.50. Landscapes in row 4625 correspond to the radius ratio of 0.01; landscapes in row 4630 correspond to the radius ratio of 0.05; landscapes in row 4635 correspond to the radius ratio of 0.10; and landscapes in row 4640 correspond to the radius ratio of 0.50.

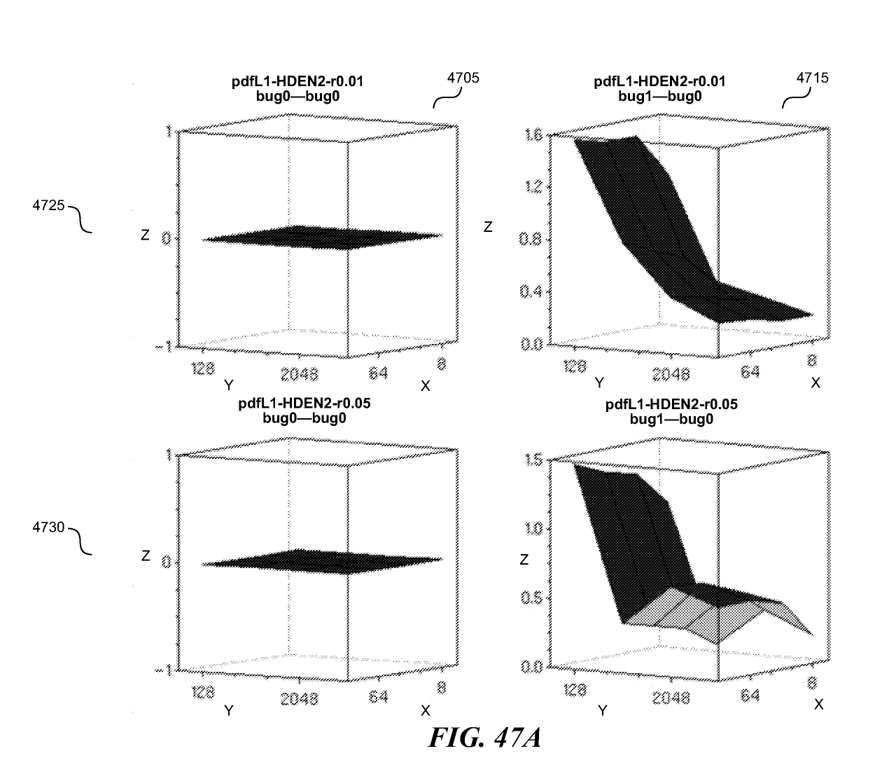

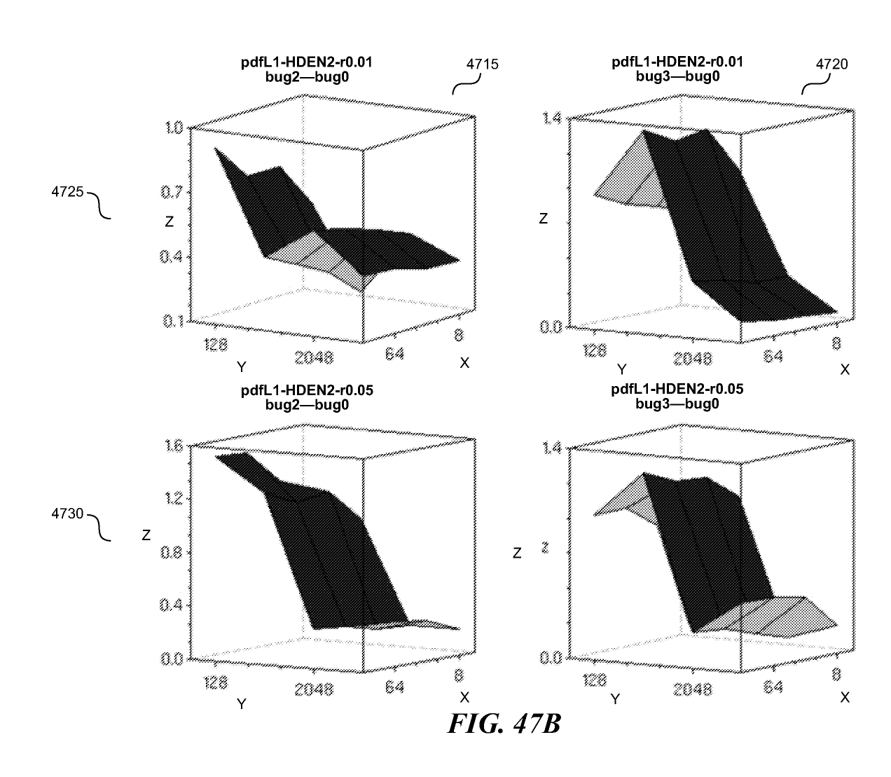

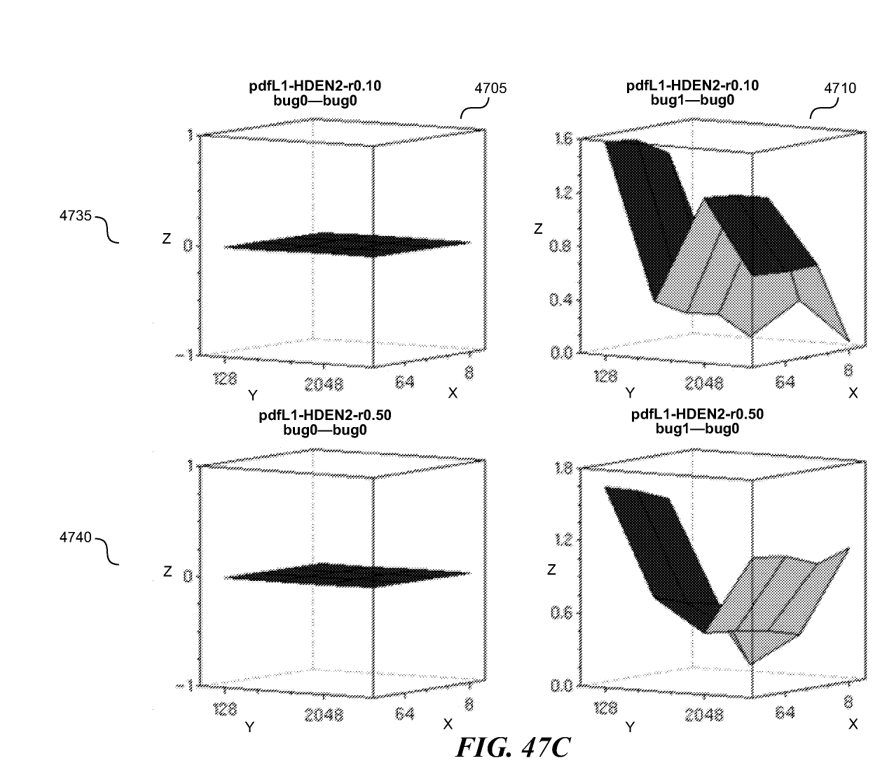

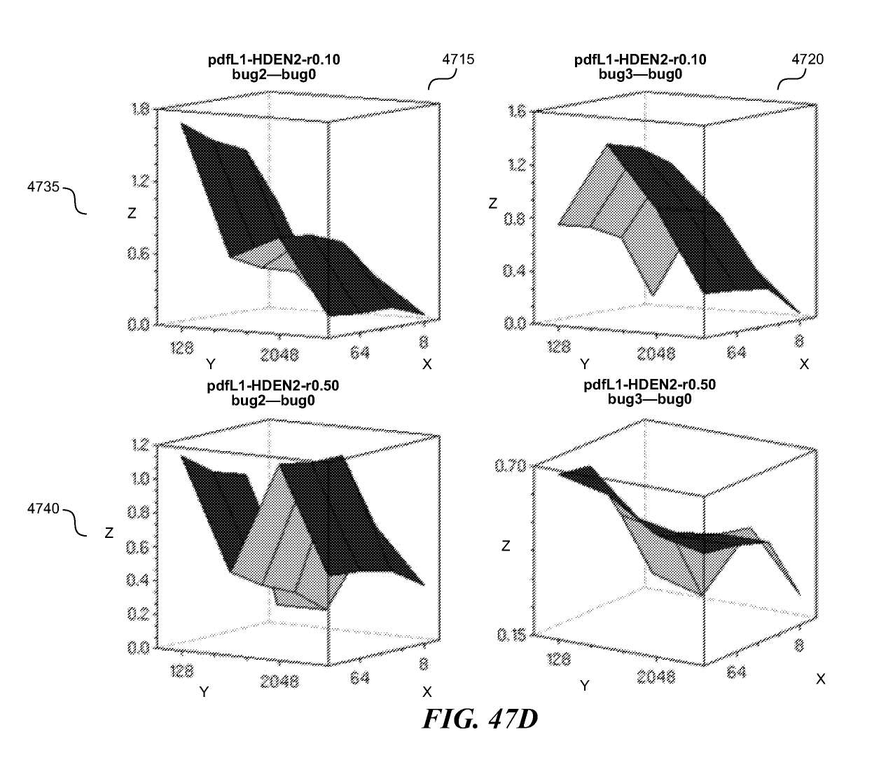

FIG. 47 includes difference score landscapes in columns 4705-4720 and rows 4725-4740 generated according to the HDEN2 sampling function for the models of FIG. 4. Landscapes in each column 4705-4720 correspond to a comparison between a common pair of models. Landscapes in column 4705 correspond to a comparison between Bug0 and itself; landscapes in column 4710 correspond to a comparison between Bug1 and Bug0; landscapes in column 4715 correspond to a comparison between Bug2 and Bug0; and landscapes in column 4720 correspond to a comparison between Bug3 and Bug0.

Landscapes in each row 4725-4740 correspond to a common radius ratio, selected from the set comprised of 0.01, 0.05, 0.10, and 0.50. Landscapes in row 4725 correspond to the radius ratio of 0.01; landscapes in row 4730 correspond to the radius ratio of 0.05; landscapes in row 4735 correspond to the radius ratio of 0.10; and landscapes in row 4740 correspond to the radius ratio of 0.50.

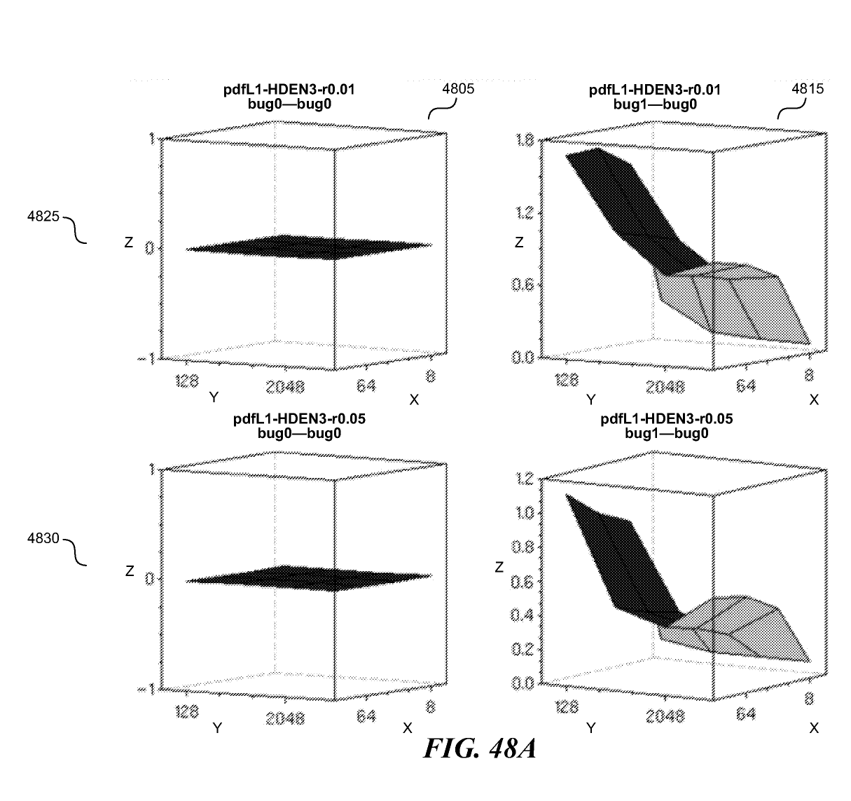

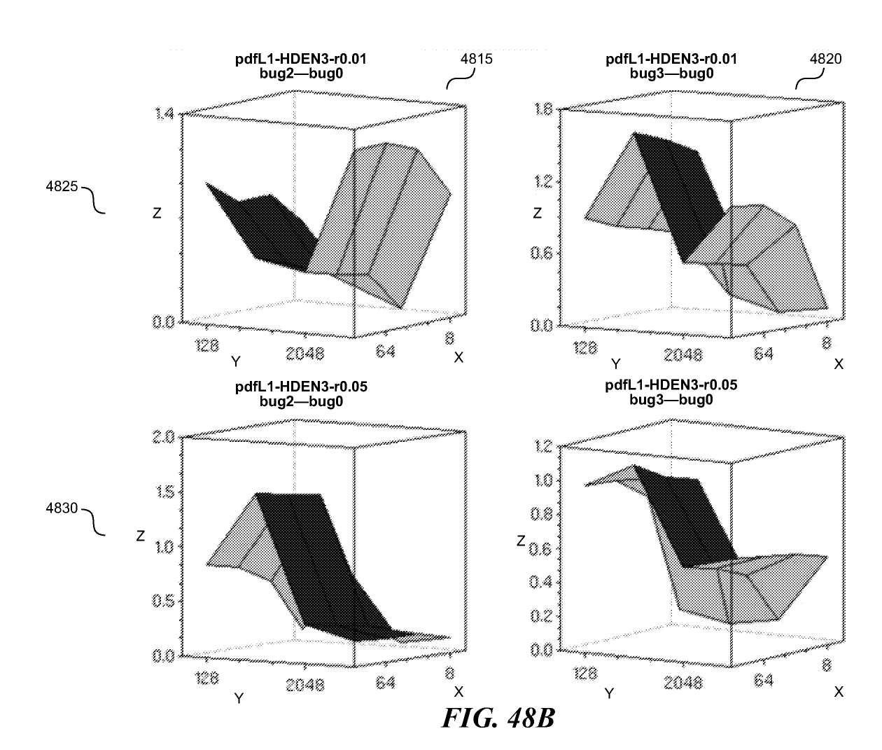

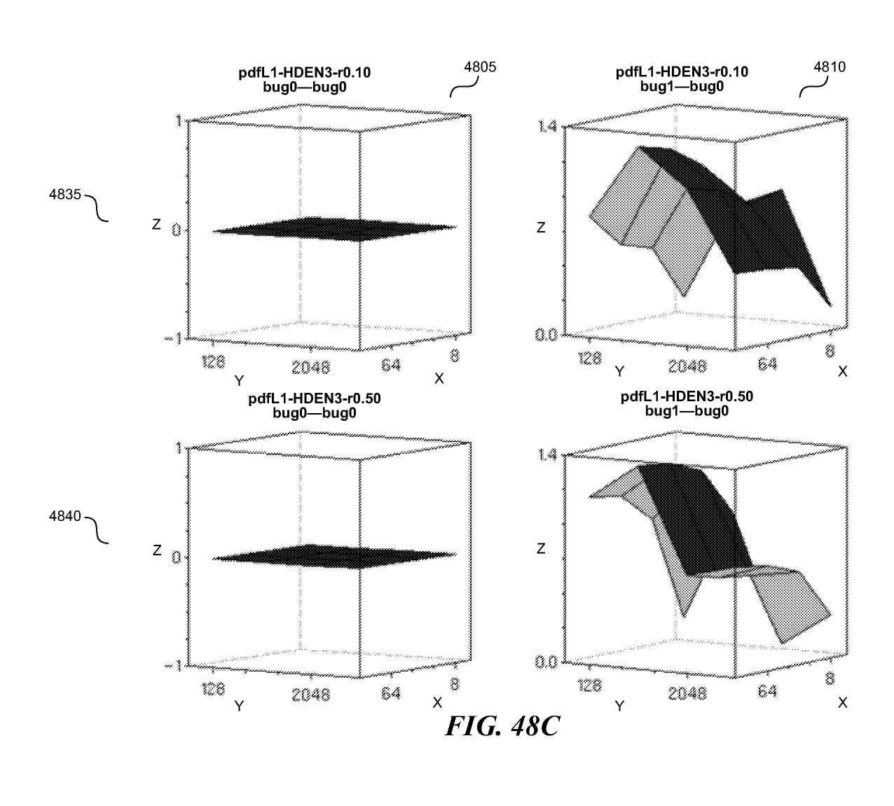

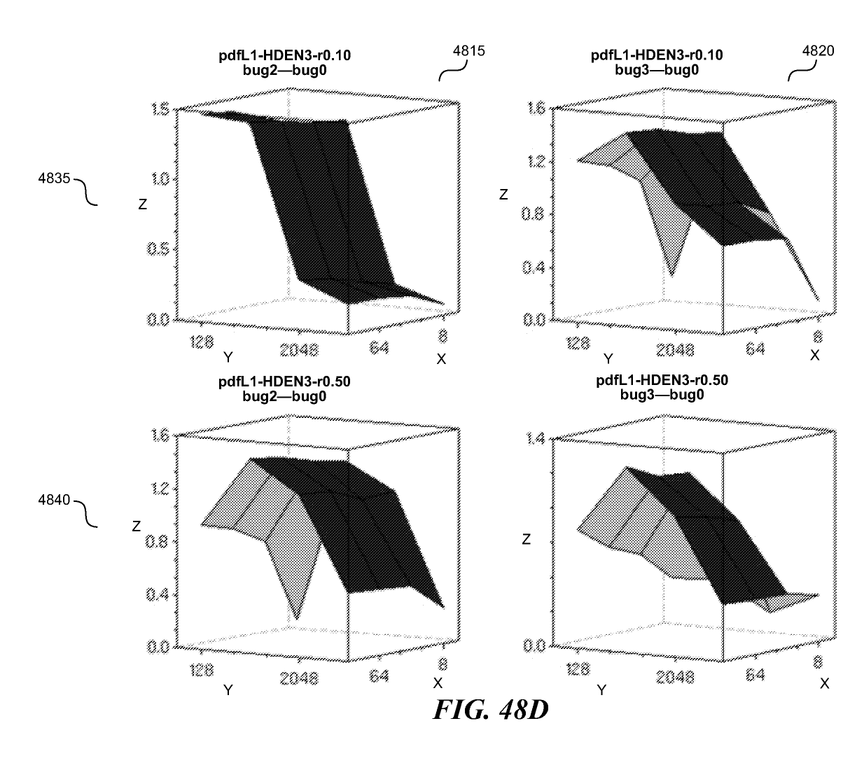

FIG. 48 includes difference score landscapes in columns 4805-4820 and rows 4825-4840 generated according to the HDEN3 sampling function for the models of FIG. 4. Landscapes in each column 4805-4820 correspond to a comparison between a common pair of models. Landscapes in column 4805 correspond to a comparison between Bug0 and itself; landscapes in column 4810 correspond to a comparison between Bug1 and Bug0; landscapes in column 4815 correspond to a comparison between Bug2 and Bug0; and landscapes in column 4820 correspond to a comparison between Bug3 and Bug0.

Landscapes in each row 4825-4840 correspond to a common radius ratio, selected from the set comprised of 0.01, 0.05, 0.10, and 0.50. Landscapes in row 4825 correspond to the radius ratio of 0.01; landscapes in row 4830 correspond to the radius ratio of 0.05; landscapes in row 4835 correspond to the radius ratio of 0.10; and landscapes in row 4840 correspond to the radius ratio of 0.50.

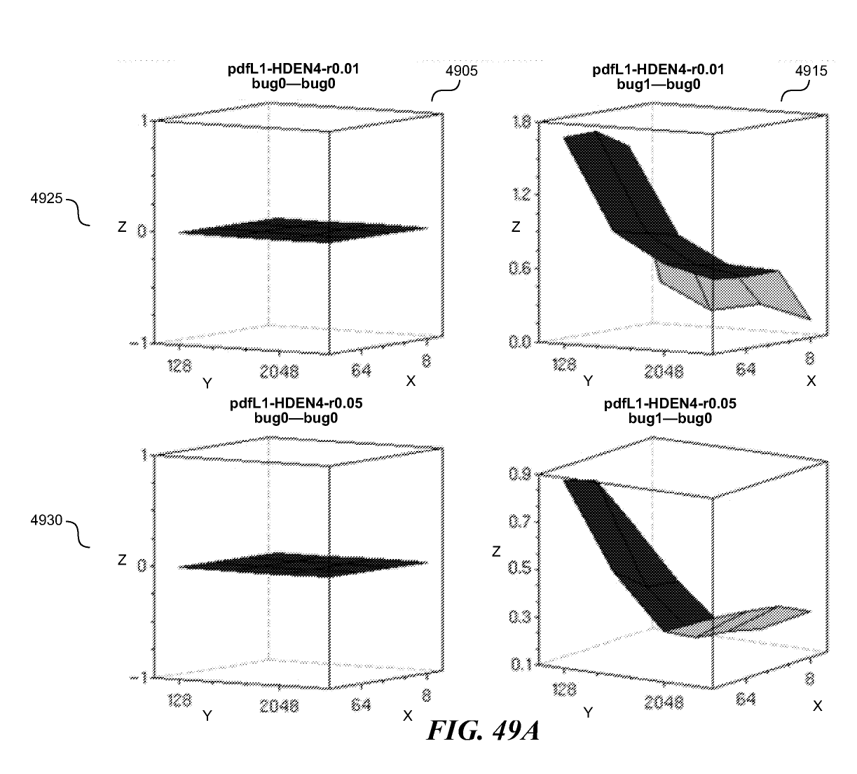

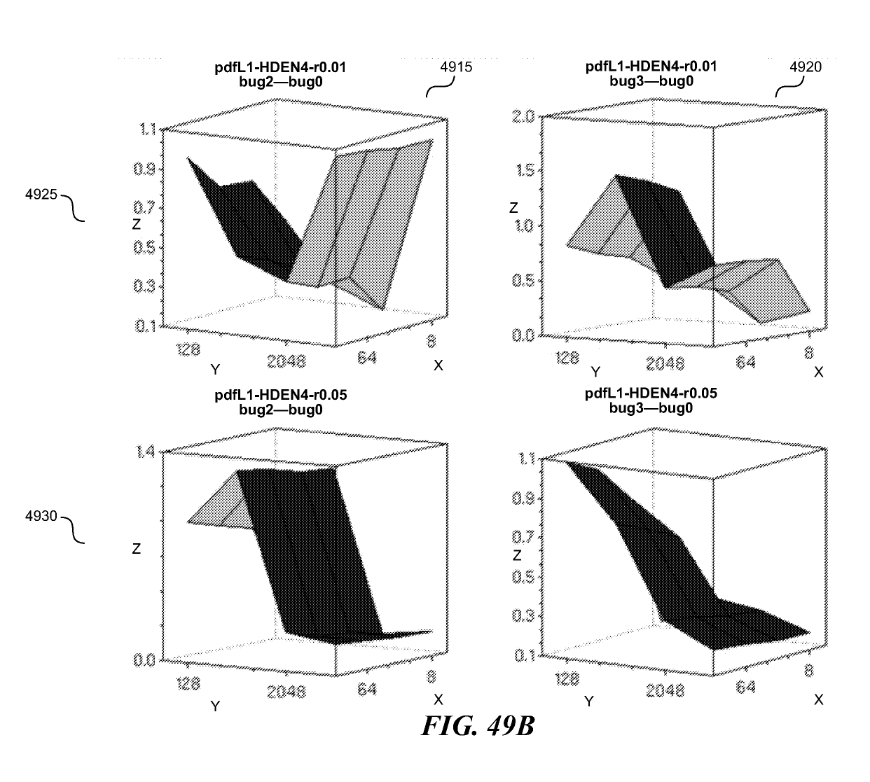

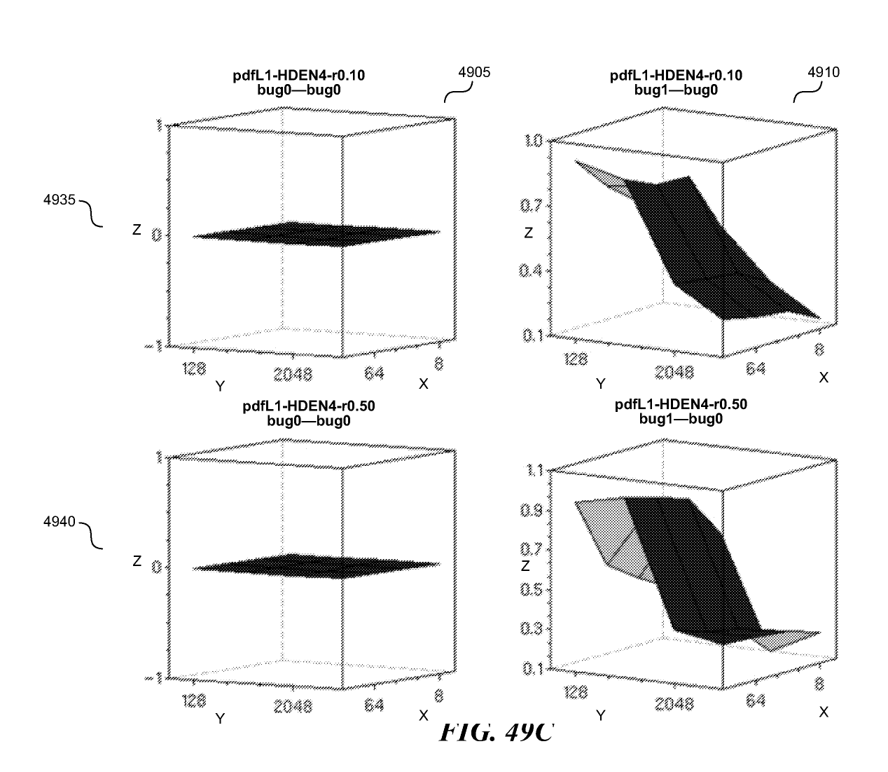

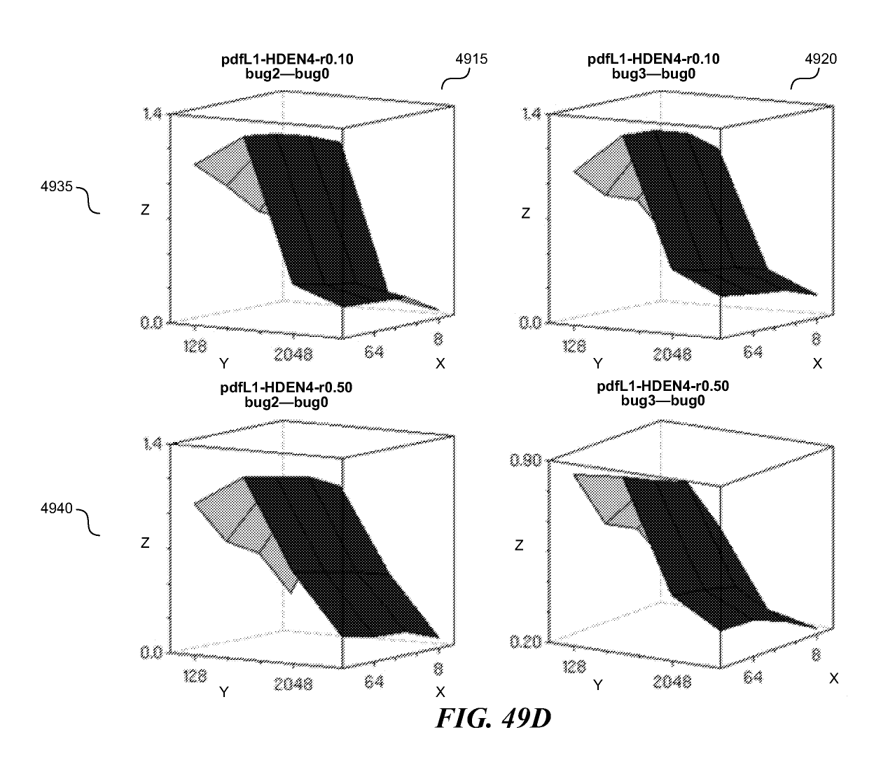

FIG. 49 includes difference score landscapes in columns 4905-4920 and rows 4925-4940 generated according to the HDEN4 sampling function for the models of FIG. 4. Landscapes in each column 4905-4920 correspond to a comparison between a common pair of models. Landscapes in column 4905 correspond to a comparison between Bug0 and itself; landscapes in column 4910 correspond to a comparison between Bug1 and Bug0; landscapes in column 4915 correspond to a comparison between Bug2 and Bug0; and landscapes in column 4920 correspond to a comparison between Bug3 and Bug0.

Landscapes in each row 4925-4940 correspond to a common radius ratio, selected from the set comprised of 0.01, 0.05, 0.10, and 0.50. Landscapes in row 4925 correspond to the radius ratio of 0.01; landscapes in row 4930 correspond to the radius ratio of 0.05; landscapes in row 4935 correspond to the radius ratio of 0.10; and landscapes in row 4940 correspond to the radius ratio of 0.50.

### ii. Example 2

### Ellipse

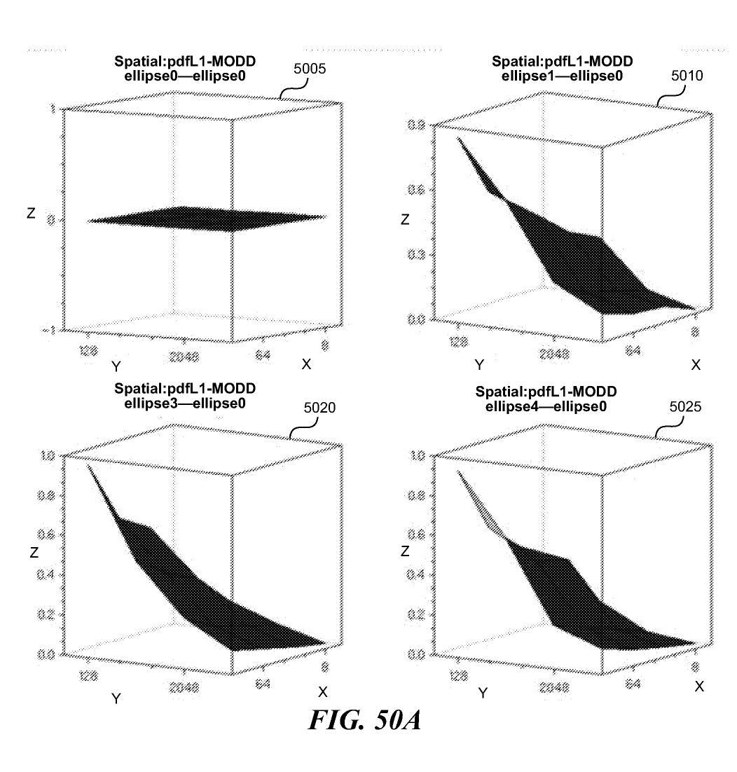

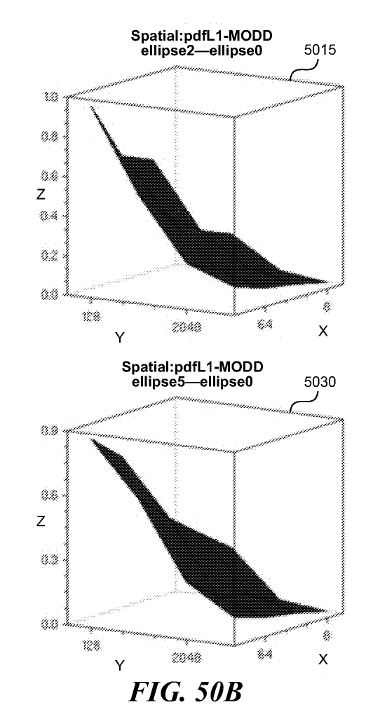

FIGS. 50-57 include difference score landscapes depicting comparisons between multiple difference distribution histograms representing the models of FIG. 14 (ellipses). Each difference score landscape is generated according to the pdfL1 test function. The number of samples varies according to the set comprised of 128, 512, 2048, and 8192. The number of bins varies according to the set comprised of 8, 32, 64, and 128. The x-axis denotes the number of bins, on a scale of 8-128; the y-axis denotes the number of samples, on a scale of 128-8192; and the z-axis denotes a difference score of the corresponding sampling function.

FIG. 50 includes difference score landscapes 5005-5030 generated based on the continuous difference score of the MODD sampling function for the models of FIG. 14. Landscape 5005 corresponds to a comparison between Ellipse0 of graph 1405 and itself; landscape 5010 corresponds to a comparison between Ellipse1 of graph 1410 and Ellipse0; landscape 5015 corresponds to a comparison between Ellipse2 of graph 1415 and Ellipse0; landscape 5020 corresponds to a comparison between Ellipse3 of graph 1420 and Ellipse0; landscape 5025 corresponds to a comparison between Ellipse4 of graph 1425 and Ellipse0; and landscape 5030 corresponds to a comparison between Ellipse5 of graph 1430 and Ellipse0.

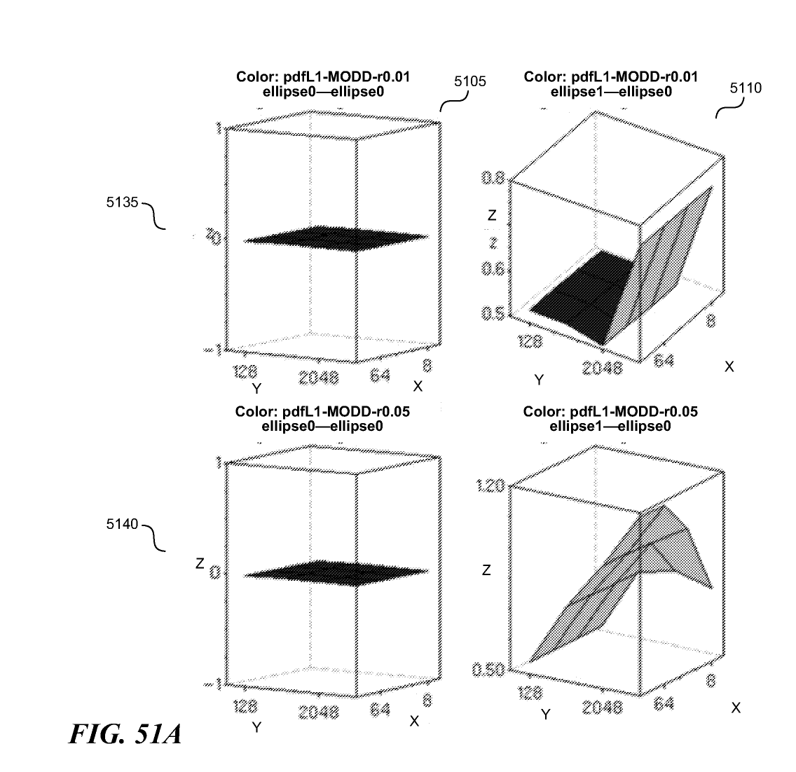

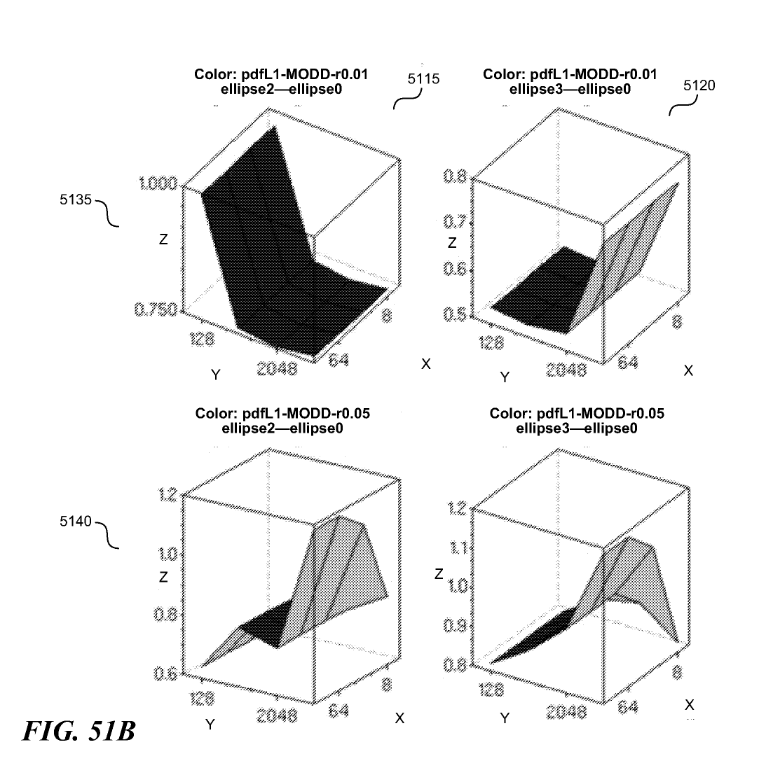

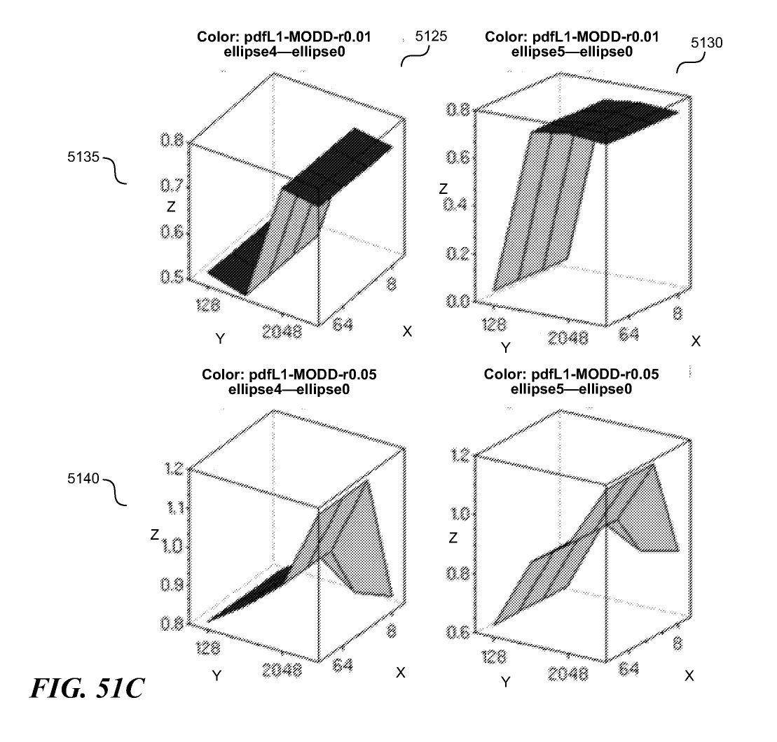

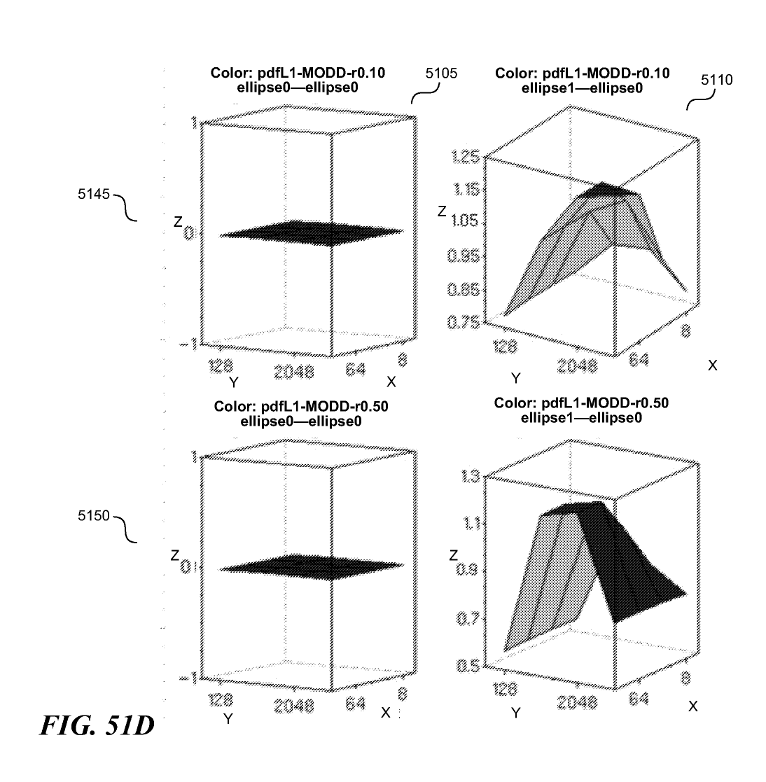

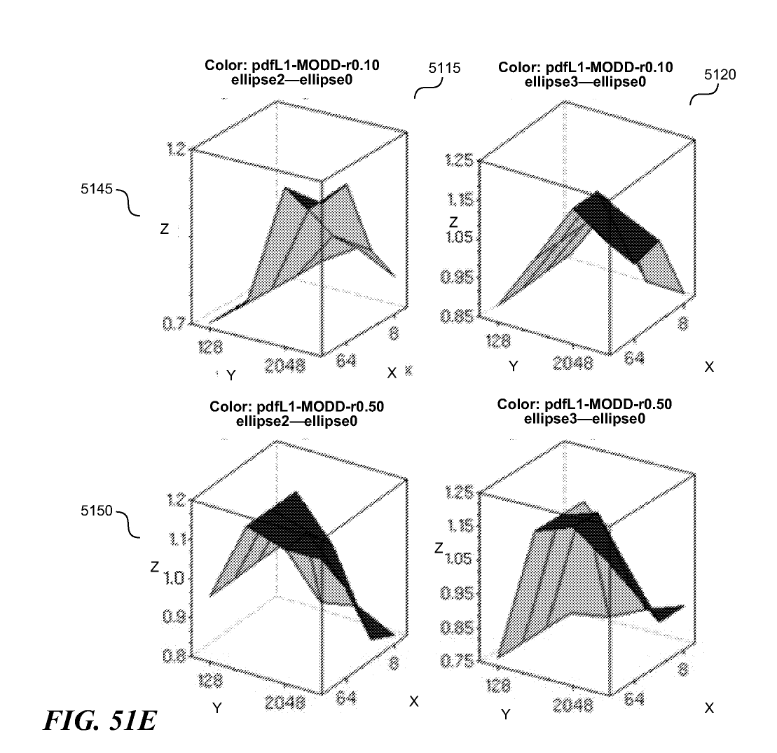

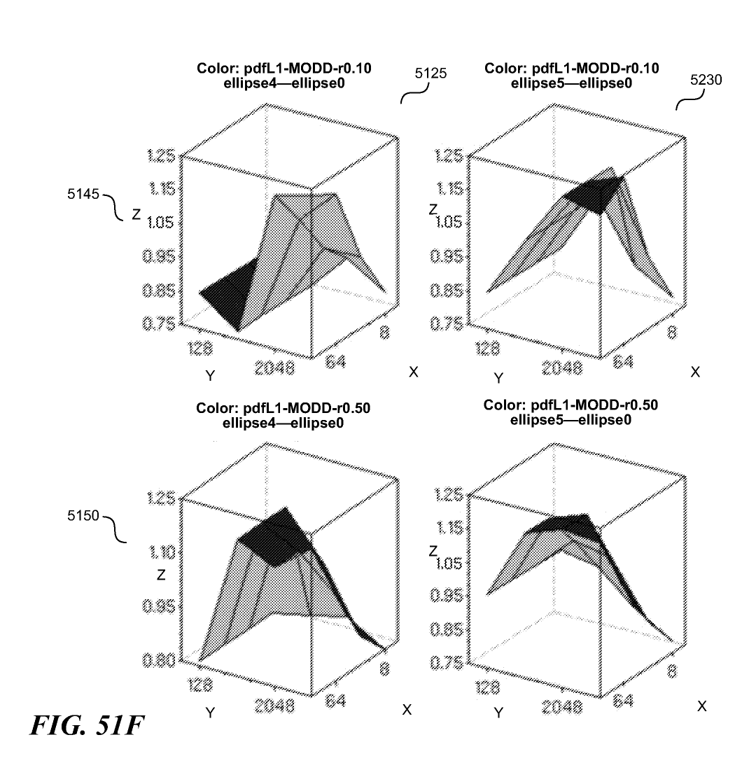

FIG. 51 includes difference score landscapes in columns 5105-5130 and rows 5135-3150 generated based on the nominal difference score of the MODD sampling function for the models of FIG. 14. Landscapes in each column 5105-5130 correspond to a comparison between a common pair of models. Landscapes in column 5105 correspond to a comparison between Ellipse0 and itself; landscapes in column 5110 correspond to a comparison between Ellipse1 and Ellipse0; landscapes in column 5115 correspond to a comparison between Ellipse2 and Ellipse0; landscapes in column 5120 correspond to a comparison between Ellipse3 and Ellipse0; landscapes in column 5125 correspond to a comparison between Ellipse4 and Ellipse0; and landscapes in column 5130 correspond to a comparison between Ellipse5 and Ellipse0.

Landscapes in each row 5135-5150 correspond to a common radius ratio, selected from the set comprised of 0.01, 0.05, 0.10, and 0.50. Landscapes in row 5135 correspond to the radius ratio of 0.01; landscapes in row 5140 correspond to the radius ratio of 0.05; landscapes in row 5145 correspond to the radius ratio of 0.10; and landscapes in row 5150 correspond to the radius ratio of 0.50.

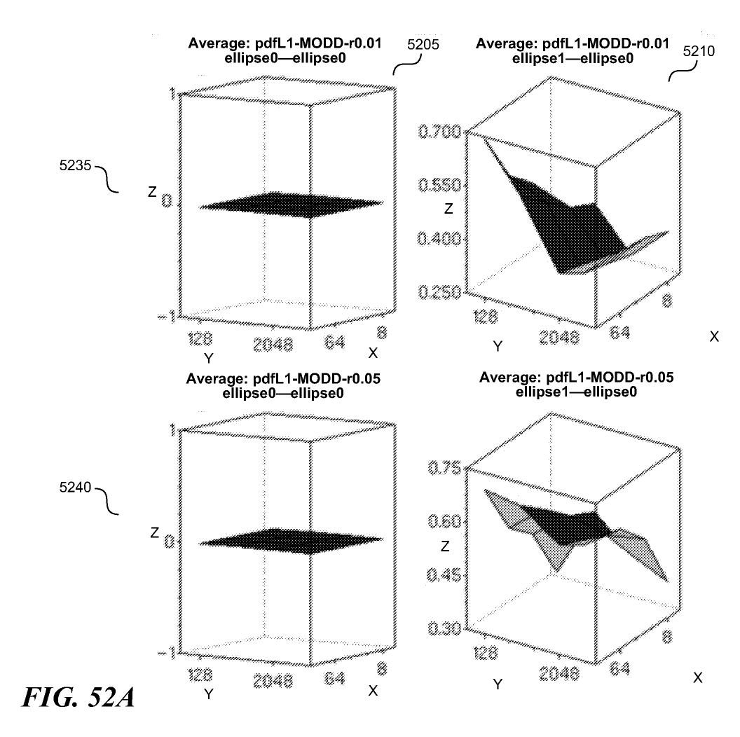

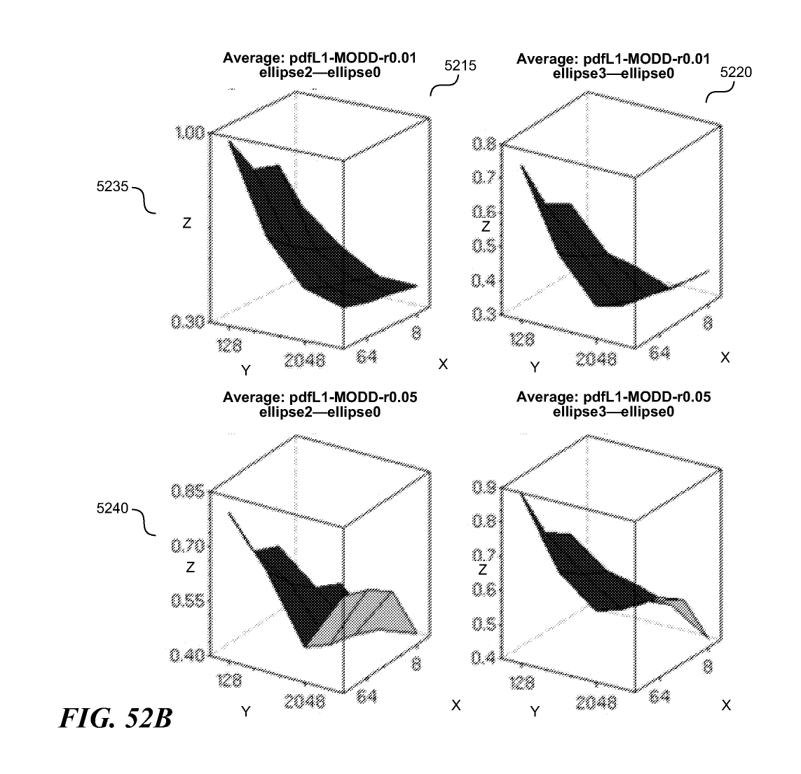

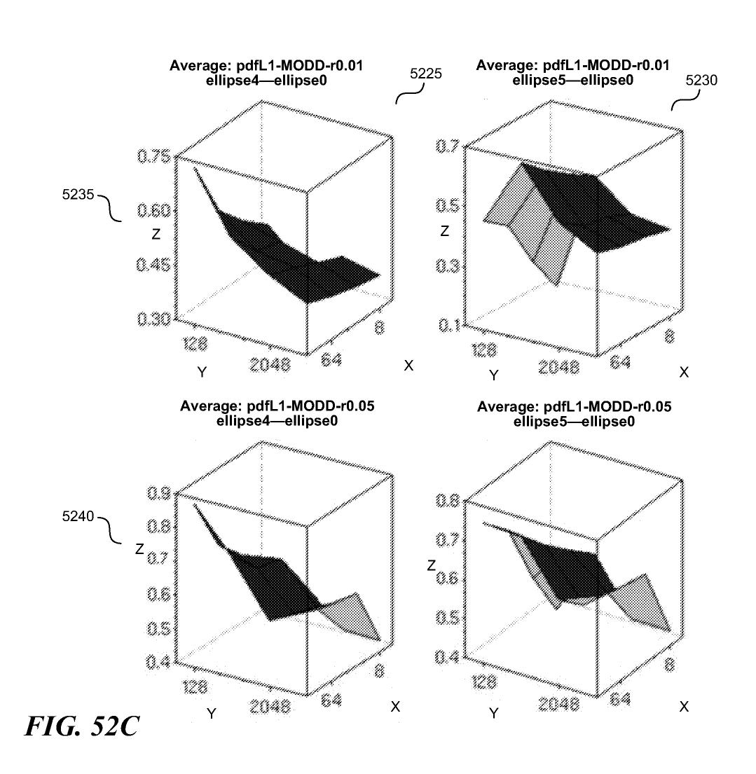

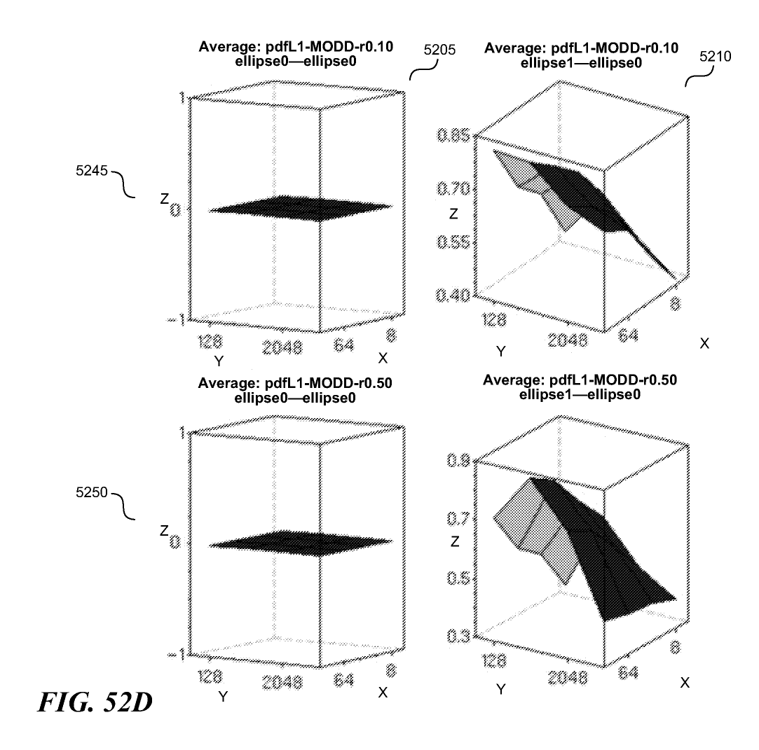

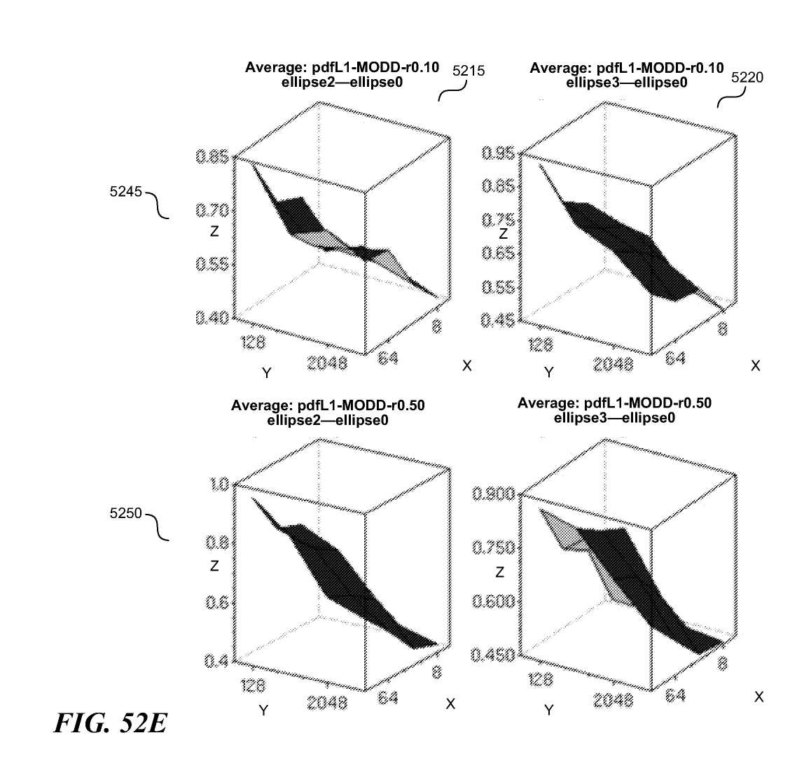

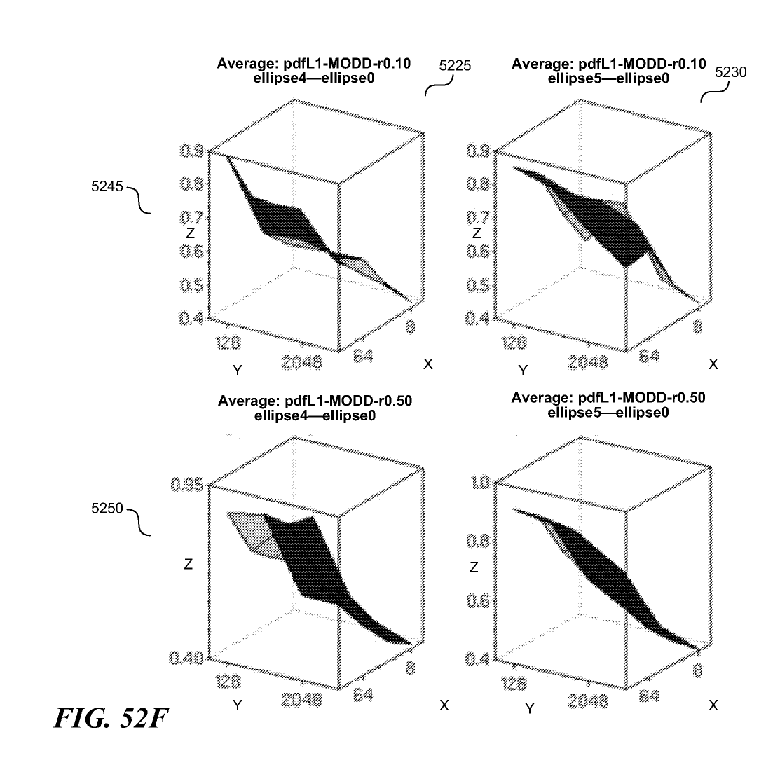

FIG. 52 includes difference score landscapes in columns 5205-5230 and rows 5235-5250 generated based on the average difference score of the MODD sampling function for the models of FIG. 14. As previously described, the average difference score is generated by evenly distributing the continuous difference scores and the nominal difference scores. Landscapes in each column 5205-5230 correspond to a comparison between a common pair of models. Landscapes in column 5205 correspond to a comparison between Ellipse0 and itself; landscapes in column 5210 correspond to a comparison between Ellipse1 and Ellipse0; landscapes in column 5215 correspond to a comparison between Ellipse2 and Ellipse0; landscapes in column 5220 correspond to a comparison between Ellipse3 and Ellipse0; landscapes in column 5225 correspond to a comparison between Ellipse4 and Ellipse0; and landscapes in column 5230 correspond to a comparison between Ellipse5 and Ellipse0.

Landscapes in each row 5235-5250 correspond to a common radius ratio, selected from the set comprised of 0.01, 0.05, 0.10, and 0.50. Landscapes in row 5235 correspond to the radius ratio of 0.01; landscapes in row 5240 correspond to the radius ratio of 0.05; landscapes in row 5245 correspond to the radius ratio of 0.10; and landscapes in row 5250 correspond to the radius ratio of 0.50.

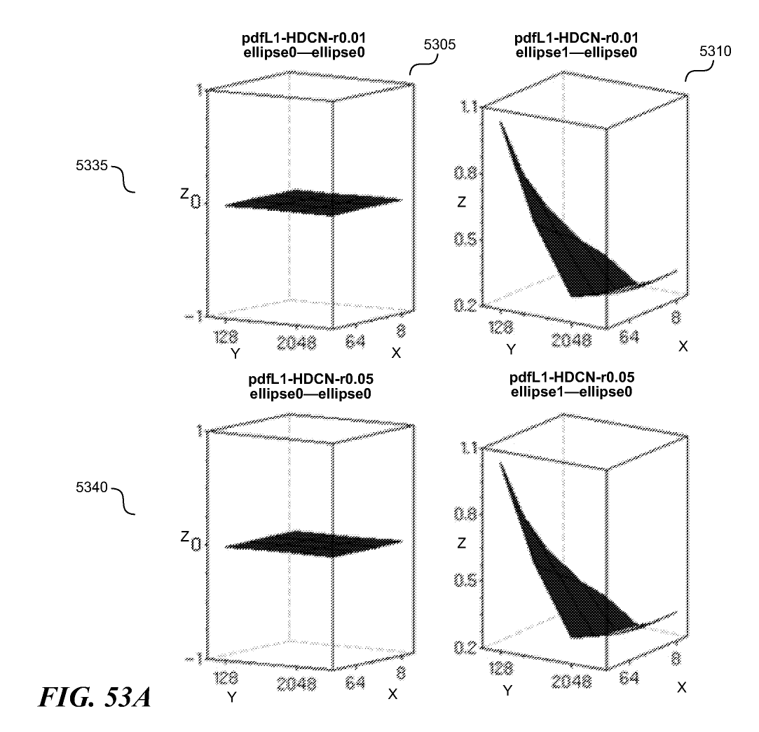

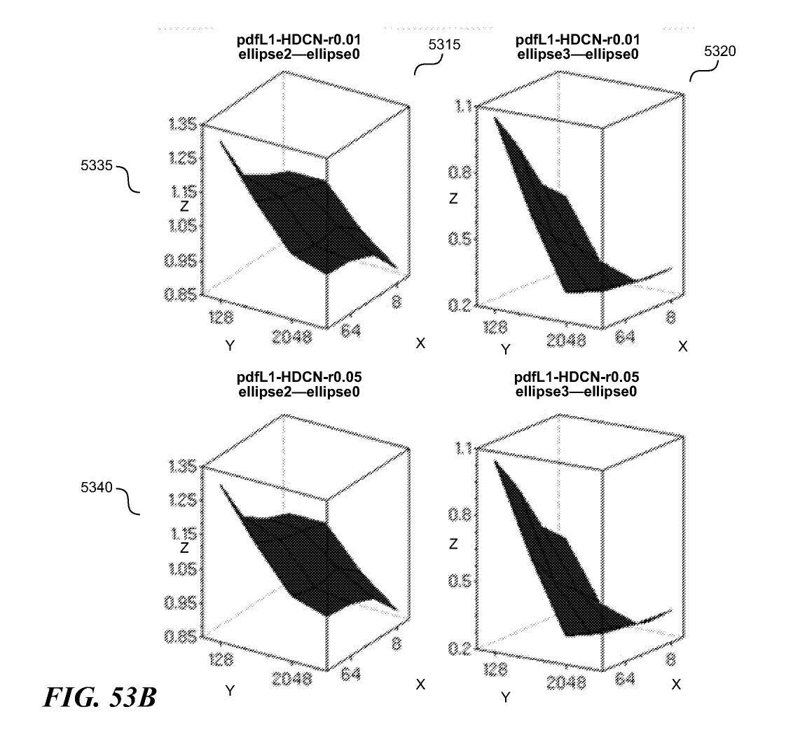

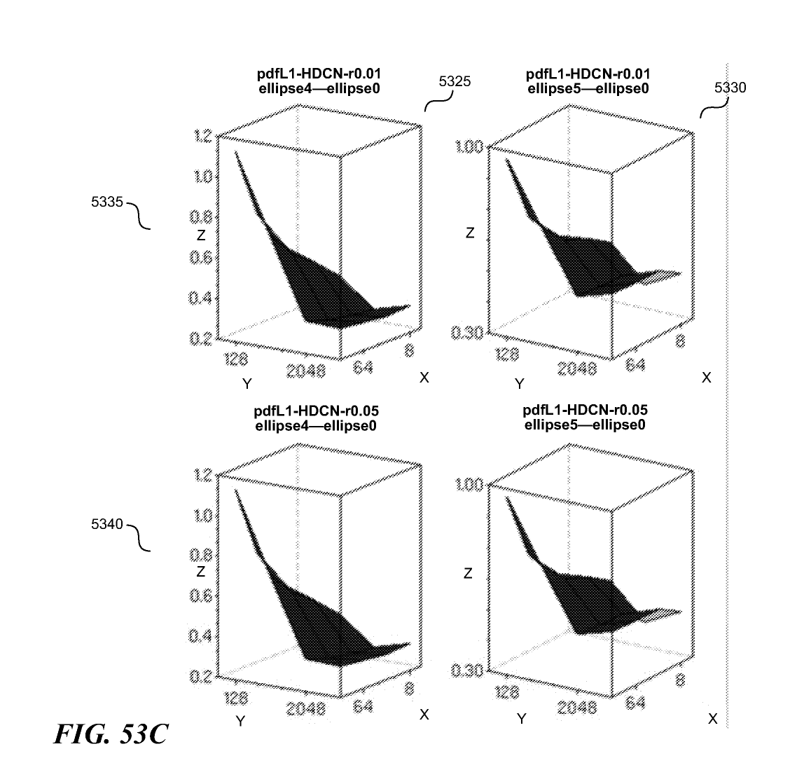

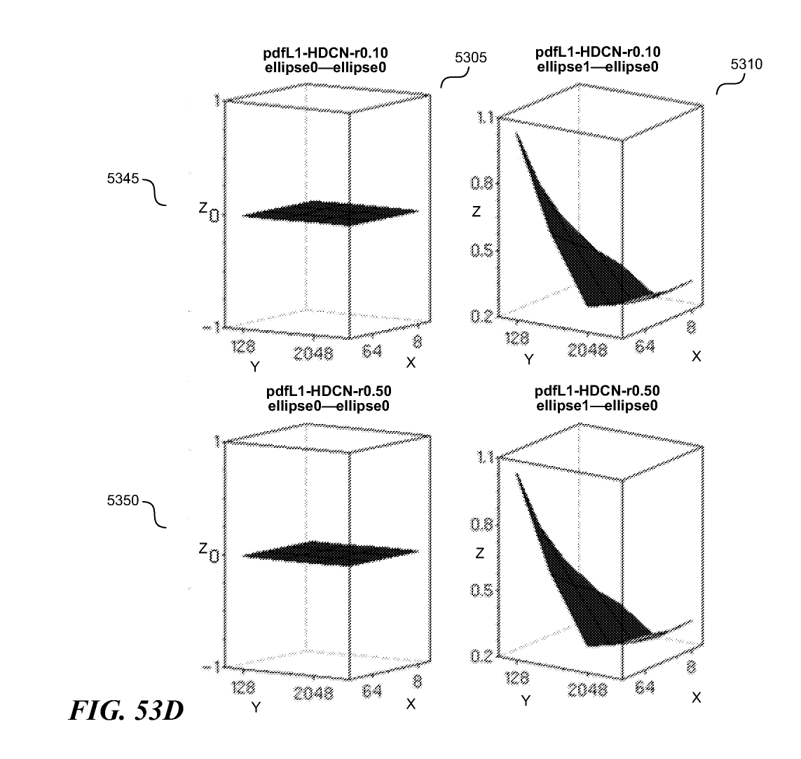

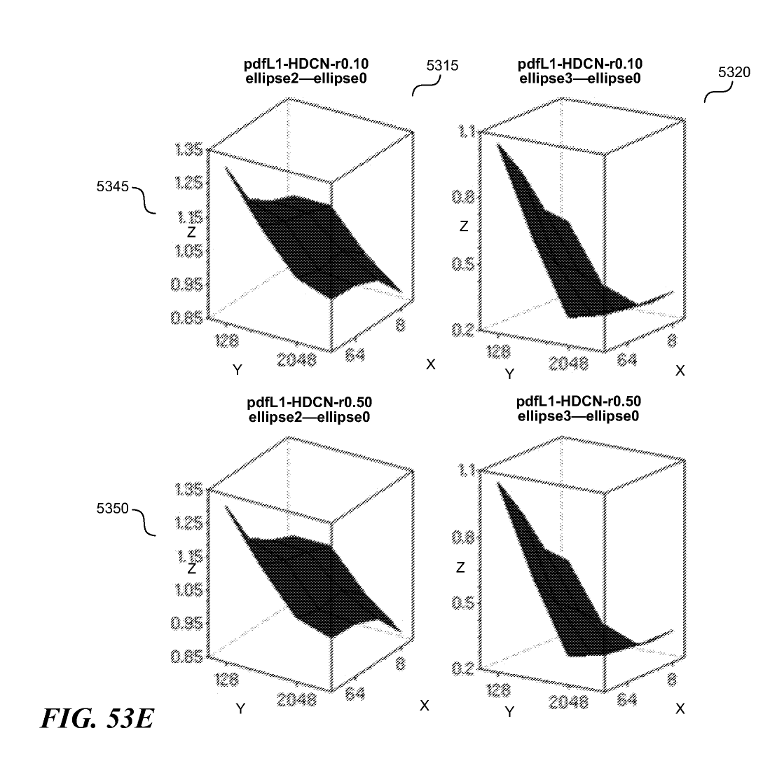

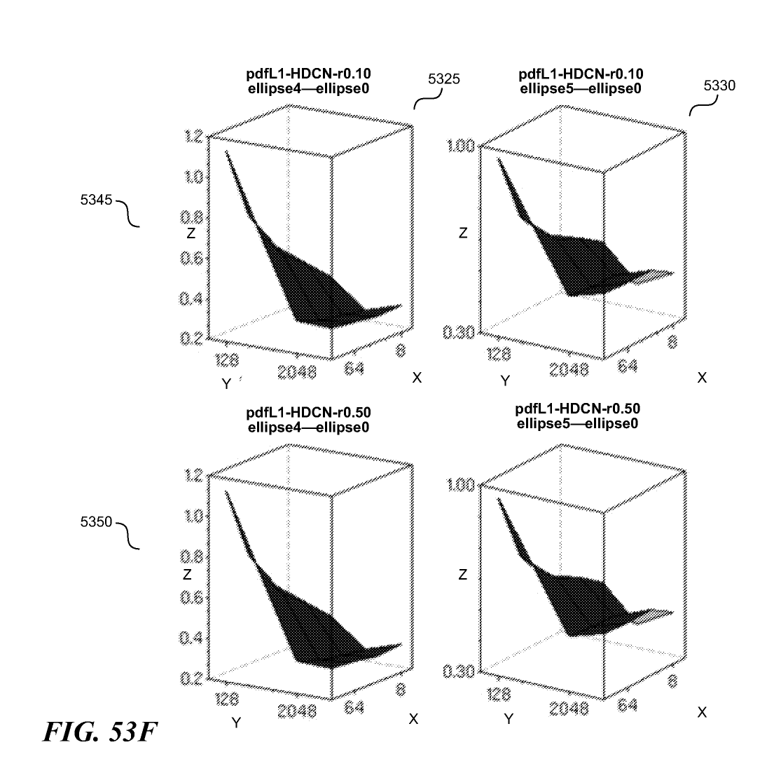

FIG. 53 includes difference score landscapes in columns 5305-5330 and rows 5335-5350 generated according to the HDCN sampling function for the models of FIG. 14. Landscapes in each column 5305-5330 correspond to a comparison between a common pair of models. Landscapes in column 5305 correspond to a comparison between Ellipse0 and itself; landscapes in column 5310 correspond to a comparison between Ellipse1 and Ellipse0; landscapes in column 5315 correspond to a comparison between Ellipse2 and Ellipse0; landscapes in column 5320 correspond to a comparison between Ellipse3 and Ellipse0; landscapes in column 5325 correspond to a comparison between Ellipse4 and Ellipse0; and landscapes in column 5330 correspond to a comparison between Ellipse5 and Ellipse0.

Landscapes in each row 5335-5350 correspond to a common radius ratio, selected from the set comprised of 0.01, 0.05, 0.10, and 0.50. Landscapes in row 5335 correspond to the radius ratio of 0.01; landscapes in row 5340 correspond to the radius ratio of 0.05; landscapes in row 5345 correspond to the radius ratio of 0.10; and landscapes in row 5350 correspond to the radius ratio of 0.50.

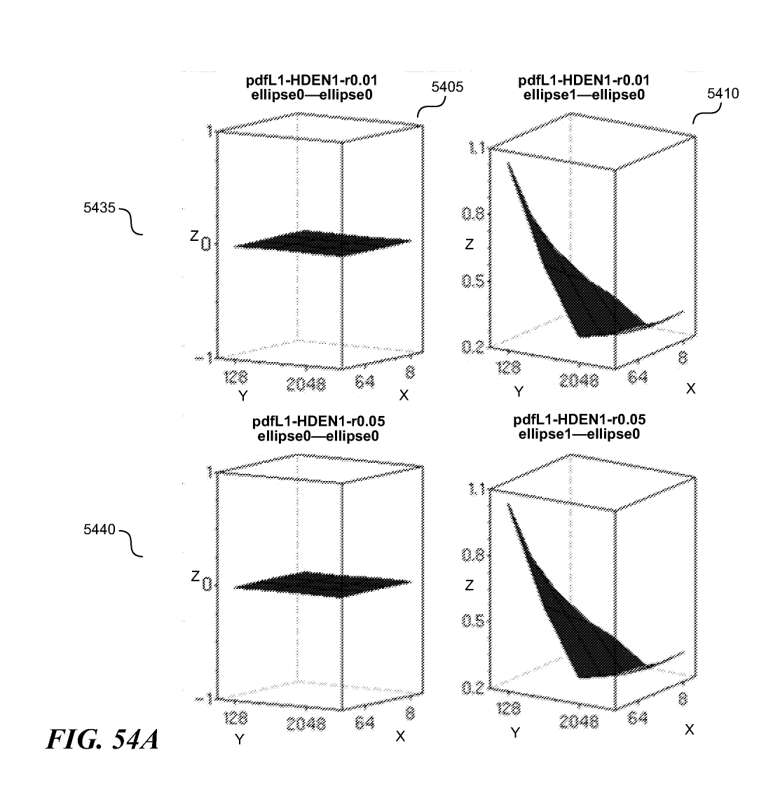

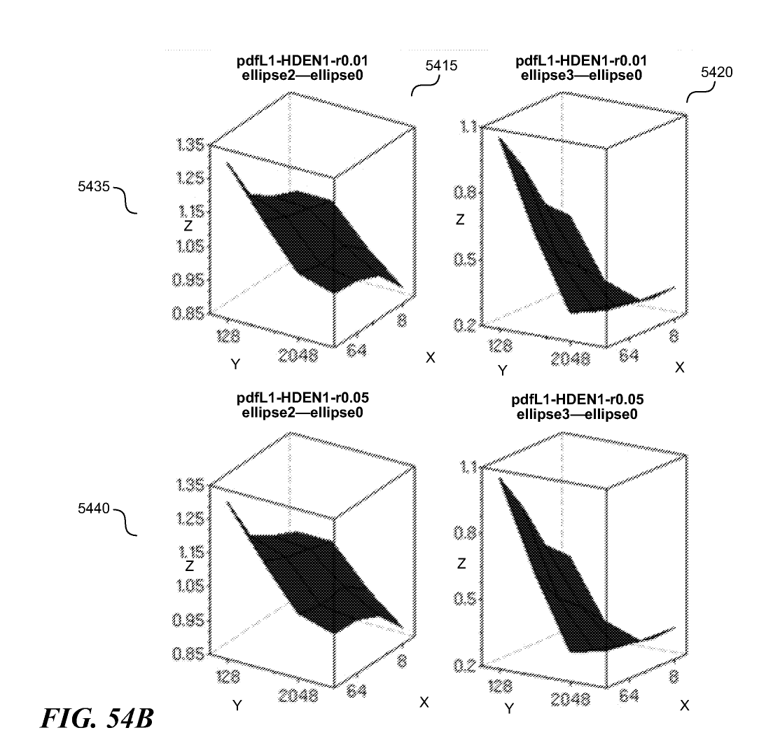

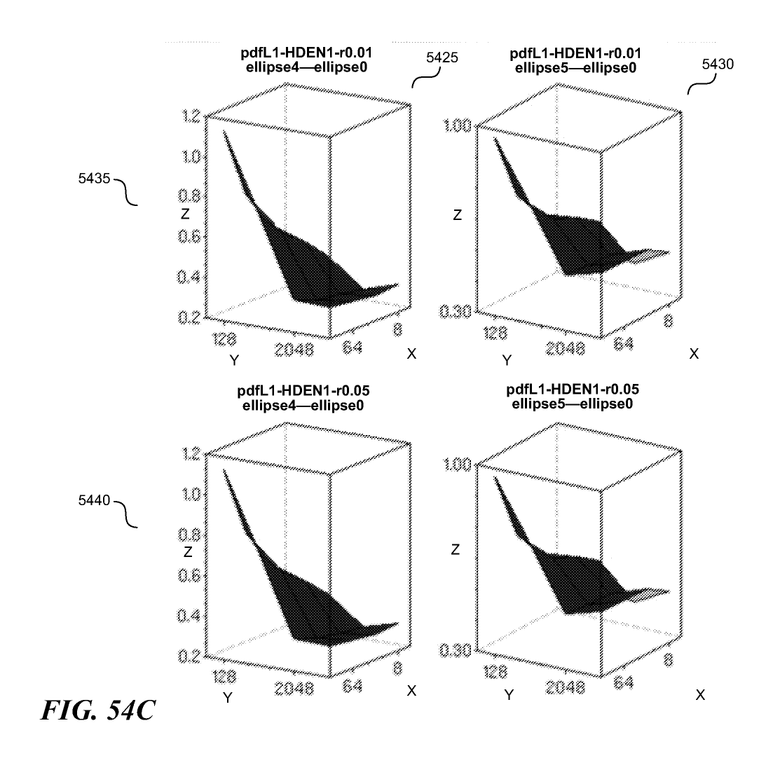

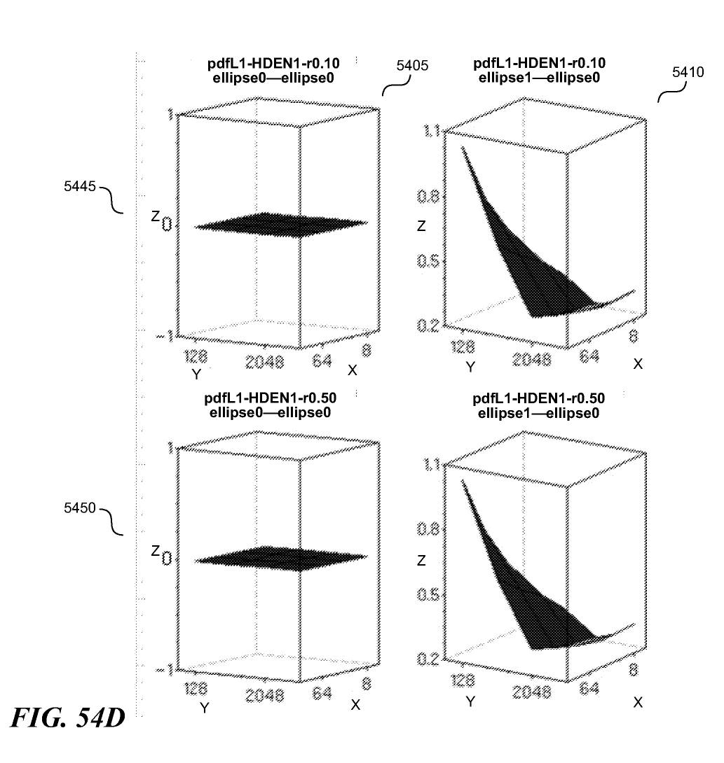

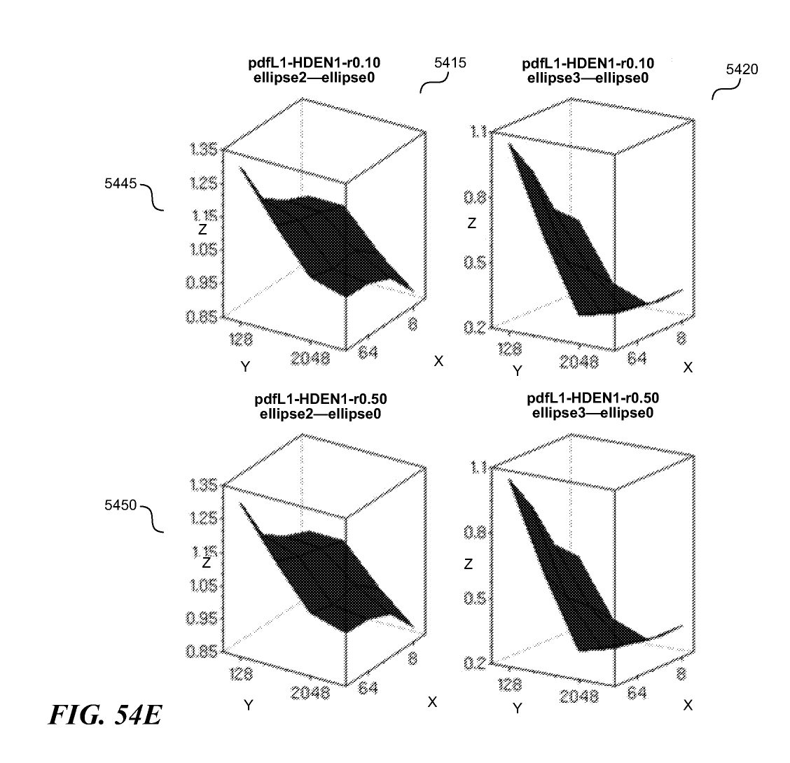

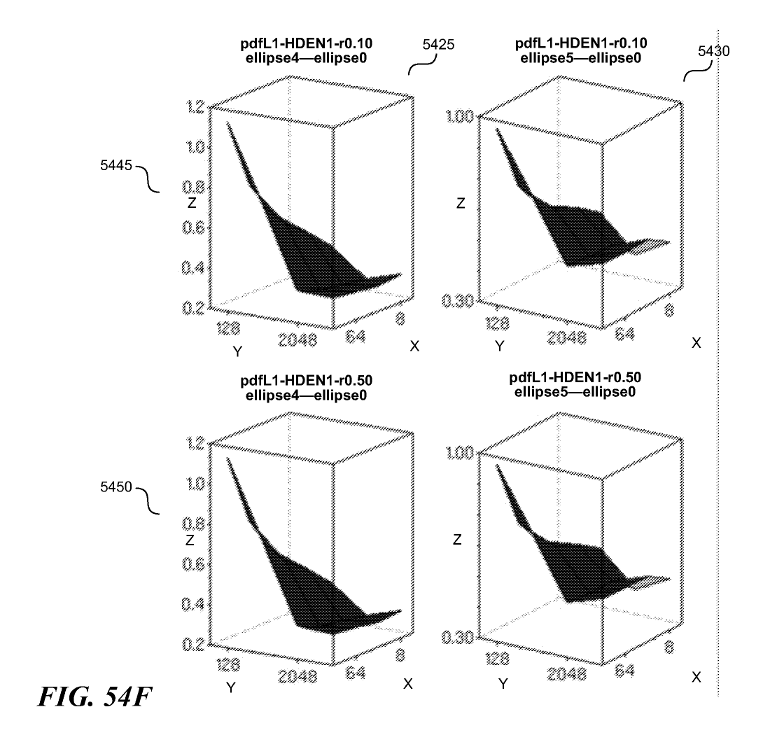

FIG. 54 includes difference score landscapes in columns 5405-5430 and rows 5435-5450 generated according to the HDEN1 sampling function for the models of FIG. 14. Landscapes in each column 5405-5430 correspond to a comparison between a common pair of models. Landscapes in column 5405 correspond to a comparison between Ellipse0 and itself; landscapes in column 5410 correspond to a comparison between Ellipse1 and Ellipse0; landscapes in column 5415 correspond to a comparison between Ellipse2 and Ellipse0; landscapes in column 5420 correspond to a comparison between Ellipse3 and Ellipse0; landscapes in column 5425 correspond to a comparison between Ellipse4 and Ellipse0; and landscapes in column 5430 correspond to a comparison between Ellipse5 and Ellipse0.

Landscapes in each row 5435-5450 correspond to a common radius ratio, selected from the set comprised of 0.01, 0.05, 0.10, and 0.50. Landscapes in row 5435 correspond to the radius ratio of 0.01; landscapes in row 5440 correspond to the radius ratio of 0.05; landscapes in row 5445 correspond to the radius ratio of 0.10; and landscapes in row 5450 correspond to the radius ratio of 0.50.

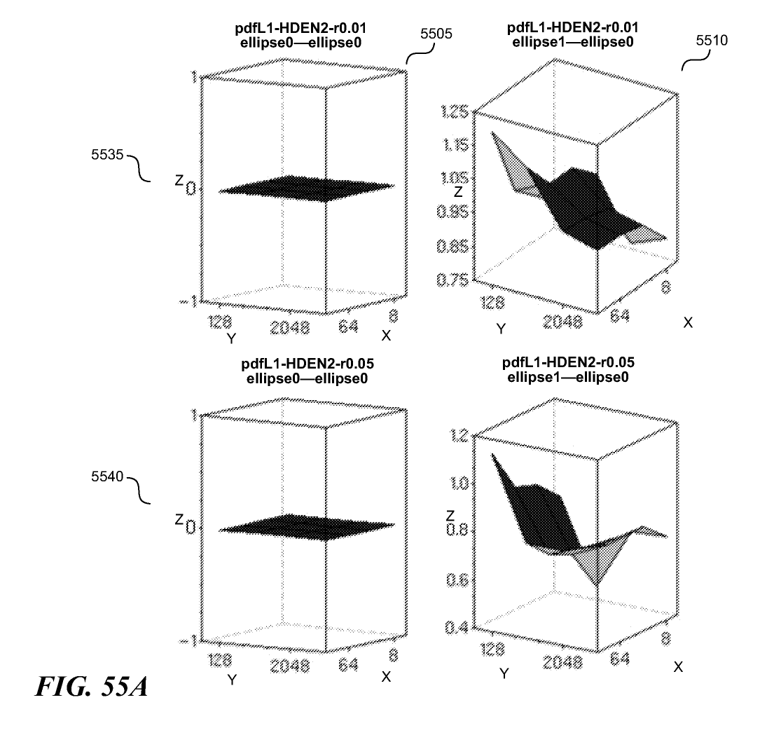

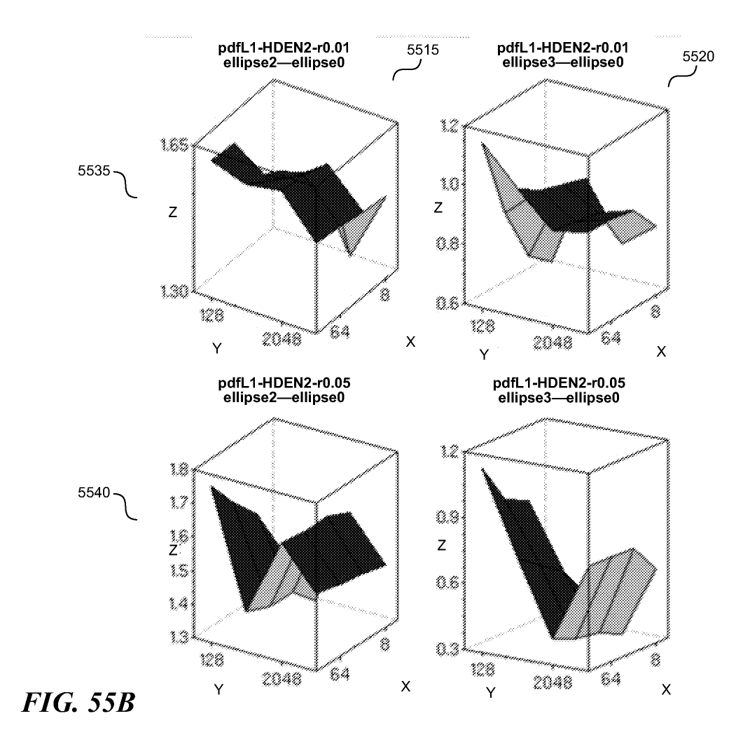

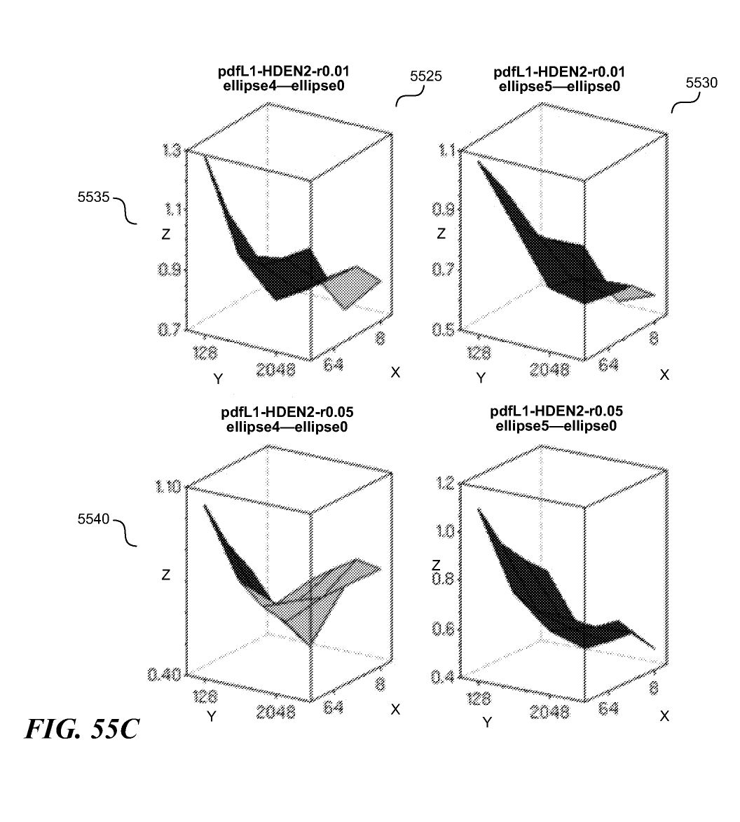

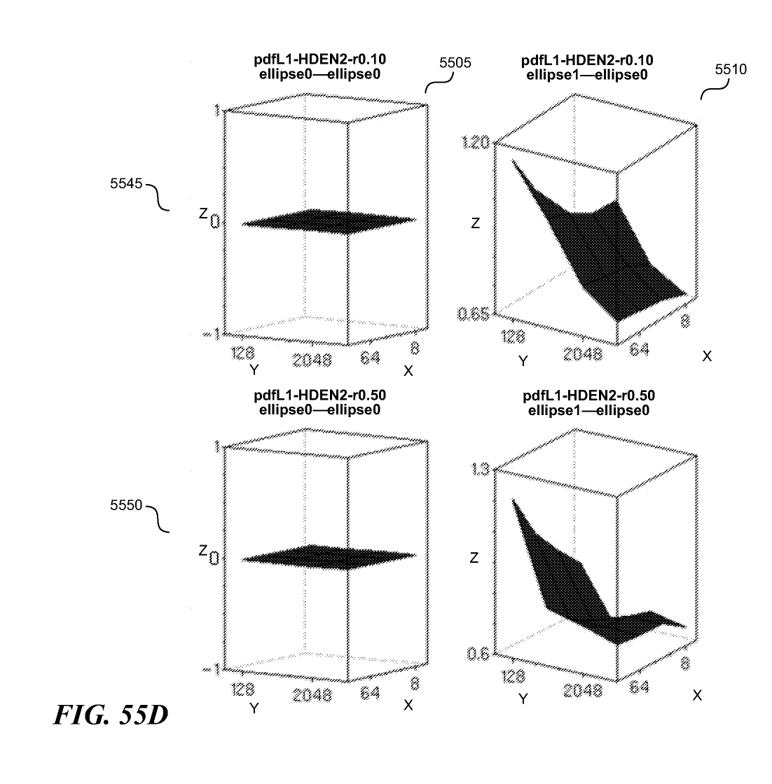

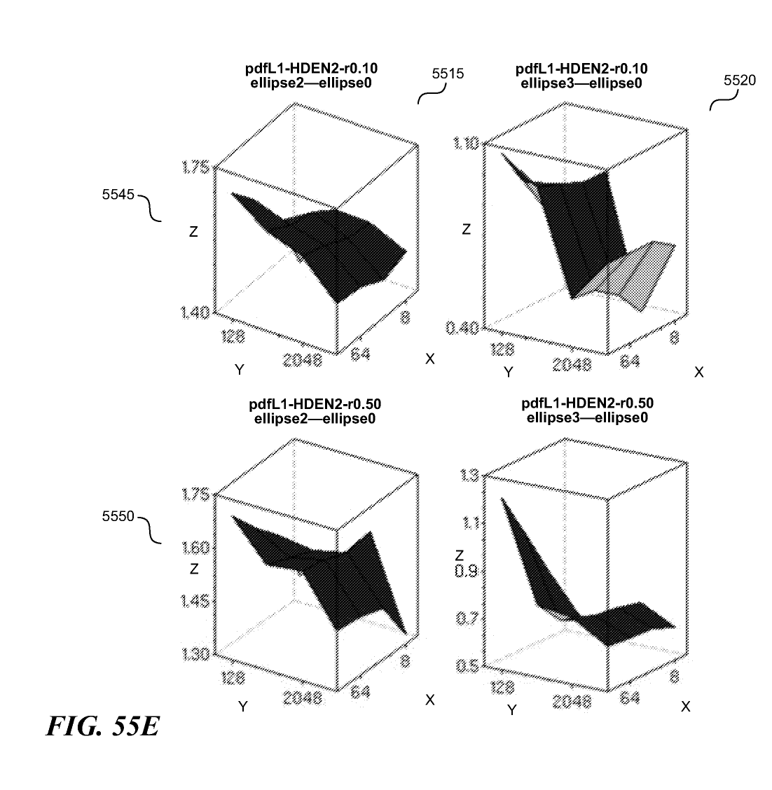

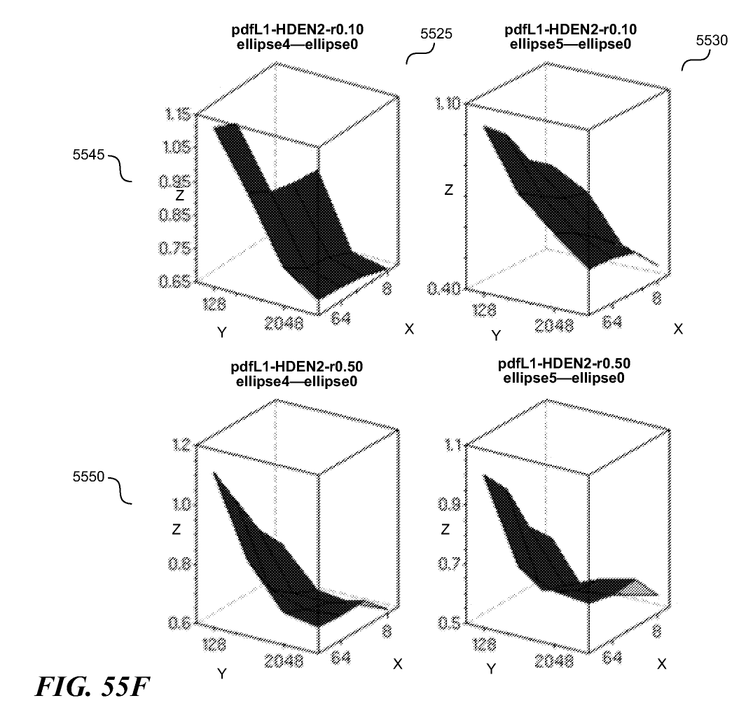

FIG. 55 includes difference score landscapes in columns 5505-5530 and rows 5535-5550 generated according to the HDEN2 sampling function for the models of FIG. 14. Landscapes in each column 5505-5530 correspond to a comparison between a common pair of models. Landscapes in column 5505 correspond to a comparison between Ellipse0 and itself; landscapes in column 5510 correspond to a comparison between Ellipse1 and Ellipse0; landscapes in column 5515 correspond to a comparison between Ellipse2 and Ellipse0; landscapes in column 5520 correspond to a comparison between Ellipse3 and Ellipse0; landscapes in column 5525 correspond to a comparison between Ellipse4 and Ellipse0; and landscapes in column 5530 correspond to a comparison between Ellipse5 and Ellipse0.

Landscapes in each row 5535-5550 correspond to a common radius ratio, selected from the set comprised of 0.01, 0.05, 0.10, and 0.50. Landscapes in row 5535 correspond to the radius ratio of 0.01; landscapes in row 5540 correspond to the radius ratio of 0.05; landscapes in row 5545 correspond to the radius ratio of 0.10; and landscapes in row 5550 correspond to the radius ratio of 0.50.

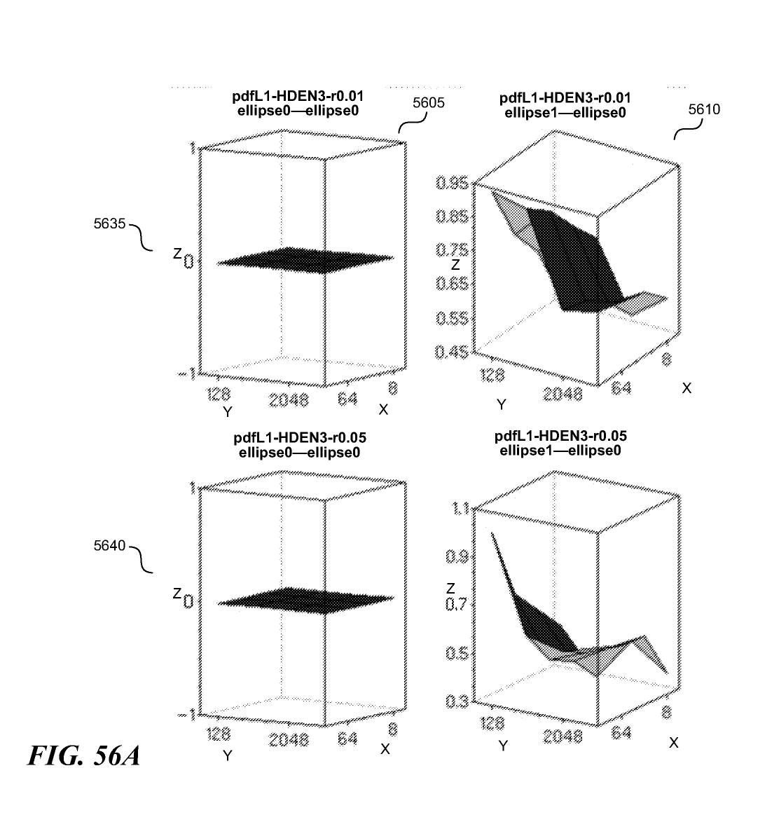

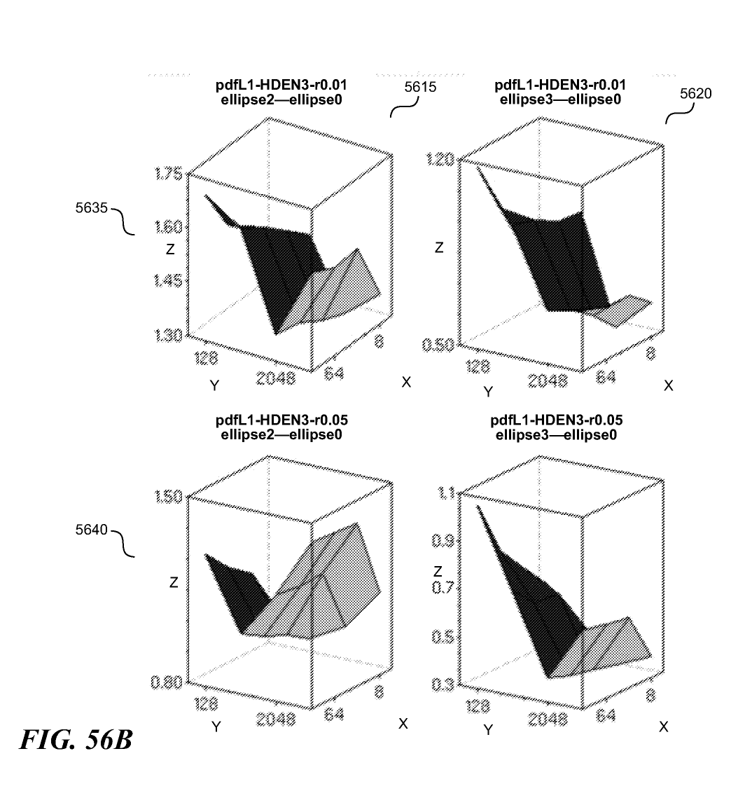

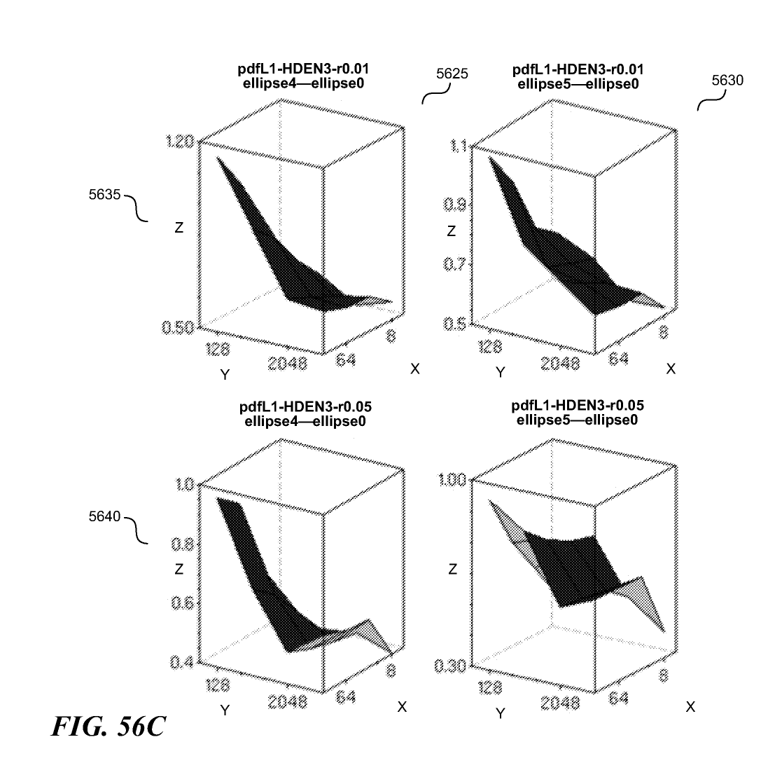

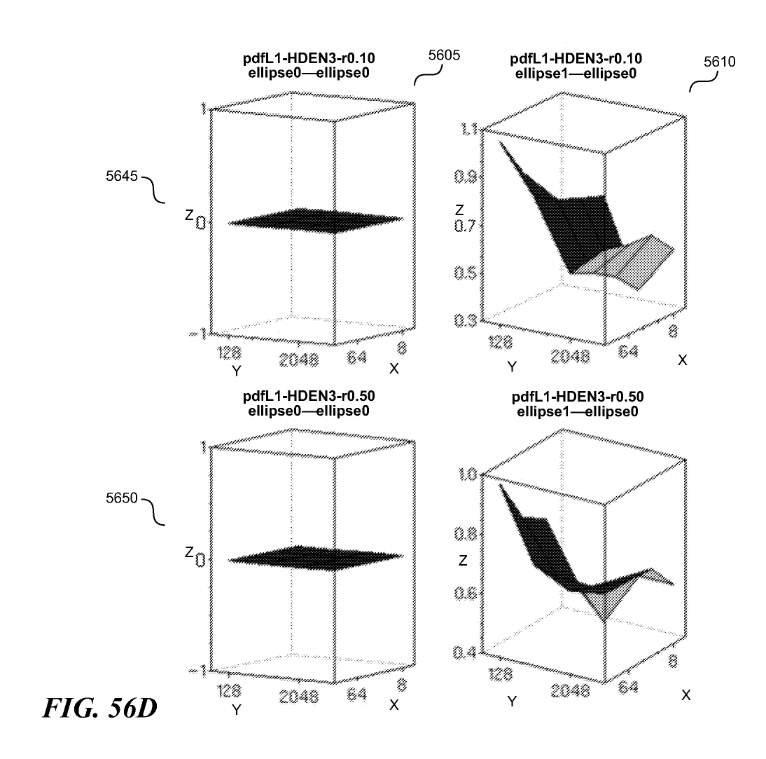

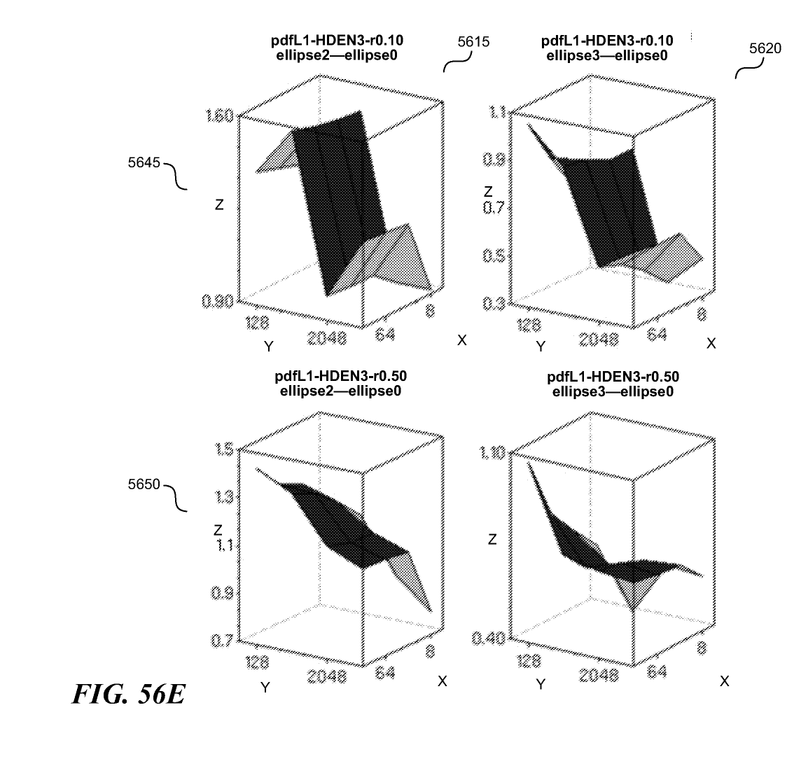

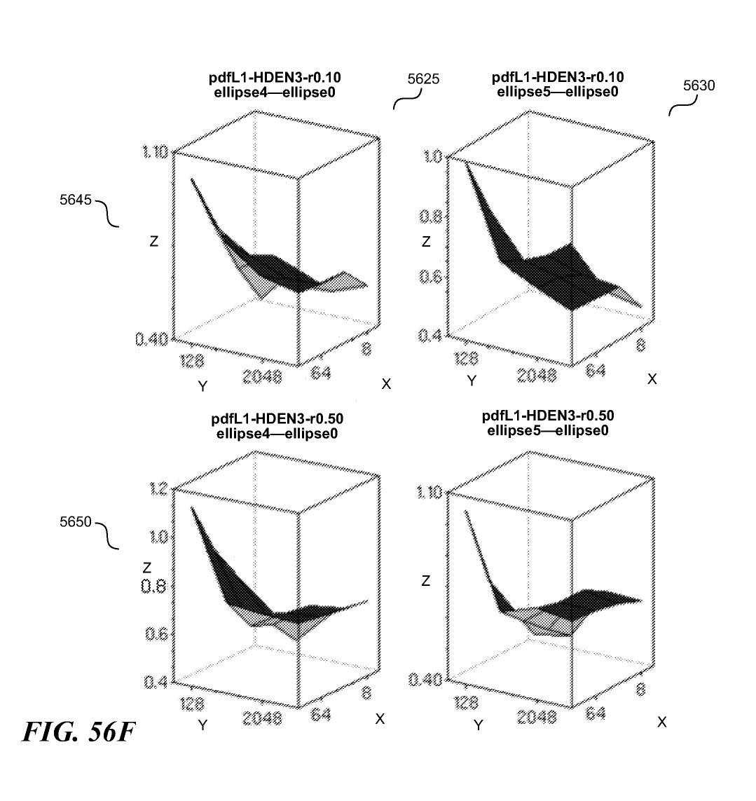

FIG. 56 includes difference score landscapes in columns 5605-5630 and rows 5635-5650 generated according to the HDEN3 sampling function for the models of FIG. 14. Landscapes in each column 5605-5630 correspond to a comparison between a common pair of models. Landscapes in column 5605 correspond to a comparison between Ellipse0 and itself; landscapes in column 5610 correspond to a comparison between Ellipse1 and Ellipse0; landscapes in column 5615 correspond to a comparison between Ellipse2 and Ellipse0; landscapes in column 5620 correspond to a comparison between Ellipse3 and Ellipse0; landscapes in column 5625 correspond to a comparison between Ellipse4 and Ellipse0; and landscapes in column 5630 correspond to a comparison between Ellipse5 and Ellipse0.

Landscapes in each row 5635-5650 correspond to a common radius ratio, selected from the set comprised of 0.01, 0.05, 0.10, and 0.50. Landscapes in row 5635 correspond to the radius ratio of 0.01; landscapes in row 5640 correspond to the radius ratio of 0.05; landscapes in row 5645 correspond to the radius ratio of 0.10; and landscapes in row 5650 correspond to the radius ratio of 0.50.

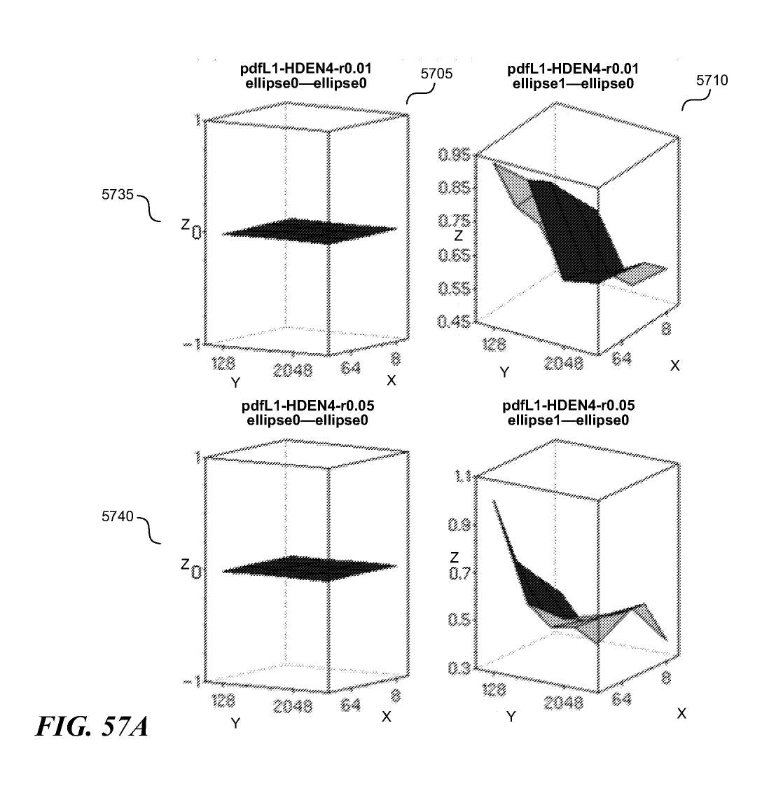

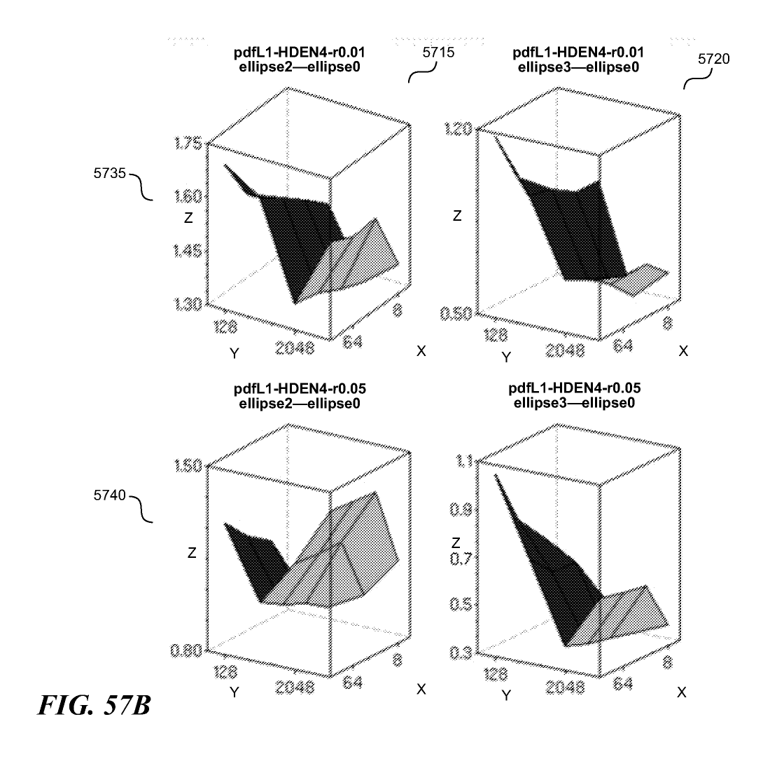

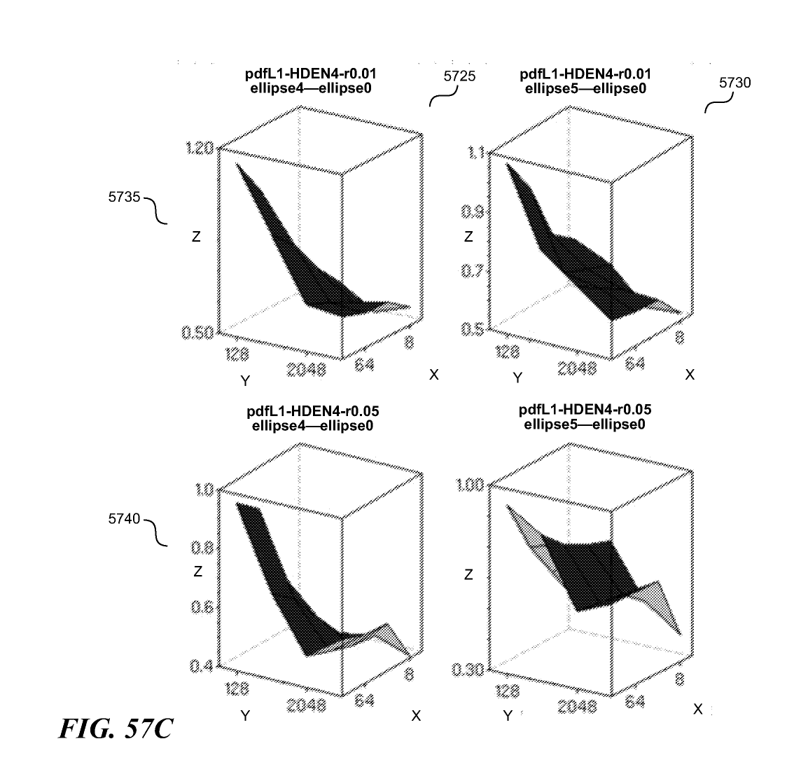

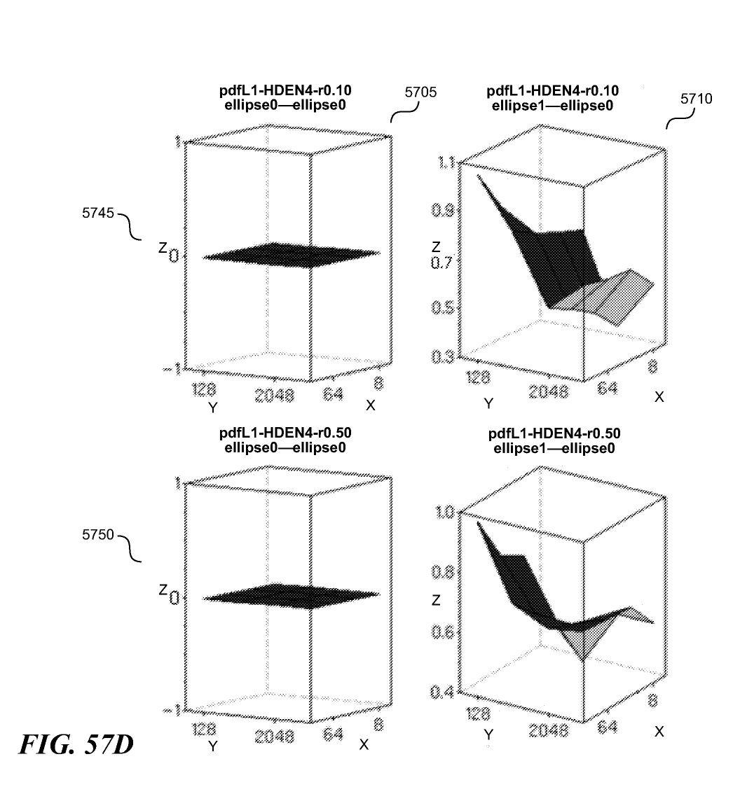

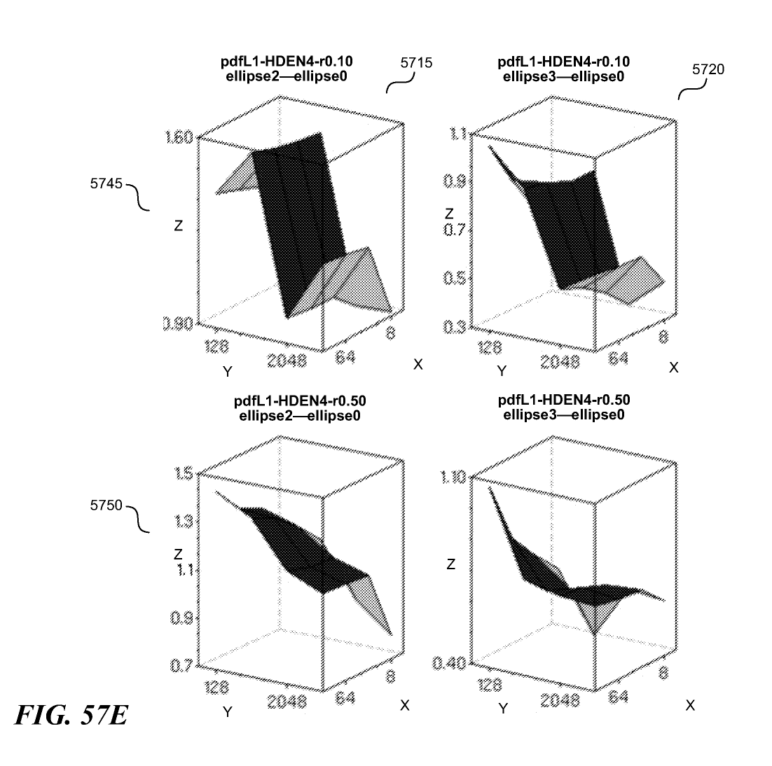

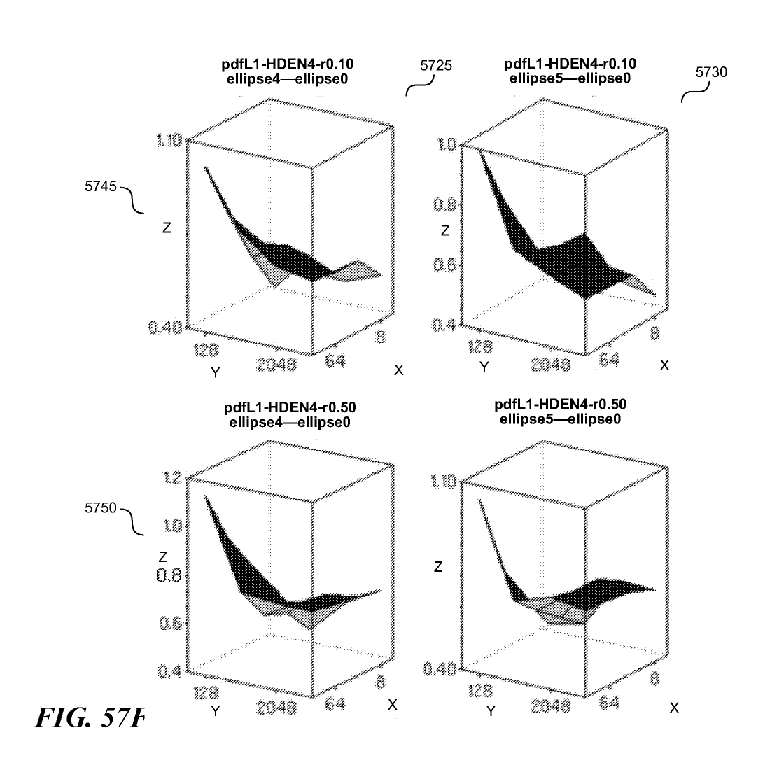

FIG. 57 includes difference score landscapes in columns 5705-5730 and rows 5735-5750 generated according to the HDEN4 sampling function for the models of FIG. 14. Landscapes in each column 5705-5730 correspond to a comparison between a common pair of models. Landscapes in column 5705 correspond to a comparison between Ellipse0 and itself; landscapes in column 5710 correspond to a comparison between Ellipse1 and Ellipse0; landscapes in column 5715 correspond to a comparison between Ellipse2 and Ellipse0; landscapes in column 5720 correspond to a comparison between Ellipse3 and Ellipse0; landscapes in column 5725 correspond to a comparison between Ellipse4 and Ellipse0; and landscapes in column 5730 correspond to a comparison between Ellipse5 and Ellipse0.

Landscapes in each row 5735-5750 correspond to a common radius ratio, selected from the set comprised of 0.01, 0.05, 0.10, and 0.50. Landscapes in row 5735 correspond to the radius ratio of 0.01; landscapes in row 5740 correspond to the radius ratio of 0.05; landscapes in row 5745 correspond to the radius ratio of 0.10; and landscapes in row 5750 correspond to the radius ratio of 0.50.

D. Analysis of Results

i. Difference Distributions

In the illustrated embodiments, the HDCN sampling function performs more effectively in discriminating between the ellipses than in discriminating between the bugs. The difference in the effectiveness of HDCN is due in part to the differences in the volume of each color in the models. For the bugs, each color has the same volume for each bug. For the ellipses, each color has a different volume. Ellipse1, Ellipse3, and Ellipse4 have colors with approximately the same proportions of volume, while Ellipse0, Ellipse2, and Ellipse5 have colors with different proportions of volume. As a result, as depicted in FIGS. 21-26, the differences between the MODD spatial difference score and the HDCN score are generally smaller than 0.05.

On the other hand, as depicted in FIGS. 32 (comparing Ellipse1 and Ellipse2), 36 (comparing Ellipse2 and Ellipse3), 37 (comparing Ellipse2 and Ellipse4), and 38 (comparing Ellipse2 and Ellipse5), the differences between the MODD spatial difference score and the HDCN score are relatively distinct. However, for the ellipses with similar proportions of volume, as depicted by FIGS. 33 (comparing Ellipse1 and Ellipse3), 34 (comparing Ellipse1 and Ellipse4), and 39 (comparing Ellipse3 and Ellipse4), the difference between the MODD spatial difference score and the HDCN score are relatively small.

Accordingly, for models that have similar color patterns, color distributions, and overall model volumes, the HDCN sampling function may reflect the similarity of a general pattern between models. However, depending on the models, the choice of the constant color value for the fixed data point B may affect the resultant difference scores. For example, in the illustrated embodiments, if blue were selected as the constant color value, the HDCN sampling function would not detect the differences between the ellipses or between the bugs, as blue is not a color that varies between either type of model.

In cases where the HDCN sampling function does not discriminate effectively between models, the HDEN and MODD sampling functions generally discriminate more effectively. The effectiveness of the HDEN and MODD sampling functions is generally radius ratio dependent. As illustrated by FIGS. 27 through 41 (comparisons between ellipses), HDEN3 and HDEN4 difference scores are generally higher than HDEN2 difference scores. As illustrated by FIGS. 21 through 26 (comparisons between bugs), HDEN3 difference scores are generally higher than HDEN1, HDEN2, and HDEN4 difference scores. Accordingly, including more nominal values representative of the differences between the models increases the overall difference scores for the HDEN sampling functions. In FIGS. 21 through 26, the HDEN4 sampling function does not perform better than the HDEN3 sampling function because the fourth color is yellow, whose portion remains the same for all bugs. Adding yellow to the distribution tends to average out the difference scores.

As illustrated by FIGS. 21 through 41, the MODD sampling function effectively displays the relationships between the spatial pattern and the nominal pattern of the corresponding model. However, the MODD sampling function does not necessarily outperform the HDEN sampling function, at least in the illustrated embodiment. Separating continuous attributes from nominal attributes in the MODD sampling function may sacrifice the positional information implied in the original nominal attribute values.

Each of the sampling functions described herein may be applied in a variety of circumstances. In some embodiments, the system selects a sampling function that is most suited to the circumstances. For example, among other circumstances, the HDCN sampling function is applicable for comparing a general pattern of nominal attributes according to a suitable constant nominal value. Among other circumstances, the HDEN and MODD sampling functions are applicable to discriminate between complex nominal attributes. In some embodiments, the HDEN and MODD sampling functions achieve improved performance where only the nominal attributes that distinguish the models are included.

ii. Radius Ratios

The HDEN and MODD sampling functions are radius-sensitive, while the HDCN sampling function is not. As illustrated in FIGS. 27 through 41 (comparisons between ellipses), HDEN3 and HDEN4 difference scores are generally higher when the radius ratio is around 0.3, while the MODD nominal (color) difference scores are generally higher when the radius ratio is around 0.03 or 0.05. As illustrated in FIGS. 21 through 26 (comparisons between bugs), both the HDEN difference scores and the MODD nominal difference scores vary irregularly throughout the difference radius ratios. Selecting an appropriate radius ratio (or ratios) tailors the discrimination effectiveness of a sampling function to the different attribute resolution levels in the compared models.

FIGS. 10-13 illustrate the sensitivity of the radius ratio in the MODD sampling function. FIG. 10 includes histograms based on the nominal attribute values, while FIGS. 11-13 include sub-histograms that are concatenated to form such histograms. FIGS. 11-13 correspond to radius ratios of 0.03, 0.05, and 0.07, respectively. Because the distance between the two center legs on each side of the model (greater than 5% of the maximum distance in the model) is slightly greater than the distance between the two upper and lower pairs of legs (less than 5% of the maximum distance in the model), the radius ratio of 0.05 is an important point for discriminating between the models.

As illustrated by FIG. 12, sub-histograms 1212 and 1220 (Bug1) and 1216 and 1224 (Bug3) have different distribution patterns than sub-histograms 1210 and 1218 (Bug0) and 1214 and 1222 (Bug2). Sub-histograms 1212, 1220, 1216, and 1224 each have one fewer “spike” than sub-histograms 1210, 1218, 1214, and 1222. The missing spike is due to the difference in distance between the red legs and the green legs. For example, there are no local geometric landscapes generated between the red and green legs for Bug0 or Bug2 when the radius ratio is 0.05, because the distance between the two center legs on both sides of the bugs is greater than 5% of the maximum distance in the model. However, if the radius ratio is increased or decreased, to 0.07 as depicted in FIG. 13 or to 0.03 as depicted in FIG. 11, the pattern difference between the models disappears. In FIG. 11 the spikes are missing for all models due to the small radius ratio, while in FIG. 13 the same spikes appear for all models due to the larger radius ratio.

iii. Distribution Test Functions

As illustrated by FIGS. 21-41, the maximum difference scores generated according to the pdfL1 test function are generally higher than those generated by the chi, bha, and pdfL2 test functions. Accordingly, in some embodiments, the pdfL1 test function outperforms the other test functions, providing a greater range of difference scores for facilitating discrimination between models.

iv. Shape Generation, Number of Samples, and Number of Bins

As illustrated by FIGS. 42-57, as the number of samples and bins increases, the spatial difference scores decrease. However, the average difference scores are generally higher than the corresponding continuous difference scores, based at least in part on the incorporation of nominal attribute values into the average difference scores. Among other things, these results demonstrate that the described technology effectively discriminates between models with different non-spatial (nominal) features.

### 4. CONCLUSION

From the foregoing, it will be appreciated that specific embodiments of the technology have been described herein for purposes of illustration, but that various modifications may be made without deviating from the spirit and scope of the described technology. For example, those skilled in the art will appreciate that a variety of sampling functions, distribution test functions, and/or other equations and/or algorithms other than those described herein may be implemented in accordance with the technology described herein. Those skilled in the art will further appreciate that the depicted flow diagrams may be altered in a variety of ways. For example, the order of the blocks may be rearranged, blocks may be performed in parallel, blocks may be omitted, or other blocks may be included. Accordingly, the described technology is not limited except as by the appended claims.

I/We claim:

1. A method in a computing system for generating a difference distribution, the method comprising:
receiving by the computing system a model, wherein the model comprises at least one non-spatial attribute;
selecting by the computing system a sampling function, wherein the sampling function measures a difference between values of the non-spatial attribute associated with two or more data samples selected from the model; and
generating by the computing system a histogram that represents the model by applying the selected sampling function to multiple groups of two or more data samples selected from the model.

2. The method of claim 1 wherein the model is generated according to a genetic simulation.

3. The method of claim 1 wherein the at least one non-spatial attribute comprises a physical attribute.

4. The method of claim 1 wherein the at least one non-spatial attribute comprises a chemical attribute.

5. The method of claim 1 wherein the at least one non-spatial attribute comprises a dynamic attribute.

6. The method of claim 1 wherein the model further comprises at least one spatial attribute.

7. The method of claim 1, further comprising:
displaying the histogram on a display device coupled to the computing system.

8. A computer-readable storage medium having stored thereon computer-executable instructions that, if executed by a computing system, generating difference distributions by:
receiving multiple models, wherein a model comprises at least one non-spatial attribute;
selecting a sampling function, wherein the sampling function measures a difference between values of the non-spatial attribute associated with two or more data samples selected from a model; and
for individual of the multiple models, applying the selected sampling function to multiple groups of two or more data samples selected from the model to generate a frequency distribution that represents the model.

9. The computer-readable storage medium of claim 8 wherein the model is generated by a genetic simulation system.

10. The computer-readable storage medium of claim 8 wherein the at least one non-spatial attribute comprises a continuous attribute.

11. The computer-readable storage medium of claim 8 wherein the at least one non-spatial attribute comprises a nominal attribute.

12. The computer-readable storage medium of claim 8 wherein the sampling function incorporates both a continuous attribute and a nominal attribute of the model.

13. The computer-readable storage medium of claim 8 wherein the sampling function separates continuous attributes and nominal attributes of the model.

14. The computer-readable storage medium of claim 8, further comprising:
selecting at least two generated frequency distributions;
selecting a distribution test function, wherein the distribution test function measures similarity of frequency distributions; and
comparing the selected frequency distributions by applying the selected distribution test function to the selected frequency distributions.

15. The computer-readable storage medium of claim 14 wherein the comparing further comprises generating a graph comparing the selected frequency distributions.

16. The computer-readable storage medium of claim 15, further comprising:
displaying the graph on a display device coupled to the computing system.

17. A method in a computing system for determining model fitness, the method comprising:
receiving by the computing system at least two histograms, wherein each histogram represents a model comprising at least one non-spatial attribute;
selecting by the computing system a distribution test function, wherein the distribution test function measures histogram similarity;
comparing by the computing system the received histograms by applying the selected distribution test function to the histograms; and
based at least in part on the comparison, determining by the computing system the fitness of the model represented by at least one of the received histograms.

18. The method of claim 17, further comprising:
taking by the computing system an action associated with the model, wherein the action is based at least in part on the determination of the fitness of the model.

19. The method of claim 17 wherein the model is generated by a genetic simulation system.

20. The method of claim 17 wherein the at least one non-spatial attribute comprises a physical attribute.

21. The method of claim 17 wherein the at least one non-spatial attribute comprises a chemical attribute.

22. The method of claim 17 wherein the at least one non-spatial attribute comprises a dynamic attribute.

23. A computing system for searching a model database using difference distributions, wherein the system comprises:
a database configured to store a plurality of identified models, wherein each of the models includes at least one non-spatial feature, and wherein each of the identified models is associated with a histogram that represents the identified model;
an input component configured to receive a model for a query against the database;
a histogram generation component configured to:
select a sampling function; and
generate a histogram that represents the received model by applying the selected sampling function to the received model; and
a search component configured to execute the query against the database, wherein the executing comprises:
comparing the generated histogram with the histograms associated with the identified models; and
based on the comparison, identifying one or more of the identified models that are similar to the received model.

24. The computing system of claim 23 wherein the identified models and the received model are objects.

25. The computing system of claim 23 wherein the identified models and the received model are patterns.

26. The computing system of claim 23 wherein the identified models and the received model are data sets.

27. The computing system of claim 23 wherein the sampling function measures a difference between values of the non-spatial attribute associated with two or more data samples selected from the received model, and
wherein applying the selected sampling function to the received model comprises applying the selected sampling function to multiple groups of two or more data samples selected from the received model.

28. The computing system of claim 23 wherein comparing the generated histogram with the histograms associated with the identified models comprises:
selecting a distribution test function, wherein the distribution test function measures histogram similarity; and
for individual of the histograms associated with the identified models, applying the selected distribution test function to the generated histogram and the individual histogram.

29. A method in a computing system for comparing difference distributions to assess fitness or similarity in a search performed on the computer system, wherein the method comprises:
receiving by the computing system a candidate model, wherein the candidate model comprises at least one non-spatial attribute;
generating by the computing system a histogram for the received candidate model, wherein the histogram is generated by applying a sampling function to the candidate model;
performing by the computing system a search against a target model, wherein the target model comprises at least one spatial attribute, and wherein the search comprises comparing the generated histogram to a target histogram representing the target model.

30. The method of claim 29, further comprising:
retrieving the target object from a database coupled to the computing system.

31. The method of claim 29 wherein the candidate model and the target model are generated by a genetic simulation system.

32. The method of claim 29 wherein the candidate model and the target model are objects.

33. The method of claim 29 wherein the candidate model and the target model are patterns.

34. The method of claim 29 wherein the candidate model and the target model are data sets.
